(19) United States
(12) Patent Application Publication
(10) Pub. No.: US 2026/0266164 A1
(43) Pub. Date: Sep. 10, 2026

(54) SYSTEMS AND METHODS FOR PREDICTING AND CONTROLLING INDUCED SEISMIC EVENTS BY ADJUSTING WELL OPERATIONS

(71) Applicant: Berger Geosciences, LLC, Houston, TX (US)

(72) Inventors: William J. Berger, III, Spring, TX (US); Norman E. Wells, JR., Houston, TX (US); Oladayo O. Komolafe, Houston, TX (US); Zachary I. Metz, Magnolia, TX (US); William J. Berger, II, Stagecoach, TX (US)

(73) Assignee: Berger Geosciences, LLC, Houston, TX (US)

(21) Appl. No.: 19/558,353

(22) Filed: Mar. 5, 2026

Related U.S. Application Data
(60) Provisional application No. 63/767,977, filed on Mar. 6, 2025.

(51) Int. Cl. E21B 43/12

(52) U.S. Cl. CPC E21B 43/12; E21B 2200/20; E21B 2200/22

(57) ABSTRACT

A system for predicting and controlling induced seismic events trains a predictive model to learn a relationship between (i) well parameters of historical wells that operate to inject fluid into or produce fluid from underground geological formations within a geographic area during a historical time period and (ii) seismic events occurring within the geographic area during the historical time period. The system uses the predictive model to predict a new seismic event predicted to occur within the geographic area during a future time period as a result of operating controlled wells to inject fluid into or produce fluid from the underground geological formations within the geographic area during the future time period. The system adjusts the controlled wells to prevent the new seismic event from occurring or mitigate an impact of the new seismic event during the future time period.

### CROSS-REFERENCE TO RELATED PATENT APPLICATION

This application claims the benefit of and priority to U.S. Provisional Patent Application No. 63/767,977 filed Mar. 6, 2025, the entire disclosure of which is incorporated by reference herein.

### BACKGROUND

The present disclosure relates generally to systems and methods for monitoring and controlling wells that operate to inject fluid into underground geological formations or produce fluid from the underground geological formations. The present disclosure relates more particularly to systems and methods for monitoring and controlling wells to reduce or mitigate induced seismic events and/or other subsurface pressure-related issues caused by injection well operations or production well operations.

An injection well is a specialized, engineered structure configured for the controlled injection of fluid into underground geological formations. An injection well typically includes a vertically oriented wellbore that extends from the earth's surface through multiple subsurface strata to a target injection zone, typically located within a porous and permeable rock formation. The injection well system is designed to safely introduce fluids, such as water, brine, carbon dioxide, or other liquids, for storage, disposal, or enhanced recovery processes. A production well is similar to an injection well but operates to extract or produce fluids from underground geological formations rather than inject fluids.

Induced seismic events, or human-caused earthquakes, can occur as a result of injection well or production well activities. Induced seismic events can damage buildings, infrastructure, and critical facilities such as dams or power plants. Induced seismic events can also present public safety risks by increasing the likelihood of injuries and fatalities, especially in populated areas. Seismic activity can trigger landslides, groundwater contamination, or changes in subsurface geology, affecting ecosystems and water resources. Increased seismicity can raise insurance costs, deter investment in affected areas, and lead to operational restrictions on industries contributing to the issue. Communities near induced seismicity hotspots may resist industrial activities, leading to social conflicts and regulatory pressure. Injection well activities or production well activities can also lead to other types of subsurface pressure-related issues such as ground deformation, changes in fluid migration patterns, damage to subsurface pipelines or equipment, and/or various other issues caused by increased or decreased subsurface pressures.

Existing technologies in the field of well monitoring and control systems typically use data from seismic monitoring stations and/or wellsite monitoring equipment to detect problems which have already occurred, such as earthquakes or well leaks. Wellsite operators then must respond to these events retroactively and must repair or replace any wellsite equipment that has been damaged as a result of the detected problems. Existing technologies only allow for a retroactive response after an induced seismic event occurs and the damage caused by the event has already been incurred, both to the wellsite equipment and to any critical infrastructure or buildings in the surrounding geographic region.

### SUMMARY

One implementation of the present disclosure is a system for predicting and controlling induced seismic events. The system includes one or more processors and one or more non-transitory computer-readable storage media storing instructions that, when executed by the one or more processors, cause the one or more processors to perform operations. The operations include training a predictive model to learn a relationship between (i) well parameters of one or more historical injection wells that operate to inject fluid into underground geological formations within a geographic area during a historical time period and (ii) seismic events occurring within the geographic area during the historical time period, using the predictive model to predict a new seismic event predicted to occur within the geographic area during a future time period as a result of operating one or more controlled injection wells to inject fluid into the underground geological formations within the geographic area during the future time period, and adjusting the one or more controlled injection wells to prevent the new seismic event from occurring or mitigate an impact of the new seismic event during the future time period.

In some embodiments, the predictive model includes an artificial intelligence (AI) model. Using the predictive model to predict the new seismic event may include using the AI model to quantify a predicted occurrence of the new seismic event during the future time period. Quantifying the predicted occurrence of the new seismic event may include generating predicted values of at least one of a likelihood of the new seismic event occurring during the future time period, a magnitude of the new seismic event, a location of the new seismic event, or the impact of the new seismic event.

In some embodiments, adjusting the one or more controlled injection wells includes adjusting at least one of an injection volume, an injection rate, an injection time, or an operating pressure of the one or more controlled injection wells during the future time period.

In some embodiments, adjusting the one or more controlled injection wells includes providing control signals or recommendations to one or more controllers or operators that operate wellsite equipment of the one or more controlled injection wells during the future time period.

In some embodiments, training the predictive model includes determining respective amounts that the well parameters contribute toward causing the seismic events. In some embodiments, using the predictive model to predict the new seismic event includes evaluating new well parameters of the one or more controlled injection wells using the respective amounts to quantify a predicted occurrence of the new seismic event during the future time period.

In some embodiments, the one or more controlled injection wells include one or more of the historical injection wells. In some embodiments, adjusting the one or more controlled injection wells includes adjusting operation of the one or more historical injection wells to reduce a hazard determined by the predictive model of the new seismic event occurring during the future time period.

In some embodiments, the one or more controlled injection wells include one or more additional injection wells separate from the one or more historical injection wells. In some embodiments, adjusting the one or more controlled injection wells includes adjusting at least one of (i) one or more locations of the one or more additional injection wells or (ii) operation of the one or more additional injection wells, to reduce a hazard determined by the predictive model of the new seismic event occurring during the future time period.

In some embodiments, the one or more controlled injection wells include one or more new injection wells to be constructed within the geographic area. In some embodiments, adjusting the one or more controlled injection wells includes determining optimal locations at which to construct the one or more new injection wells to reduce a hazard determined by the predictive model of the new seismic event occurring during the future time period.

In some embodiments, the operations include using the predictive model to determine a hazard of the new seismic event occurring during the future time period based on new well parameters of the one or more controlled injection wells and determining optimal values of the new well parameters based on the hazard of the new seismic event occurring during the future time period.

In some embodiments, determining the optimal values of the new well parameters includes at least one of (i) performing an optimization of a first objective function that quantifies a performance of the one or more controlled injection wells subject to a first constraint that requires the hazard determined by the predictive model to be maintained below a hazard threshold or (ii) performing an optimization of a second objective function that quantifies a control objective based on the hazard determined by the predictive model subject to a second constraint that requires the performance of the one or more controlled injection wells to be maintained above a performance threshold.

Another implementation of the present disclosure is a method for predicting and controlling induced seismic events. The method includes training a predictive model to learn a relationship between (i) well parameters of one or more historical injection wells that operate to inject fluid into underground geological formations within a geographic area during a historical time period and (ii) seismic events occurring within the geographic area during the historical time period, using the predictive model to predict a new seismic event predicted to occur within the geographic area during a future time period as a result of operating one or more controlled injection wells to inject fluid into the underground geological formations within the geographic area during the future time period, and adjusting the one or more controlled injection wells to prevent the new seismic event from occurring or mitigate an impact of the new seismic event during the future time period.

In some embodiments, the predictive model includes an artificial intelligence (AI) model. Using the predictive model to predict the new seismic event may include using the AI model to quantify a predicted occurrence of the new seismic event. Quantifying the predicted occurrence may include generating predicted values of at least one of a likelihood of the new seismic event occurring during the future time period, a magnitude of the new seismic event, a location of the new seismic event, or the impact of the new seismic event.

In some embodiments, adjusting the one or more controlled injection wells includes adjusting at least one of an injection volume, an injection rate, an injection time, or an operating pressure of the one or more controlled injection wells during the future time period.

In some embodiments, adjusting the one or more controlled injection wells includes providing control signals or recommendations to one or more controllers or operators that operate wellsite equipment of the one or more controlled injection wells during the future time period.

In some embodiments, training the predictive model includes determining respective amounts that the well parameters contribute toward causing the seismic events. In some embodiments, using the predictive model to predict the new seismic event includes evaluating new well parameters of the one or more controlled injection wells using the respective amounts to quantify a predicted occurrence of the new seismic event during the future time period.

In some embodiments, the one or more controlled injection wells include one or more of the historical injection wells. In some embodiments, adjusting the one or more controlled injection wells includes adjusting operation of the one or more historical injection wells to reduce a hazard determined by the predictive model of the new seismic event occurring during the future time period.

In some embodiments, the one or more controlled injection wells include one or more additional injection wells separate from the one or more historical injection wells. In some embodiments, adjusting the one or more controlled injection wells includes adjusting at least one of (i) one or more locations of the one or more additional injection wells or (ii) operation of the one or more additional injection wells, to reduce a hazard determined by the predictive model of the new seismic event occurring during the future time period.

In some embodiments, the one or more controlled injection wells include one or more new injection wells to be constructed within the geographic area. In some embodiments, adjusting the one or more controlled injection wells includes determining optimal locations at which to construct the one or more new injection wells to reduce a hazard determined by the predictive model of the new seismic event occurring during the future time period.

In some embodiments, the method includes using the predictive model to determine a hazard of the new seismic event occurring during the future time period based on new well parameters of the one or more controlled injection wells and determining optimal values of the new well parameters based on the hazard of the new seismic event occurring during the future time period.

In some embodiments, determining the optimal values of the new well parameters includes at least one of (i) performing an optimization of a first objective function that quantifies a performance of the one or more controlled injection wells subject to a first constraint that requires the hazard determined by the predictive model to be maintained below a hazard threshold or (ii) performing an optimization of a second objective function that quantifies a control objective based on the hazard determined by the predictive model subject to a second constraint that requires the performance of the one or more controlled injection wells to be maintained above a performance threshold.

Another implementation of the present disclosure is a system for predicting and controlling induced seismic events. The system includes one or more processors and one or more non-transitory computer-readable storage media storing instructions that, when executed by the one or more processors, cause the one or more processors to perform operations. The operations include training a predictive model to learn a relationship between (i) well parameters of one or more historical wells that operate to inject fluid into underground geological formations or produce fluid from the underground geological formations within a geographic area during a historical time period and (ii) seismic events occurring within the geographic area during the historical time period, using the predictive model to predict a new seismic event predicted to occur within the geographic area during a future time period as a result of operating one or more controlled wells to inject fluid into the underground geological formations or produce fluid from the underground geological formations within the geographic area during the future time period, and adjusting the one or more controlled wells to prevent the new seismic event from occurring or mitigate an impact of the new seismic event during the future time period.

In some embodiments, the predictive model includes an artificial intelligence (AI) model. Using the predictive model to predict the new seismic event may include using the AI model to quantify a predicted occurrence of the new seismic event during the future time period. Quantifying the predicted occurrence of the new seismic event may include generating predicted values of at least one of a likelihood of the new seismic event occurring during the future time period, a magnitude of the new seismic event, a location of the new seismic event, or the impact of the new seismic event.

In some embodiments, adjusting the one or more controlled wells includes adjusting at least one of an injection volume, a production volume, an injection rate, a production rate, an injection time, a production time, or an operating pressure of the one or more controlled wells during the future time period.

In some embodiments, adjusting the one or more controlled wells includes providing control signals or recommendations to one or more controllers or operators that operate wellsite equipment of the one or more controlled wells during the future time period.

In some embodiments, training the predictive model includes determining respective amounts that the well parameters contribute toward causing the seismic events. In some embodiments, using the predictive model to predict the new seismic event includes evaluating new well parameters of the one or more controlled wells using the respective amounts to quantify a predicted occurrence of the new seismic event during the future time period.

In some embodiments, the one or more controlled wells include one or more of the historical wells. In some embodiments, adjusting the one or more controlled wells includes adjusting operation of the one or more historical wells to reduce a hazard determined by the predictive model of the new seismic event occurring during the future time period.

In some embodiments, the one or more controlled wells include one or more additional wells separate from the one or more historical wells. In some embodiments, adjusting the one or more controlled wells includes adjusting at least one of (i) one or more locations of the one or more additional wells or (ii) operation of the one or more additional wells, to reduce a hazard determined by the predictive model of the new seismic event occurring during the future time period.

In some embodiments, the one or more controlled wells include one or more new wells to be constructed within the geographic area. In some embodiments, adjusting the one or more controlled wells includes determining optimal locations at which to construct the one or more new wells to reduce a hazard determined by the predictive model of the new seismic event occurring during the future time period.

In some embodiments, the operations include using the predictive model to determine a hazard of the new seismic event occurring during the future time period based on new well parameters of the one or more controlled wells and determining optimal values of the new well parameters based on the hazard of the new seismic event occurring during the future time period.

In some embodiments, determining the optimal values of the new well parameters includes at least one of (i) performing an optimization of a first objective function that quantifies a performance of the one or more controlled wells subject to a first constraint that requires the hazard determined by the predictive model to be maintained below a hazard threshold or (ii) performing an optimization of a second objective function that quantifies a control objective based on the hazard determined by the predictive model subject to a second constraint that requires the performance of the one or more controlled wells to be maintained above a performance threshold.

Another implementation of the present disclosure is a method for predicting and controlling induced seismic events. The method includes training a predictive model to learn a relationship between (i) well parameters of one or more historical wells that operate to inject fluid into underground geological formations or produce fluid from the underground geological formations within a geographic area during a historical time period and (ii) seismic events occurring within the geographic area during the historical time period, using the predictive model to predict a new seismic event predicted to occur within the geographic area during a future time period as a result of operating one or more controlled wells to inject fluid into the underground geological formations or produce fluid from the underground geological formations within the geographic area during the future time period, and adjusting the one or more controlled wells to prevent the new seismic event from occurring or mitigate an impact of the new seismic event during the future time period.

In some embodiments, the predictive model includes an artificial intelligence (AI) model. Using the predictive model to predict the new seismic event may include using the AI model to quantify a predicted occurrence of the new seismic event. Quantifying the predicted occurrence may include generating predicted values of at least one of a likelihood of the new seismic event occurring during the future time period, a magnitude of the new seismic event, a location of the new seismic event, or the impact of the new seismic event.

In some embodiments, adjusting the one or more controlled wells includes adjusting at least one of an injection volume, a production volume, an injection rate, a production rate, an injection time, a production time, or an operating pressure of the one or more controlled wells during the future time period.

In some embodiments, adjusting the one or more controlled wells includes providing control signals or recommendations to one or more controllers or operators that operate wellsite equipment of the one or more controlled wells during the future time period.

In some embodiments, training the predictive model includes determining respective amounts that the well parameters contribute toward causing the seismic events. In some embodiments, using the predictive model to predict the new seismic event includes evaluating new well parameters of the one or more controlled wells using the respective amounts to quantify a predicted occurrence of the new seismic event during the future time period.

In some embodiments, the one or more controlled wells include one or more of the historical wells. In some embodiments, adjusting the one or more controlled wells includes adjusting operation of the one or more historical wells to reduce a hazard determined by the predictive model of the new seismic event occurring during the future time period.

In some embodiments, the one or more controlled wells include one or more additional wells separate from the one or more historical wells. In some embodiments, adjusting the one or more controlled wells includes adjusting at least one of (i) one or more locations of the one or more additional wells or (ii) operation of the one or more additional wells, to reduce a hazard determined by the predictive model of the new seismic event occurring during the future time period.

In some embodiments, the one or more controlled wells include one or more new wells to be constructed within the geographic area. In some embodiments, adjusting the one or more controlled wells includes determining optimal locations at which to construct the one or more new wells to reduce a hazard determined by the predictive model of the new seismic event occurring during the future time period.

In some embodiments, the method includes using the predictive model to determine a hazard of the new seismic event occurring during the future time period based on new well parameters of the one or more controlled wells and determining optimal values of the new well parameters based on the hazard of the new seismic event occurring during the future time period.

In some embodiments, determining the optimal values of the new well parameters includes at least one of (i) performing an optimization of a first objective function that quantifies a performance of the one or more controlled wells subject to a first constraint that requires the hazard determined by the predictive model to be maintained below a hazard threshold or (ii) performing an optimization of a second objective function that quantifies a control objective based on the hazard determined by the predictive model subject to a second constraint that requires the performance of the one or more controlled wells to be maintained above a performance threshold.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a cross-sectional view of a geographic region of the earth illustrating injection wells operating to inject fluid into underground formations, according to some embodiments.

FIG. 2 is another cross-sectional view of the geographic region of FIG. 1 after an induced seismic event has occurred, causing a fault slip and surface deformation, according to some embodiments.

FIG. 3 is a diagram illustrating components which can be installed at the injection wells shown in FIG. 1, according to some embodiments.

FIG. 4 is a diagram illustrating the flow of data in the system of FIG. 1, according to some embodiments.

FIG. 5 is a block diagram illustrating the computing system of FIG. 1 in greater detail along with its data sources and outputs, according to some embodiments.

FIG. 6 is a block diagram illustrating the geographical data sources of FIG. 5 in greater detail, according to some embodiments.

FIG. 7 is a block diagram illustrating the geological data sources of FIG. 5 in greater detail, according to some embodiments.

FIG. 8 is a block diagram illustrating the seismic/earthquake data sources of FIG. 5 in greater detail, according to some embodiments.

FIG. 9 is a block diagram illustrating the real-time wellsite data sources of FIG. 5 in greater detail, according to some embodiments.

FIGS. 10A-10B are block diagrams illustrating the engineering data sources of FIG. 5 in greater detail, according to some embodiments.

FIG. 11 is a block diagram illustrating the aerospace data sources of FIG. 5 in greater detail, according to some embodiments.

FIG. 12 is a block diagram illustrating the other data sources of FIG. 5 in greater detail, according to some embodiments.

FIG. 13 is a block diagram illustrating the maps output of FIG. 5 in greater detail, according to some embodiments.

FIG. 14 is a block diagram illustrating the flow models output of FIG. 5 in greater detail, according to some embodiments.

FIG. 15 is a block diagram illustrating the pressure tracking output of FIG. 5 in greater detail, according to some embodiments.

FIG. 16 is a block diagram illustrating the charts output of FIG. 5 in greater detail, according to some embodiments.

FIG. 17 is a block diagram illustrating the alerts output of FIG. 5 in greater detail, according to some embodiments.

FIGS. 18A-18B are block diagrams illustrating the analytics output of FIG. 5 in greater detail, according to some embodiments.

FIG. 19 is a drawing of a map which can be provided as one of the map outputs of FIG. 13, according to some embodiments.

FIG. 20 is a drawing of another map which can be provided as one of the map outputs of FIG. 13, according to some embodiments.

FIG. 21 is a drawing of another map which can be provided as one of the map outputs of FIG. 13, according to some embodiments.

FIG. 22 is a drawing of another map which can be provided as one of the map outputs of FIG. 13, according to some embodiments.

FIG. 23 is a drawing of another map which can be provided as one of the map outputs of FIG. 13, according to some embodiments.

FIG. 24 is a drawing of another map which can be provided as one of the map outputs of FIG. 13, according to some embodiments.

FIG. 25 is a drawing of another map which can be provided as one of the map outputs of FIG. 13, according to some embodiments.

FIG. 26 is a view of a database user interface which can be provided as one of the user interface outputs of FIG. 5, according to some embodiments.

FIG. 27 is another view of the database user interface which can be provided as one of the user interface outputs of FIG. 5, according to some embodiments.

FIG. 28 is another view of the database user interface which can be provided as one of the user interface outputs of FIG. 5, according to some embodiments.

FIG. 29 is another view of the database user interface which can be provided as one of the user interface outputs of FIG. 5, according to some embodiments.

FIG. 30 is another view of the database user interface which can be provided as one of the user interface outputs of FIG. 5, according to some embodiments.

FIG. 31 is another view of the database user interface which can be provided as one of the user interface outputs of FIG. 5, according to some embodiments.

FIG. 32 is another view of the database user interface which can be provided as one of the user interface outputs of FIG. 5, according to some embodiments.

FIG. 33 is another view of the database user interface which can be provided as one of the user interface outputs of FIG. 5, according to some embodiments.

FIG. 34 is another view of the database user interface which can be provided as one of the user interface outputs of FIG. 5, according to some embodiments.

FIG. 35 is a view of a maps user interface which can be provided as one of the user interface outputs of FIG. 5, according to some embodiments.

FIG. 36 is another view of the maps user interface which can be provided as one of the user interface outputs of FIG. 5, according to some embodiments.

FIG. 37 is another view of the maps user interface which can be provided as one of the user interface outputs of FIG. 5, according to some embodiments.

FIG. 38 is a view of a charts user interface which can be provided as one of the user interface outputs of FIG. 5, according to some embodiments.

FIG. 39 is another view of the charts user interface which can be provided as one of the user interface outputs of FIG. 5, according to some embodiments.

FIG. 40 is another view of the charts user interface which can be provided as one of the user interface outputs of FIG. 5, according to some embodiments.

FIG. 41 is a view of a seismic user interface which can be provided as one of the user interface outputs of FIG. 5, according to some embodiments.

FIG. 42 is another view of the seismic user interface which can be provided as one of the user interface outputs of FIG. 5, according to some embodiments.

FIG. 43 is another view of the seismic user interface which can be provided as one of the user interface outputs of FIG. 5, according to some embodiments.

FIG. 44 is another view of the seismic user interface which can be provided as one of the user interface outputs of FIG. 5, according to some embodiments.

FIG. 45 is another view of the seismic user interface which can be provided as one of the user interface outputs of FIG. 5, according to some embodiments.

FIG. 46 is another view of the seismic user interface which can be provided as one of the user interface outputs of FIG. 5, according to some embodiments.

FIG. 47 is a view of an alerts user interface which can be provided as one of the user interface outputs of FIG. 5, according to some embodiments.

FIG. 48 is another view of the alerts user interface which can be provided as one of the user interface outputs of FIG. 5, according to some embodiments.

FIG. 49 is another view of the alerts user interface which can be provided as one of the user interface outputs of FIG. 5, according to some embodiments.

FIG. 50 is a view of a reports user interface which can be provided as one of the user interface outputs of FIG. 5, according to some embodiments.

FIG. 51 is another view of the reports user interface which can be provided as one of the user interface outputs of FIG. 5, according to some embodiments.

FIG. 52 is another view of the reports user interface which can be provided as one of the user interface outputs of FIG. 5, according to some embodiments.

FIG. 53 is another view of the reports user interface which can be provided as one of the user interface outputs of FIG. 5, according to some embodiments.

FIG. 54 is another view of the reports user interface which can be provided as one of the user interface outputs of FIG. 5, according to some embodiments.

FIG. 55 is another view of the reports user interface which can be provided as one of the user interface outputs of FIG. 5, according to some embodiments.

FIG. 56 is a view of an optimization user interface which can be provided as one of the user interface outputs of FIG. 5, according to some embodiments.

FIG. 57 is a view of an optimization user interface which can be provided as one of the user interface outputs of FIG. 5, according to some embodiments.

FIG. 58 is a view of an optimization user interface which can be provided as one of the user interface outputs of FIG. 5, according to some embodiments.

FIG. 59 is a flowchart of the process for training an AI model to predict induced seismic events, which can be performed by the computing system of FIG. 1, according to some embodiments.

FIG. 60 is a flowchart of another process for training an AI model to predict induced seismic events, which can be performed by the computing system of FIG. 1 for embodiments in which the AI model is implemented as a retrieval-augmented generation (RAG) model, according to some embodiments.

FIG. 61 is a flowchart of another process for training an AI model to predict induced seismic events, which can be performed by the computing system of FIG. 1 for embodiments in which the AI model is implemented as a deep learning AI model, according to some embodiments.

FIG. 62 is a flowchart of another process for training an AI model to predict induced seismic events, which can be performed by the computing system of FIG. 1 for embodiments in which the AI model is implemented as a causal AI model, according to some embodiments.

FIG. 63 is a flowchart of another process for training an AI model to predict induced seismic events, which can be performed by the computing system of FIG. 1 for embodiments in which the AI model is implemented as a machine learning AI model, according to some embodiments.

FIG. 64 is a flowchart of another process for training an AI model to predict induced seismic events, which can be performed by the computing system of FIG. 1 for embodiments in which the AI model is implemented as a fuzzy logic AI model, according to some embodiments.

FIG. 65 is a flowchart of a process for looking for clean zones of interest, which can be performed by the computing system of FIG. 1, according to some embodiments.

FIG. 66 a flowchart of a process for constructing and using the various models described throughout the present disclosure which can be performed by the computing system of FIG. 1, according to some embodiments.

### DETAILED DESCRIPTION

### Overview

Referring generally to the FIGURES, systems and methods for predicting and controlling induced seismic events by adjusting injection well operations are shown, according to various exemplary embodiments. An injection well is a specialized, engineered structure configured for the controlled injection of fluid into underground geological formations. An injection well typically includes a vertically oriented wellbore that extends from the earth's surface through multiple subsurface strata to a target injection zone, typically located within a porous and permeable rock formation. The injection well system is designed to safely introduce fluids, such as water, brine, carbon dioxide, or other liquids or gases (e.g., hydrogen, nitrogen, helium, natural gas, etc.), for storage, disposal, or enhanced recovery processes.

The systems and methods described herein address the technical problem of induced seismicity, or human-caused earthquakes, that can occur as a result of injection well activities. Induced seismicity poses several problems across environmental, economic, and societal dimensions. For example, induced seismic events can damage buildings, infrastructure, and critical facilities such as dams or power plants. Induced seismic events can also present public safety risks by increasing the likelihood of injuries and fatalities, especially in populated areas. Seismic activity can trigger landslides, groundwater contamination, or changes in subsurface geology, affecting ecosystems and water resources. Increased seismicity can raise insurance costs, deter investment in affected areas, and lead to operational restrictions on industries contributing to the issue. Communities near induced seismicity hotspots may resist industrial activities, leading to social conflicts and regulatory pressure.

The systems and methods described herein use predictive models to determine the factors that contribute most significantly to induced seismic events and predict (e.g., forecast, estimate, etc.) the risk of future induced seismic events based on a proposed set of well parameters (e.g., well locations and/or control actions for wellsite equipment) over a future time period. For example, the computing system described herein can create a database of well and formation information to build a history of wellsite activity and causally related effects (e.g., earthquakes, well leaks, ground deformation, etc.). The computing system can use an AI model to evaluate this information, determine the root cause of the adverse effects, and forecast future effects based on historical, real-time, and/or proposed well parameters for a future time period.

The computing system and AI model described herein can predict the fluid and pressure movements throughout the subsurface from multiple points of injection and various zones that may interconnect (e.g., using machine learning and deep learning AI to model flow, pressure, etc.) predicted to result from a proposed set of well parameters. This allows the computing system to forecast future induced seismic events and other adverse effects based on current activities and trends, and potential future manipulation of wellsite activities. Advantageously, the computing system can predict outcomes such as induced seismic events, well leaks, ground deformation, fluid flows, and pressures in subsurface formation predicted to result from various alternative or hypothetical scenarios (e.g., best case scenario, average scenario, worst case scenario, etc.). The computing system can provide recommendations to wellsite operators and/or automatically control wellsite equipment to take preemptive action based on the predictions generated by the AI model to reduce the risks of induced seismic events while optimizing wellsite operations.

A significant improvement provided by the systems and methods of the present disclosure over existing technology is that the computing system can be used to control (e.g., minimize, mitigate, reduce the impact of, etc.) induced seismic events and other adverse effects associated with induced seismicity (e.g., ground deformation, damage to buildings or infrastructure, well leaks, etc.). Controlling an induced seismic event may include taking proactive or preventative measures to reduce the risk of induced seismic events or other adverse effects. For example, existing technologies in the field of well monitoring and control systems typically use data from seismic monitoring stations and/or wellsite monitoring equipment to detect problems which have already occurred, such as earthquakes or well leaks. Wellsite operators then must respond to these events reactively and must repair or replace any wellsite equipment that has been damaged as a result of the detected problems. Existing technologies only allow for a reactive response after an induced seismic event occurs and the damage caused by the event has already been incurred, both to the wellsite equipment and to any critical infrastructure or buildings in the surrounding geographic region.

Advantageously, the computing system and AI model described herein can be used to forecast future induced seismic events and other adverse consequences predicted to result from a given set of well parameters such as well locations and control actions for wellsite equipment. The computing system can optimize the well parameters to reduce the risk of induced seismic events while ensuring that the wells are operated efficiently and productively. The computing system can automatically control wellsite equipment to execute the recommended control actions and/or can provide recommendations to wellsite operators or other entities to optimize the locations and activities of their controlled wells. In this way, the computing system enables preemptive or preventative actions to be taken to prevent induced seismic events from occurring or minimize the risk of induced seismic events, thereby preventing or mitigating the damage caused by such events before they occur. These and other advantages and improvements provided by the systems and methods of the present disclosure are described in detail below.

Before discussing the computing system and AI model in detail, it should be understood that the terms “predicted induced seismic event,” “predicted magnitude,” “predicted location,” and similar future-looking terms used throughout the present disclosure (e.g., “predicted,” “forecasted,” “estimated,” “expected,” etc.) refer to potential induced seismic events which may or may not occur during a future time period and their potential attributes (e.g., potential magnitude, potential location, potential impact, etc.). The predictions made by the computing system and/or the AI model described herein should be understood as characterizing events that could occur during the future time period or have a significant risk, probability, or likelihood of occurring as predicted by the AI model, but are not guaranteed to occur, nor are they guaranteed to have the attributes predicted by the AI model. Any induced seismic events predicted to occur during a future time period should be understood as predicted induced seismic events.

In various embodiments, the predicted attributes of induced seismic events (e.g., predicted magnitude, predicted location, predicted impact, predicted time, etc.) forecast by the computing system and/or the AI model may include specific numerical values and/or ranges of values. For example, a predicted magnitude may include a single magnitude value or a range of magnitude values. Similarly, a predicted location may include a single location (e.g., a single point) or a range of locations (e.g., an area or volume around a point, a geographic region, etc.). In some embodiments, the predicted attributes of the predicted induced seismic events can be expressed as a range around a median value (e.g., X+/−Y) or as a range bounded by a minimum and maximum value. The predicted attributes should be understood as attributes that the predicted induced seismic events could have or are probable or likely to have as predicted by the AI model but are not guaranteed to have. Any attributes of induced seismic events predicted to occur during a future time period should be understood as predicted attributes.

As used herein, the term “hazard” in association with induced seismic events should be understood as a risk or likelihood of an induced seismic event occurring, a risk or likelihood of other adverse effects associated with induced seismic events, and/or a predicted impact of induced seismic events or other adverse effects. Such adverse effects may include but are not limited to ground deformation, damage to buildings or infrastructure, landslides, groundwater contamination, well leaks, changes in subsurface geology, or any of the other potentially negative consequences or outcomes of seismic events and/or wellsite activities described throughout the present disclosure. The predicted impact may indicate or describe (e.g., quantitatively or qualitatively) any potentially negative outcomes or consequences associated with induced seismic events or other adverse effects. For example, predicted impacts may include a predicted severity, magnitude, amount of loss, amount of damage, or any other metric or descriptor characterizing the effects of induced seismic events or other adverse effects.

Accordingly, the terms “reducing a hazard,” “minimizing a hazard,” “mitigating a hazard” and like terminology used throughout the present disclosure should be understood as reducing a risk or likelihood of an induced seismic event occurring, a risk or likelihood of other adverse effects associated with induced seismic events, and/or a predicted impact of induced seismic events or other adverse effects. For example, reducing a hazard of an induced seismic event may include reducing a likelihood that the induced seismic event occurs, reducing a magnitude of the induced seismic event, reducing an amount of damage or harm caused by the induced seismic event, reducing an amount of ground deformation, or reducing any other potentially negative consequence or adverse effect associated with the induced seismic event.

For ease of reference, the term “induced seismic event” is used throughout the present disclosure to refer to both induced earthquakes and/or any other adverse effects described herein which could be caused or influenced by wellsite activities. The term “controlling” is used throughout the present disclosure to refer to any activity which affects or lessens the impact (e.g., mitigates, reduces, minimizes, etc.) of induced seismic events or other adverse effects associated therewith. Accordingly, any description of “controlling induced seismic events” throughout the present disclosure should be understood as controlling (e.g., influencing, mitigating, reducing the likelihood, reducing the impact, etc.) of induced earthquakes and/or other adverse effects which could be caused or influenced by wellsite activities, unless otherwise specified.

### Injection Wells and Induced Seismic Events

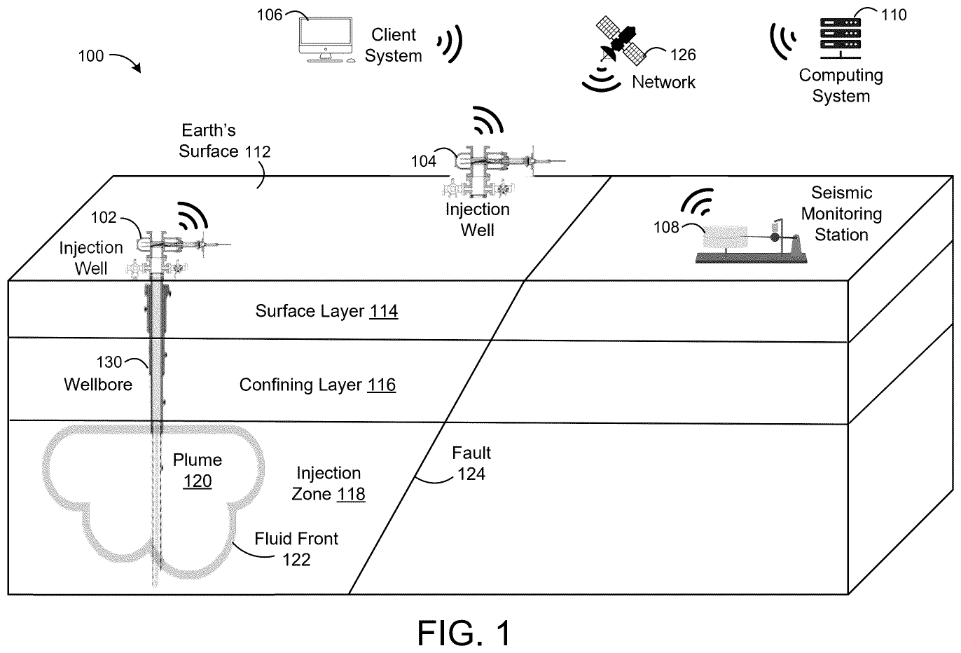

Referring now to FIG. 1, a system 100 for monitoring and controlling injection wells is shown, according to some embodiments. System 100 is shown to include two injection wells 102 and 104, a client system 106, a seismic monitoring station 108, and a computing system 110 connected via a network 126. Injection wells 102-104 are specialized, engineered structures configured for the controlled injection of fluid into underground geological formations. Injection wells 102-104 can be operated to introduce fluids, such as water, brine, carbon dioxide, or other liquids, for storage, disposal, or enhanced recovery processes.

FIG. 1 is a cross-sectional view of the earth showing a surface layer 114, a confining layer 116, and an injection zone 118. Surface layer 114 may be located directly below the earth's surface 112 and may include the uppermost layer of soil and unconsolidated materials, including topsoil and sediments, above bedrock. Confining layer 116 may include caprock or other dense or impermeable materials (e.g., rock layers, shale, clay, etc.) that prevent the upward migration of fluids from injection zone 118. Injection zone 118 may include reservoir rock or other porous and/or permeable rock that holds the fluid injected by injection well 102. Injection zone 118 may contain pre-existing fluids such as water, oil, or gas which can be removed from the earth (e.g., by injection well 102 or other nearby wells) and replaced with fluid injected by injection well 102. Deeper layers of the earth not shown in FIG. 1 may include a seal or impermeable strata below injection zone 118 that prevents downward migration of the injected fluid and/or basement rock below the impermeable strata. Basement rock may be the deepest and least permeable layer, typically made of crystalline or metamorphic rock, and may not be suitable for fluid injection.

Injection well 102 is shown to include a vertically oriented wellbore 130 extending downward from the earth's surface 112 through multiple subsurface strata (e.g., through surface layer 114 and confining layer 116) and into injection zone 118. Wellbore 130 may include a drilled cylindrical cavity surrounded by surface casing (e.g., steel pipe encased in cement) to isolate and protect shallow groundwater zones, intermediate casing to provide additional zonal isolation as needed, and/or production casing or injection casing. The production or injection casing may include a tubular structure extending to the depth of injection zone 118 and may be cemented along its length to prevent fluid migration outside the casing. Injection well 102 may include a wellhead assembly positioned at the surface 112 and including a series of valves and fittings for controlling fluid flow into the well. The wellhead assembly may serve as a secure interface between surface piping and the injection casing. In some embodiments, injection well 102 may include a packer and/or a tubing string. The packer may include an expandable sealing device located within wellbore 130 and configured to provide zonal isolation above injection zone 118 to prevent fluid migration along the annulus. The tubing string may include a conduit within the casing used to transport the injected fluid to the designated depth. Tubing may be secured with packers to enhance fluid control.

Injection well 102 may operate to deliver fluid from the surface 112 through the wellhead and wellbore 130 into the tubing string and discharged into injection zone 118. The casing and cementing system provides structural integrity and zonal isolation, ensuring that fluids remain confined within the designated formation. Pressure monitoring systems may be integrated to manage injection pressures, detect anomalies, and prevent over-pressurization that could compromise well integrity or induce unwanted fractures. It is contemplated that injection well 102 may include any variety and/or type of component, device, system, or other equipment known in the art and configured to facilitate the monitoring and control of injection well 102 to inject fluid into injection zone 118.

The fluid injected into injection zone 118 by injection well 102 may form a plume 120 having a fluid front 122 or boundary at the leading edge of plume 120. The shape of plume 120 may depend on various factors such as injection pressure, injection rate, or injection volume. For example, higher injection pressures, rates, or volumes can result in a larger plume 120. The size and shape of plume 120 may further depend on the permeability and porosity of the surrounding rock and geological structures and/or a variety of other geologic or technical factors, as described in greater detail below with reference to data sources 502. For example, more permeable rock allows fluid to spread more easily and allows fluid front 122 to advance further or faster than less permeable rock, whereas faults and fractures (e.g., fault 124) can guide or block the migration of plume 120. Density differences between the injected fluid and other fluids in injection zone 118 can also affect the size and shape of plume 120, as well as the direction of movement of plume 120. For example, fluids lighter than native groundwater (e.g., CO₂) or other fluids within injection zone 118 may rise from the injection location, whereas denser fluids may sink. Fluid front 122 marks the extent of the fluid migration of plume 120 within the formation. The fluids within plume 120 may consist primarily of the fluid injected by injection well 102, whereas native fluids within injection zone 118 (e.g., brine or hydrocarbons) may be present outside plume 120.

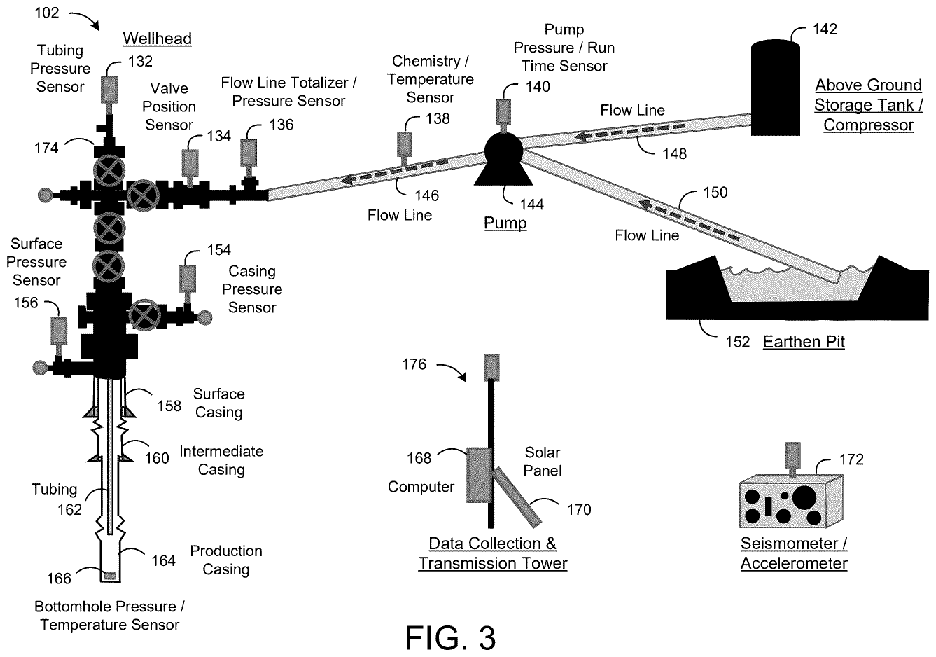

Client system 106 can be configured to monitor and control the operation of injection wells 102-104. Client system 106 can be implemented as an on-site monitoring station (e.g., located at or nearby injection wells 102-104) or an off-site facility (e.g., remote from injection wells 102-104) in various embodiments. Client system 106 can be configured to receive measurements, operating parameters, control settings, and/or other data from injection wells 102-104. For example, client system 106 can receive measurements or reports of pump pressure, wellhead pressure, bottomhole pressure, fluid injection rate, fluid injection volume, fluid type, fluid viscosity, fluid weight, fluid chemistry, or any other type of measurements indicating the operation of injection wells 102-104. Client system 106 can be configured to control the equipment of injection wells 102-104 (e.g., pumps, valves, compressors, etc.) to affect the amount, rate, volume, or other attributes of the fluid injected by injection wells 102-104 over time. Several examples of specific sensors and controllable equipment which can provide data to client system 106 and receive operating commands from client system 106 are described in greater detail with reference to FIG. 3.

Seismic monitoring station 108 can be configured to measure seismic activity (e.g., earthquakes, ground tremors, etc.) in the geographic area of injection wells 102-104. Seismic monitoring station 108 may include any type of facility or equipment configured to detect, record, and/or analyze seismic waves generated by earthquakes or other ground vibrations. Although only one seismic monitoring station 108 is shown in FIG. 1, it is contemplated that any number of seismic monitoring stations 108 can be installed in a geographic area. For example, seismic monitoring station 108 may be part of a broader seismic network such as the United States Geological Survey (USGS) network or regional systems with multiple distributed seismic monitoring facilities that allow for comprehensive earthquake detection and analysis within a geographic region (e.g., city, county, state, country) or globally. As such, any references to seismic monitoring station 108 throughout the present disclosure should be understood as one or more instances of seismic monitoring station 108 distributed across a geographic region.

Seismic monitoring station 108 may include sensory equipment such as a seismometer or geophone configured to detect ground motion and measure velocity, displacement, or acceleration of ground movement caused by seismic waves. Seismic monitoring station 108 may include a data recorder or digitizer configured to convert an analog signal from the seismometer into digital data for processing and storage and record continuous or event-triggered ground motion data. Seismic monitoring station 108 may include a timing system configured to synchronize data with precise time references (e.g., GPS signals) to accurately determine when seismic events occur. Seismic monitoring station 108 may be powered by the energy grid or by local batteries, solar panels, or other energy sources. Seismic monitoring station 108 can be configured to communicate with client system 106, injection wells 102-104, and/or computing system 110 via network 126 to transmit the seismic data recorded by seismic monitoring station.

Computing system 110 may include one or more computers, computer servers, cloud computing devices, mobile computing devices, or other computer systems configured to analyze the received from injection wells 102-104, client system 106, seismic monitoring station 108, or other components of system 100 or other data sources. In various embodiments, computing system 110 can be implemented as a single computer installed at a single location or as a network of distributed computing components installed at multiple locations. For example, some portions of computing system 110 may be located on-site (e.g., within the same building or campus as injection wells 102-104, client system 106, and/or seismic monitoring station 108) whereas other portions of computing system 110 may be located off-site (e.g., in a remote server, cloud computing system, etc.). Computing system 110 may include any type of computer hardware (e.g., processors, memory, etc.) or software configured to perform the various functions described throughout the present disclosure.

Network 126 can include any type of communications network capable of facilitating communications among the various components of system 100. Although network 126 is shown as a satellite in FIG. 1, it is contemplated that any type of communications network can be used in various embodiments (e.g., cellular, satellite, wired, wireless, etc.). Network 126 can be connected to any or all components of system 100 (e.g., injection wells 102-104, client system 106, seismic monitoring station 108, computing system 110, etc.) or any other systems or devices configured to provide input data to system 100 or receive output data from system 100.

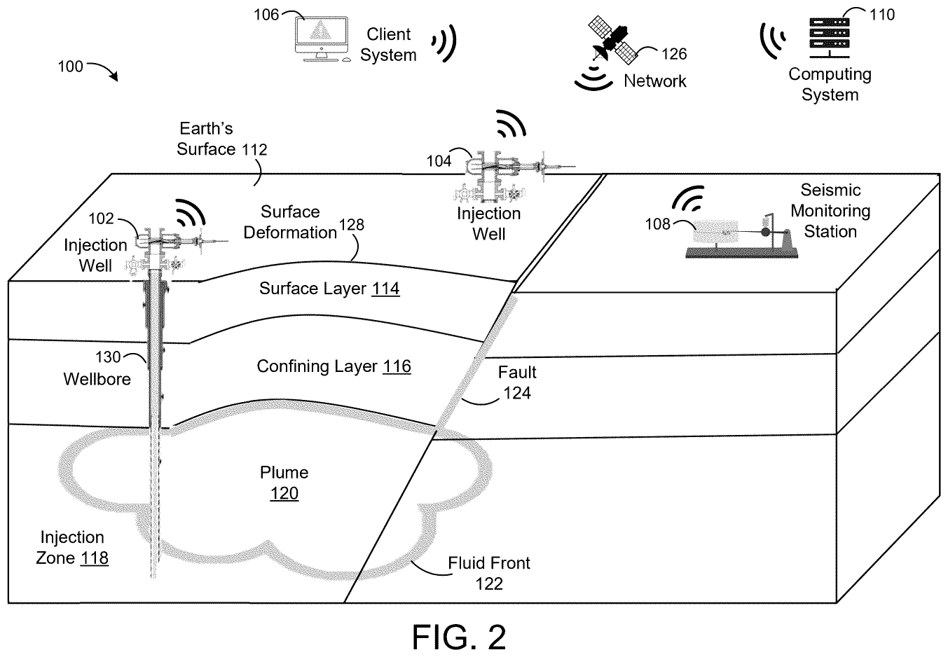

Referring now to FIG. 2, another cross-sectional view of the earth is shown after an induced seismic event has occurred. Induced seismic events are earthquakes or other seismic activities (e.g., ground tremors, ground movement, etc.) that are at least partially caused by human activities, as opposed to natural seismic events which are caused only by natural tectonic processes. One type of human activity which can cause induced seismic events is the injection of fluid through injection wells. For example, the size of plume 120 in FIG. 2 is substantially larger than shown in FIG. 1 as a result of injection well 102 injecting a large amount of fluid into injection zone 118 over time. The growth of plume 120 can cause deformation in the surrounding geological structures as well as surface deformation 128 visible above ground. The growth of plume 120 can also increase the pore pressure in surrounding rock formations, which reduces the frictional resistance along existing faults or fractures, making them more prone to slipping. Injecting large volumes of fluid can also alter the overall stress distribution in the subsurface. Changes in the normal and shear stresses on fault planes can lead to fault reactivation. Fluids can migrate through permeable pathways and influence faults far from the injection point. If these faults are critically stressed, the additional fluid pressure can trigger seismic activity.

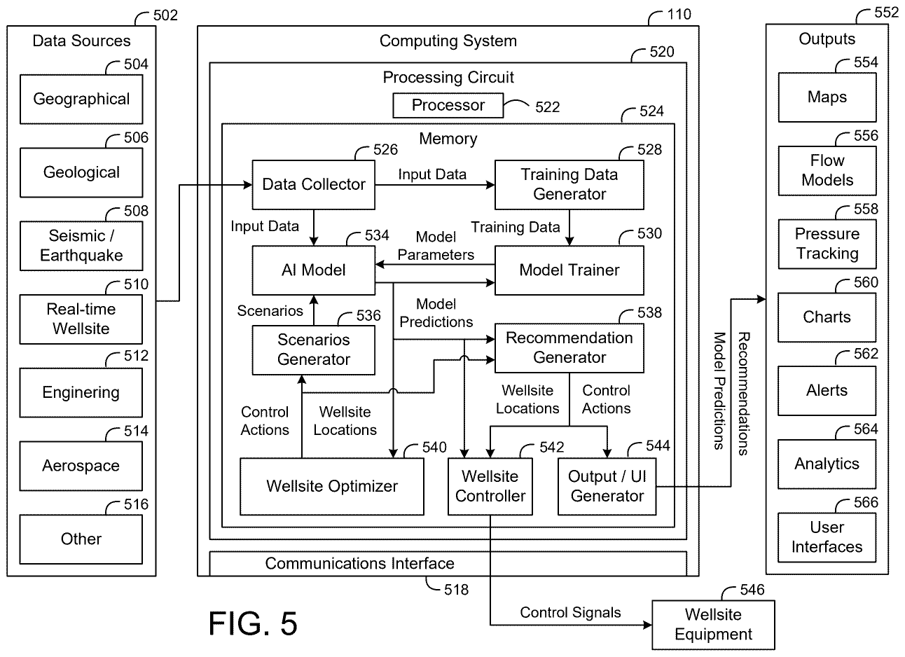

For example, slippage along fault 124 is shown in FIG. 2 as a result of the deformation, stresses, and pressures caused by injecting fluid via injection well 102. This seismic activity can be detected by seismic monitoring station 108 and transmitted to client system 106, computing system 110, and/or injection wells 102-104 via network 126. Computing system 110 can use the seismic data from seismic monitoring station 108 in combination with the operational data from injection wells 102-104 and client system 106 to develop and execute various predictive models capable of predicting induced seismic events. For example, computing system 110 can train an artificial intelligence (AI) model capable of predicting the likelihood, severity (e.g., magnitude), location, or other attributes of induced seismic events caused by operating injection wells 102-104. Computing system 110 can be configured to provide various predictions, analytics, recommendations, or other outputs to optimize the operation and/or locations of injection wells 102-104 to mitigate the occurrence or effects of induced seismic events, as described in detail with reference to FIGS. 5-58.

Referring now to FIG. 3, a diagram illustrating the components of injection well 102 in greater detail is shown, according to an exemplary embodiment. Injection well 102 is shown to include a wellhead 174 and a pump 144. Pump 144 can be configured to draw fluid from an above ground storage tank or compressor 142 and/or an earthen pit 152 via flow lines 148 and/or 150 respectively. The fluid from pump 144 can be routed through flow line 146, into wellhead 174, and injected into the earth. Subterranean components of injection well 102 may include surface casing 158, intermediate casing 160, tubing 162, and production casing 164 which deliver the injected fluid from wellhead 174 into injection zone 118.

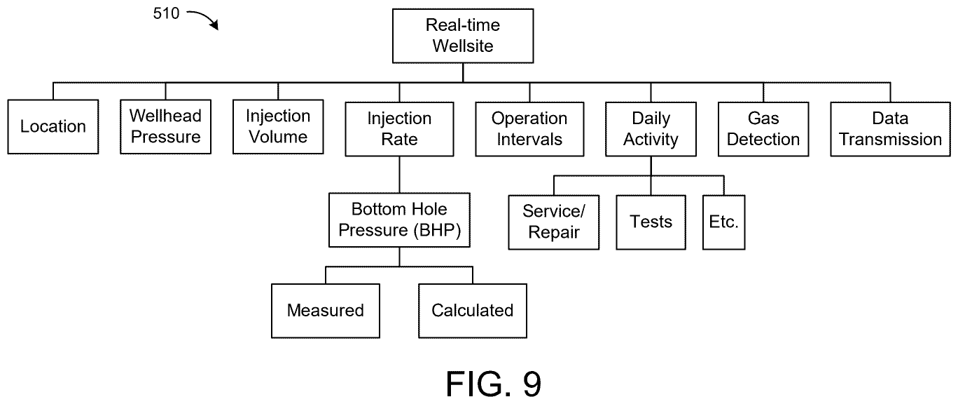

Injection well 102 is shown to include a variety of sensors capable of measuring temperature, pressure, flow, chemistry, or other variables at several locations. For example, injection well 102 is shown to include a tubing pressure sensor 132, a valve position sensor 134, a flow line totalizer/pressure sensor 136, a chemistry/temperature sensor 138, a pump pressure/run time sensor 140, a surface pressure sensor 156, a casing pressure sensor 154, and a bottomhole pressure/temperature sensor 166. These sensors may measure, record, and transmit measurements of the injected fluid or other sensed conditions at injection well 102. Several examples of specific variables and other types of data which can be gathered from the sensors and other electronics at injection well 102 are described in greater detail with reference to FIG. 9.

In some embodiments, injection well 102 includes an on-site data collection and transmission tower 176 including a computer 168 and solar panel 170. These components may be capable of gathering the measurements and other data from the sensors and other components of injection well 102 and transmitting such data via network 126. In some embodiments, injection well 102 includes an on-site seismometer 172 configured to measure seismic activity at the location of injection well 102. Seismometer 172 may include an accelerometer or other seismic measuring devices and may be the same as or similar to seismic monitoring station 108 as previously described.

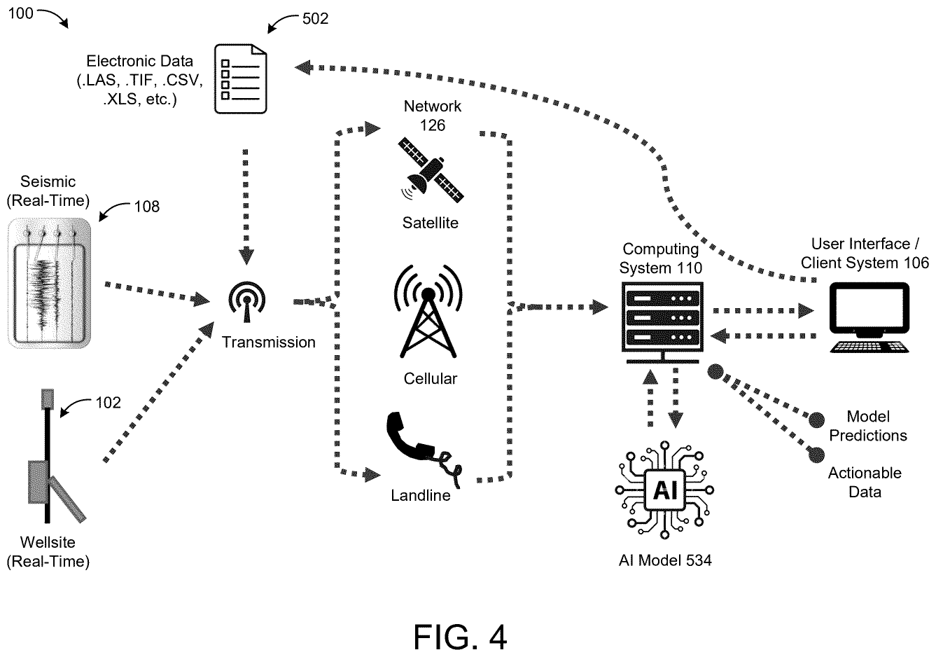

Referring now to FIG. 4, a diagram illustrating the data flow in system 100 is shown, according to an exemplary embodiment. Measurements and other real-time data can be gathered from wellhead 102, as shown in FIG. 3, whereas seismic real-time data can be obtained from seismic monitoring station 108. Various other types of data can also be gathered from a variety of data sources 502 (e.g., geographical, geological, seismic/earthquake, real-time wellsite, engineering aerospace, etc.) as described in greater detail with reference to FIGS. 5-12. These data can be transmitted via network 126 (e.g., satellite, cellular, landline, etc.) and received at computing system 110. Computing system 110 may use the gathered data to train an AI model 534, described in greater detail with reference to FIG. 5.

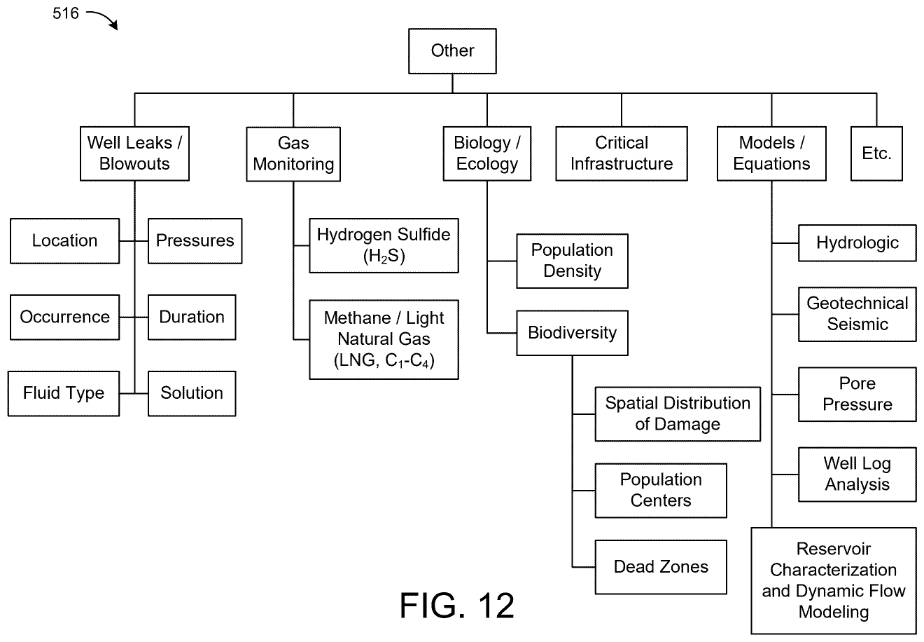

Once AI model 534 is trained, computing system 110 can use AI model 534 to generate model predictions (e.g., probability of a seismic event, range of magnitude of a seismic event, location of the seismic event, pressure fronts, etc.) based on new incoming data from data sources 502. Computing system 110 can provide the model predictions and other actionable data as outputs of AI model 534 (e.g., recommended injection well locations, injection volumes, injection rates, etc.) to mitigate the likelihood or impact of induced seismic events. Exemplary processes for training and using AI model 534, as well as a variety of different predictions which can be made by AI model 534, are described in greater detail with reference to FIGS. 5-64. The model predictions and actionable data can be provided as outputs to client system 106. Other outputs of computing system 110 may include various maps, flow models, pressure tracking data, charts, alerts, analytics, and other information which can be used by client system 106 to monitor and control the operation of injection wells 102-104, as described in greater detail with reference to FIGS. 13-18B.

### Predicting and Controlling Induced Seismic Events

Referring now to FIG. 5, a block diagram illustrating computing system 110 in greater detail is shown, according to an exemplary embodiment. Computing system 110 can be configured to predict and control induced seismic events. Controlling induced seismic events may include automatically operating wellsite equipment 546 to adjust the factors that contribute to induced seismic events (e.g., fluid injection rates, locations, volumes, etc.) and/or providing recommendations to wellsite operators (e.g., to injection wells 102-104, to client system 106, etc.) to allow the wellsite operators to make informed decisions based on the predictions generated by computing system 110. Advantageously, the predictions and recommendations generated by computing system 110 can be used to reduce or mitigate the impact of induced seismic events.

Computing system 110 is shown receiving data from various data sources 502, which may include any of a variety of geographical data sources 504, geological data sources 506, seismic/earthquake data sources 508, real-time wellsite data sources 510, engineering data sources 512, aerospace data sources 514, and/or other data sources 516. Computing system 110 can use the data obtained from data sources 502 to train AI model 534 to generate a variety of model predictions. For example, AI model 534 can be trained to predict the probability of inducing a seismic event, a range of magnitudes of the induced seismic event, a location of the induced seismic event, pressure fronts, or other predicted geological conditions as a result of a given or simulated control strategy for wellsite equipment 546 (e.g., injection rates, volumes, locations, etc.).

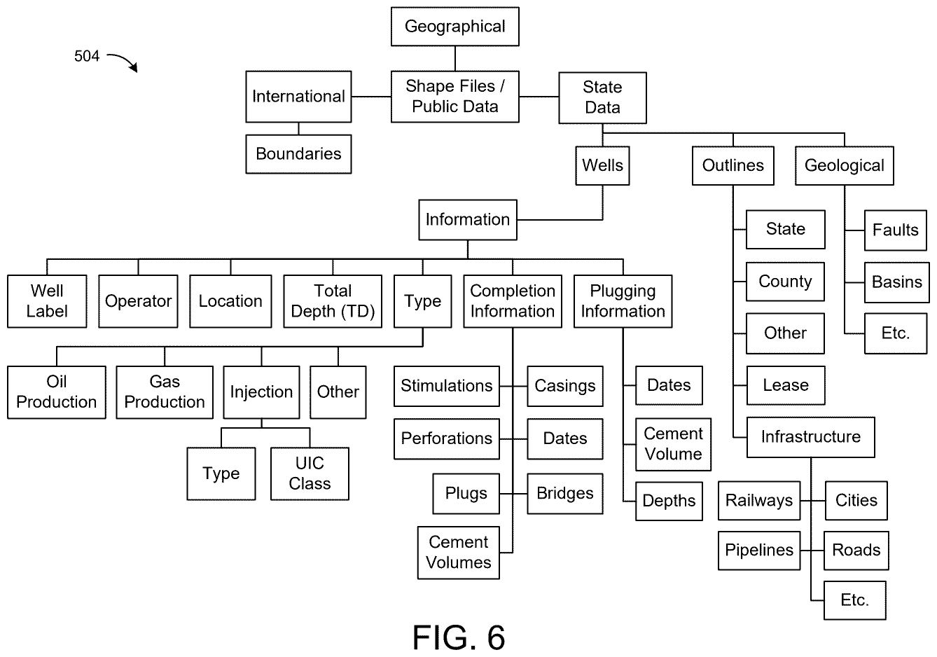

Computing system 110 can use the model predictions to generate recommended wellsite locations for new injection wells and/or optimal control actions for wellsite equipment 546 (e.g., injection rates, injection volumes, etc.). The optimal wellsite locations and control actions can be selected to reduce or minimize the likelihood, severity, or other attributes of the induced seismic events predicted by AI model 534. In some embodiments, computing system 110 uses the model predictions and recommended control actions to automatically generate control signals for wellsite equipment 546, which can be provided to injection wells 102-104 as part of a closed loop feedback control process. In some embodiments, computing system 110 uses the model predictions and other recommendations to generate and provide various outputs 552, which may include maps 554, flow models 556, pressure tracking 558, charts 560, alerts 562, analytics 564, user interfaces 566, and/or any other outputs. Several examples and uses of data sources 502 and outputs 552 are described in greater detail with reference to FIGS. 6-18B.

Still referring to FIG. 5, computing system 110 is shown to include a communications interface 518 and a processing circuit 520. Communications interface 518 may facilitate communications between computing system 110 and various other systems or devices (e.g., data sources 502, injection wells 102-104, seismic monitoring station 108, wellsite equipment 546, etc.) for allowing user control, monitoring, and adjustment of wellsite operations. Communications interface 518 may also facilitate communications between computing system 110 and client system 106 or other downstream systems or devices that consume the outputs 552 generated by computing system 110 (e.g., presenting outputs 552 to client system 106, using outputs 552 to operate wellsite equipment 546, etc.).

Communications interface 518 can be or include wired or wireless communications interfaces (e.g., jacks, antennas, transmitters, receivers, transceivers, wire terminals, etc.) for conducting data communications between computing system 110 and other components of system 100. In various embodiments, the data communications via communications interface 518 can be direct (e.g., local wired or wireless communications) or via a communications network 126 (e.g., a WAN, the Internet, a cellular network, etc.). For example, communications interface 518 can include an Ethernet card and port for sending and receiving data via an Ethernet-based communications link or network. In another example, communications interface 518 can include a Wi-Fi transceiver for communicating via a wireless communications network. In another example, communications interface 518can include cellular or mobile phone communications transceivers.

Processing circuit 520 is shown to include a processor 522 and memory 524. Processing circuit 520 can be communicably connected to communications interface 518 such that processing circuit 520 and the various components thereof can send and receive data via communications interface 518. Processor 522 can be implemented as a general purpose processor, an application specific integrated circuit (ASIC), one or more field programmable gate arrays (FPGAs), a group of processing components, or other suitable electronic processing components. Processor 522 may include one or more processors which can be located within the same machine or device or distributed across machines or devices in various embodiments.

Memory 524 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 524 can be or include volatile memory or non-volatile memory. Memory 524 can include database components, object code components, script components, or any other type of information structure for supporting the various activities and information structures described in the present application. Memory 524 include one or more non-transitory computer-readable storage media which can be located within the same machine or device or distributed across machines or devices in various embodiments. According to some embodiments, memory 524 is communicably connected to processor 522 via processing circuit 520 and includes computer code for executing (e.g., by processing circuit 520 and/or processor 522) one or more processes described herein.

### Data Collection and Processing

Still referring to FIG. 5, computing system 110 is shown to include a data collector 526. Data collector 526 can be configured to collect (e.g., receive, obtain, request, etc.) data from various data sources 502 for use in training AI model 534 and/or as inputs to AI model 534 after training has been completed. Data sources 502 are shown to include geographical data sources 504, geological data sources 506, seismic/earthquake data sources 508, real-time wellsite data sources 510, engineering data sources 512, aerospace data sources 514, and/or other data sources 516, each of which is described in greater detail below with reference to FIGS. 6-12. Data collector 526 can be configured to process the raw input data received from data sources 502 to prepare the input data for use in training AI model 534 and/or as inputs to AI model 534. Processing the raw input data may include, for example, generating timeseries of the raw input data including series of data values and corresponding time stamps, tagging or marking the input data with metadata or other attributes indicating the data source (e.g., specific databases, external systems, sensors, etc.), units of measure, location of measurement, and/or any other information that provides context for the input data. In some embodiments, data collector 526 processes the raw input data by correlating data samples from different data sources 502 with each other or time-matching the data samples with each other for subsequent use by computing system 110.

Computing system 110 is shown to include a training data generator 528. Training data generator 528 can be configured to obtain the processed input data from data collector 526 and/or the raw input data from data sources 502 (collectively input data) and generate the set of training data used to train AI model 534 from the input data. The training data used to train AI model 534 may include a subset of the input data and/or additional data derived from the input data. For example, training data generator 528 can be configured to calculate various derived metrics using multiple samples of the input data from the same or different data sources 502. Some derived metrics may use data from multiple different data sources 502 to calculate various indices, key performance indicators (KPIs), fluid or thermal properties, ratios, correction factors, or other derived data values based on the input data. Examples of such derived metrics may include well production or injection rate, wellbore pressure drop, reservoir pressure, wellbore productivity index, formation damage, pump efficiency, hydraulic power, and many others, as described in greater detail with reference to FIGS. 6-12. In some embodiments, training data generator 528 assigns a confidence level or uncertainty level to each sample of the training data for use by model trainer 530. The training data generated by training data generator 528 can be provided as inputs to model trainer 530.

In some embodiments, training data generator 528 uses one or more models, equations, empirical relationships, conversion factors, or other inputs indicating relationships between variables to calculate derived metrics based on the input data from data sources 502. Examples of models and equations which can be used to calculate derived metrics include pore pressure models, hydrogeology models, geotechnical-seismic models, well log analysis calculations, log analysis tables, seismic models, reservoir characterization models, dynamic flow models, or any other models which can be used to calculate derived metrics based on the input data from data sources 502. Examples of pore pressure models may include effective stress principle models, empirical relationships, petrophysical relationships, geophysical methods, thermodynamic and fluid flow equations, geomechanical models, compaction and consolidation models, seismic methods, thermal and chemical models, ground deformation models, etc. Examples of hydrogeology models may include Darcy's law of fluid flow, hydraulic diffusivity models, hydrologic equations, effective depth of precipitation models, infiltration capacity curves, baseflow recession models, overland flow models, runoff prediction models, ground water discharge models, recession curve displacement models, matter and energy equations (e.g., equations for calculating force, weight, density, specific weight, pressure, etc.), porosity equations, hydraulic conductivity models, storativity models, hydraulic conductivity models, etc.

Examples of geotechnical-seismic models include the Gutenberg-Richter recurrence law, return period equations for earthquakes exceeding a particular magnitude, attenuation models to obtain peak horizontal acceleration values, empirical relationships between moment magnitude (Mw), surface rupture length (km), rupture area (km²), and maximum surface displacement (m), etc. Examples of well log analysis calculations include porosity equations, water saturation equations, hydrocarbon saturation equations, resistivity equations, archies equation, formation temperature models, temperature gradient calculations, resistivity models for fluids at different depths and temperatures, shale volume calculations (e.g., based on gamma rays, expressed as a decimal or %, for tertiary rocks, etc.), sonic porosity (e.g., in normal formations and unconsolidated formations), compaction factor equations, hydrocarbon effects relationships, bulk density equations, induction logs, true resistivity from dual induction logs, nuclear magnetic resonance (NMR) permeability, mean-t2 (or SDR) NMR permeability model, bulk volume water (BVW) equations, m-n lithology plots, mineral-identification plots, apparent matrix volumetric photoelectric factor equations, etc.

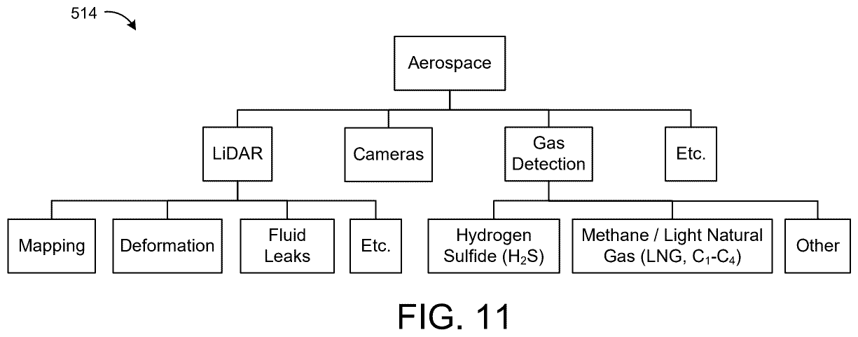

Examples of inputs used to calculate derived metrics from log analysis tables include conversion values for hydraulic conductivity, ranges of intrinsic permeabilities and hydraulic conductivities for unconsolidated sediments, different coefficients and exponents used to calculate formation factor (f), sonic velocities and interval transit times for different matrixes, typical NMR properties of reservoir fluids, matrix coefficients of several minerals and types of porosity (e.g., for liquid-filled boreholes), and bulk volume water (BVM) as a function of grain size and lithology, etc. Examples of seismic models include Linear Slip Theory equations, principal horizontal stress equations, Differential Horizontal Stress Ratio calculations, etc. Examples of reservoir characterization models include Influence of Confining Stress and Klinkenberg Effect models, Principal Pore Throat Diameter (PPTD) calculations, etc. Examples of dynamic flow models include models for estimating the mass of CO₂ or other fluids that can be stored in a target formation, etc. These and other types of models and equations which can be provided as inputs to computing system 110 (e.g., for use in training AI model 534, during online operation of AI model 534, or otherwise used by computing system 110) are described in greater detail with reference to FIG. 12 and other data sources 516. Several examples of derived metrics which can be calculated using these and other models, equations, or other calculations are described in detail with reference to FIGS. 6-18B.

### Model Training

Still referring to FIG. 5, computing system 110 is shown to include a model trainer 530 and an AI model 534. Model trainer 530 can be configured to train AI model 534 using the training data generated by training data generator 528. The specific type of training process performed by model trainer 530 may depend on the type of AI model 534. In some embodiments, AI model 534 includes one or more machine learning models, which can be implemented in hardware, software, firmware, or any combination thereof. By way of example, some types of machine learning models which can be used as AI model 534 may include supervised learning models, clustering models, neural network models, reinforcement learning models, decision trees, support-vector machines, Bayesian networks, Gaussian processes, genetic algorithms models, any other models that can be used by one or more machine learning algorithms, any other models that can learn from the training data from training data generator 528 to perform tasks without explicit instructions, or various combinations thereof. In some embodiments, AI model 534 is a causal AI model configured to determine or predict the causes of seismic events.

Types of neural network models which can be used as AI model 534 may include, for example and without limitation, artificial neural networks (ANNs), deep neural networks (DNNs), deep belief networks (DBNs), one or more language models, large language models (LLMs), attention-based neural networks, transformer-based neural networks, generative pretrained transformer (GPT) models, bidirectional encoder representations from transformers (BERT) models, encoder/decoder models, sequence to sequence models, autoencoder models, generative adversarial networks (GANs), convolutional neural networks (CNNs), recurrent neural networks (RNNs), diffusion models (e.g., denoising diffusion probabilistic models (DDPMs)), any other models that can make decisions similar to the human brain, or various combinations thereof. In some embodiments, the neural network of AI model 534 includes a plurality of nodes, which may be arranged in layers for providing outputs of one or more nodes of one layer as inputs to one or more nodes of another layer. The neural network can include one or more input layers, one or more hidden layers, and one or more output layers. Each node can include or be associated with parameters such as weights, biases, and/or thresholds, representing how the node can perform computations to process inputs to generate outputs.

Model trainer 530 can be configured to train (e.g., update, configure, learn, fine-tune, adapt, etc.) AI model 534 using various learning or training operations, such as unsupervised learning, weakly supervised learning, semi-supervised learning, supervised learning, any other learning or training operations that can learn from the training data and generalize to unseen data, or various combinations thereof. For example, model trainer 530 can be configured to generate or update parameters of nodes of a neural network model such as weights, biases, and/or thresholds to configure AI model 534 to make the various types of predictions and/or generate the outputs 552 described throughout the present disclosure. Such outputs 552 may include maps 554, flow models 556, pressure tracking 558, charts 560, alerts 562, analytics 564, user interfaces 566 and/or any other outputs which can be used to predict or mitigate induced seismic events and/or operate wellsite equipment 546. Outputs 552 are described in greater detail with reference to FIGS. 13-18B.

Model trainer 530 can be configured to train AI model 534 using training data from various domain-agnostic and/or domain-specific data sources (e.g., data sources 502), including but not limited to various forms of sensor data, timeseries data, text data, image data, audio data, numeric data, and/or video data, or various combinations thereof. The training data can include a plurality of training data elements (e.g., training data instances). Each training data element can be arranged in structured or unstructured formats. For example, a training data element can include an example output of AI model 534 (e.g., seismic/earthquake predictions or any of the other model predictions described herein) mapped to an example input of AI model 534 (e.g., real-time wellsite data, geological data, and/or data from any of data sources 502). The training data can include data that is not separated into input and output subsets (e.g., for configuring the machine learning model to perform clustering, classification, or other unsupervised machine learning operations). The training data can include human-labeled information, including but not limited to feedback regarding outputs of the machine learning model, which can allow the machine learning model to generate more human-like outputs.

In some embodiments, AI model 534 includes one or more language models such as large language models (LLMs), attention-based neural networks, transformer-based neural networks, generative pretrained transformer (GPT) models, bidirectional encoder representations from transformers (BERT) models, encoder/decoder models, sequence to sequence models, autoencoder models, generative adversarial networks (GANs), convolutional neural networks (CNNs), recurrent neural networks (RNNs), diffusion models (e.g., denoising diffusion probabilistic models (DDPMs)), or various combinations thereof. Such models can be configured to receive the model predictions and recommendations generated by AI model 534 and prepare various outputs 552 (e.g., text descriptions, images, graphs, infographics, animations, etc.) for consumption by a human user or downstream system or process.

For example, in some embodiments, AI model 534 includes at least one GPT model. A GPT model can receive an input sequence, and can parse the input sequence to determine a sequence of tokens (e.g., words or other semantic units of the input sequence, such as by using Byte Pair Encoding tokenization). The GPT model can include or be coupled with a vocabulary of tokens, which can be represented as a one-hot encoding vector, where each token of the vocabulary has a corresponding index in the encoding vector. One-hot encoding can be used to convert categorical variables into a binary format (e.g., a value of one indicating a category is present and a value of zero indicating a category is not present) to ensure categorical data can be used effectively by AI model 534. As such, the GPT model can convert the input sequence into a modified input sequence, such as by applying an embedding matrix to the token tokens of the input sequence (e.g., using a neural network embedding function), and/or applying positional encoding (e.g., sin-cosine positional encoding) to the tokens of the input sequence. The GPT model can process the modified input sequence to determine a next token in the sequence (e.g., to append to the end of the sequence), such as by determining probability scores indicating the likelihood of one or more candidate tokens being the next token, and selecting the next token according to the probability scores (e.g., selecting the candidate token having the highest probability scores as the next token). For example, the GPT model can apply various attention and/or transformer based operations or networks to the modified input sequence to identify relationships between tokens for detecting the next token to form the output sequence.

In some embodiments, AI model 534 includes at least one diffusion model, which can be used to generate image and/or video data. For example, the diffusion model can include a denoising neural network and/or a denoising diffusion probabilistic model neural network. Model trainer 530 can configure the denoising neural network by applying noise to one or more training data elements (e.g., images, video frames) to generate noised data, providing the noised data as input to a candidate denoising neural network, causing the candidate denoising neural network to modify the noised data according to a denoising schedule, evaluating a convergence condition based on comparing the modified noised data with the training data instances, and modifying the candidate denoising neural network according to the convergence condition (e.g., modifying weights and/or biases of one or more layers of the neural network). In some implementations, AI model 534 includes a plurality of generative models, such as GPT and diffusion models, that can be trained separately or jointly by model trainer 530 to facilitate generating multi-modal outputs, such as maps 554, charts 560, alerts 562, or other outputs 552 that include both text and image/video information.

In some embodiments, model trainer 530 receives an initially untrained version of AI model 534 and executes a model training process to generate the trained version of AI model 534 which can be used by computing system 110 during online operation or offline predictions. For example, model trainer 530 can train (e.g., configure, update, modify, fine-tune, etc.) the untrained version of AI model 534 to generate the trained version of AI model 534. In some implementations, AI model 534 can be used to provide application-specific outputs, such as outputs having greater precision, accuracy, or other metrics, relative to the untrained AI model, for targeted applications. The model training process performed by model trainer 530 may include iteratively updating the model parameters of AI model 534 (e.g., neural network weights, biases, etc.) until the model predictions generated by AI model 534 based on the training data (i.e., the model input data in the set of training data) are sufficiently close to the training data outputs (i.e., model output in the set of training data). In other words, the model training process may be performed until AI model 534 becomes sufficiently accurate at predicting the various model outputs represented in the training data.

In some embodiments, model trainer 530 performs various training operations on AI model 534 via one or more interfaces, such as application programming interfaces (APIs). For example, AI model 534 can be operated and maintained by a remote instance of model trainer 530, which can be implemented at a different physical location than AI model (e.g., a different computer, different building, different cloud computing hardware, etc.) for embodiments in which computing system 110 is distributed across multiple physical systems or devices which communicate with each other via a communications network. In such implementations, model trainer 530 can provide training data to AI model 534, via the API, to train the parameters (e.g., weights, nodes, biases, etc.) of AI model 534 based on the training data. Model trainer 530 can control various training parameters or hyperparameters (e.g., learning rates, etc.) by providing instructions via the API to manage configuring AI model 534.

In some embodiments, model trainer 530 can identify one or more parameters (e.g., weights and/or biases) of one or more layers of AI model 534 and maintain (e.g., freeze, maintain as the identified values while updating) the values of the one or more parameters of the one or more layers. In some implementations, model trainer 530 can modify one or more layers, such as to add, remove, or change an output layer of the one or more layers, or to not maintain the values of the one or more parameters. Model trainer 530 can select at least a subset of the identified one or parameters to maintain according to various criteria, such as user input or other instructions indicative of an extent to which AI model 534 is to be modified during the training process. In some implementations, model trainer 530 can modify AI model 534 so that an output layer of AI model 534 produces outputs 552 or other model predictions.

Model trainer 530 can apply, as input to AI model 534, training data from data sources 502. For example, model trainer 530 can apply the training data as input to AI model 534 (e.g., a candidate AI model with untrained or partially trained parameters) to cause AI model 534 to generate one or more candidate outputs corresponding to outputs 552. Model trainer 530 can evaluate a convergence condition to modify the candidate AI model 534 based at least on the one or more candidate outputs and the training data applied as input to the candidate AI model 534. For example, model trainer 530 can evaluate an objective function of the convergence condition, such as a loss function (e.g., L1 loss, L2 loss, root mean square error, cross-entropy or log loss, etc.) based on the one or more candidate outputs and the training data. This evaluation can indicate how closely the candidate outputs generated by the candidate AI model 534 correspond to the ground truth represented by the training data. Model trainer 530 can use any of a variety of optimization algorithms (e.g., gradient descent, stochastic descent, Adam optimization, etc.) to modify one or more adjustable parameters of the candidate AI model 534 (e.g., non-frozen weights or biases of the layer(s) of the candidate AI model 534) of according to the evaluation of the objective function. In some implementations, model trainer 530 can use various hyperparameters to evaluate the convergence condition and/or perform the configuration of the candidate AI model 534 to determine the fully trained version of AI model 534, including but not limited to hyperparameters such as learning rates, numbers of iterations or epochs of training, etc.

Model trainer 530 can perform various machine learning model configuration/training operations to generate or train AI model 534 using the data from data sources 502. For example, the model trainer 530 can perform various updating, optimization, retraining, reconfiguration, fine-tuning, or transfer learning operations, or various combinations thereof, to train AI model 534. Model trainer 530 can configure AI model 534, using data sources 502, to generate various model predictions in response to receiving inputs (e.g., input data) from data sources 502. In some embodiments, model trainer 530 trains AI model 534 to identify correlations or patterns between various data sources 502, such that AI model 534 learns to predict the data from one or more of data sources 502 (e.g., induced seismic events indicated by seismic/earthquake data source 508) based on the data from other data sources 502 (e.g., injection volumes, rates, locations, etc. indicated by real-time wellsite data source 510).

In some embodiments, model trainer 530 can select a set or subset of the training data from training data generator 528 to use when training AI model 534 model training based on a particular application for which AI model 534 will be used. For example, model trainer 530 can select data from at least seismic/earthquake data source 508 and real-time wellsite data source 510 for use in training AI model 534 to predict the impact of real-time wellsite operations on induced seismic/earthquake activity. Model trainer 530 can be configured to select a set or subset of data sources 502 for use in predicting seismic events and/or generating each of the model predictions of AI model 534 or other outputs 552 based on which of data sources 502 contribute to the seismic events or outputs 552. In some embodiments, model trainer 530 uses a stored set of correlations or relationships between various data sources 502, model predictions generated by AI model 534, and outputs 552 to determine which specific data sources 502 to use when training AI model 534 to generate a correlated or related model prediction or output 552. Model trainer 530 can apply various combinations of data from data sources 502 to facilitate configuring AI model 534 for use in generating or predicting each type of model prediction or output 552.

In some embodiments, model trainer 530 trains AI model 534 using geological data (e.g., core data, drill stem test (DST) data, well locations, fault locations, etc.), historical seismic/earthquake data (e.g., earthquake histories, locations, magnitudes, etc.), historical or real-time wellsite data (e.g., injection histories, production or injection data, pressure data, etc.), or any other information gathered from data sources 502. Such data can be obtained from online data sources, log libraries, or any other source as described in detail with reference to FIGS. 6-12. In various embodiments, the training data generator 528 may provide the raw data from data sources 502 as the training data for model trainer 530 (e.g., without preprocessing) or may perform preprocessing on the raw input data (e.g., preprocessing wireline and MWD/LWD logs to correct for hole size variance and log response for better interpretation).

Advantageously, model trainer 530 can train AI model 534 to analyze the factors that contribute to induced seismic events (e.g., injection volumes, injection rates, injection pressures, injection well locations, etc.) in the training data and provide feedback on the primary causes of the induced seismic events. For example, model trainer 530 can train AI model 534 to generate model predictions including a likelihood that one or more induced seismic events will occur within a geographic region or at a particular location (e.g., likelihood of a fault slip), a predicted magnitude or magnitude range of the induced seismic events, and/or a percentage that each factor contributes to induced seismic events. Model trainer 530 can train AI model 534 to identify patterns or correlations between historical seismic events in the set of training data and the factors that contribute to induced seismic events. By analyzing a set of historical seismic events in combination with their contributing factors in the set of training data, AI model 534 can learn which contributing factors are most important or impactful and thus serve as the best predictors of future induced seismic events.

In some embodiments, model trainer 530 trains AI model 534 to model pressure fronts, fluid flows, or other conditions in the underground formations as a result of the injection well operations that contribute to such conditions (e.g., injection volumes, injection rates, injection pressures, injection well locations, etc.). For example, model trainer 530 can train AI model 534 to generate model predictions including predicted sub-surface conditions (e.g., predicted pressures, predicted fluid flows or movement within the reservoirs or formations, etc.) as a result of injection well operations. Model trainer 530 can train AI model 534 to identify patterns or correlations between historical sub-surface conditions in the set of training data and the factors that contribute to such conditions. By analyzing a set of historical sub-surface conditions in combination with their contributing factors in the set of training data, AI model 534 can learn which contributing factors are most important or impactful and thus serve as the best predictors of future sub-surface conditions. In some embodiments, model trainer 530 trains AI model 534 to predict interactions between multiple injection wells and model the pressure fronts and fluid flows that result from injection wells operating at multiple locations within a geographic region.

In some embodiments, model trainer 530 can perform at least one of conditioning, classifier-based guidance, or classifier-free guidance to configure AI model 534 using the data from data sources 502. For example, model trainer 530 can use classifiers associated with the training data (e.g., identifiers of the geographical or geological structures or formations, a type of sensor or system providing the training data, a type of entity operating the sensor or system, a site or location at which the training data is generated or measured, a history of seismic events, etc.) to condition the training of AI model 534. For example, model trainer 530 can combine (e.g., concatenate) various such classifiers with the training data provided as inputs to AI model 534 during training, for at least a subset of the training data used to configure AI model 534. This can enable AI model 534 to be responsive to analogous information for runtime/inference time operations.

In some embodiments, model trainer 530 performs feedback training on AI model 534 to increase the precision and/or accuracy of the outputs generated by AI model 534 according to feedback provided by users of computing system 110 and/or downstream systems or applications (e.g., wellsite operators, client system 106, etc.). Model trainer 530 can use feedback received from users regarding outputs 552 or other model predictions generated by AI model 534. For example, some of outputs 552 can be presented via applications (e.g., computer programs, computer interfaces, graphical user interfaces, etc.) configured to present one or more user input elements (e.g., buttons, selectors, text boxes, voting prompts, etc.) for receiving feedback regarding outputs 552. The user input elements can include, for example, indications of binary feedback regarding outputs 552 (e.g., good/bad feedback, feedback indicating outputs 552 do or do not meet the user's criteria such as technical accuracy or precision), indications of multiple levels of feedback (e.g., scoring the outputs on a predetermined scale, such as a 1-5 scale or 1-10 scale), freeform feedback (e.g., text or audio feedback), or various combinations thereof.

In some embodiments, model trainer 530 can store and/or maintain feedback in a feedback repository. Model trainer 530 can store the feedback with one or more data elements associated with the feedback, including but not limited to the outputs 552 for which the feedback was received, a version or instance of AI model 534 used to generate the outputs 552, and/or input information (e.g., data from data sources 502) used by AI model 534 generate the outputs 552 (e.g., real-time wellsite operating data, geological data, etc.). Model trainer 530 can update AI model 534 using the feedback. Similar to the initial model training process, model trainer 530 can perform various configuration operations (e.g., retraining, fine-tuning, transfer learning, etc.) on AI model 534 using the feedback from the feedback repository. In some embodiments, model trainer 530 identifies one or more first parameters of AI model 534 to maintain as having predetermined values (e.g., freeze the weights and/or biases of one or more first layers of AI model 534), and performs a training process, such as a fine tuning process, to configure or more second parameters of AI model 534 using the feedback (e.g., one or more second layers of AI model 534, such as output layers or output heads of AI model 534).

In some embodiments, model trainer 530 includes an accuracy checker or output processor that can evaluate and/or modify outputs from AI model 534 prior to using such outputs to generate the model predictions, recommendations, or other outputs 552 used by other components of system 100. Accuracy checking can include performing any of various post-processing operations on the output from AI model 534. For example, model trainer 530 can compare outputs of AI model 534 with data from data sources 502 to validate the outputs of AI model 534 and/or modify the outputs of AI model 534 (or output an error) responsive to the outputs not satisfying a validation condition. Model trainer 530 can provide a set of model parameters to AI model 534 (e.g., weights, biases, tuning parameters, hyperparameters, etc.) that configure AI model 534 to generate the various types of model predictions described throughout the present disclosure.

### Model Predictions and Operation

Still referring to FIG. 5, after AI model 534 has been trained, computing system 110 can use AI model 534 to generate model predictions. AI model 534 can be configured to generate the model predictions based on new data obtained from data sources 502 in combination with other data characterizing the wells, geographic region, and/or fault locations. The new data from data sources 502 may include live or real-time data received from real-time wellsite data sources 510 (e.g., real-time measurements from injection wells such as wellhead pressure, injection volume, injection rate, bottomhole pressure, etc.) or other data sources 502 that provide new or updated values of their various types of data. The other data used to characterize the wells may include some or all of the data received from data sources 502 during model training (e.g., core data, well logs, DST data, historic earthquakes, injection well locations, fault locations, historical injection volumes, historical injection rates, etc.).

During online operation of computing system 110, data collector 526 may receive the new data from data sources 502 and provide the new data as inputs to AI model 534. AI model 534 may use the new data to generate model predictions. In some embodiments, the model predictions generated by AI model 534 include a likelihood (e.g., percentage, risk, probability, etc.) that one or more induced seismic events will occur (e.g., likelihood of a fault slip) within a geographic region and/or at a particular location. For example, AI model 534 may predict a percentage likelihood (e.g., 20% likely, 50% likely, 85% likely, etc.) that an induced seismic will occur within a specified time period (e.g., within the next week, month, year, etc.), within an area of interest (e.g., a geographic region containing or adjacent to one or more wells), and/or at a particular location within the area of interest (e.g., a known fault location). AI model 534 may predict the risk that a given or proposed set of control actions, wellsite locations, and other parameters used to locate or operate injection wells (e.g., control signals for wellsite equipment 546) will cause an induced seismic event.

In some embodiments, the model predictions generated by AI model 534 include predicted magnitudes of the induced seismic events or other predicted impacts of the induced seismic events. For example, AI model 534 may predict a magnitude of a predicted earthquake using the Richter scale or other seismic magnitude scales. AI model 534 may predict various metrics or attributes of the induced seismic events such as moment magnitude (Mw) representing the total energy released by an earthquake, spectral acceleration (Sa) indicating the maximum acceleration experienced by a structure, and seismic moment release rate quantifying the rate of energy release over time. AI model 534 can be configured to generate predicted attributes of the induced seismic events such as peak ground acceleration (PGA) indicating the maximum ground acceleration during shaking, peak ground velocity (PGV) indicating the maximum ground velocity during shaking, arias intensity indicating the strength of ground motion, and/or cumulative absolute velocity (CAV) indicating the potential for structural damage. AI model 534 can be configured to predict any of the various metrics or attributes characterizing the predicted seismic events, including any of the types of data provided by data sources 502 and/or derived metrics which can be calculated based on the data from data sources 502, as described in detail with reference to FIGS. 6-12.

In some embodiments, the model predictions generated by AI model 534 include percentages (e.g., probabilities, weights, etc.) that various factors contribute to the induced seismic events. For example, AI model 534 can use the patterns or correlations identified during model training (e.g., patterns or correlations between induced seismic events and their contributing factors) to assign a percentage to each factor that contributes to an induced seismic event predicted by AI model 534. As one example, AI model 534 may generate a model prediction indicating that an induced seismic event predicted by AI model 534 is 20% attributable a first factor, 30% attributable to a second factor, 40% attributable to a third factor, and 10% attributable to a fourth factor. The contributing factors may include, for example, injection volumes, injection rates, injection pressures, distances between injection wells and known fault locations, other operating parameters of one or more injection wells, or any other factors that may contribute to induced seismic events. Advantageously, the percentages assigned by AI model 534 to various factors indicate the relative amounts that each factor contributes to the induced seismic events. Computing system 110 can use these percentages to generate recommendations that reduce the likelihood or impact of induced seismic events by adjusting the most significant contributing factors.

In some embodiments, the model predictions generated by AI model 534 include pressure fronts, fluid flows, or other conditions in the underground formations as a result of the injection well operations that contribute to such conditions (e.g., injection volumes, injection rates, injection pressures, injection well locations, etc.). For example, AI model 534 can be configured to predict sub-surface conditions (e.g., predicted pressures, predicted fluid flows or movement within the reservoirs or formations, etc.) as a result of injection well operations. AI model 534 can use the patterns or correlations identified during model training (e.g., patterns or correlations between sub-surface conditions and injection well operations) to predict the sub-surface conditions that will result from a given or proposed set of operating parameters for one or more injection wells.

In some embodiments, the model predictions generated by AI model 534 include interactions between multiple injection wells and models of the pressure fronts and fluid flows that are predicted to result from operating injection wells at multiple locations within a geographic region. The model predictions generated by AI model 534 may include the fluid movement between zones of interest, along fault boundaries, or otherwise using a 2D, 3D, or 4D model. A 4D model may predict the evolution of the predicted variables over time to add an extra time dimension to a 3D model. In some embodiments, the model predictions include flow modeling that indicates where and how the injected fluid is moving in the subsurface formations. Such flow modeling may enable AI model 534 to make more accurate predictions and simulate interactions between wells that may lead to adverse effects. In some embodiments, the model predictions include a predicted amount of time between an injection event and an induced seismic event predicted by AI model 534 (e.g., a lag time or delay time between cause and effect).

In some embodiments, the model predictions generated by AI model 534 include variable sub-surface stress and pressure states that are altered by the injection of fluids via injection wells. Computing system 110 and/or a wellsite operator can respond to the predictions generated by AI model 534 to set or adjust the operating parameters for wellsite equipment 546 based on the risk of induced seismic events. For example, computing system 110 can generate recommended operating parameters for wellsite equipment 546, provide control signals to wellsite equipment 546, or provide recommendations on what intervening actions can be taken to cause the injection wells to operate in a manner that minimizes or reduces the risk of induced seismic events predicted by AI model 534. Advantageously, this feature allows computing system 110 to take preventative action based on the predictions generated by AI model 534 to prevent or mitigate induced seismic events before they occur.

Still referring to FIG. 5, computing system 110 is shown to include several additional components including a scenarios generator 536, recommendation generator 538, wellsite optimizer 540, wellsite controller 542, and output/UI generator 544. Scenarios generator 536 may be configured to generate a plurality of alternative or hypothetical scenarios which can be provided as inputs to AI model 534 and used as the basis for the model predictions generated by AI model 534. The scenarios generated by scenario generator 536 may include different combinations of control actions (e.g., injection volumes, injection rates, production volumes, production rates, pressures, etc.) at one or more wells within a given geographic region.

In some embodiments, the scenarios generated by scenarios generator 536 include different combinations of control actions or other factors that are outside of the control of a particular entity (e.g., an operator, customer, client, user, etc.) that uses computing system 110 to optimize the operation of one or more wells controlled by the entity. For example, consider the geographic region shown in FIG. 2 which includes two injection wells 102 and 104. Injection well 102 may be owned or operated by a first entity who uses computing system 110 to optimize the operation of injection well 102, whereas injection well 104 may be owned or operated by a second entity and cannot be controlled by the first entity. The scenarios generated by scenarios generator 536 may include different ways in which injection well 104 (and any other wells outside the control of the first entity) can be operated. Although injection well 104 cannot be controlled by computing system 110 or the entity using computing system 110, the actions taken by injection well 104 still influence the risk of induced seismic events in the geographic region and can be considered by computing system 110 when considering the optimal control actions for injection well 102. The wells that are outside the control of the first entity are referred to herein as “uncontrolled wells.”

In some embodiments, scenarios generator 536 generates a best case scenario assuming that any uncontrolled wells are inactive or operating at minimum capacity (e.g., injecting at the minimum permitted volume, minimum permitted rate, and minimum permitted pressure) or otherwise taking actions that minimize the risk of induced seismic events in the geographic region. Scenarios generator 536 may also generate a worst case scenario assuming that any uncontrolled wells are operating at maximum capacity (e.g., injecting at the maximum permitted volume, maximum permitted rate, and maximum permitted pressure) or otherwise taking actions that maximize the risk of induced seismic events. In some embodiments, scenarios generator 536 generates any number of other scenarios between the best case scenario and the worst case scenarios. For example, scenarios generator 536 may generate an average scenario assuming that any uncontrolled wells are operating at half capacity midway between the minimum and maximum capacity. It is contemplated that any number of scenarios can be generated by scenarios generator 536 in various embodiments.

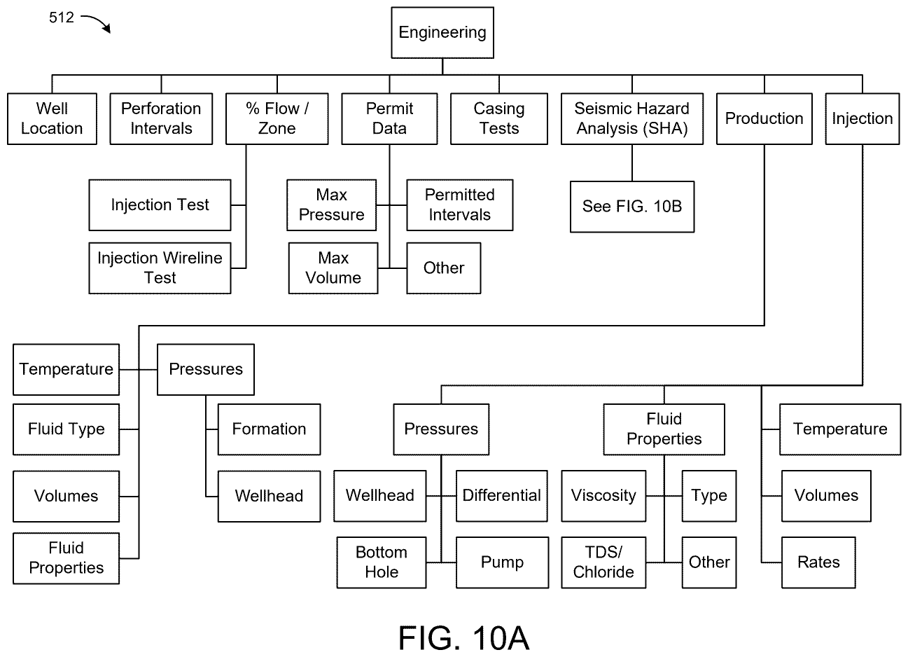

In some embodiments, scenarios generator 536 generates the scenarios based on permit data associated with the uncontrolled wells. For example, data collector 526 may obtain permit data for all wells in a geographic region as a type of input from engineering data sources 512, as described in greater detail with reference to FIGS. 10A-10B. Scenarios generator 536 can use the permit data to determine the permitted ranges of operation of the uncontrolled wells and establish expected operating ranges (e.g., minimum and maximum values) for the injection rates, production rates, injection volumes, production volumes, pressures, and/or other operating parameters or the uncontrolled wells. Scenarios generator 536 can use the expected operating ranges to generate the best case scenario, worst case scenario, average scenario, and/or any other scenarios based on the variable operation of the uncontrolled wells.

In some embodiments, scenarios generator 536 generates the scenarios based on known operating parameters of the uncontrolled wells. For example, in some cases, both the first entity (i.e., the entity that controls injection well 102) and the second entity (i.e., the entity that controls injection well 104) may independently interact with computing system 110 to optimize the operation of their separately owned and operated injection wells 102 and 104. Accordingly, computing system 110 may be aware of the current operating parameters and/or future planned operating parameters of both injection wells 102 and 104, even though the first and second entity do not communicate with each other. Computing system 110 may be configured to prevent each entity from viewing any entity-specific data associated with the other entity (e.g., to ensure privacy and confidentiality for each customer), but can use the data for both injection wells 102 and 104 to generate the model predictions. For example, scenarios generator 536 may be configured to generate a current scenario which assumes that any wells controlled by entities that share data with computing system 110 are operated in accordance with the current or planned operating parameters available to computing system 110. In this way, scenarios generator 536 can generate a scenario which accurately captures the activity of multiple wells operated by separate entities for use by AI model 534 when generating the model predictions while preventing each entity from directly viewing the data associated with the other entity.

Scenarios generator 536 may provide each scenario as an input to AI model 534, which causes AI model 534 to generate a set of scenario-specific model predictions for each scenario. The model predictions for a given scenario may include any of the various model predictions described throughout the present disclosure (e.g., likelihood of induced seismic events, magnitudes, locations, contributing factors, fluid flow models, pressure models, predicted impacts or damage of induced seismic events, etc.). AI model 534 can evaluate each scenario generated by scenarios generator 536 and predict the risk of induced seismic events for each scenario. In some embodiments, AI model 534 evaluates each scenario in combination with the parameters which can be adjusted or affected by the first entity (e.g., by operating one or more wells controlled by the first entity). For example, when evaluating a given scenario, AI model 534 may consider the parameters of the uncontrolled wells as fixed inputs, but may consider the parameters of any wells that can be controlled by the first entity as variables which can be adjusted to determine the optimal set of parameters for the controlled wells.

In some embodiments, scenarios generator 536 operates in combination with wellsite optimizer 540 to generate and evaluate the different alternative or hypothetical scenarios. For example, wellsite optimizer 540 may be configured to evaluate the model predictions generated by AI model 534 for each scenario to determine which scenarios qualify as the best case scenario, the worst case scenario, the average scenario, etc. In some embodiments, wellsite optimizer 540 uses an objective function to evaluate the model predictions from AI model 534 for each scenario and assign a value or score to each scenario. The objective function may define the value that wellsite optimizer 540 seeks to optimize as a function of the model predictions. For example, consider the following objective function which expresses the value of the control objective J as a function of the model predictions x₁, x₂, . . . xₙ:

$$J = f ( {x}_{1} , {x}_{2} , … {x}_{n} )$$

The function ƒ( ) may include any function that calculates the value of the control objective Jbased on the model predictions x₁, x₂, . . . xₙ. For example, the function ƒ( ) may calculate J as a weighted combination or sum of the induced seismic events predicted by AI model 534, where each induced seismic event is weighted based on its predicted impact (e.g., magnitude, damage to structures, impact on ecology or biology, economic damage, etc.).

In some embodiments, the function ƒ( ) accounts for the performance of the well by including a term that quantifies the amount of fluid produced or injected via the well, or otherwise quantifies the performance of the well. Accordingly, the control objective J may be a function of not only induced seismic events, but also other factors (e.g., competing control objectives) that can be weighed against the risk of induced seismic events (e.g., well profitability, well performance, etc.) when considering the optimal well parameters. Several factors which can be considered when calculating the predicted impact of induced seismic events and can be included in the function ƒ( ) are described in greater detail with reference to other data sources 516. Wellsite optimizer 540 may be configured to evaluate or score each scenario using the objective function when generating the best case, worst case, and average scenarios.

In some embodiments, wellsite optimizer 540 performs a predictive optimization process for each scenario to determine a set of control actions for wellsite equipment 546 and/or wellsite locations (collectively well parameters) that are optimal for each scenario. For example, assuming scenarios generator 536 generates ten different scenarios, wellsite optimizer 540 may perform ten different predictive optimization processes (i.e., one for each scenario) to determine the optimal set of well parameters for the corresponding scenario. In some embodiments, the predictive optimization process executed by wellsite optimizer 540 may be formulated as a mathematical optimization problem (e.g., using linear programming, nonlinear programming, convex optimization, integer programming, mixed-integer programming, stochastic programming, etc.) which seeks to optimize the value of the control objective J subject to a set of constraints.

The constraints imposed on each predictive optimization process may include, for example, the set of operating parameters of the uncontrolled wells for the corresponding scenario, minimum and maximum values for any variables that can be adjusted by wellsite optimizer 540 when performing the predictive optimization (e.g., control signals for wellsite equipment 546), a permitted area for any wells that do not have fixed locations, and any models or relationships between variables in the predictive optimization process. Wellsite optimizer 540 may consider the parameters of the uncontrolled wells as fixed inputs (i.e., constrained to fixed values defined by the scenario) when performing the predictive optimization process for a given scenario, but may consider the parameters of any wells that can be controlled by the first entity as variables which can be adjusted when performing the predictive optimization process in an effort to optimize the value of the control objective J.

The parameters which can be adjusted by wellsite optimizer 540 when performing the predictive optimization may include control actions for wellsite equipment 546 and/or wellsite locations. The control parameters for wellsite equipment 546 may include any of the controllable variables affected by operating wellsite equipment 546 when injecting or producing fluid (e.g., injection rate, injection volume, production rate, production volume, pressure, etc.) or any other parameters that define the construction or operation of wells controlled by the first entity (e.g., perforated intervals, depths, etc.). The wellsite locations may include the locations of any wells which have not yet been constructed and could be placed at a variety of different locations within a geographic region or other area of interest. For example, the wellsite locations may include latitude and longitude coordinates or other geographic coordinates that define the locations of proposed wells within a permitted area.

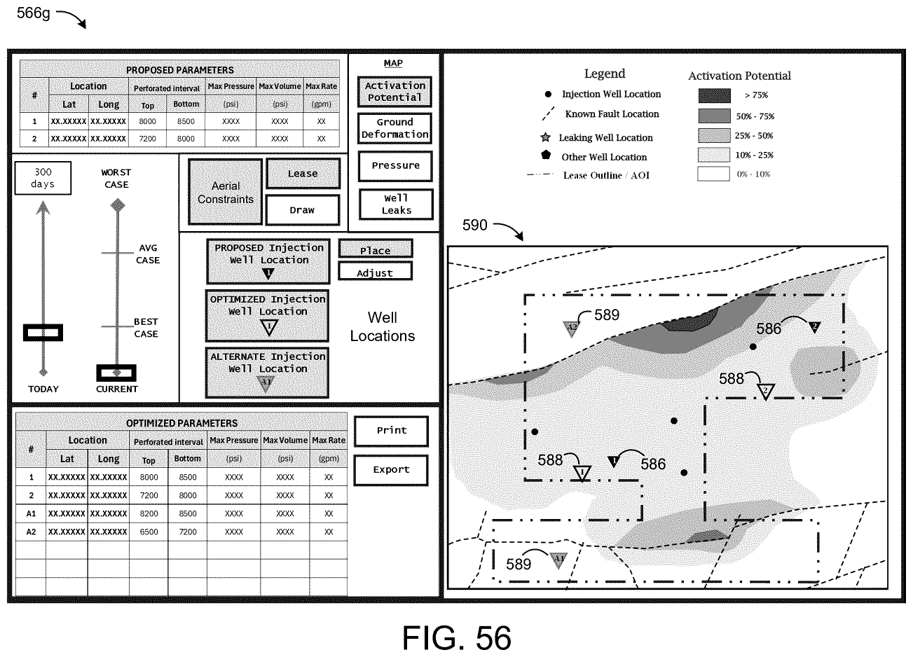

In some embodiments, the set of variables which are adjusted or optimized by wellsite optimizer 540 and the set of variables which are treated as fixed constraints by wellsite optimizer 540 when performing the predictive optimization depends on the mode in which wellsite optimizer 540 is operated. For example, consider a first use case in which the first entity is considering installing new wells within an area of interest and uses computing system 110 to determine the optimal locations at which the wells can be constructed to reduce the risk of induced seismic events. In this use case, wellsite optimizer 540 may consider both the wellsite locations of the new wells and the operating parameters for wellsite equipment 546 of the new wells (and potentially any existing wells) as free variables which can be adjusted when performing the predictive optimization. Conversely, consider a second use case in which the wellsite locations cannot be changed (e.g., the first entity has already constructed the wells or inherited existing wells). In this use case, wellsite optimizer 540 may consider the wellsite locations as fixed inputs to the predictive optimization and may only adjust the operating parameters for wellsite equipment 546 of the existing wells when performing the predictive optimization. These use cases are described in greater detail with reference to FIGS. 56-58.

Wellsite optimizer 540 may be configured to perform an iterative optimization process to determine optimal values for the well parameters in each scenario. The iterative optimization process may include adjusting the well parameters, using AI model 534 to generate model predictions indicating conditions that are predicted to result from the set of well parameters (e.g., risk of seismic events, magnitudes, flow models, pressure conditions, etc.), and evaluating the model predictions using the objective function to determine whether the adjustment improved or worsened the value of the control objective J. Wellsite optimizer 540 may repeat this iterative optimization process until the well parameters have been sufficiently optimized (e.g., convergence criteria have been satisfied) for each scenario.

In some embodiments, the objective function ƒ( ) optimized by wellsite optimizer 540 may be a function of one or more metrics that indicate the efficiency or productivity of the well or set of wells (e.g., amount of fluid injected or produced, rate of injection or production, value of fluid produced, etc.). Wellsite optimizer 540 can be configured to optimize the objective function ƒ( ) subject to constraints that require the risk of induced seismic events to be maintained below an acceptable level. For example, wellsite optimizer 540 can adjust the well parameters (i.e., the wellsite locations and/or control actions for wellsite equipment 546) when performing the iterative optimization process and provide AI model 534 with a set of proposed well parameters with each iteration. AI model 534 can predict the risk of induced seismic events predicted to result from the set of proposed well parameters and provide the risk value back to wellsite optimizer 540. Wellsite optimizer 540 can compare the risk of induced seismic events from AI model 534 to a constraint that defines a maximum acceptable risk of induced seismic events to determine whether that set of proposed well parameters satisfies the constraint. Well optimizer 540 can also evaluate the objective function ƒ( ) using the proposed well parameters and continue adjusting the proposed well parameters in directions that cause the objective function ƒ( ) to move toward an optimal value while ensuring that the risk of induced seismic events stays below the threshold. Advantageously, wellsite optimizer 540 can find an optimal set of well parameters for a well or set of wells that maximize the performance of the well(s) while ensuring that the risk of induced seismic events does not exceed a threshold.

Recommendation generator 538 may be configured to generate recommendations based on the model predictions from AI model 534 and/or the optimal well parameters from wellsite optimizer 540. The recommendations generated by recommendation generator 538 may include, for example, recommended operating parameters for wellsite equipment 546 (e.g., injection volumes, injection rates, pressures, etc.), recommended locations of new wells to be construed within an area of interest, recommended construction parameters or drilling parameters for various wells (e.g., depth, casing, construction materials, etc.), or any other parameters that can be used to construct or operate wells within the area of interest. In some embodiments, recommendation generator 538 provides recommendations that are predicted to optimize the value of the objective function based on the model predictions generated by AI model 534. For example, the recommendations may correspond to the well parameters that are predicted to minimize the risk of induced seismic events, maximize the performance of the wells, or otherwise optimize the value of the control objective J.

Advantageously, the recommendations generated by recommendation generator 538 may be based on the forecasts or predictions generated by AI model 534 with respect to how the recommendations will affect the overall formation pressures and fault-slip activity. For example, recommendation generator 538 may provide recommendations based on the well operator's preferred location and activity, to best fit the lowest pressure/volume/risk regimes, given a boundary to stay within. In some embodiments, the recommendations include recommended injection/production volumes, pressures, and time ranges to stay within to avoid inducing a seismic event or over-pressuring the formation to cause negative effects such as well blowouts, leaks, surface deformation, etc. The recommendations generated by recommendation generator 538 may be based on the predicted fluid flows, sub-surface pressures, surface deformation, well issues, and other model predictions generated by AI model 534 to lessen the effects of sub-surface injection.

In some embodiments, the model predictions generated by AI model 534 and/or the recommendations generated by recommendation generator 538 can be updated or adjusted as more data is collected over time. For example, as AI model 534 is refined or fine-tuned over time and/or additional machine learning capabilities are developed, recommendation generator 538 can be configured to provide updated recommendations using statistical probabilities to maximize injection volumes while minimizing risk of induced seismic events. Recommendation generator 538 can be configured to provide recommendations on injection rates, durations, well locations, or other well parameters in order to gain optimal efficiencies and maximize well productivity while maintaining the risk of induced seismic events below an acceptable threshold.

In some embodiments, computing system 110 is configured to operate as a closed loop feedback control system that automatically controls wellsite equipment 546 installed at one or more wellsites. For example, computing system 110 can receive measurements and other data from real-time wellsite data sources 510 located at one or more wellsites and can use such inputs as feedback to generate recommended wellsite parameters as described above. Wellsite controller 542 may receive the recommended wellsite locations, control actions, and other recommended well parameters from recommendation generator 538. In some embodiments, wellsite controller 542 generates control signals for wellsite equipment 546 based on the recommended well parameters and automatically provides the control signals to wellsite equipment 546 to control their operation (e.g., via a communications network such as network 126). For example, if the control actions generated by recommendation generator 538 indicate recommended injection rates and pressures for a given injection well, wellsite controller 542 can be configured to generate control signals for wellsite equipment 546 that cause wellsite equipment 546 to operate in a manner that achieves the recommended injection rates and pressures.

In some embodiments, computing system 110 does not directly control wellsite equipment 546, but rather provides (e.g., transmits, sends, communicates, etc.) the recommended control actions for wellsite equipment 546 as inputs to one or more controllers configured to operate wellsite equipment 546. Such controllers may include, for example, client system 106, a cloud-based controller configured to operate one or more wells from a remote location, an on-site controller located at a well or wellsite, or any other controller configured to operate wellsite equipment 546 based on the recommendations provided by computing system 110. Accordingly, computing system 110 can operate as an advisory system or supervisory control system which provides the recommendations generated by recommendation generator 538 as targets to be achieved by one or more lower level controllers by operating wellsite equipment 546. The recommendations provided by computing system 110 can be automatically executed by the lower level controllers (i.e., by automatically operating wellsite equipment 546 based on the recommendations) or presented as recommended control actions to be approved by wellsite operators (e.g., one or more human operators) before automatic execution.

In some embodiments, the recommended wellsite locations, control actions, and other recommended well parameters from recommendation generator 538 are provided as inputs to output/UI generator 544. Output/UI generator 544 can generate one or more graphical user interfaces, dashboards, widgets, graphs, plots, data tables, annotated maps, or other user interface elements configured to present any of the information from data sources 502, any of outputs 552 generated by computing system 110, any of the recommendations generated by recommendation generator 538, any of the model predictions generated by AI model 534, or any other information generated or processed by computing system 110 as described throughout the present disclosure. For example, output/UI generator 544 can be configured to generate maps 554, flow models 556, pressure tracking outputs 558, charts 560, alerts 562, analytics 564, and/or user interfaces 566, each of which is described in detail with reference to FIGS. 13-18B. The outputs and UI elements generated by output/UI generator 544 can be presented to wellsite operators (e.g., via client system 106) or other systems or devices configured to monitor and control the operation of wellsite equipment 546.

### Improvements to Technology

The systems and methods described herein provide several unique technical solutions addressing the problem of induced seismicity in the technical field of monitoring and control systems for injection wells and production wells. Induced seismic events can damage buildings, infrastructure, and critical facilities such as dams or power plants. Induced seismic events can also present public safety risks by increasing the likelihood of injuries and fatalities, especially in populated areas. Seismic activity can trigger landslides, groundwater contamination, or changes in subsurface geology, affecting ecosystems and water resources. Increased seismicity can raise insurance costs, deter investment in affected areas, and lead to operational restrictions on industries contributing to the issue. Communities near induced seismicity hotspots may resist industrial activities, leading to social conflicts and regulatory pressure.

The systems and methods described herein address these problems and provide several advantages and improvements over existing technology. For example, existing technologies for monitoring and controlling injection and production wells are generally capable of plotting and mapping geological structures, displaying production/injection volumes per well, and presenting 3D depictions of the subsurface. Some existing technologies are capable of mapping fluid and contaminant flow within reservoirs and predicting fluid propagation over time. However, existing technologies are not capable of predicting earthquakes caused by injection activities or optimizing well parameters to reduce the risk of induced seismic events.

The systems and methods described herein improve upon existing technologies by using predictive models (e.g., AI model 534) to determine the factors that contribute most significantly to induced seismic events and predict the risk of future induced seismic events based on a proposed set of well parameters (e.g., well locations and/or control actions for wellsite equipment 546) over a future time period. For example, computing system 110 can create a database of well and formation information to build a history of wellsite activity and causally related effects (e.g., earthquakes, well leaks, ground deformation, etc.). AI model 534 can evaluate this information to determine the root cause of the adverse effects and forecast future effects based on historical, real-time, and/or proposed well parameters for a future time period.

Computing system 110 can use AI model 534 to predict the fluid and pressure movements throughout the subsurface from multiple points of injection and various zones that may interconnect (e.g., using machine learning and deep learning AI to model flow, pressure, etc.) predicted to result from a proposed set of well parameters. This allows computing system 110 to forecast future induced seismic events and other adverse effects based on current activities and trends, and potential future manipulation of wellsite activities. Advantageously, computing system 110 can predict outcomes such as induced seismic events, well leaks, ground formation, fluid flows, and pressures in subsurface formation predicted to result from various alternative or hypothetical scenarios (e.g., best case scenario, average scenario, worst case scenario, etc.). Computing system 110 can provide recommendations to wellsite operators and/or automatically control wellsite equipment 546 to take preemptive action based on the predictions generated by AI model 534 to reduce the risks of induced seismic events while optimizing wellsite operations.

A significant improvement provided by the systems and methods of the present disclosure over existing technology is that computing system 110 enables proactive or preventative measures to be taken to reduce the risk of induced seismic events or other adverse effects. For example, existing technologies in the field of well monitoring and control systems typically use data from seismic monitoring stations and/or wellsite monitoring equipment to detect problems which have already occurred, such as earthquakes or well leaks. Wellsite operators then must respond to these events retroactively and must repair or replace any wellsite equipment that has been damaged as a result of the detected problems. Existing technologies only allow for a retroactive response after an induced seismic event occurs and the damage caused by the event has already been incurred, both to the wellsite equipment and to any critical infrastructure or buildings in the surrounding geographic region.

Advantageously, computing system 110 and AI model 534 can be used to forecast future induced seismic events and other adverse consequences predicted to result from a given set of well parameters such as well locations and control actions for wellsite equipment 546. Computing system 110 can optimize the well parameters to reduce the risk of induced seismic events while ensuring that the wells are operated efficiently and productively. Computing system 110 can automatically control wellsite equipment 546 to execute the recommended control actions and/or can provide recommendations to wellsite operators or other entities to optimize the locations and activities of their controlled wells. In this way, computing system 110 enables preemptive or preventative actions to be taken to prevent induced seismic events from occurring or minimize the risk of induced seismic events, thereby preventing or mitigating the damage caused by such events before they occur.

Additionally, computing system 110 and AI model 534 enable insights and actions that are not possible or practical for a human to generate mentally due to the large amount of data used to train and operate AI model 534. For example, AI model 534 may analyze hundreds or thousands of large datasets from data sources 502 over a historical time period spanning years or decades to identify or derive correlations between variables in the datasets and identify the root causes of adverse effects (e.g., earthquakes, well leaks, etc.). It would be impossible or impractical for a human to perform this analysis mentally due to the sheer volume of data processed by AI model 534 to derive the correlations. The long and variable lags between the time when injection started and the time of the event, the geological complexity of the formations, and fluid/pressure movement in the subsurface are also too complex to model appropriately by hand.

Furthermore, it would be impossible for a human to process new incoming data from data sources 502 (e.g., live or real-time data) within a timeframe sufficient to predict future induced seismic events and take preventative action before such events occur. However, AI model 534 is capable of processing new data from data sources 502 in near real-time and can provide model predictions within a timeframe sufficiently short to allow preventative measures to be taken before adverse events occur. In these ways, computing system 110 improves upon existing technologies and provides a practical application in the field of monitoring and control systems for injection and production wells.

### Data Sources

Referring now to FIGS. 6-12, diagrams illustrating data sources 502 in greater detail are shown, according to an exemplary embodiment. Data sources 502 may provide the input data used to train AI model 534 and/or as inputs to AI model 534 after training has been completed. The data provided by data sources 502 can be processed by data collector 526 as described with reference to FIG. 5 and used as inputs for model training and/or model operation. Computing system 110 may use any combination of data sources 502 and/or any metrics derived from the data provided by data sources 502 when training AI model 534, using AI model 534 to make model predictions, generating recommendations, generating outputs 552, or otherwise as described in greater detail below. Data sources 502 are shown to include geographical data sources 504, geological data sources 506, seismic/earthquake data sources 508, real-time wellsite data sources 510, engineering data sources 512, aerospace data sources 514, and/or other data sources 516, each of which is described below.

### Geographical Data Sources

Referring specifically to FIG. 6, a diagram illustrating geographical data sources 504 in greater detail is shown, according to an exemplary embodiment. Geographical data sources 504 are shown to include a variety of data sources that provide information regarding the geography of the locations of injection wells 102-104 and surrounding geographic regions. Geographic information may include, for example, topographic information affecting construction feasibility, site stability, and drainage systems available at injection wells 102-104, land use and zoning of surrounding land, and surface water bodies such as rivers lakes, and other reservoirs, or other geographic features. Such information can be obtained in a variety of ways including, for example, historical LIDAR and aerial imagery. For example, aerial imagery and 3D elevation LiDAR data can be obtained from online sources (e.g., TX RRC, NM OCD, USGS, etc.) along with client-specific files. This data may also be developed in-house or obtained through sources such as drones, surveys, and other technology.

In some embodiments, geographical data sources 504 include shape files and/or public data. Shape files may include map files used to display geographical base maps, wells, surveys and pipelines layers. Such information may include international geographic regions and their associated boundaries as well as state data. The state data may include information on wells such as well label, operator, location, total depth (TD), type (e.g., oil production, gas production, injection, etc.), completion information, and plugging information. Injection well data can be further specified as the type of injection well and underground injection control (UIC) well class. Class I wells are for the injection of hazardous or non-hazardous wastes, Class II wells are for the injection of fluids associated with oil & gas, Class III wells are for the injection of fluids to dissolve and extract minerals, and Class VI wells are to inject carbon dioxide for sequestration. Completion information can include simulations, perforations, plugs, cement volumes, casings, dates, bridges, and/or any other information associated with the completion of injection wells 102-104. Plugging information can include similar information pertaining to the dates, cement volumes, and depths. The state data may further include outline data indicating the state, county, or other geographic regions, as well as leases and infrastructure. Instructure information can include railways, pipelines, cities, roads, etc. The state data may further include geological information such as the locations of faults, basins, etc.

In some embodiments, geographical data sources 504 include ASCII data sources including ASCII data files and dBase (.dbf) files containing the American Petroleum Institute (API) number, survey name, well number, lease name, lease ID number, completion date, and plug date. Geographical data sources 504 may include georeferenced files such as digital maps or images that have been tied to a known earth coordinate system. In such georeferenced files, the internal coordinate system of the file can be related to a ground system of geographic coordinates, allowing users to determine the exact location of any point on the map or image on the earth's surface.

In some embodiments, geographical data sources 504 include rasters. Rasters are a type of spatial data format that represents geographic information through a grid of cells or pixels. Each cell in a raster file contains a value representing information, such as temperature, elevation, or land cover. In some embodiments, geographical data sources 504 include grids. Grids are a network of intersecting lines (e.g., lines of latitude and longitude) drawn on a map, which allows users to pinpoint the exact location of a place on earth by using coordinates at the intersection of those lines. Stated differently, grids may include a system for identifying specific points on a map using a set of horizontal and vertical reference lines.

In some embodiments, geographical data sources 504 include computer-aided design (CAD) files. CAD files can be created by a CAD modeling or software system and may include detailed, precise 2D and 3D designs of real-world objects such as buildings, infrastructure, or landscapes. CAD files are often used in fields such as civil engineering and urban planning, where precise measurements and visualizations are crucial. Unlike geographic information systems (GIS) which focus on analyzing spatial data, CAD primarily focuses on designing objects within a specific geographic context. In some embodiments, geographical data sources 504 include vector information. A vector is a geographic data type in which data are stored as a collection of points, lines, or polygons along with attribute data. Vector data can include individual points recorded as coordinate pairs, which represent a physical position in the world.

In some embodiments, geographical data sources 504 include photographs. Photographs can include pictures or images captured by one or more cameras that represent the physical and human features of a specific location at a particular time. Photographs may allow geographers to visually analyze and interpret geographical elements like landforms, vegetation, human settlements, and activities within a given area. Computing system 110 can use photographs as a visual tool to understand the characteristics of a place. In some embodiments, geographical data sources 504 include GeoTIFF data. GeoTIFF data may include a standard tagged image file format (TIFF) image that includes embedded geographic metadata, allowing the image to be precisely positioned on a map. GeoTIFF data can be used for storing and sharing georeferenced raster data like satellite imagery, aerial photography, or digital elevation models within GIS applications. GeoTiff data can include a raster image with built-in (e.g., via metadata or other tags) spatial information about its location on earth. In some embodiments, geographical data sources 504 include any other type of geographical image source configured to provide information (e.g., any of the information or properties included in GeoTIFF data) in a variety of different formats (e.g., an.ec_{w} file from the ER Mapper geospatial imagery application).

Data collector 526 can be configured to process the geographic data obtained from geographical data sources 504 by identifying a datum of the geographic data used to reference a particular point on the earth's surface. Such a datum may be a reference point or mathematical model used to define the precise location of points on earth's surface and may function as a starting point for calculating coordinates such as latitude and longitude (e.g., by specifying the shape and orientation of the earth's ellipsoid relative to the center of the earth). Different datums may exist depending on how accurately they model the earth's shape for a specific region, leading to slight variations in coordinates when switching between them. Therefore, multiple files may overlay each other as they relate to the particular coordinates, and may visually depict various attributes. Data collector 526 can be configured to standardize or convert one or more of the geographic data into a standard coordinate system to allow multiple types of geographic data to be overlaid onto a single map or representation of the earth's surface.

### Geological Data Sources

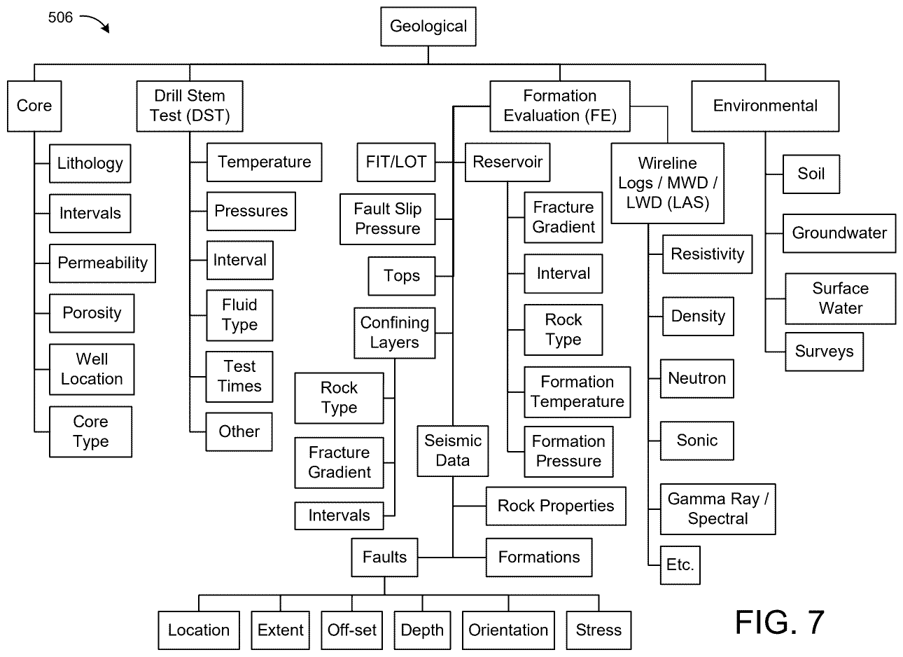

Referring now to FIG. 7, a diagram illustrating geological data sources 506 in greater detail is shown, according to an exemplary embodiment. Geological data sources 506 may include any type of geological data that affects how fluids behave once injected into the subsurface at or around the wellsite locations. Geological data sources 506 may provide information regarding the target formation (e.g., type of rock) of injection zone 118, confining layer 116, and/or surface later 114. Geological data sources 506 may indicate the depth of injection wells, faults and fractures in the geographic region of the wellsite locations, or other geological information that influences the migration of the injected fluids.

Geological data sources 506 are shown to include core data such as lithology, intervals, permeability, porosity, well location, and core type. Core data may include a unique well identifier (UWI, API number, etc.) including an identifying number/letter series unique to the specific wellbore and location. This information can be used by computing system 110 or by an external regulatory agency. Core data may further include location information such as a geographic datum, latitude and longitude, X/Y coordinates, geographic location (e.g., survey, block, township, range, section, northing, easting, etc.). Computing system 110 can use such data to determine the physical location of a well, while also being able to plot the location on a map.

Core data may include operator information, a lease name, or a well number. Operator information may indicate a company or individual legally responsible for the exploration, development, production, and management of oil and gas resources within a designated area, such as a lease or field.

The lease name may be part of the well label (e.g., lease name+well number), and may signify on which lease the well was drilled. In some cases, the lease name may specify the land or mineral rights owner. The lease name may also change with operators or unitization. The well number may also be part of the well label (e.g., lease name+well number) and may identify a particular well in the lease. For example, if multiple wells are included in the lease, the well number may distinguish the wells from each other to provide a unique identifier for each well in the lease. In some cases, the well number may be designated in order drilled or section grid. The well number may also change with the operator or unitization.

Core data may include a variety of other geological information such as depth(s), porosity, permeability, rock type, formation name, date(s), analysis type, filed name, oil saturation, water saturation, oil fluorescence, and/or other notes. Depth information may indicate the depths in which the analyses were conducted. Porosity may indicate the percentage of void space in a rock and may be defined as the ratio of the volume of the voids or pore space divided by the total volume. Permeability may be a property of porous materials that is an indication of the ability for fluids (e.g., gas or liquid) to flow through them. The rock type may be defined in accordance with the processes that resulted in their formation. There are three main classes of rock type including: igneous, sedimentary and metamorphic. The formation name may indicate the of the mappable, distinct layer of rock with a consistent lithology (rock type), fossil content, or other defining characteristics that distinguish it from adjacent layers. Formations are the basic units used in stratigraphy for describing and correlating sedimentary, igneous, or metamorphic rocks over a geographic area. The dates may indicate the time and/or date on which the analysis was conducted, whereas the analysis type may indicate the type of test that was performed (e.g., whole core, conventional, special, etc.). The filed name may identify the production/injection zone and the geometric boundaries it encompasses. Oil saturation can be defined as the percent of the pore volume occupied by oil, whereas water saturation can be defined as the percent of the pore volume occupied by water. Oil fluorescence may include the results of tests used to evaluate the presence of hydrocarbons in a reservoir. Such tests are based on the principle that certain oils and hydrocarbons emit a fluorescence when exposed to ultraviolet (UV) light.

Core data provides data on the petrophysical and mechanical properties of reservoir rocks. Computing system 110 can use core data to derive a variety of metrics to help characterize the reservoir and guide decisions on exploration, development, and production. These metrics are derived from laboratory tests on core samples obtained from the reservoir. Derived metrics from core data may include, for example, porosity, permeability, bulk density, grain density, water saturation, hydrocarbon saturation, formation factor, cementation factor, capillary pressure, relative permeability, fracture porosity, compressibility, and acoustic properties (P-wave and S-wave velocities). In some embodiments, data collector 526 uses core data in correlations to calculate lateral and vertical extent of a zone of interest. This can provide a direct estimation of the volumetrics used both as an input and output. Geo-mechanical properties of the desired zones can in turn be used to forecast the pressure/temperate variations and associated risks as external fluids are pumped in the subsurface formations/rocks.

Still referring to FIG. 7, geological data sources 506 are shown to include drill stem test (DST) data. DST data acquisition may include a sequence of well-controlled operations that carefully manage the shut-in, flow, build-up periods, recording pressure, temperature, and flow rate data, to derive useful information. DSTs are well tests usually conducted with a downhole shut-in tool (packer) that allows the well to be opened and closed at the bottom of the hole with a surface-actuated valve. The objective of the test is to isolate the formation from the annulus between the drill string and the wellbore, thereby forcing any produced fluids to enter only the drill string where the pressure will then be measured. DSTs are used to determine whether a well has found a commercial hydrocarbon reservoir by establishing the permeability thickness and flow potential.

DST data acquisition may be from paper historical records (e.g., scout tickets, well histories, etc.) from clients, regulatory offices, or libraries, as well as online regulatory or organization databases (e.g., Texas RRC, New Mexico OCD, University Lands, etc.) and/or online data vendors (e.g., S&P Global, Enverus, etc.). DST data can include temperatures, pressures, interval, fluid type, test times, and/or other types of DST data. In some embodiments, DST data may include a date indicating a date when the test was conducted, a test number or name identifying the number or name of the test, a unique well identifier (e.g., UWI or API number) unique to the specific wellbore and location, and/or location information such as a geographic datum, latitude and longitude, X/Y coordinates, geographic location (e.g., survey, block, township, range, section, northing, easting, etc.). Computing system 110 can use such data to determine the physical location of a well, while also being able to plot the location on a map.

In some embodiments, DST data includes a top packer depth (i.e., the depth in which the top packer is set, in reference to a pressure in which the formation stabilizes the flow in the sealed tested area), a bottom packer depth (i.e., the depth in which the bottom packer is set, in reference to a predefined datum), a total depth indicating a total depth of the well, a casing size indicating an internal diameter of the casing, or a formation name indicating the name of the geological formation that encompasses the tested interval. DST data may further include a mud type indicating a type of fluid (e.g., water, gas, mud, etc.) used to fill up the drill sting while conducting the test as well as various attributes of the fluid (e.g., mud weight, mud viscosity, etc.). DST data may include a filter loss indicating a volume of tested fluid lost by infiltration to the test formation, a filter cake indicating the amount of impurities (e.g., solids, barite, etc.) that forms on the wall of a wellbore after the mud liquid infiltrates the tested formation.

DST data may include a tool open time indicating a duration of time in which the tool (test valve) remains opened allowing formation fluid to flow into the drill pipe, and a tool close (or shut-in) time indicating a duration of time that takes for the formation to build back to formation pressure, an initial hydro mud pressure indicating the hydrostatic pressure measured before the beginning of the test, an initial flow pressure indicating a pressure in which the formation first starts to flow in the sealed tested area, a final flow pressure indicating pressure build-up in which the formation stabilizes the flow in the sealed tested area, a closed in pressure indicating a pressure measured at the moment when the well is shut in, a final hydro mud pressure indicating a final hydrostatic pressure recorded at the end of the test, and recovery information indicating a volume of recovered formation fluid and test fluid. DST data may further include remarks indicating any anomalies observed while conducting the test.

Computing system 110 can use DST data to interpret reservoir characteristics and calculate various derived metrics based on the pressures, temperatures, flow rates, and other raw data gathered during the DST. Some derived metrics which computing system 110 can calculate from the DST data include permeability, skin factor, reservoir pressure, productivity index, wellbore storage coefficient, flow efficiency, transmissivity, radius of investigation, mobility, flow capacity, and reservoir compressibility.

Still referring to FIG. 7, geological data sources 506 are shown to include formation evaluation (FE) data. Formation evaluation is a fundamental process in the oil and gas industry that involves analyzing subsurface formations to estimate their hydrocarbon potential. FE data and metrics derived therefore may provide deeper insights into reservoir properties. These data/metrics can be obtained from well logs, core data, seismic data, and/or other evaluation techniques. FE data is shown to include several sub-types of FE data including formation integrity test (FIT)/leak-off test (LOT), reservoir, fault slip pressure, tops, confining layers, seismic data, and wireline logs.

FIT and LOT are tests conducted to assess the pressure integrity of a formation. FIT measures the pressure a formation can sustain, while LOT determines the point at which the formation begins to leak. Fault slip pressure may be important for understanding fault stability, mitigating risks of induced seismicity, and ensuring safe subsurface operations. Tops data may include top name referring to the identification or naming of a specific geological formation or stratigraphic boundary encountered during well drilling or formation evaluation. The top name represents a marker or reference point used to correlate data. Tops data may further include top depth referring to the measured depth at which a specific top is located. Fault slip pressure may indicate the critical pressure at which a fault within the subsurface begins to slip due to induced or natural stress changes.

The integration of formation top, FIT/LOT, and fault slip pressure data allows computing system 110 and other downstream data consumers (e.g., engineers and geologists) to make informed decisions about the safety, stability, and productivity of a well. These datasets provide complementary insights into pressure regimes, fault behavior, and formation integrity, helping to predict and manage risks associated with drilling and production. By correlating these factors, computing system 110 and well operators can optimize drilling operations, prevent wellbore instability, and maximize resource recovery while ensuring safety. In some embodiments, FE data further includes step-rate test (SRT) data. SRT is a procedure that measures the fracture pressure of a geologic formation by injecting fluid into it at increasing rates. SRT tests are used to evaluate a well's performance and are often performed before a hydraulic fracturing treatment.

Data collector 526 can be configured to calculate various derived metrics based on the FE data. Derived metrics are calculated parameters that provide deeper insights into reservoir properties and can be calculated as functions of one or more of the FE data. These metrics can be obtained from well logs, core data, seismic data, and other evaluation techniques. Derived metrics based on the FE data may include, for example, porosity, permeability, water saturation, hydrocarbon saturation, net pay thickness, net-to-gross ratio, formation factor, bulk volume water, resistivity index, capillary pressure, saturation height function, lithology identification, brittleness index, elastic properties, reservoir quality index, flow units, mobility ratio, fluid types and properties, geo-mechanical properties, seismic attributes, recovery factor, hydrocarbon pore volume, original hydrocarbons in place, fracture density and orientation, and wettability.

Confining layers data may include information on rock type, fracture gradient, intervals, depth. Rock type can be described in accordance with the processes that resulted in its formation and represent a unique combination of chemical composition, mineralogy, grain size, texture, or other distinguishing characteristics. Rocks are generally classified as igneous, sedimentary and metamorphic. The fracture gradient may include a pressure gradient at which the rock in a subsurface formation fractures or splits apart. In formation evaluation, rock type, depth, and fracture gradient are highly interconnected, especially in the context of confining layers. Understanding how these factors correlate allows for more accurate predictions of wellbore stability, pressure regimes, and the potential for formation fracturing.

Data collector 526 can be configured to calculate various derived metrics based on the confining layers data. Derived metrics of confining layers refer to parameters that describe the physical and mechanical properties of the low-permeability layers (such as shale or claystone) that act as barriers to fluid flow. These metrics are useful for assessing the effectiveness of confining layers in trapping hydrocarbons, preventing upward migration of fluids, or protecting aquifers from contamination. Derived metrics based on the confining layers data may include, for example, caprock permeability, capillary entry pressure, fracture pressure, thickness, effective stress, rock compressibility, caprock integrity index, geochemical stability, acoustic impedance, water saturation, tensile strength, shear strength, sealing efficiency index, leak-off coefficient, diffusion coefficient, and elastic moduli.

Seismic data can be acquired by observing seismic waves, recording the reflections and refractions as they travel through the subsurface, and then processing and interpreting the data. Seismic data acquisition may be from paper historical records (e.g., scout tickets, well histories, etc.), publications, or other data sources. Seismic data may include information characterizing rock properties, formations, and faults. Rock properties may include information on the physical, chemical, and mechanical characteristics of rocks that influence their behavior under various geological and engineering conditions. Formation data may include information on various rock formations, which can be defined as mappable, distinct layers of rock with a consistent lithology (rock type), fossil content, or other defining characteristics that distinguish it from adjacent layers. Formations are the basic units used in stratigraphy for describing and correlating sedimentary, igneous, or metamorphic rocks over a geographic area.

Fault data may include various attributes of faults such as fault location indicating the location where a fracture or discontinuity in the earth's crust along which there has been displacement of the rock layers on either side due to tectonic forces and fault extent indicating the dimension of a fracture or discontinuity in earth's crust along which there has been displacement of the rock layers on either side due to tectonic forces. Fault data may further include fault off-sets indicating the amount of displacement or separation of rock layers, markers, or geological features on either side of a fault plane due to faulting, which may include measurements of relative movement caused by tectonic forces, depth, orientation, and stress. Fault data may further include fault depths indicating the vertical extent or penetration of a fault into the earth's subsurface (i.e., the depth at which the fault exists). Fault data may further include fault orientation indicating the geometric position and alignment of a fault in three-dimensional space, typically defined by two primary attributes: the strike and the dip, which describe the fault's horizontal direction and its inclination, respectively. Fault data may further include fault stress data indicating stress acting on or within a fault zone that drives fault movement and deformation. Fault stress may be a result of the tectonic forces exerted on the earth's crust due to the movement of lithospheric plates, internal pressures, and other geological processes.

Data collector 526 can be configured to calculate various derived metrics based on the seismic data. Derived metrics based on seismic data may include, for example, acoustic impedance, reflection coefficient, amplitude variation with offset, seismic velocity, density, Poisson's ratio, Vp/Vs ratio, elastic moduli porosity (o\phio), lithology discrimination, fluid indicators, seismic attribute analysis, anisotropy metrics, time-to-depth conversion, geo-mechanical properties, reservoir continuity and geometry, fluid 1, seismic inversion products, seismic-derived thickness, and direct hydrocarbon indicators. The relationships between rock properties, formation, fault location, fault extent, fault offsets, and fault depth are integral to understanding the subsurface geology, reservoir characteristics, and wellbore stability. These elements are interconnected, with each influencing how subsurface features behave, how reservoirs are managed, and how drilling and exploration activities are optimized.

Reservoir data can be acquired from various sources such as paper historical records (e.g., scout tickets, well histories, etc.), clients, regulatory offices, or libraries, online regulatory or organization databases (e.g., Texas RRC, New Mexico OCD, University Lands, etc.), and/or online data vendors (e.g., S&P Global, Enverus, etc.). Reservoir data may include information on the fracture gradient, interval, rock type, formation temperature, formation pressure, or other characteristics of the reservoir. Fracture gradient may indicate the rate at which the pressure required to initiate a fracture increases with depth in the earth's subsurface. Fracture gradient may be a measure of the pressure needed to overcome the rock's inherent strength and cause it to fracture. Interval data may include the specific vertical or horizontal section of rock, sediment, or strata within a larger sequence of geological formations. Interval data can be used to describe the thickness or extent of a particular unit or layer, such as a sedimentary layer, rock formation, or zone of interest within the Earth's crust. Rock type can be defined in accordance with the processes that resulted in their formation. There are 3 main classes of rock as per following: igneous, sedimentary and metamorphic. Formation temperature may indicate the temperature of the rocks or sediments at a specific depth within the Earth's subsurface, whereas formation pressure may indicate the pressure exerted by the fluids (e.g., water, oil, or gas) contained within the pore spaces of a rock formation at a given depth in the Earth's subsurface. Formation pressure may be the result of the weight of the overlying rock layers and the fluid within the formation.

Data collector 526 can be configured to calculate various derived metrics based on the reservoir data. Derived metrics from reservoir analysis can be used for formation evaluation, offering insights into the reservoir's ability to store and produce hydrocarbons. These metrics combine data from well logs, core samples, seismic surveys, and dynamic flow tests to characterize the reservoir's physical, geological, and fluid properties. Derived metrics based on reservoir data may include, for example, porosity, permeability, water saturation, hydrocarbon saturation, net-to-gross ratio, formation volume factor, recovery factor, original hydrocarbons in place, drainage area, reservoir pressure, compressibility, productivity index, saturation-height function, reservoir connectivity, fluid contacts, sweep efficiency, fracture density and orientation, reservoir temperature, wettability, relative permeability, and net pay thickness. These factors are intricately linked, with each influencing the others in complex ways. For example, the rock type determines the fracture gradient, which sets the limits for formation pressure during drilling and production. The formation temperature impacts both the physical properties of the reservoir and the behavior of fluids, further influencing wellbore stability and reservoir performance.

Wireline logs may include measurements while drilling (MWD) logs, logging while drilling (LWD) logs, or other types of measurements or logs. In some embodiments, wireline logs, MWD, and/or LWD logs are collected in the log ASCII standard (LAS), which is a standardized format for storing and sharing well log data, including data from wireline, MWD, and LWD logs. Wireline/MWD/LWD data may include various types of measurements such as resistivity, neutron, density, sonic, gamma ray, spectral, etc. Resistivity logs can be acquired using tools that emit electrical currents into the formation and measure the resulting voltage. Resistivity logs measure the electrical resistance of the formation. Resistivity data can be used to identify fluid types (e.g., oil, gas, or water), estimate porosity, and delineate lithology. Data collector 526 can be configured to calculate various derived metrics based on the resistivity data. Such derived metrics may include water saturation which can be derived from resistivity and porosity logs. Water saturation indicates the amount of water in the pore spaces of the rock and may be a key parameter for determining hydrocarbon presence and reservoir quality. Another derived metric based on resistivity data is formation factor. Formation factor can be calculated from resistivity and porosity logs and provides insights into the rock's pore structure and permeability. Resistivity can also help differentiate between different rock types, especially in sedimentary environments. For instance, high resistivity often indicates the presence of hydrocarbon-bearing sands, while low resistivity may indicate shale or water-saturated zones.

Neutron logs may use a neutron source and detectors to measure the scattering of neutrons by hydrogen atoms. Neutron logs measure the hydrogen index of the formation, which is primarily related to the amount of water or hydrocarbons present. This data is used to estimate porosity and identify fluid types. Data collector 526 can be configured to calculate various derived metrics based on the neutron log data. Such derived metrics may include porosity, which is directly measured by neutron logs and indicates the volume of pore space in a rock. Porosity may be useful for estimating reservoir capacity and fluid flow. In combination with density logs, neutron logs can also help identify lithology (e.g., sandstone, shale, limestone) based on their different responses to neutron radiation.

Density logs may use gamma-ray sources and detectors to measure the formation's density. Density logs may measure the bulk density of the formation, which is a combination of the density of the rock matrix and the fluid filling the pore spaces. This data can be used to estimate porosity and lithology. For example, density logs, in conjunction with neutron logs, provide accurate porosity estimates. Density logs measure the bulk density of the formation, which can be combined with neutron porosity to estimate matrix density and, subsequently, porosity. Density logs can also help differentiate between different rock types (lithology) based on their bulk density, especially when combined with other log data such as gamma-ray logs.

Sonic logs may use acoustic transmitters and receivers to measure the time it takes for sound waves to travel through the formation. Stated differently, sonic logs may measure the travel time of acoustic waves through the formation. This data can be used to estimate porosity, lithology, and mechanical properties of the rock. Sonic logs can be used to estimate porosity, especially in combination with density logs. The velocity of sound in a rock is also related to its permeability, allowing for indirect estimation of permeability from the sonic logs. Sonic logs can also provide information about the mechanical properties of the rock, such as Young's modulus and Poisson's ratio, which can be used for drilling, production, and injection operations.

Gamma ray and spectral gamma data can be gathered using a detector tool (e.g., a scintillation detector) that measures the gamma radiation emitted from the formation. As the tool is moved along the wellbore, it records the intensity of gamma rays at different depths. The data can then be processed to generate a gamma ray log, which is a plot of gamma ray intensity versus depth. Gamma-ray logs measure the natural radioactivity of the formation, which can be used to identify lithology, particularly shale content, and estimate mineralogy. Gamma-ray logs can identify shale-rich zones, which can be important for understanding reservoir heterogeneity and fluid flow. Spectral gamma ray tools use advanced detectors and electronics to measure the energy spectrum of gamma rays. This allows for the identification of different radioactive elements and the calculation of their concentrations in the formation. Spectral gamma-ray logs provide more detailed information about the types of radioactive elements present in the formation. For example, spectral gamma-ray logs can provide information about the mineralogy of the formation, including the presence of clay minerals, which can affect reservoir properties and fluid flow.

Still referring to FIG. 7, geological data sources 506 are shown to include environmental data. Environmental data may include data such as soil sampling, ground water sampling, surface water sampling, contaminant evaluation, clean-up method, and land surveys. Data acquisition for soil sampling may include collecting and analyzing soil samples to determine their physical, chemical, and biological properties. Soil sampling analysis provides valuable information about soil health, its ability to support plant life, and its suitability for land use or contamination risks. Data collector 526 can be configured to calculate various derived metrics based on the soil sampling data. Such derived metrics may provide comprehensive insights into soil health, fertility, and contamination and may include, for example, metrics such as pH, organic matter content, nutrient levels, and heavy metal concentration inform sustainable land use and remediation strategies. Monitoring these parameters ensures soil productivity, supports agricultural practices, and protects environmental and human health.

Groundwater sampling is the process of collecting and analyzing water from subsurface aquifers to assess its quality, quantity, and contamination levels. Groundwater sampling analysis is useful for understanding the health of groundwater systems, ensuring safe drinking water, monitoring contamination, and managing water resources. Data collector 526 can be configured to calculate various derived metrics based on the groundwater data. Such derived metrics may include pH, dissolved oxygen, TDS, heavy metals, and microbial contamination, and can be used for assessing water quality and identifying potential risks to human health and the environment. These metrics guide decision-making for water resource management, regulatory compliance, and remediation efforts.

Surface water sampling may include collecting and analyzing water from rivers, lakes, streams, ponds, and reservoirs to assess water quality, monitor pollution, or understand ecosystem health. The process is systematic and aims to ensure accurate and representative data. Surface water sampling analysis can be used for monitoring water health, assessing environmental impacts, ensuring safe drinking water, and supporting regulatory compliance. Data collector 526 can be configured to calculate various derived metrics based on the surface water sampling data. Such derived metrics may include, for example, water temperature, pH level, dissolved oxygen, turbidity, conductivity, total suspended solids, chemical oxygen demand, biological oxygen demand, nutrient levels, etc. The surface water sampling data and metrics derived therefore may provide information regarding the quality of water in lakes, rivers, streams, and other surface water bodies. These metrics help assess the ecological health of water bodies, evaluate contamination levels, and support regulatory compliance.

In some embodiments, environmental data includes contaminant evaluation data. Contaminant evaluation may include systematically collecting and analyzing samples from environmental media (e.g., soil, water, air, or biota) to assess the presence, concentration, and distribution of pollutants. Contaminant evaluation can be used to assess the presence and concentration of harmful substances in the environment, particularly in soil, water, and air. This evaluation is useful for identifying pollution sources, understanding the impacts of contamination, and ensuring public health and ecosystem protection. Data sources that provide contaminant evaluation data may include, for example, field sampling, laboratory analysis, remote sensing, and monitoring systems. Data collector 526 can be configured to calculate various derived metrics based on the contaminant evaluation data. The derived metrics provide useful information to assess the concentration, distribution, migration, toxicity, and overall environmental and health risks associated with contaminants. These metrics can be used for effective environmental management, risk assessment, regulatory compliance, and determining the need for remediation or cleanup efforts.

In some embodiments, environmental data includes clean-up method data. Data acquisition for environmental clean-up methods may include collecting, analyzing, and interpreting data to assess the extent of contamination and determine the most suitable remediation strategies. Clean-up methods are strategies employed to remove or reduce contaminants from environmental media, such as soil, water, and air, to mitigate their harmful effects on human health, ecosystems, and the economy. These methods can be used for remediating polluted areas, restoring natural resources, and ensuring environmental sustainability. Data collector 526 can be configured to calculate various derived metrics based on the clean-up method data. Derived metrics for an environmental cleanup project typically focus on quantifying the environmental footprint and assessing the impact of the cleanup activities. Such derived metrics may include, for example, percent of refined materials used onsite, hazardous waste generated, onsite water use, total energy use, hazardous air pollutant (HAP) emissions, and effects on ecosystem services such as nutrient uptake and erosion control.

In some embodiments, environmental data includes land survey data. Data acquisition for land surveys may include collecting accurate spatial and geographic data to assess the physical features of a plot of land. This process is useful for a range of applications, including boundary determination, construction planning, environmental studies, and legal documentation. Land surveying is the process of measuring and mapping the physical features of a piece of land, including its boundaries, topography, and natural or man-made features. Land surveys provide useful information in various sectors, from construction and real estate to environmental management and legal matters. Land surveys provide a variety of data that is transformed into useful metrics for a wide range of applications, including legal documentation, construction, environmental protection, and infrastructure planning. Data collector 526 can be configured to calculate various derived metrics based on the land survey data including, for example, property boundaries, elevation, slope, and proximity. Such derived metrics help inform decisions in real estate, engineering, urban planning, agriculture, and environmental management. These metrics are also useful for ensuring accurate land use, preventing legal disputes, optimizing land development, and protecting natural resources.

In some embodiments, data collector 526 identifies correlations between various types of environmental data. The correlation between soil sampling, groundwater sampling, contaminant evaluation, cleanup methods, and land surveys reflects their interconnected roles in environmental assessment and management. Together, these types of environmental data provide a holistic understanding of environmental conditions, contamination risks, and remediation needs. These five components are interdependent, forming a comprehensive framework for environmental investigation and management. For example, soil and groundwater sampling provide foundational data, contaminant evaluation interprets the risk, cleanup methods address the problem, and land surveys contextualize and support all stages. This interconnected approach ensures effective decision-making, resource management, and environmental protection.

### Seismic/Earthquake Data Sources

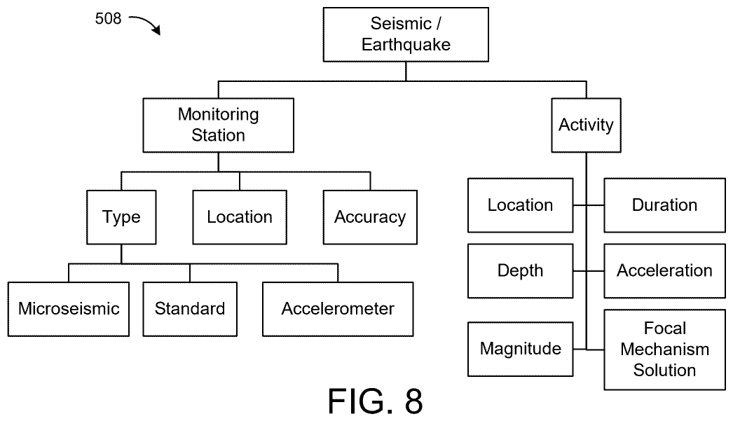

Referring now to FIG. 8, a diagram illustrating seismic/earthquake data sources 508 in greater detail is shown, according to an exemplary embodiment. Seismic/earthquake data sources 508 may provide historical and/or real-time data characterizing various seismic events which can be detected by seismic monitoring station 108 and/or other seismic monitoring stations distributed across the geographic region. Seismic/earthquake data sources 508 are shown to include monitoring station data which indicate various attributes of seismic monitoring station 108 such as type, location, and accuracy. The types of sensors from which monitoring station data can be received may include, for example, micro-seismic sensors, standard seismic sensors, and accelerometers. Seismic/earthquake data sources 508 may further include activity data for detected seismic events such as location, depth, magnitude, duration, acceleration, and focal mechanism solution.

In some embodiments, seismic/earthquake data sources 508 include broadband seismometers configured to provide seismicity data. Broadband seismometers may be components of the monitoring station shown in FIG. 8 or installed at other locations separate from the monitoring station. Broadband seismometers may provide a continuous recording of ground velocity in three components (e.g., N-S, E-W, vertical) using sensitive electronic sensors. Data from broadband seismometers may capture the full spectrum of seismic waves, which is useful for accurate magnitude estimation and source characterization. Data collector 526 can be configured to calculate various derived metrics based on the broadband seismometer data. Such derived metrics may include, for example, moment magnitude (Mw) representing the total energy released by an earthquake, spectral acceleration (Sa) indicating the maximum acceleration experienced by a structure, b-value describing the relative frequency of small to large earthquakes, and seismic moment release rate quantifying the rate of energy release over time. In some embodiments, the moment magnitude data can be sampled at 100-200 Hz and may have a resolution of better than 0.1 picometers (μm) in a bandwidth of 1 Hz for a short-period seismic band. The moment magnitude data can resolve accelerations in the order of 10-11 g, which is the typical level of vertical seismic noise at a quiet seismic monitoring station. The spectral acceleration and seismic moment release rate may be continuously recorded and/or collected over years for long term analysis. Advantageously, the data from the broadband seismometers can be used by computing system 110 to correlate injection-induced stress changes with resulting seismic activity and associate wellsite operations with seismic events recorded at monitoring stations.

In some embodiments, seismic/earthquake data sources 508 include strong motion accelerometers configured to provide seismicity data. Data from strong motion accelerometers may include on-scale recording of strong ground motions using high-dynamic range sensors. Strong motion accelerometers may provide accurate measurements of potentially damaging ground shaking. In some embodiments, strong motion accelerometers can be used to measure or calculate ground acceleration (PGA) indicating the maximum ground acceleration during shaking, peak ground velocity (PGV) indicating the maximum ground velocity during shaking, arias intensity indicating the strength of ground motion, and/or cumulative absolute velocity (CAV) indicating the potential for structural damage. In some embodiments, PGA can be measured at a sampling rate of 200-500 Hz and may have an accuracy of +2% of 1/2 g full scale for sensitivity and linearity and may have a zero point drift of up to 2% of full scale during a typical record, with total variation up to #30% of full scale for a 100° F. temperature range. PGA may have noise of 1.4% of full scale, RMS, which is primarily attributable to the tape recording system commonly used for such measurements. PGV may be a triggered recording, whereas arias intensity and CAV may be event-based data collection. Computing system 110 can use the data from strong motion accelerometers to identify a strong correlation between recorded ground motions and structural damage. Computing system 110 can also use the data from strong motion accelerometers to link wellsite injection activities to ground shaking intensity.

In some embodiments, seismic/earthquake data sources 508 include high-precision GPS configured to provide positioning data. High-precision GPS may provide continuous monitoring of ground displacements using dual-frequency receivers and advanced processing techniques. High-precision GPS may measure long-term deformation and co-seismic displacements, which can be used for understanding tectonic stress accumulation. Metrics measured by the high-precision GPS or derived from such measurements can include strain rates indicating the rate of crustal deformation, fault slip rates quantifying the movement along faults, and/or coulomb stress changes assessing how earthquakes influence stress on nearby faults. In some embodiments, strain rates are sampled between 1-30 seconds and may have an accuracy of approximately 3m and an update rate of 10 Hz (i.e., updated every 100 ms). Fault slip rates may be continuously recorded whereas the coulomb stress changes can be collected over years for trend analysis. Computing system 110 can use the data from high-precision GPS to correlate aseismic deformation with potential for induced seismicity and associate long-term deformation patterns with injection activities.

In some embodiments, seismic/earthquake data sources 508 include downhole pressure sensors configured to provide well data. Downhole pressure sensors may allow for real-time monitoring of fluid pressures in injection/production wells using fiber optic or electronic pressure gauges. Data provided by downhole pressure sensors can be used for understanding pore pressure changes and their relation to induced seismicity. Downhole pressure sensors may be configured to measure bottomhole pressure (BHP) indicating the pressure at the bottom of the wellbore (e.g., sensor 166 in FIG. 3), pore pressure diffusion rates indicating a speed at which pressure changes propagate through the formation, and hydraulic diffusivity indicating how easily fluid pressure changes spread in the subsurface. In some embodiments, BHP is sampled at a rate of 1 Hz-1 min and may have a pressure accuracy of +0.05% full scale and a resolution of 24-bit, with optimum pressure resolution of about +0.00006 psi for a 1,000 psi range. Pore pressure diffusion rates may be continuously recorded, whereas hydraulic diffusivity may have an operational timescale of days to years. Computing system 110 can use the data from downhole pressure sensors to determine a strong correlation between pressure changes at various wellsites (e.g., at injection wells 102-104) and seismicity rates observed at monitoring stations (e.g., at seismic monitoring station 108). Computing system 110 can also use the data from downhole pressure sensors to determine a direct link between operational parameters of wellsites and subsurface response (e.g., fluid dispersion, flow rates, pressures, seismic activity, etc.).

In some embodiments, seismic/earthquake data sources 508 include injection/production data sources configured to provide operations data. Injection/production data sources may provide automated logging of wellhead parameters using flow meters, pressure sensors, and Supervisory Control and Data Acquisition (SCADA) systems. Information from injection/production data sources can be used to quantify the direct human influence on subsurface stress state, which can help understand induced seismicity. Injection/production data sources can be configured to measure or calculate injection rates indicating a volume of fluid injected per unit time, cumulative injected volumes indicating the total amount of fluid injected over time, wellhead pressure indicating pressure measured at the surface of the well, and injection pressure-seismicity index relating injection pressures to seismic activity. Injection rates may have a logging interval of 1 min-1 hour, whereas cumulative injected volumes may be continuously recorded. Wellhead pressures and the injection pressure-seismicity index may have an operational timescale of days to years. Computing system 110 can use injection/production data to determine a direct correlation between injection/production activities and induced seismicity occurrence and magnitude and associate operational decisions with seismic risk.

In some embodiments, seismic/earthquake data sources 508 include borehole seismometers configured to provide seismicity data. Borehole seismometers may include downhole installation of seismometers in dedicated monitoring wells. Borehole seismometers may provide high-quality seismic data with reduced surface noise, allowing for the detection of smaller seismic events. In some embodiments, borehole seismometers can be used to measure or calculate micro-seismic event locations indicating the precise 3D positions of small seismic events, focal mechanisms indicating the orientation and type of fault slip for each seismic event, and/or stress tensor inversions estimating the orientation and magnitude of principal stresses. Micro-seismic event locations can be measured at a sampling rate of 500-2000 Hz, whereas focal mechanisms can be continuously recorded or triggered by detected events. Stress tensor inversions may be measured using event-based and long-term monitoring. Computing system 110 can use the data from borehole seismometers to correlate fracture network evolution and stress field changes with injection activities and link subsurface deformation to wellsite operations.

### Real-Time Wellsite Data Sources

Referring now to FIG. 9, a diagram illustrating real-time wellsite data sources 510 in greater detail is shown, according to an exemplary embodiment. Real-time wellsite data sources 510 may include some or all of the sensors, actuators (e.g., pumps, valves, or other controllable equipment), data collection and transmission equipment, and/or other components shown in FIG. 3, which may be installed at the wellsite (e.g., at injection wells 102-104) to monitor and control the operations thereof. Real-time wellsite data sources 510 can provide measured or calculated metrics to computing system 110 to help correlate the operations of various wellsites (e.g., injection rates, injection volumes, pressures, etc.) with induced seismic events in the geographic region. Real-time wellsite data sources 510 are shown to include wellsite location, wellhead pressure, injection volume, injection rate (e.g., measured or calculated BHP), operation intervals, daily activities (e.g., service/repair, tests, etc.), gas detection, and data transmission.

### Pressure Sensors

In some embodiments, real-time wellsite data sources 510 include pressure sensors. Pressure sensors may include one or more pressure transducers installed at the wellhead, within the well, directly connected to the pipeline or flowline, or otherwise located at the wellsite. In some embodiments, the pressure sensors are housed in weatherproof enclosures to protect them from harsh environmental conditions. Pressure sensors can be configured to transmit measured pressures using wired transmission (e.g., sensors are connected to a central control room via wired communication channels, such as Ethernet or fiber optic cables) or wireless transmission (e.g., in remote or challenging locations, wireless technologies like Wi-Fi, cellular, or satellite communication may be used to transmit data) in various embodiments. Measurements from the pressure sensors can be gathered by a data acquisition system (DAS) such as a SCADA system configured to collect data from the pressure sensors and other field instruments. The DAS may collect data samples from the pressure sensors at regular intervals (e.g., every second, every few seconds, every minute, every few minutes, etc.). Data collected from the pressure sensors can be processed to ensure accuracy and consistency and stored in a database for historical reference and analysis.

In some embodiments, the pressure sensors are selected, located, or configured based on one or more of the following key considerations. Regular calibration can ensure the accuracy of pressure measurements. Environmental factors such as temperature, pressure, and vibration can affect sensor performance. Data security considerations may include using robust cybersecurity measures to protect sensitive data. Data redundancy considerations may include using redundant sensors and communication systems to improve data reliability and minimize downtime. By effectively acquiring and analyzing wellhead pressure data, wellsite operators and computing system 110 can optimize production, reduce downtime, and improve overall field performance. Data from wellhead pressure sensors can be updated in real-time or can occur on a per-well basis. In some embodiments, wellhead pressure measurements may have a range from 0 to 20,000 psi, an accuracy of +0.25% of full scale (~50 psi), and a resolution of +0.1% of full scale (~20 psi), which may differ based on application and sensor type.

In some embodiments, wellhead pressure measurements can be used for well performance monitoring. Such monitoring may include monitoring production or injection rate of the well. For example, wellhead pressure is directly related to the flow rate of fluids from the well or into the well. By monitoring pressure changes, computing system 110 can assess well performance and identify potential issues like scaling, corrosion, or formation damage. Wellhead pressure can also help determine the need for artificial lift methods like pumps or gas lift to maintain production, or be utilized in injection to determine expected bottomhole pressure and impact on the formation. In some embodiments, reservoir pressure monitoring can be used to measure or calculate reservoir depletion because a decline in wellhead pressure can indicate a decrease in reservoir pressure, which may signal reservoir depletion. In some embodiments, reservoir pressure monitoring can be used to determine how the injected fluid is interacting with the formation and reservoir fluid, which may lead to complications such as formation fracturing or fluid migrating out of the reservoir. Reservoir pressure monitoring can also be used for pressure maintenance. For example, by analyzing pressure trends, computing system 110 or engineers can assess the effectiveness of pressure maintenance strategies, such as waterflooding or gas injection.

Pressure sensors installed at the wellsite can also be used to measure or determine wellbore integrity. For example, abnormally low or high wellhead pressure can indicate potential leaks in the wellbore or production tubing. Changes in pressure can also be indicative of corrosion-related issues, especially in corrosive environments. Pressure sensors can also be used for safety and environmental compliance. For example, wellhead pressure data can be used for designing and calibrating pressure relief devices to prevent hazardous situations. Monitoring wellhead pressure can also help ensure compliance with environmental regulations, such as those related to emissions and spills.

Pressure measurements from real-time wellsite data sources 510 can be used by computing system 110 to support a variety of models or other operations performed by computing system 110. For example, computing system 110 can use wellhead pressure data to calibrate and validate reservoir simulation models, improving their accuracy in predicting future performance. Computing system 110 can analyze historical wellhead pressure data to forecast future production or injection trends and optimize production or injection strategies. In some embodiments, wellhead pressure data may be utilized to calibrate and validate injection response models, improving their accuracy in predicting future performance or geological responses. Computing system 110 can use wellhead pressure data as input for machine learning models (e.g., AI model 534) to predict well performance, identify anomalies, and optimize production and injection operations. Computing system 110 can integrate wellhead pressure data into real-time monitoring systems to enable timely intervention and prevent production or injection disruptions. In summary, wellhead pressure sensor data is a valuable tool for understanding reservoir behavior, optimizing production or injection operations, and ensuring the safety and environmental compliance of oil and gas operations.

In some embodiments, computing system 110 uses wellhead pressure measurements to calculate various derived metrics. One derived metric which can be calculated based on wellhead pressure measurements is production or injection rate indicating the volume of fluid produced or injected per unit time. Production or injection rate can be calculated by combining wellhead pressure data with flowmeter readings. Another derived metric which can be calculated based on wellhead pressure measurements is injection rate and bottomhole pressure indicating the volume of fluid injected and pressure at point of contact with the formation per unit time. Computing system 110 can also use the wellhead pressure measurements to calculate wellbore pressure drop representing the pressure loss between the wellhead and the bottomhole. Wellbore pressure drop can be calculated by subtracting the bottomhole pressure from the wellhead pressure. Computing system 110 can also use the wellhead pressure measurements to determine reservoir pressure, which is a key parameter for understanding reservoir performance and production or injection potential. While not directly measured by wellhead pressure sensors, reservoir pressure can be estimated using techniques such as pressure transient analysis or by combining wellhead pressure data with other reservoir parameters. In some embodiments, computing system 110 uses the wellhead pressure measurements to calculate a wellbore productivity index. The wellbore productivity index (PI) quantifies the ability of a well to produce hydrocarbons and can be calculated using the following formula:

$$PI = \frac{Q}{{P}_{w f} - {P}_{r s}}$$

where PI is the productivity index, Q is the production rate, P_{wf} is the wellhead pressure, and Pᵣₛ is the reservoir pressure.

Computing system 110 can use the wellhead pressure measurements as inputs to various operations performed by computing system 110. For example, computing system 110 can use the wellhead pressure measurements for reservoir management by understanding reservoir pressure and fluid flow behavior. Computing system 110 can use the wellhead pressure measurements for well performance evaluation by assessing the performance of individual wells and identifying potential issues. Computing system 110 can use the wellhead pressure measurements from production or injection operations in order to optimize production or injection rates and well operations. Computing system 110 can use the wellhead pressure measurements for field development planning by making informed decisions about future development, production, and injection strategies. Finally, computing system 110 can use the wellhead pressure measurements for reservoir simulation by calibrating and validating reservoir simulation models. By analyzing these derived metrics, computing system 110 and engineers can make data-driven decisions to improve production and injection efficiency, reduce operational costs, and maximize hydrocarbon recovery or fluid injection volumes.

In some embodiments, computing system 110 uses the wellhead pressure measurements to derive or identify correlations between wellhead pressure and various other data sources. For example, wellhead pressure may be correlated with production or injection rate because higher wellhead pressure often corresponds to higher production or injection rates, especially in wells with artificial lift systems, whereas lower wellhead pressure may indicate declining reservoir pressure or wellbore issues. Wellhead pressure may be correlated with bottomhole pressure because the difference between wellhead and bottomhole pressure represents the pressure drop across the wellbore. A significant pressure drop can indicate flow restrictions, such as scaling or formation damage. Wellhead pressure may be correlated with fluid properties because changes in fluid properties, such as gas-oil ratio or water cut, can affect wellhead pressure. For example, increased gas production or increased density or viscosity of injected fluid can lead to higher wellhead pressure. Wellhead pressure may be correlated with reservoir pressure because wellhead pressure is directly linked to reservoir pressure. A decline in wellhead pressure can indicate a decline in reservoir pressure, leaking casing, or formation damage. Computing system 110 can be configured to analyze the various input data from real-time wellsite data source 510 and other data sources 502 to identify any correlations which may exist between the wellhead pressure and other measured or calculated data values.

By understanding these correlations, computing system 110 and engineers can effectively utilize wellhead pressure data for model training and operation. For example, training data generator 528 of computing system 110 can be configured to provide wellhead pressure and any correlated data sources to model trainer 530 as training data. Model trainer 530 can use wellhead pressure as a data source when training AI model 534. In some embodiments, wellhead pressure can be used for feature engineering. For example, wellhead pressure can be used as a feature to train AI model 534 for predicting production or injection rates, reservoir performance, and wellbore issues. Historical wellhead pressure data can be used to calibrate AI model 534 and improve its accuracy.

During operation of computing system 110 to monitor and control wellsite operations, wellhead pressure data can be used as input for reservoir simulation models. For example, data collector 526 can collect wellhead pressure data from real-time wellsite data source 510 and provide the wellhead pressure data as an input to AI model 534 or other simulation models. Computing system 110 can use wellhead pressure data to history match reservoir simulation models, improving their predictive capabilities. In some embodiments, computing system 110 uses wellhead pressure data to optimize wellsite production or injection. For example, wellsite optimizer 540 can be configured to analyze wellhead pressure trends to identify underperforming wells and optimize production or injection strategies. In some embodiments, wellsite optimizer 540 uses wellhead pressure data to optimize artificial lift systems, such as pumps and gas lift. In some embodiments, wellsite optimizer 540 uses wellhead pressure data to optimize injection systems, such as pumps and choke positions. By effectively utilizing wellhead pressure data, computing system 110 and engineers can optimize production or injection operations, improve reservoir performance, and minimize operational risks.

Another type of pressure measurement which can be provided by pressure sensors installed at the wellsite is bottomhole pressure. For example, a bottomhole pressure sensor can be installed at the bottom of the wellbore as shown in FIG. 3 (e.g., sensor 166). Bottomhole pressure can be used to monitor reservoir performance. For example, bottomhole pressure decline indicates reservoir depletion and can help estimate remaining reserves. Bottomhole pressure also provides information about reservoir energy, which drives fluid flow and production or injection rates. In some embodiments, computing system 110 uses bottomhole pressure to calculate metrics indicating well performance. For example, computing system 110 can use bottomhole pressure to calculate the productivity index of a well, which measures its ability to produce hydrocarbons. Additionally, by monitoring pressure differences between the formation and the wellbore, computing system 110 or engineers can estimate flow rates. Data from bottomhole pressure sensors can be updated in real-time or can occur on a per-well basis. In some embodiments, bottomhole pressure measurements may have a range from 0 to 10,000 psi, an accuracy of ±0.25% of full scale, and a resolution of ±0.1 psi to 0.2% of full scale, which may differ based on application and sensor type.

Computing system 110 can use bottomhole pressure to determine wellbore integrity. For example, abnormally low bottomhole pressure may indicate leaks in the wellbore or production or injection tubing. Conversely, high bottomhole pressure can be a sign of formation damage, such as permeability reduction or plugging. In some embodiments, computing system 110 uses bottomhole pressure to calculate artificial lift. For example, computing system 110 can use bottomhole pressure to evaluate the performance of artificial lift systems, such as pumps and gas lift. Computing system 110 can also use bottomhole pressure to optimize artificial lift systems to maximize production. In some embodiments, computing system 110 can use bottomhole pressure to determine formation response from injection of fluids. For example, utilizing bottomhole pressure, instead of a calculated bottomhole pressure from wellhead pressure, more accurately determines if pressures are near or exceeding the fracture gradient of the injection formation. Computing system 110 can also use bottomhole pressure to optimize injection systems to maximize injection rates and volumes.

In some embodiments, computing system 110 uses bottomhole pressure to calibrate and validate reservoir simulation models, such as AI model 534 or other reservoir simulation models. Computing system 110 can also use bottomhole pressure for production or injection forecasting. For example, by analyzing historical bottomhole pressure data, computing system 110 or engineers can forecast future production or injection trends. Computing system 110 can use bottomhole pressure as a feature in AI model 534 (i.e., as an input to AI model 534) to predict well performance, reservoir behavior, and both production and injection rates. Computing system 110 can also perform real-time monitoring of bottomhole pressure to enable timely intervention and optimization of production and injection operations. Advantageously, by effectively utilizing bottomhole pressure data, computing system 110 can optimize production and injection strategies, improve reservoir performance, and minimize operational risks.

In some embodiments, computing system 110 uses bottomhole pressure to calculate various derived metrics. One derived metric which can be calculated based on bottomhole pressure is reservoir pressure, which is a fundamental parameter which influences fluid flow and production or injection rates. By analyzing pressure transient data, computing system 110 can estimate reservoir pressure. Bottomhole pressure can also be used to calculate wellbore pressure drop (i.e., wellhead pressure minus bottomhole pressure) and the wellbore productivity index as described above. Computing system 110 can use the bottomhole pressure measurements as inputs to various operations performed by computing system 110. For example, computing system 110 can use the bottomhole pressure measurements for reservoir management, well performance evaluation, production and injection optimization, field development planning, and reservoir simulation in the same manner as the wellhead pressure described above. By analyzing these derived metrics, computing system 110 and engineers can make data-driven decisions to improve production or injection efficiency, reduce operational costs, and maximize hydrocarbon recovery.

In some embodiments, computing system 110 uses the bottomhole pressure measurements to derive or identify correlations between bottomhole pressure and various other data sources. For example, bottomhole pressure may be correlated with wellhead pressure because the difference between wellhead and bottomhole pressure represents the pressure differential across the wellbore. A significant pressure differential can indicate flow restrictions, such as scaling or formation damage. Bottomhole pressure may be correlated with production or injection rate. For example, higher bottomhole pressure can lead to increased production or injection rates, especially in wells with artificial lift systems, whereas lower bottomhole pressure can indicate declining reservoir pressure or wellbore issues. Bottomhole pressure may be correlated with reservoir pressure because bottomhole pressure is directly linked to reservoir pressure. A decline in bottomhole pressure can indicate a decline in reservoir pressure. Bottomhole pressure can also be correlated with fluid properties because changes in fluid properties (e.g., gas-oil ratio, water cut, etc.) can affect bottomhole pressure. Computing system 110 can be configured to analyze the various input data from real-time wellsite data source 510 and other data sources 502 to identify any correlations which may exist between the bottomhole pressure and other measured or calculated data values.

By understanding these correlations, computing system 110 and engineers can effectively utilize bottomhole pressure data for model training and operation. For example, training data generator 528 of computing system 110 can be configured to provide bottomhole pressure and any correlated data sources to model trainer 530 as training data. Model trainer 530 can use bottomhole pressure as a data source when training AI model 534. In some embodiments, bottomhole pressure can be used for feature engineering. For example, bottomhole pressure can be used as a feature to train AI model 534 for predicting production or injection rates, reservoir performance, and wellbore issues. Historical bottomhole pressure data can be used to calibrate AI model 534 and improve its accuracy.

During operation of computing system 110 to monitor and control wellsite operations, bottomhole pressure data can be used as input for reservoir simulation models. For example, data collector 526 can collect bottomhole pressure data from real-time wellsite data source 510 and provide the bottomhole pressure data as an input to AI model 534 or other simulation models. Computing system 110 can use bottomhole pressure data to history match reservoir simulation models, improving their predictive capabilities. In some embodiments, computing system 110 uses bottomhole pressure data to optimize wellsite production or injection. For example, wellsite optimizer 540 can be configured to analyze bottomhole pressure trends to identify underperforming wells and optimize production or injection strategies. In some embodiments, wellsite optimizer 540 uses bottomhole pressure data to optimize artificial lift systems, such as pumps and gas lift. By effectively utilizing bottomhole pressure data, computing system 110 and engineers can optimize production or injection operations, improve reservoir performance, and minimize operational risks.

Another type of pressure measurement which can be provided by pressure sensors installed at the wellsite is pump pressure. Pump pressure can be measured by pump pressure sensor 140 as shown in FIG. 3. Data from pump pressure sensors can be updated in real-time or can occur on a per-well basis. In some embodiments, pump pressure measurements may have a range from 0 to 10,000 psi, an accuracy of ±0.5% of full scale (~50 psi), and a resolution of ±0.1% of full scale (~1 to 1,000 psi depending on the sensitivity of the sensor), which may differ based on application and sensor type.

Computing system 110 can use pump pressure measurements to determine a variety of metrics characterizing the operation of the wellsite, such as pump performance, wellbore conditions, reservoir performance, and production or injection optimization. For example, computing system 110 can use pump pressure to assess the efficiency of the pump (e.g., pump 144) and identify potential issues such as cavitation or wear and tear. Monitoring pump pressure can help optimize power consumption and reduce operational costs. High pump pressure may indicate increased flow resistance in the flowline or wellbore, which could be due to factors such as scaling, paraffin deposition, or formation damage. Abnormally high or low pump pressure may signal potential flowline or wellbore integrity issues, such as leaks or casing damage. In some embodiments, computing system 110 uses pump pressure to infer reservoir pressure, especially in declining reservoirs, whereas changes in pump pressure can provide insights into fluid flow behavior within the reservoir. By analyzing pump pressure data, computing system 110 can optimize the settings of artificial lift systems to maximize production or injection and minimize energy consumption. Computing system 110 can also use pump pressure to assess the impact of one well on another, particularly in closely spaced wells.

In some embodiments, training data generator 528 and model trainer 530 use pump pressure as a feature to train AI model 534 for predicting pump performance, wellbore issues, and production rates. Model trainer 530 can use pump pressure data to calibrate and validate reservoir simulation models. Wellsite optimizer 540 can use pump pressure data to optimize production or injection schedules and well interventions. By effectively utilizing pump pressure data, computing system 110 can improve the efficiency of artificial lift systems, optimize production, and minimize operational costs.

In some embodiments, data collector 526 uses pump pressure to calculate various derived metrics which can be used as input data to training data generator 528 and/or AI model 534. Derived metrics based on pump pressure may include pump efficiency representing how effectively the pump converts input power into fluid energy. By analyzing the relationship between pump pressure, flow rate, and power consumption, computing system 110 can estimate pump efficiency. Another derived metric based in pump pressure is hydraulic horsepower. Hydraulic horsepower represents the power delivered to the fluid by the pump and can be calculated using the following formula:

$$Hydraulic Horsepower = ( Q * Δ P ) / 1714$$

where Q indicates the flow rate (e.g., gpm) and AP indicates the pressure difference across the pump (e.g., psi). Another derived metric based on pump pressure is net positive suction head (NPSH). NPSH is a measure of the available net positive pressure head at the suction side of the pump. NPSH can be calculated using various methods, including the use of pump performance curves and system characteristics. Another derived metric based on pump pressure is wellbore pressure drop. Wellbore pressure drop may indicate the presence of flow restrictions or damage in the wellbore and can be calculated by analyzing the relationship between pump pressure and flow rate.

Computing system 110 can use metrics derived from pump pressure for a variety of purposes including pump optimization, well performance evaluation, production or injection optimization, artificial lift system design, and reservoir management. For example, computing system 110 can use pump pressure to identify opportunities to improve pump efficiency and reduce energy consumption. Pump pressure can be used for assessing the performance of wells and identifying potential issues, such as scaling or formation damage. In some embodiments, wellsite optimizer 540 uses pump pressure for optimizing production or injection rates and minimizing operational costs. Computing system 110 can use pump pressure to select appropriate artificial lift systems and design optimal operating parameters. Pump pressure can also be used by computing system 110 for understanding reservoir pressure and fluid flow behavior. By analyzing these derived metrics, computing system 110 can make data-driven decisions to improve production or injection efficiency, reduce operational costs, and maximize hydrocarbon recovery.

In some embodiments, data collector 526 is configured to correlate casing pressure with other data sources to generate features provided as input data to AI model 534. For example, data collector 526 can correlate casing pressure with flow rate, wellhead pressure, and/or reservoir pressure. For example, higher pump pressure is often required to achieve higher flow rates, especially in high-pressure, low-permeability reservoirs. The relationship between pump pressure and flow rate can be used to assess pump performance and identify potential issues. The difference between pump pressure and wellhead pressure represents the pressure drop across the pump and wellbore. This pressure drop can provide insights into the efficiency of the pumping system and the condition of the wellbore. In some cases, pump pressure can be used to infer reservoir pressure, especially in declining reservoirs. The relationship between pump pressure and reservoir pressure can help optimize production or injection strategies.

In some embodiments, model trainer 530 uses these correlations to effectively use pump pressure for model training and operation. For example, model trainer 530 can use pump pressure as a feature to train AI model 534 for predicting pump performance, wellbore issues, and production or injection rates. Model trainer 530 can use historical pump pressure data to calibrate AI model 534 and improve its accuracy. Computing system 110 can use pump pressure data as input for reservoir simulation models, especially in cases where artificial lift is used, as well as to history match reservoir simulation models, improving their predictive capabilities. Wellsite optimizer 540 can use pump pressure data to optimize pump settings to improve efficiency and reduce energy consumption. Computing system 110 can also use pump pressure data to assess well performance and identify potential issues, such as scaling or formation damage. By effectively utilizing pump pressure data, computing system 110 can improve the efficiency of artificial lift systems, optimize production, and minimize operational costs.

Another type of pressure measurement which can be provided by pressure sensors installed at the wellsite is casing pressure. Casing pressure can be measured by casing pressure sensor 154 as shown in FIG. 3. Data from casing pressure sensors can be updated in real-time or can occur on a per-well basis. In some embodiments, casing pressure measurements may have a range from 0 to 10,000 psi, an accuracy of ±0.25% of full scale (~25 psi), and a resolution of ±0.1 psi, which may differ based on application and sensor type.

Computing system 110 can use casing pressure measurements to determine a variety of metrics characterizing the operation of the wellsite, such as wellbore integrity, reservoir pressure, fluid flow, and artificial lift. Detecting wellbore integrity may include using abnormally high or low casing pressure measurements to detect potential leaks in the casing or tubing and/or using casing pressure measurements to detect corrosion-related issues. Casing pressure can also be used to provide insights into reservoir pressure and help assess the effectiveness of pressure maintenance strategies. In some embodiments, computing system 110 uses casing pressure to detect reservoir depletion. For example, a decline in casing pressure may signal reservoir depletion. In some embodiments, computing system 110 uses changes in casing pressure to estimate changes in fluid flow within the wellbore (e.g., scaling or paraffin deposition) as well as to detect wellbore damage. For example, high casing pressure may be a sign of formation damage or wellbore restrictions. In some embodiments, computing system 110 uses casing pressure to estimate pump performance because casing pressure can influence the performance of artificial lift systems, such as pumps and gas lift. Monitoring casing pressure can also help optimize artificial lift systems to maximize production.

In some embodiments, training data generator 528 and model trainer 530 use casing pressure as a feature to train AI model 534 for predicting well performance, reservoir behavior, and production or injection rates. Casing pressure can also be used by model trainer 530 to calibrate and validate reservoir simulation models. In some embodiments, wellsite optimizer 540 uses casing pressure to optimize production or injection strategies, such as well spacing and artificial lift. Advantageously, by effectively utilizing casing pressure data, computing system 110 can improve well performance, optimize production or injection, and minimize operational risks.

In some embodiments, data collector 526 uses casing pressure to calculate various derived metrics which can be used as input data to training data generator 528 and/or AI model 534. Derived metrics based on casing pressure may include wellbore pressure drop representing the pressure loss between the casing and the wellbore tubing, which can be calculated by subtracting the tubing pressure from the casing pressure. Another metric derived from casing pressure is formation pressure, which is a key parameter for understanding reservoir performance and production or injection potential. Formation pressure can be calculated based on casing pressure in certain cases such as low-pressure reservoirs. In some embodiments, data collector 526 uses casing pressure to generate a new data stream indicating potential leaks in the casing or tubing by monitoring casing pressure trends and comparing them to historical data. Data collector 526 can also use casing pressure to assess the impact of corrosion on wellbore integrity, as increased casing pressure may indicate scaling or other formation damage. Metrics derived from casing pressure can be used for a variety of purposes including identifying and addressing potential issues such as leaks, corrosion, and scaling, optimizing production or injection rates and minimizing production or injection losses, understanding reservoir pressure and fluid flow behavior, and ensuring safe and environmentally responsible operations. By analyzing these derived metrics, computing system 110 can make informed decisions about well maintenance, production or injection optimization, and reservoir management.

In some embodiments, data collector 526 is configured to correlate casing pressure with other data sources to generate features provided as input data to AI model 534. For example, data collector 526 can correlate casing pressure with flow rate, wellhead pressure, and/or reservoir pressure. Higher casing pressure is often required to achieve higher flow rates, especially in high-pressure, low-permeability reservoirs. The relationship between casing pressure and flow rate can be used to assess pump performance and identify potential issues. The difference between casing pressure and wellhead pressure represents the pressure drop across the pump and wellbore. This pressure drop can provide insights into the efficiency of the pumping system and the condition of the wellbore. In some cases, casing pressure can be used to infer reservoir pressure, especially in declining reservoirs. The relationship between casing pressure and reservoir pressure can help optimize production or injection strategies.

In some embodiments, model trainer 530 uses these correlations to effectively use casing pressure for model training and operation. For example, model trainer 530 can use casing pressure as a feature to train AI model 534 for predicting pump performance, wellbore issues, and production or injection rates. Model trainer 530 can use historical casing pressure data to calibrate AI model 534 and improve its accuracy. During operation, computing system 110 can use casing pressure data as input for reservoir simulation models, especially in cases where artificial lift is used, and/or to history match reservoir simulation models, improving their predictive capabilities. Wellsite optimizer 540 can use casing pressure data to optimize pump settings to improve efficiency and reduce energy consumption. Wellsite optimizer 540 can also use casing pressure data to assess well performance and identify potential issues, such as scaling or formation damage. By effectively utilizing casing pressure data, computing system 110 can improve the efficiency of artificial lift systems, optimize production, and minimize operational costs.

Another type of pressure measurement which can be provided by pressure sensors installed at the wellsite is tubing pressure. In some embodiments, tubing pressure is measured by tubing pressure sensor 132 as shown in FIG. 3. Data from tubing pressure sensor 132 can be updated in real-time or can occur on a per-well basis. In some embodiments, tubing pressure measurements may have a range from 0 to 10,000 psi, an accuracy of ±0.25% of full scale (~25 psi), and a resolution of =0.1 psi, which may differ based on application and sensor type.

Tubing pressure can provide useful information on wellbore integrity. For example, abnormally high or low tubing pressure can indicate potential leaks in the tubing or casing, whereas changes in tubing pressure can be indicative of corrosion-related issues, especially in corrosive environments. Tubing pressure can also be used to estimate fluid flow. For example, high tubing pressure can indicate increased flow resistance due to factors like scaling, paraffin deposition, or formation damage. Tubing pressure can be used to assess the impact of multiphase flow on well performance. Tubing pressure can provide information on artificial lift. For example, tubing pressure can be used to evaluate the performance of artificial lift systems, such as pumps and gas lift. Monitoring tubing pressure can help optimize artificial lift systems to maximize production. Tubing pressure can be used to infer reservoir pressure, especially in declining reservoirs. Changes in tubing pressure can provide insights into fluid flow behavior within the reservoir.

In some embodiments, training data generator 528 and model trainer 530 use tubing pressure as a feature to train AI model 534 for predicting well performance, reservoir behavior, and production or injection rates. Tubing pressure data can also be used to calibrate and validate reservoir simulation models and optimize production or injection strategies, such as well spacing and artificial lift. Advantageously, by effectively utilizing tubing pressure data, computing system 110 can improve well performance, optimize production, and minimize operational risks.

In some embodiments, data collector 526 uses tubing pressure to calculate various derived metrics which can be used as input data to training data generator 528 and/or AI model 534. Derived metrics based on tubing pressure may include wellbore pressure drop representing the pressure loss between the wellhead and the bottomhole, which can be calculated by subtracting the bottomhole pressure from the tubing pressure. Another derived metric based on tubing pressure is fluid flow rate. The flow rate of fluid through the tubing affects production or injection rates and well performance. By analyzing the relationship between tubing pressure and flow rate, computing system 110 can estimate fluid flow rates. Another derived metric based on tubing pressure is formation pressure, which is a key parameter for understanding reservoir performance and production or injection potential. In some cases, tubing pressure can be used to estimate formation pressure, especially in low-pressure reservoirs. Another derived metric based on tubing pressure is wellbore integrity. For example, abnormally high or low tubing pressure can indicate potential leaks in the tubing or casing, whereas changes in tubing pressure can be indicative of corrosion-related issues. Metrics derived from tubing pressure can be used for a variety of purposes including assessing the performance of individual wells and identifying potential issues, such as wellbore damage or formation damage, optimizing production or injection rates, minimizing production or injection losses, understanding reservoir pressure and fluid flow behavior, and ensuring safe and environmentally responsible operations. By analyzing these derived metrics, computing system 110 can make informed decisions about well maintenance, production or injection optimization, and reservoir management.

In some embodiments, data collector 526 is configured to correlate tubing pressure with other data sources to generate features provided as input data to AI model 534. For example, data collector 526 can correlate tubing pressure with flow rate, wellhead pressure, and/or reservoir pressure. Higher tubing pressure is often required to achieve higher flow rates, especially in high-pressure, low-permeability reservoirs. The relationship between tubing pressure and flow rate can be used to assess pump performance and identify potential issues. The difference between tubing pressure and wellhead pressure represents the pressure drop across the pump and wellbore. This pressure drop can provide insights into the efficiency of the pumping system and the condition of the wellbore. In some cases, tubing pressure can be used to infer reservoir pressure, especially in declining reservoirs. For example, the relationship between tubing pressure and reservoir pressure can help optimize production or injection strategies.

In some embodiments, model trainer 530 uses these correlations to effectively use tubing pressure for model training and operation. For example, model trainer 530 can use tubing pressure as a feature to train AI model 534 for predicting pump performance, wellbore issues, and production or injection rates. Model trainer 530 can use historical tubing pressure data to calibrate AI model 534 and improve its accuracy. Tubing pressure data can be used as input for reservoir simulation models, especially in cases where artificial lift is used, as well as to history match reservoir simulation models, improving their predictive capabilities. Wellsite optimizer 540 can use tubing pressure data to optimize pump settings to improve efficiency and reduce energy consumption. Wellsite optimizer 540 can also use tubing pressure data to assess well performance and identify potential issues, such as scaling or formation damage. By effectively utilizing tubing pressure data, computing system 110 can improve the efficiency of artificial lift systems, optimize production or injection, and minimize operational costs.

Another type of pressure measurement which can be provided by pressure sensors installed at the wellsite is flowline pressure. Flowline pressure can be measured by flowline pressure sensor 136 as shown in FIG. 3. Data from flowline pressure sensors can be updated in real-time or can occur on a per-well basis. In some embodiments, flowline pressure measurements may have a range from 0 to 10,000 psi, an accuracy of ±0.25% of full scale (~25 psi), and a resolution of ±0.1% of full scale, which may differ based on application and sensor type.

Computing system 110 can use flowline pressure measurements to determine a variety of metrics characterizing the operation of the wellsite, such as flow rate, pipeline integrity, facility operations, and production or injection optimization. For example, the pressure drop across a flowline is directly related to the flow rate of fluids. Computing system 110 can monitor flowline pressure to help identify potential flow assurance challenges, such as liquid dropout or hydrate formation. Abnormally low or high flowline pressure can indicate potential leaks in the pipeline. Changes in flowline pressure can provide insights into corrosion-related issues, especially in corrosive environments. Computing system 110 can use flowline pressure to assess the performance of pumps and compressors used to transport fluids. Pressure drops across separators can indicate the efficiency of separation processes. In some embodiments, computing system 110 uses flowline pressure to evaluate the performance of individual wells and identify underperforming wells. By monitoring flowline pressures, computing system 110 can optimize production or injection allocation among different wells.

In some embodiments, training data generator 528 and model trainer 530 use flowline pressure as a feature to train AI model 534 for predicting pipeline performance, detecting anomalies, and optimizing operations. Model trainer 530 can use flowline pressure data to calibrate and validate pipeline simulation models. Wellsite optimizer 540 can use flowline pressure to optimize production or injection rates, minimize pressure drops, and reduce energy consumption. By effectively utilizing flowline pressure data, computing system 110 can improve pipeline efficiency, enhance safety, and optimize production or injection operations.

In some embodiments, data collector 526 uses flowline pressure to calculate various derived metrics which can be used as input data to training data generator 528 and/or AI model 534. Derived metrics based on flowline pressure may include flow rate, which is a fundamental parameter for monitoring production or injection and optimizing operations. By analyzing the pressure drop across a flowmeter, data collector 526 can calculate flow rate. Additionally, pressure drop along the pipeline indicates energy losses due to friction and other factors. Accordingly, by measuring pressure at different points along the pipeline, computing system 110 can calculate pressure drops. Abnormally low or high flowline pressure can also indicate potential leaks in the pipeline, whereas changes in flowline pressure can be used to assess the impact of corrosion on pipeline integrity. In some embodiments, computing system 110 uses flowline pressure to estimate the power consumption of pumps and compressors. By analyzing the relationship between flow rate and pressure drop, computing system 110 can assess the efficiency of pumping and compression systems. Computing system 110 can use flowline pressure to identify bottlenecks, optimize flow rates, and minimize energy consumption. Wellsite optimizer 540 can use flowline pressure to optimize production by ensuring efficient production and transportation of hydrocarbons, or to optimize injection by ensuring efficient injection and transportation of injectable fluids (e.g. water, brine, carbon dioxide, etc.). Flowline pressure can be used for preventing accidents and minimizing environmental impact as well as monitoring the health of pipelines and production or injection facilities. By analyzing flowline pressure data, computing system 110 can make informed decisions about pipeline maintenance, production or injection optimization, and risk management.

In some embodiments, data collector 526 is configured to correlate flowline pressure with other data sources to generate features provided as input data to AI model 534. For example, data collector 526 can correlate casing pressure with flow rate, wellhead pressure, and/or reservoir pressure. Higher flowline pressure is often required to achieve higher flow rates, especially in high-pressure, low-permeability reservoirs. The relationship between flowline pressure and flow rate can be used to assess pump performance and identify potential issues. The difference between flowline pressure and wellhead pressure represents the pressure drop across the pump and wellbore. This pressure drop can provide insights into the efficiency of the pumping system and the condition of the wellbore. In some cases, flowline pressure can be used to infer reservoir pressure, especially in declining reservoirs. The relationship between flowline pressure and reservoir pressure can help optimize production or injection strategies.

In some embodiments, model trainer 530 uses these correlations to effectively utilize flowline pressure data for model training and operation. For example, model trainer 530 can use flowline pressure as a feature to train AI model 534 for predicting pump performance, wellbore issues, and production or injection rates. Model trainer 530 can use historical flowline pressure data to calibrate AI model 534 and improve its accuracy. Flowline pressure data can also be used as input for reservoir simulation models, especially in cases where artificial lift is used, as well as to history match reservoir simulation models, improving their predictive capabilities. Wellsite optimizer 540 can analyze flowline pressure data to optimize pump settings to improve efficiency and reduce energy consumption. Flowline pressure data can also be used to assess well performance and identify potential issues, such as scaling or formation damage. By effectively utilizing flowline pressure data, computing system 110 can improve the efficiency of artificial lift systems, optimize production or injection, and minimize operational costs.

### Temperature Sensors

In some embodiments, real-time wellsite data sources 510 include temperature sensors. Temperature transducers can be installed at the wellhead, within the well, and/or directly connected to the pipeline or flowline. Temperature sensors can be housed in weatherproof enclosures to protect them from harsh environmental conditions. Temperature sensors can be configured to transmit data using wired transmission (e.g., sensors connected to a central control room via wired communication channels, such as Ethernet or fiber optic cables) or wireless transmission (e.g., in remote or challenging locations, wireless technologies like Wi-Fi, cellular, or satellite communication may be used to transmit data) in various embodiments. Measurements from temperature sensors and other field instruments can be gathered or collected at a data acquisition system (DAS) at regular intervals, such as every few seconds or minutes. The collected temperature data can be processed to ensure accuracy and consistency. Temperature data can be stored in a database for historical reference and analysis.

In some embodiments, the temperature sensors are selected, located, or configured based on one or more of the following key considerations. Regular calibration can ensure the accuracy of temperature measurements. Environmental factors such as temperature, pressure, and vibration can affect sensor performance. Robust cybersecurity measures can be implemented to protect sensitive data. Redundant sensors and communication systems can improve data reliability and minimize downtime. By effectively acquiring and analyzing wellhead temperature data, computing system 110 can optimize production, reduce downtime, and improve overall field performance of wellsite equipment 546.

One type of temperature measurement which can be provided by temperature sensors installed at the wellsite is bottomhole temperature. Bottomhole temperature can be measured, for example, by bottomhole pressure/temperature sensor 166 as shown in FIG. 3. In some embodiments, bottomhole temperature is updated in real-time on a per-well basis. In some embodiments, the measured bottomhole temperature may range from 0 to 200° C. (32 to 392° F.) with an accuracy of 0.5° C. and a resolution of ±0.1° C., which may differ dependent on application and sensor type. Bottomhole temperature provides data that signifies the temperature at the bottom of a wellbore. Bottomhole temperature can be used for reservoir characterization, well performance analysis, and optimizing production or injection strategies because it allows computing system 110 to estimate important parameters like formation pressure, fluid properties, and potential issues like gas coning, water influx, or formation damage, ultimately informing decisions about well operations and production or injection optimization.

Computing system 110 can use bottomhole temperature data to generate a variety of metrics that characterize the wellsite and/or reservoir. For example, computing system 110 can use bottomhole pressure for fluid property calculations. Bottomhole temperature significantly impacts the density and viscosity of fluids in a reservoir, which are used for calculating flow rates and pressure gradients. In some embodiments, computing system 110 uses bottomhole temperature to estimate formation pressure by combining bottomhole temperature with pressure measurements. Computing system 110 can also use bottomhole temperature for wellbore heat transfer analysis by monitoring temperature changes along the wellbore. This can help identify potential problems such as stuck pipe or inadequate cementing, where heat transfer dynamics are altered. In some embodiments, computing system 110 uses bottomhole temperature to determine gas-liquid contact. For example, in multiphase flow, bottomhole temperature data can help locate the gas-liquid contact in a reservoir, which can be used by wellsite optimizer 540 for optimizing production or injection strategies. In some embodiments, computing system 110 uses bottomhole temperature to determine formation damage. For example, in injection operations, the difference between natural reservoir temperatures and injected fluid may cause a cooling effect that rapidly shrinks the formation causing formation damage such as fracturing. Computing system 110 can also use bottomhole temperature for reservoir simulation modeling. For example, accurate bottomhole temperature data can be used to build reliable reservoir simulation models, which can be used by AI model 534 to predict future production or injection behavior and make informed development decisions.

Bottomhole temperature can be used by AI model 534 to make model predictions. For example, bottomhole temperature can be used for inflow performance relationship (IPR) curves. By incorporating temperature data, AI model 534 can more precisely calculate the relationship between wellhead pressure and production or injection rate, allowing for better well optimization. Bottomhole temperature can also be used by AI model 534 for rate transient analysis (RTA). For example, bottomhole temperature data can be used for analyzing pressure transient tests and providing insights into reservoir properties and potential production or injection issues. In some embodiments, AI model 534 uses bottomhole temperature data for wellbore pressure drop calculations. For example, bottomhole temperature data can be used to calculate pressure drops along the wellbore, aiding in the design of appropriate completion and production or injection systems.

Data collector 526 can be configured to calculate a variety of derived metrics based on the bottomhole temperature data. Derived metrics calculated from bottomhole temperature data, often in combination with other data sources such as pressure or flow rate, may represent the estimated reservoir temperature gradient, which can be used for understanding reservoir dynamics, optimizing production or injection strategies, and predicting potential problems such as pressure build-up or fluid migration. By analyzing the temperature gradient, computing system 110 and other downstream data consumers (e.g., geologists and engineers) can infer important reservoir properties like formation depth, fluid type, and potential for thermal recovery methods. The temperature gradient can also be used by wellsite optimizer 540 to determine the optimal production or injection rate and wellhead pressure to maximize oil recovery, especially in cases where thermal expansion is a factor. The temperature gradient can also be used by wellsite optimizer 540 to determine the optimal injection rate and wellhead pressure to maximize injection volumes and rates especially in cases where thermal expansion is a factor. Additionally, abnormally high temperature gradients can indicate wellbore integrity issues such as stuck pipe, casing damage, gas influx, or formation damage allowing for timely intervention to prevent further complications.

Examples of derived metrics which can be calculated based on the bottomhole temperature data include temperature anomaly metrics. For example, data collector 526 can compare the measured bottomhole temperature to a predicted temperature based on depth to provide an indicator of potential reservoir heterogeneities or fluid movement. Data collector 526 can calculate heat flux by combining bottomhole temperature data with flow rate, indicating the rate of heat transfer within the wellbore, which can be used for identifying potential problems such as water influx. Data collector 526 can use the bottomhole temperature data to calculate fluid contact depth by analyzing the temperature gradient change and derive an estimate of the boundary between oil, gas, and water zones within the reservoir.

In some embodiments, computing system 110 considers several factors when processing and using the bottomhole temperature data. Such factors may include data quality, integration with other data, and geological context. For example, sensor calibration and proper data collection practices can be used to obtain accurate bottomhole temperature measurements to ensure that any derived metrics based on the bottomhole temperature are accurate. Computing system 110 can combine bottomhole temperature with pressure and flow rate data to provide a more comprehensive picture of reservoir conditions. Geological context can be considered by computing system 110 because interpreting derived metrics may require knowledge of the local geological setting and reservoir characteristics.

In some embodiments, computing system 110 correlates measurements from a bottomhole temperature sensor with other data sources such as wellbore pressure, drilling mud properties, depth, flow rate, and formation pressure, as these factors directly influence the temperature profile within the wellbore, making them crucial for model training and operation when analyzing data from a bottomhole temperature sensor. Some examples of correlations which can be generated by computing system 110 include pressure and temperature correlations, drilling mud properties, depth, flow rate, and formation pressure. For example, higher pressure in the wellbore generally leads to higher temperatures due to adiabatic compression, making pressure data useful for interpreting temperature readings. The type and properties of drilling mud can impact heat transfer within the wellbore, influencing the measured temperature. Temperature typically increases with depth due to geothermal gradient, which requires depth data to accurately interpret temperature readings. Additionally, fluid flow rate can affect heat transfer in the wellbore, causing variations in temperature depending on the flow regime. The pressure of the reservoir formation can be inferred from the temperature profile, especially when combined with other well data.

Model trainer 530 can use the correlations between bottomhole temperature and other data sources when training AI model 534. These correlations can also be used to detect various issues at the wellsite and optimize wellsite operations. For example, by incorporating data from a bottomhole temperature sensor with other well data, AI model 534 can predict reservoir characteristics like porosity and permeability. Significant deviations from expected temperature profiles can indicate issues such as stuck pipe, gas influx, or formation damage, allowing for early intervention. Wellsite optimizer 540 can use these correlations to optimize drilling parameters such as mud weight and flow rate based on predicted temperature changes. In general, accurate and reliable data from all relevant sensors is important for effective model training. Contextual factors such as geological conditions, well design, and drilling operations are also relevant because such factors can influence the correlations between temperature and other data sources. Accordingly, computing system 110 can use these correlations and contextual factors when generating the training data for AI model 534, using AI model 534 to generate model predictions, and in other operations performed by computing system 110.

Another type of temperature measurement which can be provided by temperature sensors installed at the wellsite is wellhead temperature. Wellhead temperature can be measured, for example, by a temperature sensor positioned to measure the temperature of wellhead 174 in FIG. 3. In some embodiments, wellhead temperature is updated in real-time on a per-well basis. In some embodiments, the measured wellhead temperature may range from −50 to 200° C. (−58 to 392° F.) with an accuracy of 0.5° C. and a resolution of ±0.1° C., which may differ dependent on application and sensor type. Wellhead temperature provides data that signifies the temperature of the fluid flowing into or out of a well at the surface, which can be used for monitoring well performance, identifying potential issues such as flow restrictions or changes in fluid composition, and ultimately optimizing production or injection by allowing computing system 110 to make informed adjustments to well operations based on the temperature readings.

Computing system 110 can use wellhead temperature data to generate a variety of metrics that characterize the wellsite and/or reservoir. For example, computing system 110 can use wellhead temperature data for flow rate estimation. Temperature fluctuations can indicate changes in flow rate, allowing for estimations of production or injection volume even when direct flow measurement is not available. In some embodiments, computing system 110 uses wellhead temperature data to identify flow restrictions. For example, a sudden temperature drop at the wellhead can signal a partial blockage in the tubing, allowing for timely intervention to prevent further production or injection decline. Computing system 110 can use wellhead temperature data to monitor reservoir conditions. For example, wellhead temperature data can be used to infer changes in reservoir pressure and fluid properties, which can help predict future production or injection behavior. In some embodiments, computing system 110 uses wellhead temperature to detect gas-liquid separation. For example, changes in temperature can indicate the presence of gas-liquid separation within the wellbore, which can impact production or injection efficiency. Computing system 110 can use wellhead temperature to analyze wellbore heat transfer. For example, by monitoring the temperature profile along the wellbore, computing system 110 can analyze heat transfer mechanisms and optimize well design.

Wellhead temperature can be used by AI model 534 to make model predictions. For example, AI model can use wellhead temperature in one or more production or injection forecasting models (e.g., reservoir simulation models) which use wellhead temperature data to predict future production or injection rates and optimize extraction or injection strategies. In some embodiments, computing system 110 uses wellhead temperature for well performance analysis. For example, computing system 110 can use wellhead temperature data alongside pressure and flow rate measurements to analyze well health and identify potential problems. Computing system 110 can also use wellhead temperature data for downhole pressure estimation, in some cases by combining wellhead temperature with other measurements.

Data collector 526 can be configured to calculate a variety of derived metrics based on the wellhead temperature data. Derived metrics calculated from wellhead temperature may include the estimated pressure at the reservoir, which is significant because it provides valuable insight into the reservoir health and production or injection potential. By combining wellhead temperature data with other measurements such as flow rate and pressure readings, computing system 110 can monitor pressure depletion or augmentation (i.e., pressure decreases or increases) and optimize production or injection strategies. In addition to wellhead temperature, other data sources which can be used to calculate the estimated pressure at the reservoir include glow rate measurements from wellhead 174, pressure readings at different points in the wellbore, and fluid properties (e.g., density, viscosity) based on fluid analysis. By applying thermodynamic principles and using the gathered data, computing system 110 can estimate the pressure at the reservoir level by considering the temperature change as the fluid flows up the wellbore, taking into account pressure drops due to friction and other factors.

Computing system 110 can use the estimated pressure at the reservoir to support various management, analytic, and forecasting activities. For example, computing system 110 can use the reservoir pressure to monitor pressure depletion or augmentation (i.e., pressure decreases or increases) over time. Wellsite optimizer 540 can use depletion information to optimize production or injection rates and determine when to implement pressure maintenance strategies such as water injection or gas lift. Wellsite optimizer 540 can use augmentation information to optimize injection rates and determine when to implement pressure maintenance strategies such as lowering rates and volumes, or shutting down operations. By comparing the calculated reservoir pressure to the expected pressure based on reservoir modeling, computing system 110 can identify potential problems such as water coning, gas influx, or wellbore damage. Additionally, accurate reservoir pressure estimations are important for reliable production or injection forecasting, which allows computing system 110 to plan for future production or injection levels, production or injection volumes and rates, and provide wellsite operations with the information needed to make informed investment decisions.

In some embodiments, computing system 110 considers several factors when processing and using the wellhead temperature data. Such factors may include accuracy, calibration and maintenance, and software tools. The accuracy of any metric derived from the wellhead temperature data is heavily reliant on the quality and reliability of the data collected from all the sensors involved. Regular calibration and maintenance of the wellhead temperature sensor and other monitoring equipment may be important for accurate data collection. In some embodiments, computing system 110 uses specialized software to perform the calculations and integrate data from different sources to derive the reservoir pressure estimate.

In some embodiments, computing system 110 correlates measurements from a wellhead temperature sensor with other data sources such as wellhead pressure, flow rate, and production or injection depth. These factors directly influence the temperature of the produced or injected fluid and thus may be relevant data sources to consider when training or operating AI model 534 utilizing wellhead temperature data. Some examples of correlations which can be generated by computing system 110 based on the wellhead temperature data include a pressure-temperature relationship, impact on flow rate, and depth and reservoir conditions. For example, higher wellhead pressure typically leads to a higher wellhead temperature due to the adiabatic compression of the fluid as it rises from the reservoir. Increased flow rate can result in a higher wellhead temperature due to friction heat generated during fluid movement through the wellbore. Additionally, the temperature of the reservoir, which is influenced by depth, has a direct impact on the wellhead temperature.

In some embodiments, the data correlations based on wellhead temperature are used when training and operating AI model 534. For example, model trainer 530 can use wellhead pressure, flow rate, and production or injection depth data alongside wellhead temperature to train AI model 534 to predict future wellhead temperature trends. Advantageously, training AI model 534 to make this prediction aids in production or injection optimization and anomaly detection. Additionally, computing system 110 may compare actual values of wellhead temperature compared to expected values based on other correlated parameters. If the actual values are not sufficiently close to the expected values, computing system 110 may infer or detect the existence of an issue such as pipeline blockages, changes in reservoir pressure, or equipment malfunction. In some embodiments, computing system 110 uses correlations between wellhead temperature and other production or injection parameters to improve the accuracy of production or injection forecasts, enabling better planning and decision-making. In some embodiments, the strength of the correlations generated by computing system 110 may vary depending on the specific well characteristics, such as reservoir type, fluid properties, and well design.

Another type of temperature measurement which can be provided by temperature sensors installed at the wellsite is fluid temperature. Fluid temperature can be measured, for example, by one or more temperature sensors positioned to measure the temperature of the fluid in flow lines 146-150, in wellhead 174, in tubing 162, in earthen pit 152, and/or in the subterranean reservoir. In some embodiments, fluid temperature is updated in real-time on a per-well basis. In some embodiments, the fluid wellhead temperature may range from −200 to 250° C. (−328 to 482° F.) with an accuracy of ±0.2% of full scale and a resolution of ±0.1° C., which may differ dependent on application and sensor type. Fluid temperature may provide important information for monitoring operational efficiency, detecting potential issues such as blockages or flow imbalances, and optimizing production or injection processes. Accordingly, fluid temperature may serve as an important indicator of the overall health and performance of the system, allowing for timely adjustments to prevent damage or safety hazards.

Computing system 110 can use fluid temperature data to generate a variety of metrics that characterize the wellsite and/or reservoir. For example, wellsite optimizer 540 may use the fluid temperature for flow optimization. Knowing the fluid temperature allows for accurate calculations of fluid viscosity, which can be used for optimizing flow rates and managing pressure within the pipeline, ensuring efficient extraction and transportation of oil and gas. In some embodiments, computing system 110 uses the fluid temperature for phase behavior analysis. For example, fluid temperature data can be used to predict and monitor phase changes in the fluid mixture (e.g., liquid to gas), which can impact production, injection, and separation processes, enabling adjustments to prevent issues like gas locking or liquid dropout. In some embodiments, computing system 110 uses fluid temperature data to assess wellbore integrity. For example, significant temperature fluctuations can indicate potential problems such as casing leaks, wellbore instability, or water influx, allowing for timely intervention to prevent further complications and potential damage. Computing system 110 can also use the fluid temperature data for corrosion monitoring. For example, high temperatures can accelerate corrosion rates within the pipeline, so monitoring fluid temperature helps identify areas where corrosion might be a concern, enabling preventive maintenance strategies. In some embodiments, computing system 110 uses the fluid temperature to assess safety considerations. For example, abnormally high temperatures can signal potential safety hazards such as overheating or pressure build-up, requiring immediate action to mitigate risks.

It is appreciated that the location of the fluid temperature sensor at the wellsite is important to capture the most relevant data for the specific application. Depending on the application that consumes the fluid temperature data, it may be desirable to locate the fluid temperature sensor to different locations to ensure the most relevant fluid temperature data is collected. Computing system 110 can analyze fluid temperature data in conjunction with other parameters such as pressure, flow rate, and fluid composition for a comprehensive understanding of the system. In some embodiments, AI model 534 uses fluid temperature data to make the model predictions and identify potential problems before they occur, enabling proactive decision-making in the petroleum operation.

Data collector 526 can be configured to calculate a variety of derived metrics based on the fluid temperature data. Derived metrics calculated from fluid temperature may include the average reservoir temperature, which is calculated by combining temperature readings from different wellbore depths, pressure measurements, and/or geological data. The average reservoir temperature may provide a more comprehensive understanding of the reservoir's thermal profile and its impact on fluid flow dynamics. This is significant because it allows for better estimations of production or injection potential, fluid properties, and optimal extraction strategies. Advantageously, because temperature can vary significantly within a reservoir depending on depth, location, and production or injection activity, using data from multiple sources helps to create a more accurate overall picture.

Computing system 110 can use fluid temperature data to perform several calculations and analyses. For example, computing system 110 can use the average reservoir temperature to calculate other fluid properties such as fluid viscosity, which directly affects flow rates and production or injection optimization. Computing system 110 can also use the fluid temperature data to perform a pressure-volume-temperature (PVT) analysis. Precise temperature data is important for accurate PVT modeling, which helps predict reservoir behavior under changing production or injection conditions. In some embodiments, computing system 110 uses the fluid temperature data to perform a heat transfer analysis. For example, analyzing temperature variations can provide insights into heat transfer within the reservoir, which can be important for understanding potential thermal recovery methods. In some embodiments, computing system 110 uses fluid temperature data to identify reservoir compartments. For example, sudden temperature changes between different well locations can indicate the presence of separate reservoir compartments.

Examples of derived metrics which can be calculated by computing system 110 based on the fluid temperature data include average fluid temperature, temperature gradient, and temperature anomalies. For example, computing system 110 can calculate average reservoir temperature by averaging temperature readings from multiple depth levels within a well. Computing system 110 can use the fluid temperatures to determine the temperature gradient (i.e., the rate of temperature change per unit depth) within the well, which can be used to assess reservoir characteristics and potential for thermal recovery. In some embodiments, computing system uses the fluid temperature data to detect temperature anomalies. For example, significant deviation from the expected temperature trend may indicate geological features or fluid contact boundaries.

In some embodiments, computing system 110 correlates fluid temperatures with other data sources such as flow rate, depth, pressure, and production or injection rate. Relevant correlations for model training or operation often exist between the temperature data and other sources like well pressure, flow rate, depth, production or injection rate, and downhole measurements of pressure and temperature from nearby wells. These connections can be used to improve the accuracy of predictive models by providing context and understanding of the overall system dynamics. For example, higher flow rates may correspond to increased fluid temperature due to friction heat generated in the pipeline. Temperature typically increases with depth in a wellbore, providing a correlation for estimating depth based on measured temperature. Depending on the fluid properties, pressure can be correlated with temperature, particularly when considering phase changes like gas-liquid transitions. Changes in production or injection rate can impact the fluid temperature due to variations in flow dynamics.

Computing system 110 can use these correlations when training and using AI model 534 to make model predictions. For example, by incorporating related data sources as features in AI model 534, AI model 534 can leverage these connections to make more accurate predictions about fluid temperature. In some embodiments, computing system 110 compares the measured fluid temperature to expected or predicted values of fluid temperature based on other correlated data to help identify potential issues such as abnormal flow patterns or equipment malfunctions. Fluid temperature data can also be used for predictive maintenance. For example, by analyzing trends in fluid temperature data combined with other parameters, AI model 534 can predict potential equipment failures before they occur. The correlations between data sources can vary significantly depending on the specific well conditions, reservoir properties, and production or injection phase.

### Choke/Valve Sensors

In some embodiments, real-time wellsite data sources 510 include choke/valve sensors. Choke valve sensors can be installed on various valves at the wellsite and may be configured to detect the valve position. For example, valve position sensor 134 shown in FIG. 3 can be configured to measure or detect the position of a flow control valve (e.g., a choke valve) that controls the flow of fluid into or out of wellhead 174. Measurements from a choke valve position sensor may signify the degree of restriction placed on the flow of oil and gas from a well or flow of a fluid into the well. The position of such a valve can be adjusted to control the production or injection rate of the well. Accordingly, the valve position may be highly relevant to AI model 534 because it directly impacts calculations of well production or injection, pressure management, and overall optimization of the reservoir by allowing for precise adjustments to the flow rate based on current conditions. In some embodiments, computing system 110 collects measurements from a choke valve position sensor in real-time on a per-well basis. Such measurements may range from 0% (i.e., valve is fully closed) to 100% (i.e., valve is fully open) with an accuracy of ±0.5% and a resolution of ±0.1%, which may differ depending on application and sensor type.

Computing system 110 can be configured to monitor and/or control the position of one or more choke valves. For example, wellsite controller 542 can be configured to generate control signals to adjust the valve position to control the flow rate of the fluid through the choke valve. Computing system 110 can precisely regulate the amount of fluid extracted from, or injected into, a well by adjusting the valve position, thereby preventing excessive production or injection and ensuring efficient operations. Additionally, the choke valve position directly affects the pressure drop across the valve, which is important for maintaining optimal pressure within the reservoir and pipeline system. In some embodiments, computing system 110 uses choke valve position as an input to AI model 534 to enable more accurate predictions of future production or injection rates based on planned adjustments to choke settings. Computing system 110 can also analyze the performance of the well by analyzing trends in choke valve position over time. For example, computing system 110 can identify potential issues such as changes in reservoir pressure, wellbore damage, or equipment malfunction based on the choke valve position. In some embodiments, wellsite optimizer 540 and/or wellsite controller use the choke valve position data to optimize production by adjusting choke settings to maximize recovery or to optimize injection by adjusting choke settings to maximize injection volumes and rates, and minimize costs.

Another type of data which can be provided by choke/valve equipment installed at the wellsite is choke/valve controller data. Rather than measuring the position of the choke valve using a sensor, information from a controller that operates the choke valve (e.g., position control signals) can be used to determine the valve position. The controller may be situated on the valve/choke or at a remote location to allow for remote positional control. Like the choke valve position measurements, the information gathered from the controller for the valve can be updated in real-time and may occur on a per-well basis. The controller may report the choke valve position in a range from 0% (i.e., valve is fully closed) to 100% (i.e., valve is fully open) with an accuracy of 1-3% and a resolution of ±0.1%, which may differ dependent on application and sensor type. In some embodiments, the controller which operates the choke valve is a part of computing system 110 (e.g., wellsite controller 542) or a separate controller located at the wellsite or a remote location.

In some embodiments, information from the choke valve controller signifies the current flow rate of oil, water, and gas through a pipeline. Accordingly, the choke valve position data may allow computing system 110 to monitor and adjust production or injection levels precisely to optimize well performance, manage pressure fluctuations, and prevent damage to equipment. Computing system 110 can use the choke valve data to optimize production or injection and ensure safe operations based on the predictions from AI model 534.

Computing system 110 can use the choke valve position data for various operations such as flow rate control, pressure management, wellhead operation, and safety management. For example, computing system 110 can monitor and use flow rate data to adjust the choke valve opening to maintain desired production or injection rates, thereby preventing over-production or under-production from, or over-injection into, a well. In some embodiments, computing system 110 uses the choke valve to regulate pressure by creating a pressure drop across the valve, which can be used to prevent excessive pressure build-up in the wellbore and pipeline. In some embodiments, computing system 110 uses the choke valve data to optimize wellhead production or injection by identifying issues such as water coning or gas breakthrough and allowing for adjustments to maximize hydrocarbon recovery. In some embodiments, computing system 110 uses the choke valve data to optimize injection issues such as over pressurization of the injected formation and allowing for adjustments to maximize injected fluid volume. Computing system 110 can also use real-time data from choke controllers to detect abnormal flow conditions that could indicate potential problems such as leaks or well blowouts, allowing for prompt intervention to prevent accidents.

Computing system 110 can use the data from a choke valve position sensor or controller to calculate various data points or metrics. Such data points include upstream pressure (i.e., pressure at the inlet of the choke valve), downstream pressure (i.e., pressure at the outlet of the choke valve), differential pressure (i.e., the difference between upstream and downstream pressure) which is directly related to the flow rate), choke valve position (i.e., the current opening of the choke valve), and/or fluid properties that convey important information about the composition of the fluid (e.g., gas-liquid ratio) and can be used to perform flow rate calculations.

In some embodiments, computing system 110 uses the choke valve position data for production or injection forecasting. For example, AI model 534 can use historical choke data to predict future production or injection trends and optimize well scheduling. In some embodiments, computing system 110 uses the choke valve position data for fault detection. For example, analyzing deviations from expected flow patterns, AI model 534 can identify potential issues in the well or pipeline system. In some embodiments, computing system 110 uses choke valve position data for real-time control. For example, wellsite optimizer 540 and/or wellsite controller 542 can use the choke data to automatically adjust valve positions to maintain desired production or injection parameters.

In some embodiments, computing system 110 uses the choke valve position data to calculate various derived metrics. One example of a derived metric which can be calculated based on the choke valve position is effective choke size. Effective choke size combines information from the actual choke size setting, wellhead pressure, and flow rate to provide a more accurate representation of the restriction the choke is imposing on fluid flow. Effective choke size can be used for optimizing production or injection and managing well performance. By considering multiple variables, effective choke size provides a better understanding of the actual flow rate under varying reservoir conditions, allowing for more precise production and injection forecasts and operational planning. Additionally, analyzing effective choke size helps identify potential bottlenecks in the system, enabling adjustments to choke settings to maximize production or injection while minimizing pressure drawdown, which can impact reservoir recovery. Computing system 110 can also use the effective choke size for pressure management. For example, monitoring effective choke size helps computing system 110 maintain desired wellhead pressure, which may be important for preventing excessive pressure drops that could damage the reservoir or lead to gas coning issues. In some embodiments, computing system 110 calculates effective choke size using a simple flow equation based on the choke size, wellhead pressure, and flow rate. More complex models (e.g., AI model 534) may incorporate additional factors such as reservoir pressure decline, fluid properties, and/or downhole pressure measurements to provide a more nuanced picture of the flow dynamics.

Other derived metrics which computing system 110 can calculate related to choke position include choke differential pressure, flow coefficient, and production index. The choke differential pressure can be defined as the pressure difference across the choke, which indicates the flow restriction imposed by the choke. The flow coefficient (Cv) is a measure of the choke's ability to flow fluid, which can be used to compare different choke sizes. The production index can be calculated by dividing the flow rate by the bottomhole pressure. In some embodiments, computing system 110 uses the production index to assess the overall performance of a well and identify choke optimization opportunities.

In some embodiments, computing system 110 derives or identifies correlations between choke valve position and other data sources 502 such as wellhead pressure, flow rate of fluids, downhole pressure, reservoir pressure, choke size, fluid properties (e.g., viscosity, gravity), and production or injection logs. Changes in choke position directly impact flow rate and pressure dynamics, allowing for analysis of these interconnected variables to optimize production or injection and predict well behavior. For example, as choke position is adjusted, the flow rate of fluid from or into the well changes proportionally, creating a direct correlation that can be used to predict production or injection based on choke settings. Decreasing choke size (i.e., closing the choke) increases wellhead pressure, while opening the choke lowers pressure, providing a clear relationship for pressure management. Changes in choke position can significantly affect downhole pressure, allowing for monitoring of reservoir performance and potential issues such as water coning. The viscosity and gravity of the produced fluid can influence how a choke impacts flow rate, necessitating consideration of these properties in model training.

In some embodiments, model trainer 530 uses the correlations relating to choke valve position when training AI model 534. For example, by utilizing historical data on choke position, flow rate, wellhead pressure, and other relevant parameters, model trainer 530 can train AI model 534 to predict production or injection behavior under different choke settings. Wellsite optimizer 540 may use the choke valve position and/or correlations with other data sources to optimize choke position based on real-time data to maximize production or injection while maintaining desired pressure constraints. It is contemplated that each well has unique characteristics and thus AI model 534 (or separate instances of AI model 534) may be developed and calibrated for individual wells to ensure accuracy. Additionally, reservoir pressure and fluid properties can change over time, which can lead to improvements in accuracy if AI model 534 is updated over time to adapt to new patterns and correlations.

### Flow Sensors

In some embodiments, real-time wellsite data sources 510 include flow sensors. Flow sensors can be installed on various fluid flow conduits at the wellsite and configured to measure the flow rate of the fluid therethrough. One example of a flow sensor is flow line totalizer 136 shown in FIG. 3, which may be configured to measure the flow of fluid through flow line 146 and into wellhead 174. Other flow sensors can be installed at other locations (e.g., along flow lines 148 or 150, along tubing 162, etc.) to measure the flow of fluid at different locations at the wellsite or in the reservoir.

In some embodiments, the flow sensors include a pump flow rate sensor. The pump flow rate sensor can be located at or near pump 144 shown in FIG. 3 and configured to measure the flow of fluid through pump 144. Measurements from the pump flow rate sensor may signify the volume of fluid being pumped through a pipeline per unit time. Computing system 110 can use the pump flow rate measurements for monitoring production or injection levels, optimizing extraction or augmentation processes (i.e., removing fluid from the well or adding fluid to the well), detecting potential issues such as leaks or pipeline blockages, and ensuring compliance with regulatory requirements. Pump flow rate measurements may thus serve as a key indicator for the efficiency and health of the well and pumping system. In some embodiments, the measurements from the pump flow rate sensors are updated in real-time and may occur on a per-well basis. In some embodiments, the pump flow rate sensors may have a range of 0 to 1,000+gallons per minute (gpm), an accuracy of ±0.2% to ±0.5% of full scale, and a resolution of ±0.1% of full scale. A Coriolis flow meter may achieve even higher precision at around ±0.1% accuracy. Accuracy and range for some or all pump flow rate sensors may differ depending on application and sensor type.

Computing system 110 can use the pump flow rate measurements in several ways. For example, computing system 110 can use the pump flow rate to assess the amount of oil or gas being extracted from a well or the amount of fluid injected into a well, which allows for timely adjustments to production or injection plans based on changing reservoir conditions or market demands. In some embodiments, computing system 110 uses the pump flow rate measurements for leak detection. For example, significant drops in flow rate can indicate potential leaks in the pipeline, enabling prompt maintenance actions to prevent environmental damage and economic losses. In some embodiments, computing system 110 uses the pump flow rate measurements for performance optimization. For example, wellsite optimizer 540 can compare flow rate data with other parameters such as pressure and pump power to perform an analysis of system efficiency and identify areas for improvement or potential issues with pump performance. In some embodiments, computing system 110 monitors the pump flow rate measurements from different wells and uses such information to allocate production or injection quotas effectively and manage the overall well network efficiently. In some embodiments, computing system 110 uses the pump flow rate measurements to assess the amount of fluid being injected into a well, which allows for timely adjustments to injection plans based on changing reservoir conditions. In some embodiments, computing system 110 uses the pump flow rate measurements to ensure regulatory compliance. For example, computing system 110 can use the pump flow rate measurements to provide accurate reporting of extracted volumes and monitoring emissions to ensure compliance with regulations on each.

Advantageously, computing system 110 can use the pump flow rate data to perform real-time monitoring of wellsite operations. For example, the pump flow rate sensors may provide continuous data, allowing for immediate detection of changes in flow rate. Computing system 110 can use the pump flow rate data as inputs to AI model 534 to predict future production or injection trends, optimize pumping schedules, and identify potential problems proactively. Computing system 110 may ensure that the pump flow rate sensor is regularly calibrated and maintained to ensure accurate data collection and reliable decision-making.

Data collector 526 may use the pump flow rate measurements in combination with data from other data sources 502 to calculate various derived metrics. For example, derived metrics based on the pump flow rate measurements may be based on pressure, temperature, fluid density, and the raw flow rate measurement from the sensor, providing a more comprehensive picture of the actual fluid flow and potential operational issues. This is significant because it allows for better monitoring, troubleshooting, and optimization of the pumping system by identifying inconsistencies or potential problems not readily apparent from just the flow rate alone. Advantageously, by incorporating data from other sensors, derived metrics can compensate for variations in fluid properties such as temperature and density, leading to a more accurate representation of the actual fluid flow rate. By analyzing combinations of data, derived metrics can flag potential issues like pump efficiency degradation, pipeline blockages, or fluid quality problems before they become major issues. Understanding derived metrics allows computing system 110 to adjust pump settings, optimize flow rates, and make informed decisions regarding overall system performance.

Some examples of derived metrics which data collector 526 can generate based on data from a pump flow rate sensor and other data sources 502 include mass flow rate, pump efficiency, liquid viscosity correction factor, and pipeline flow velocity. Mass flow rate can be calculated by multiplying the volumetric flow rate from the flow rate sensor by the fluid density (e.g., from a density sensor). Pump efficiency can be derived by comparing the power input to the calculated mass flow rate, providing insights into pump performance. The liquid viscosity correction factor is a calculation which uses temperature and pressure to adjust the raw flow rate measurement based on fluid viscosity changes. Pipeline flow velocity can be derived by dividing the flow rate by the cross-sectional area of the pipeline, allowing for analysis of potential flow restrictions.

In some embodiments, computing system 110 derives or identifies correlations between the pump flow rate measurements and other data sources 502. Relevant correlations between pump flow rate and other data sources 502 include wellhead pressure, downhole pressure, pump intake pressure, pump discharge pressure, pump motor power consumption, fluid properties (viscosity, density), choke size, pump speed, vibration levels, and wellhead temperature; where changes in one parameter can often directly influence the pump flow rate, making them valuable for training and operating predictive models. For example, higher pressure differential between wellhead and pump intake leads to increased flow rate. Pump discharge pressure is directly related to the flow rate, with higher discharge pressure indicating higher flow. Pump motor power consumption is a strong indicator of pump work, which is directly linked to flow rate. Pump speed adjustments significantly impact flow rate. Additionally, fluid viscosity affects the flow rate, with higher viscosity leading to lower flow. Density variations can also influence flow rate calculations. Choke size can be used to regulate wellhead pressure and can influence the pump flow rate. In some embodiments, computing system 110 uses flow rate data from a pump flow rate sensor for operational monitoring. For example, abnormal vibration levels from the pump can indicate issues that affect flow rate and can be detected as abnormal flow rate measurements.

Computing system 110 can use pump flow rate measurements to train AI model 534. For example, computing system 110 can combine relevant data sources as features AI model 534 to enable AI model 534 to learn complex relationships between variables and predict pump flow rate with greater accuracy. Computing system 110 can use the pump flow rate measurements for anomaly detection by monitoring changes in key data points such as pressure or power consumption to help identify potential pump issues affecting flow rate. Important considerations relating to the pump flow rate measurements include ensuring accurate and consistent data collection from all relevant sensors for reliable model training, as well as accounting for well-specific characteristics and dynamic conditions. For example, different wells may have varying pressure and fluid properties, requiring customized models. Computing system 110 can consider the impact of changing reservoir pressure and production or injection rates on pump flow over time.

Another type of flow measurement which can be provided by flow sensors installed at the wellsite is wellhead flow rate. Wellhead flow rate signifies the volume of fluid flowing from or into a well at the surface. Wellhead flow rate may provide useful information for monitoring production or injection levels, optimizing well operations, allocating production or injection quotas, identifying potential issues like declining production or injection or well damage, and ultimately maximizing hydrocarbon recovery from, or maximizing volume of fluid injected into, a reservoir. Accordingly, wellhead flow rate may be an important input for reservoir modeling and production or injection forecasting. In some embodiments, measurements from a wellhead flow rate sensor are updated in real-time on a per-well basis. Wellhead flow rate sensors may have a range of 1:10 to 1:20 (i.e., meaning the sensor can accurately measure flow rates from a low to a high value within that ratio), an accuracy of ±0.25% to =1.0% of full scale, and a resolution of ±0.1% of full scale, which may differ dependent on application and sensor type.

Computing system 110 can use the wellhead flow rate data for production or injection monitoring. For example, computing system 110 can monitor real-time flow rate data to track how much fluid is being extracted from or injected into each well, enabling timely adjustments to production or injection strategies based on current conditions. By comparing flow rates over time, computing system 110 can identify trends and potential problems such as declining production, water influx, gas-lift issues, or increasing injection volumes allowing for preventative measures. Computing system 110 can use the wellhead flow rate data to optimize well production or injection by adjusting choke sizes, pump settings, or other operating parameters to maximize recovery. In some embodiments, computing system 110 uses the wellhead flow rate data for reservoir modeling. For example, integrating wellhead flow rate data into reservoir simulation models (e.g., AI model 534 or other models) helps to refine predictions about reservoir pressures, fluid flow dynamics, and future production or injection potential. In some embodiments, computing system 110 uses wellhead flow rate data for allocation and accounting purposes. For example, for shared production and injection from a reservoir, precise flow rate measurements can be used to accurately allocate production and injection volumes among different wells and operators.

Computing system 110 can use wellhead flow rate data as a key input parameter for various reservoir engineering calculations, including pressure decline analysis, well test interpretation, and production or injection forecasting models. In some embodiments, computing system 110 uses wellhead flow rate data for validation and calibration. For example, measured flow rates from sensors can be used to validate the accuracy of reservoir models and adjust parameters as needed to better reflect real-world conditions. In some embodiments, computing system 110 uses wellhead flow rate data to detect problems at the wellsite. For example, by monitoring changes in flow rates, computing system 110 can identify potential problems early on, allowing for timely intervention to mitigate production or injection losses.

Data collector 526 can use the wellhead flow rate data to calculate various derived metrics. Some derived metrics calculated based on measurements from a wellhead flow rate sensor can also be based on information from different data sources 502 (e.g., pressure, temperature, and fluid density) to provide a more accurate and comprehensive picture of the actual wellhead flow rate. Such derived metrics are significant because they can account for variations in fluid properties and environmental conditions, leading to better production or injection monitoring and optimization decisions. For example, by incorporating data from multiple data sources 502, derived metrics can compensate for potential inaccuracies in a single flow rate measurement, especially when dealing with changing fluid properties like gas-liquid ratios or variations in temperature and pressure. Additionally, combining flow rate with density and pressure data allows for calculations of important parameters such as liquid volume, gas volume, and water cut, which can provide a deeper understanding of the produced fluid composition or a deeper understanding of reservoir response caused by the injection of fluid into a formation. Computing system 110 can also use derived metrics to identify potential issues such gas-liquid separation problems, pipeline flow restrictions, or wellbore pressure imbalances, enabling timely adjustments to production or injection operations.

Some examples of derived metrics which data collector 526 can calculate from wellhead flow rate data include a liquid equivalent flow rate, a standard cubic feet (SCF) of gas, a water cut percentage, and a wellhead pressure-adjusted flow rate. The liquid equivalent flow rate may represent the equivalent volume of liquid produced by taking into account the gas-liquid ratio and fluid density. The SCF of gas may convert measured gas volume to a standard reference condition (e.g., pressure and temperature). The water cut percentage represents the proportion of water produced relative to the total fluid volume. The wellhead pressure-adjusted flow rate corrects the measured flow rate for variations in wellhead pressure.

In some embodiments, computing system 110 derives or identifies correlations between wellhead flow rate and other data sources 502. Relevant data correlations include wellhead pressure, bottom-hole pressure, choke size, gas-to-liquid ratio (GLR), fluid properties (viscosity, density), reservoir pressure, temperature, and production or injection logging data. Changes in one parameter can significantly impact the calculated wellhead flow rate, making them important factors to consider when building a predictive model such as AI model 534. For example, the pressure gradient represents the difference between wellhead pressure and bottom-hole pressure, which directly affects the flow rate (e.g., a higher pressure differential resulting in higher flow). The size of the choke significantly controls the flow rate, with smaller choke sizes restricting the flow. Fluid properties such as viscosity and density of the produced fluid impact the flow rate, with higher viscosity fluids flowing slower. The GLR represents the ratio of gas to liquid production, which influences the flow rate because the presence of gas can increase the overall flow rate. Computing system 110 can also use reservoir pressure and temperature to estimate the potential flow rate of a well, providing context for the wellhead data.

Model trainer 530 can use these and other correlations between wellhead flow rate and other data sources 502 to train AI model 534. For example, model trainer 530 can incorporate wellhead flow rate with other data sources 502 as features in AI model 534, which allows AI model 534 to learn the complex relationships between these parameters and the wellhead flow rate. In some embodiments, computing system 110 uses the measured wellhead flow rate data to calibrate AI model 534, ensuring that AI model 534 learns to predict flow rates accurately based on the available input data. Some considerations relating to wellhead flow rate include ensuring accurate and consistent data to improve model training, accounting for field-specific correlations, and model selection. For example, different oil fields may have unique flow dynamics, requiring field-specific correlations to be incorporated into AI model 534. Model selection includes choosing an appropriate machine learning algorithm based on the complexity of the relationships between data sources 502 and the desired prediction accuracy.

Another type of flow measurement which can be provided by flow sensors installed at the wellsite is the total flow volume. Total flow volume signifies the cumulative volume of fluid that has passed through a pipeline over a specific period. For example, a flow totalizer sensor accumulates the total volume of fluid over time, not just the instantaneous flow rate. Total flow volume provides important information for accurate inventory management, production or injection monitoring, and financial accounting, as it allows computing system 110 to precisely track the amount of product extracted, transported, and sold or purchased and injected, ensuring fair trade and compliance with regulations. Updates to the flow rate measurements from a total flow volume sensor may occur in real-time on a per-well basis. Such measurements may have a range from 0 to 1,000+gallons per minute (gpm), an accuracy of ±0.2% to ±1.0% of full scale, and a resolution of ±0.1% of full scale, which may differ depending on application and sensor type. For example, a Coriolis flow meter may achieve even higher precision at around ±0.2% accuracy.

Computing system 110 can use total flow volume for inventory control. For example, by tracking the total volume of fluid flowing through a pipeline, computing system 110 can accurately monitor their inventory levels, preventing shortages or overstocking, and optimizing storage capacity. Computing system 110 can use total flow volume for production or injection optimization. For example, analyzing flow totalizer data helps identify trends in production or injection rates, allowing computing system 110 to adjust extraction or augmentation operations (i.e., operations that remove fluid from the well or add fluid to the well) for maximum efficiency and identify potential issues like leaks or pressure drops. In some embodiments, computing system 110 uses total flow rate data for financial accounting. For example, accurate flow data can be used for calculating the correct amount of oil or gas sold to customers, ensuring fair billing and proper revenue collection. Computing system 110 can use total flow volume to ensure compliance with regulations. For example, regulatory bodies often require precise flow measurement for taxation and environmental monitoring, and the flow totalizer data provides the necessary information for compliance. In some embodiments, computing system 110 uses total flow volume for predictive maintenance. For example, analyzing flow data can help identify abnormal patterns that may indicate potential equipment malfunctions, enabling preventive maintenance to be scheduled before issues escalate.

In some embodiments, computing system 110 uses the total flow volume data to calculate various derived metrics. Derived metrics calculated from multiple data sources 502 related to a flow totalizer may represent a calculated value that combines information from different measurement points (e.g., pressure, temperature, and flow rate) to provide a more comprehensive understanding of the fluid flow characteristics. Such derived metrics can be used to quantify various wellsite operations or fluid properties such as liquid/gas ratio, flow quality, or pipeline efficiency, making it a significant tool for monitoring and optimizing production or injection processes. For example, by combining data from various sensors, computing system 110 can generate a derived metric to provide a more detailed picture of the fluid flow beyond just the total volume measured by the flow totalizer. In some embodiments, computing system 110 uses derived metrics to identify potential issues like abnormal liquid/gas ratios, high pressure drops, or flow inconsistencies, allowing for timely intervention and preventive maintenance. Analyzing derived metrics also enables computing system 110 to adjust operational parameters to maximize efficiency, minimize losses, and optimize pipeline performance.

Some examples of derived metrics which computing system 110 can calculate from flow totalizer data include a liquid/gas ratio (LGR), flow quality index, pipeline efficiency, and heat transfer coefficient. The LGR can be calculated by combining flow rate data with pressure and temperature measurements to determine the proportion of liquid to gas in a mixed flow. Flow quality index is a metric that assesses the consistency of flow based on variations in flow rate and pressure, indicating potential issues like slug flow or uneven distribution. Pipeline efficiency factor is a derived metric that considers flow rate, pressure drop, and pipeline length to evaluate the overall efficiency of a pipeline system. In some embodiments, computing system 110 calculates the heat transfer coefficient based on flow rate and temperature data for use in optimizing heat exchange processes. Advantageously, derived metrics based on the flow totalizer data can serve as an early warning system to identify potential problems before they escalate into major issues, allowing for proactive maintenance and troubleshooting. Computing system 110 can use such derived metrics for data-driven decision making. For example, by providing a deeper understanding of the flow dynamics, derived metrics enable computing system 110 to make informed decisions regarding operational adjustments and process optimization.

In some embodiments, computing system 110 derives or identifies correlations between total flow volume and other data sources 502. Relevant correlations and connections between total flow volume and other data sources 502 may include pressure measurements, temperature readings, fluid density calculations based on composition analysis, pipeline geometry, wellhead pressure, and/or external factors such as weather conditions. For example, one correlation which can be derived is the relationship between the pressure drop across a flow meter (e.g. an orifice plate) and the flow rate, which can be used to calculate flow volume. Additionally, temperature affects fluid viscosity, which in turn influences flow rate, and thus incorporating temperature data can enhance model accuracy. For multiphase flow (e.g., oil, gas, water), the composition of the fluid mixture can be used for precise flow calculations, and data from fluid analysis can be used in AI model 534. Pipeline characteristics such as pipeline diameter, length, and inclination can impact flow dynamics and can also be considered when building a flow totalizer model. Finally, external factors such as weather conditions and temperature and pressure changes may indirectly affect flow measurements and can be factored into AI model 534 for more robust predictions. These correlations and connections can influence the accuracy of the calculated flow volume and can be used by computing system 110 to refine AI model 534 during training or operation by incorporating these variables as additional inputs.

Some examples of correlations which can be used by computing system 110 include using pressure differential and temperature to calculate flow rate through an orifice meter, applying fluid density (derived from composition analysis) to adjust flow volume calculations, and correlating wellhead pressure with pipeline flow rate to monitor production or injection variations. For example, by incorporating relevant data sources 502 as input features in AI model 534 during model training, AI model 534 can learn complex relationships between variables and improve prediction accuracy. Model trainer 530 can use historical data with known flow rates can be calibrate the model parameters and ensure the predictions align with real-world conditions. During operation, AI model 534 can use live data from various sensors to continuously update flow calculations, adapting to changing conditions in the pipeline.

### Gas Detection Sensors

In some embodiments, real-time wellsite data sources 510 include gas detection sensors. Gas detection sensors can be installed at various locations at the wellsite to measure the concentration of gases at the installed locations. One type of gas measurement which can be provided by gas detection sensors installed at the wellsite is hydrocarbon (CₙH₂ₙ₊₂) concentration. Hydrocarbon concentration signifies the concentration of hydrocarbon gases present at wellhead 174, which can be used for monitoring production or injection efficiency, identifying potential leaks, ensuring safety, and making informed decisions about well operations by providing real-time information about the gas composition and flow rate at the well source. In some embodiments, measurements from a hydrocarbon concentration sensor occur in real-time on a per-well basis. Such measurements may range from 0 to 100% of the Lower Explosive Limit (LEL) with an accuracy of ±2.0% to ±5.0% of measured value and a resolution of ±1.0% of LEL. Some gas detection sensors may have a resolution that can vary from single-digits parts per million (ppm) for highly sensitive applications to a few percentage from broader monitoring, which may differ depending on application and sensor type.

In some embodiments, computing system 110 can use measurements from a wellhead hydrocarbon gas sensor for leak detection, production or injection optimization, safety monitoring, reservoir characterization, and/or regulatory compliance. For example, high gas readings indicate potential leaks in the wellhead system, allowing for prompt repairs to prevent environmental damage and economic losses. By monitoring gas composition, computing system 110 can adjust production or injection parameters to maximize and optimize well performance. Additionally, computing system 110 can use real-time from a wellhead hydrocarbon concentration sensor to identify hazardous gas concentrations, enabling timely evacuation and safety measures to prevent accidents. Analyzing gas composition over time can also provide insights into reservoir pressure and fluid properties, aiding in reservoir management strategies. In some embodiments, computing system 110 uses gas monitoring to ensure adherence to environmental regulations and emission standards.

Data from a hydrocarbon gas concentration sensor can be used in AI model 534 in various ways. For example, AI model 534 can analyze historical sensor data to predict potential equipment failures, allowing for preventative maintenance. By incorporating gas sensor data with other production or injection parameters, AI model 534 can forecast future well production or injection rates. AI model 534 can also analyze gas composition data to determine optimal operating conditions for each well, maximizing production or injection efficiency.

Data collector 526 may use the hydrocarbon gas concentration measurements in combination with data from other data sources 502 to calculate various derived metrics. Derived metrics which can be calculated from multiple hydrocarbon sensor data sources represent a more comprehensive understanding of the hydrocarbon composition and reservoir characteristics by combining information from different sensor types. Advantageously, such derived metrics allow for better interpretation of the overall hydrocarbon presence and potential, which is important for decision-making in exploration, production or injection, and monitoring activities, and provides additional value beyond the raw readings from individual sensors. For example, by combining data from various sensors (e.g., gas chromatographs, pressure gauges, temperature sensors), derived metrics can provide insights into factors such as hydrocarbon type (e.g., light vs. heavy), gas-oil ratio, reservoir pressure, and fluid saturation, which are difficult to determine from single-point measurements alone. Computing system 110 can use derived metrics to refine reservoir models by providing more accurate estimations of fluid properties and flow dynamics, leading to better predictions of production or injection potential and optimization strategies. Additionally, computing system 110 can analyze trends and anomalies in derived metrics across multiple sensors to detect potential leaks or changes in reservoir conditions more effectively, enabling timely intervention and mitigation actions.

Some examples of derived metrics which computing system 110 can generate based on hydrocarbon sensing include the hydrocarbon index (HI), gas-oil ratio (GOR), saturation pressure, and biomarker ratios. For example, HI can be calculated from the ratio of total hydrocarbons to organic carbon content in a sample, indicating the potential for oil generation in a source rock. GOR can be derived from the ratio of gas volume to oil volume produced from a well, providing information about reservoir pressure and fluid composition. Saturation pressure can be calculated from pressure and temperature data, signifying the pressure at which the reservoir fluid starts to vaporize, which can be used for well design and production or injection optimization. Biomarker ratios may include ratios of specific organic compounds (e.g., biomarkers) that can indicate the source rock origin and maturity of the hydrocarbon. Advantageously, the ability of computing system 110 to calculate derived metrics from multiple sensor data sources 502 allows for comprehensive hydrocarbon exploration and production or injection operations because it allows for a more nuanced understanding of the reservoir system and informed decision-making based on multi-faceted information.

In some embodiments, computing system 110 derives or identifies correlations between the hydrocarbon gas concentration measurements and other data sources 502. Some examples of correlations and connections between hydrocarbon gas concentration measurements and other data sources 502 include well production or injection data (e.g., flow rate, pressure, etc.), environmental parameters (e.g., temperature, humidity, etc.), sensor location data (e.g., depth, proximity to equipment, etc.), and historical maintenance records. These and other correlations can be used to identify patterns and trends that help predict potential hydrocarbon leaks, optimize sensor performance, and improve overall operational efficiency. For example, higher hydrocarbon sensor readings near a well with a sudden increase in production or injection could indicate a leak, especially when combined with pressure data. Fluctuations in temperature and humidity can impact sensor readings, and thus accounting for these environmental factors can ensure accurate interpretation. Past maintenance activities on nearby equipment can be used to identify potential leak sources and prioritize sensor monitoring in those areas. Analyzing trends in hydrocarbon sensor readings across different locations within a facility can help identify potential leak pathways. Advantageously, computing system 110 can ensure all data sources are accurate, consistent, and properly calibrated to maximize the value of correlations. Computing system 110 can align timestamps across different data sources for analyzing trends over time. Computing system 110 can transform raw data into meaningful features (e.g., calculating rate of change in sensor readings) to enhance the ability to identify patterns.

Another type of gas measurement which can be provided by gas detection installed at the wellsite is carbon dioxide (CO₂) concentration. CO₂ concentration signifies the concentration of CO₂ present in a specific location. CO₂ concentration can be used for monitoring and optimizing enhanced oil recovery (EOR, also known as carbon capture utilization and storage or CCUS) operations where CO₂ is injected into oil reservoirs to increase production. This information allows computing system 110 to track the movement of injected CO₂, identify potential leaks, and ensure efficient utilization of the CO₂ for maximum oil extraction, ultimately impacting production efficiency and environmental management. Accordingly, CO₂ concentration can be used for monitoring and optimizing carbon capture and storage (CCS) operations, where CO₂ is injected into deep saline formations and un-mineable coal seams. This information allows computing system 110 to track the movement of injected CO₂, identify potential leaks, and ensure efficient plume migration. Measurements from a CO₂ concentration sensor can be updated in real-time on a per-well basis. Such measurements may have a range of 0 to 5% (0-50,000 ppm), an accuracy of ±2.0% of the full scale reading, and a resolution: ±0.1% (or 100 ppm), which may differ depending on application and sensor type.

In some embodiments, computing system 110 can use measurements from a CO₂ concentration sensor for EOR monitoring, leak detection, injection optimization, and carbon sequestration assessment. For example, by measuring CO₂ levels at different points in the reservoir, computing system 110 can track the progress of the CO₂ flood, identifying areas where CO₂ is effectively displacing oil and areas where it might be channeling or bypassing oil zones. High CO₂ concentrations in unexpected locations can indicate leaks in the injection well, pipeline, or formation, allowing for timely repairs to prevent environmental contamination and loss of valuable CO₂. Real-time CO₂ concentration data can be used to adjust injection pressure and volume to optimize the EOR process and maximize oil recovery. For scenarios in which CO₂ is injected for storage, CO₂ sensors can monitor the amount of captured CO₂, ensuring the effectiveness of carbon sequestration efforts.

Data collector 526 may use the CO₂ concentration measurements in combination with data from other data sources 502 to calculate various derived metrics. Derived metrics which can be calculated from CO₂ concentration and/or other data sources 502 (e.g., pressure, temperature, flow rate, etc.) provide a more comprehensive picture of the well's performance and potential CO₂ emissions, offering insights beyond just the raw CO₂ concentration alone. This is significant because it allows computing system 110 to better understand the overall impact of CO₂ production, identify potential issues, and optimize operational strategies for emissions mitigation. For example, by incorporating pressure and temperature data, computing system 110 can adjust the measured CO₂ concentration to a standard set of conditions, enabling meaningful comparisons across different wells and time periods. Computing system 110 can calculate the CO₂ production or injection rate by combining CO₂ concentration with flow rate provides a direct measure of the total amount of CO₂ being produced from or injected into a well, which can be used for emissions monitoring and management. Computing system 110 can generate a CO₂-to-hydrocarbon ratio metric from CO₂ concentration and hydrocarbon production rate. The CO₂-to-hydrocarbon ratio metric indicates the proportion of CO₂ relative to the produced hydrocarbons, which can be used by computing system 110 to identify wells with potentially high CO₂ emissions. Additionally, by incorporating energy consumption data, computing system 110 can generate a derived metric to calculate the CO₂ emissions per unit of energy produced, which provides insight into the environmental impact of a well's operation.

Computing system 110 can use derived metrics based on CO₂ concentration measurements for improved decision-making, early detection of issues, and compliance with regulations. For example, derived metrics provide a more holistic view of well performance, allowing computing system 110 to make informed decisions regarding well optimization, emissions reduction strategies, and potential interventions. By monitoring trends in derived metrics, computing system 110 can identify potential problems early on, such as changes in reservoir pressure or unexpected increases in CO₂ content, enabling preventative action. Accurate calculation of CO₂ emissions through derived metrics can also be used to ensure compliance with environmental regulations and reporting requirements.

In some embodiments, computing system 110 derives or identifies correlations between the CO₂ concentration measurements and other data sources 502. Relevant correlations and connections between CO₂ concentration and other data sources 502 may include correlating CO₂ concentration measurements with pressure and temperature measurements at the wellhead, production or injection rate data, fluid composition analysis (including CO₂ content), reservoir pressure data, injection well data (if CO₂ is being injected), and geological information such as formation depth and porosity. These and other factors can be used to infer the source and behavior of the CO₂ at the wellhead, which allows for a more accurate prediction of CO₂ emissions and potential mitigation strategies. For example, fluctuations in wellhead pressure and temperature can be directly linked to changes in production rate, impacting the amount of CO₂ produced alongside the hydrocarbon stream. By analyzing the composition of the produced fluid, particularly the CO₂ content, computing system 110 can directly estimate the amount of CO₂ coming from the wellhead, which can be compared to other relevant data like production or injection rate to identify trends. The reservoir pressure, combined with information such as formation depth and porosity, can provide insight into the source of the CO₂, whether it is dissolved in the oil, free gas in the reservoir, or coming from deeper formations. If CO₂ is being injected into a reservoir for enhanced oil recovery (EOR) or carbon capture and storage (CCS), the injection pressure and volume can be correlated with the observed changes in wellhead CO₂ content, helping to monitor the effectiveness of the EOR or CCS operation.

Computing system 110 can use the correlations between CO₂ concentration and other data sources 502 to train AI model 534 and during operation of the wellsite. For example, model trainer 530 can incorporate relevant data points from different sources as features in AI model 534 to capture the complex relationships between variables influencing wellhead CO₂ concentration. Model trainer 530 can use historical data to train AI model 534 to accurately predict CO₂ emissions based on the measured parameters. During operation, computing system 110 can continuously monitor wellhead data and use the trained AI model 534 to identify anomalies or trends in CO₂ production, allowing for timely intervention and optimization strategies. Computing system 110 can also use AI model 534 to forecast future CO₂ emissions based on anticipated changes in production or injection conditions or reservoir pressure. Advantageously, computing system 110 can ensure data from different sources is accurate, consistent, and properly formatted for effective model training. Computing system 110 can integrate data from diverse data sources 502, considering potential time lags and discrepancies. Model trainer 530 can regularly validate the performance of AI model 534 against real-world data to ensure its reliability and can trigger retraining of AI model if the performance is below a threshold.

Another type of gas measurement which can be provided by gas detection sensors installed at the wellsite is hydrogen sulfide (H₂S) concentration. H₂S concentration signifies the concentration of H₂S present in a specific location. Computing system 110 can use H₂S concentration for safety and operational reasons because H₂S is a highly toxic gas that can pose serious health risks to personnel and damage equipment if levels become too high. Therefore, monitoring H₂S levels allows computing system 110 to trigger timely intervention to mitigate potential hazards and ensure safe working conditions within a facility. In some embodiments, H₂S concentration measurements occur in real-time on a per-well basis. Such measurements may range from 0-100 ppm with an accuracy of ±5.0% of the full-scale reading and a resolution of ±0.1 ppm, which may differ depending on application and sensor type.

In some embodiments, computing system 110 can use H₂S concentration measurements to ensure safety, protect equipment, ensure compliance with environmental regulations, and optimize the production or injection of the wellsite. For example, H₂S is extremely toxic, even at low concentrations, and can be fatal if inhaled. Real-time monitoring with a H₂S sensor allows for immediate detection of dangerous levels, enabling prompt evacuation and safety measures. H₂S can corrode metal components within oil and gas processing equipment, leading to potential failures and leaks. By monitoring H₂S levels, computing system 110 can take preventive actions to minimize corrosion damage. Many regions have strict regulations regarding H₂S emissions. Accordingly, monitoring H₂S data from sensors helps ensure compliance with environmental standards. In certain situations, controlled levels of H₂S can be used as an indicator for specific processes within a refinery, allowing for adjustments to optimize operations. In addition, the detection of H₂S at a plugged or orphan well may indicate a leak due to a bad cement plug or deterioration of casing, which may be utilized to take preventative actions.

In some embodiments, computing system 110 can use measurements from a H₂S sensor for alerting, trend analysis, and maintenance planning. For example, when H₂S levels exceed predetermined safety thresholds, computing system 110 can trigger an alarm to notify personnel about potential hazards. By tracking H₂S concentration over time, computing system 110 can identify potential issues such as leaks or changes in production or injection processes that may be contributing to increased H₂S levels. Additionally, monitoring H₂S data can allow computing system 110 to identify areas where H₂S levels are consistently high, allowing for targeted maintenance and equipment upgrades to mitigate corrosion risk.

Data collector 526 may use the H₂S concentration measurements in combination with data from other data sources 502 to calculate various derived metrics. Some examples of data sources 502 which can be combined to calculate derived metrics include gas flow rate, pressure, and raw H₂S concentration. Derived metrics based on these data sources 502 may provide a more comprehensive picture of the overall H₂S risk and potential safety hazards at a wellhead. This is significant because they allow for proactive monitoring and mitigation strategies beyond just the raw H₂S concentration alone. For example, by combining data from multiple sources 502, derived metrics can indicate potential issues such as high H₂S concentration coupled with high flow rate, which could signify a significant safety concern even if the raw H₂S level might seem moderate on its own. Computing system can use such derived metrics to predict potential problems before they occur, enabling preventative actions to be taken, such as adjusting production or injection rates or initiating safety procedures. In some embodiments, computing system 110 uses derived metrics based on H₂S concentration to calculate a more accurate risk score based on the combined data, allowing for better prioritization of wellhead maintenance and safety interventions.

Some examples of derived metrics which computing system 110 can generate based on measurements from wellhead H₂S sensors include a H₂S concentration per unit volume of gas, a H₂S emission rate, and a H₂S risk index. The H₂S concentration per unit volume of gas can be calculated by dividing the raw H₂S concentration by the gas flow rate, providing a measure of H₂S concentration relative to the amount of gas produced. The H₂S emission rate can be derived by multiplying the raw H₂S concentration by the gas flow rate, giving an indication of the total amount of H₂S being released from the wellhead. The H₂S risk index is a combined metric that considers factors such as raw H₂S concentration, gas flow rate, well pressure, and historical H₂S trends, providing a more holistic view of potential H₂S hazards.

Computing system 110 can use these and other derived metrics based on H₂S levels to improve safety, optimize wellsite operations, and ensure regulatory compliance. For example, by providing a more complete picture of the H₂S situation, derived metrics enable better decision-making for safety protocols and mitigation strategies. Analysis of derived metrics can help optimize production or injection rates while managing H₂S risks, leading to more efficient operations. Monitoring and reporting derived metrics can demonstrate compliance with safety regulations related to H₂S emissions.

In some embodiments, computing system 110 derives or identifies correlations between the H₂S gas concentration measurements and other data sources 502. Some examples of correlations and connections which computing system 110 can make between H₂S concentration and other data sources 502 include correlating H₂S concentration with well pressure, flow rate, production or injection volume, temperature, gas composition (e.g., other hydrocarbon components), operational changes (e.g., well interventions), and/or environmental factors such as weather conditions.

Computing system 110 can use these connections to help refine model predictions by providing context to the sensor readings and identifying potential influencing variables on H₂S levels. For example, higher flow rate may correlate with higher H₂S concentrations due to increased gas production from the reservoir. Well pressure decline can indicate changes in reservoir dynamics and potentially increased H₂S release. Temperature fluctuations can impact H₂S solubility and therefore measured concentrations. Some hydrocarbons may be associated with H₂S in the reservoir, leading to correlated changes in their concentrations. For example, high CO₂ levels can sometimes indicate a higher potential for H₂S presence.

Additionally, well interventions (e.g., stimulation, workovers) can temporarily disrupt reservoir pressure and potentially lead to spikes in H₂S levels. Production or injection facility changes such as modifications in processing equipment or flow rates can affect H₂S measurements. Environmental factors such as weather conditions and temperature changes can impact H₂S concentrations due to pressure variations in the pipeline.

Computing system 110 can use the correlations between H₂S concentration and other data sources 502 to execute various wellsite activities and for model training and operations. For example, model trainer 530 can incorporate H₂S concentration and relevant data from other data sources 502 as additional features when training AI model 534 to significantly improve prediction accuracy. Computing system 110 can use historical data from various data sources 502 to interpret current sensor readings and identify potential anomalies in H₂S levels (e.g., by comparing current H₂S concentration against historical values). In some embodiments, computing system 110 combines H₂S concentration data from sensors with operational information from the wellsite. AI model 534 can generate alerts when H₂S concentrations exceed safety thresholds, allowing for timely mitigation actions. Computing system 110 can ensure all data sources are accurate, consistent, and properly calibrated for reliable model training. In some embodiments, data collector 526 addresses missing values or outliers in the H₂S concentration data before using it for model training or operation.

### Data Transmission

In some embodiments, real-time wellsite data sources 510 include data transmission equipment or protocols. Data transmission equipment can be configured to gather the data provided by various sensors, controllers, and other data sources located at the wellsite and transmit the data to computing system 110 via network 126. Each type of data transmission equipment can be configured to use a different type of network (e.g., satellite, cellular, landline, etc.), each of which has various benefits and disadvantages. Data transmission protocols include various types of data files or data feeds which can be used to organize and transmit data from the wellsite to computing system 110.

One type of data transmission equipment which can be installed at the wellsite is cellular transmission equipment. Cellular transmission equipment may be part of data collection and transmission tower 176 shown in FIG. 3. Cellular transmission equipment can be used to communicate operational information from remote oil and gas wells, platforms, and pipelines. Information from cellular transmission equipment can be used for real-time monitoring of production or injection volumes, pressure levels, temperatures, flow rates, gas composition, or any other type of real-time wellsite data source 510 described herein. Such information can be used by computing system 110 to assess equipment health, identify potential issues, optimize wellsite operations, prevent costly disruptions, and make informed decisions to maximize efficiency and safety, as described throughout the present disclosure.

Cellular transmission equipment provides various benefits in the context of system 100. For example, cellular connectivity enables continuous data streaming, allowing computing system 110 to identify problems as they occur, leading to faster response times and preventative maintenance. Accessing data from geographically dispersed locations allows for centralized management and analysis of operations, even in remote or harsh environments. Additionally, by analyzing trends in sensor data, computing system 110 can predict potential equipment failures, allowing for proactive maintenance and minimizing downtime. In some embodiments, computing system 110 uses real-time data on flow rates and pressure levels to adjust operational parameters to maximize production or injection efficiency. Cellular data can also be used to monitor critical safety parameters such as gas leaks, pressure surges, and environmental conditions, triggering alerts in case of potential hazards. Data types that can be transmitted via cellular networks in the petroleum industry include, for example, wellhead pressure and flow rates, tank levels and inventory management, pump performance data, pipeline integrity monitoring, environmental sensor readings (e.g., air quality, water quality), equipment health diagnostics, or any other type of data which can be collected at the wellsite.

Another type of data transmission equipment which can be installed at the wellsite is satellite transmission equipment. Satellite transmission equipment may be part of data collection and transmission tower 176 shown in FIG. 3. Satellite transmission equipment can be used to communicate operational information such as well pressure, flow rates, temperature readings, and potential leak detection from offshore drilling platforms or remote pipeline locations. Such data transmission using satellite transmission equipment may allow for real-time monitoring, early problem identification, and efficient decision-making to optimize production or injection and safety, especially in remote areas where terrestrial networks are limited. The real-time wellsite data transmitted via satellite transmission equipment data can be used by computing system 110 to train and operate AI model 534, as such data provides insights into the health of the well, can be used to identify potential issues, and enables proactive adjustments to operations to maximize efficiency and minimize environmental risks.

Satellite transmission equipment provides various benefits in the context of system 100. For example, satellite transmission enables continuous monitoring of crucial parameters from remote locations, allowing computing system 110 to react quickly to changing conditions. By analyzing data streams from satellite transmission equipment, computing system 110 can identify potential problems such as leaks, pressure drops, or equipment malfunctions early, allowing for preventative measures. Data insights based on information transmitted via satellite transmission equipment can be used for adjusting operational parameters such as pump speeds or valve settings to maximize production or injection efficiency. Computing system 110 can monitor such data to help identify potential safety hazards and enable swift response in case of emergencies. Satellite connectivity may be important for operations in remote offshore areas where terrestrial networks are not available.

Another type of data transmission equipment which can be installed at the wellsite is hardwire transmission equipment. Hardwire transmission equipment may be part of data collection and transmission tower 176 shown in FIG. 3, and may include one or more physical cables, communication lines, wires, or other physical data transmission conduit. Hardwire transmission can be used to communicate real-time operational information from various equipment such as sensors, pressure gauges, and flow meters located across drilling rigs, pipelines, and processing facilities. Data transmitted via hardwire communications may provide insights into the efficiency, safety, and potential issues at the wellsite, which allows computing system 110 to initiate proactive maintenance, optimize production or injection, and provide a rapid response to anomalies, making it highly valuable for monitoring and controlling operations in a timely manner.

Hardwired data transmission equipment provides various benefits in the context of system 100. For example, hardwired connections ensure fast and reliable data transmission, enabling computing system 110 to monitor crucial parameters such as pressure, flow rate, temperature, and vibration in real-time, allowing for immediate intervention if abnormalities occur. By analyzing trends in sensor data, computing system 110 can identify potential equipment failures before they happen, allowing for planned maintenance and minimizing costly downtime. Computing system 110 can use data from various sources to optimize production or injection processes including adjusting drilling parameters, optimizing pipeline flow, and maximizing resource extraction. Computing system 110 can monitor critical parameters such as pressure and leak detection through hardwired data transmission to help identify potential safety hazards and trigger alarms to prevent incidents. In some embodiments, computing system 110 uses data transmitted via hardwired communications to ensure compliance with regulations by providing accurate and reliable data transmission.

Examples of data points which can be transmitted through hardwired connections include wellhead pressure, flow rate, tank levels, and pump performance data. Wellhead pressure indicates the pressure at the wellhead and can be used for monitoring production or injection processes and identifying potential issues. Flow rate measures the volume of fluid flowing through a pipeline and can be used for optimizing injection, production, and distribution. Tank levels monitor the level of fluid stored in tanks, allowing for inventory management. Pump performance data provides insights into the efficiency of pumps, enabling timely maintenance.

Another type of data source which can provide data from the wellsite is a wellsite information transfer standard markup language (WITSML) feed. WITSML is a set of standards and protocols for exchanging subsurface data between business partners in the petroleum industry. WITSML is a web-based, XML-based standard for sharing data between oilfield service companies, operators, and integrators. WITSML can be used to transmit data from rig sites to other parties, and for sharing information among partners, vendors, and government agencies. WITSML uses XML which is a language designed to be easy to read for both humans and machines. Examples of WITSML data which can be used by computing system 110 (e.g., to train and use AI model 534) include drilling mud properties (e.g., viscosity, density, pH level, etc.), drilling parameters (e.g., rotary speed, weight on bit, torque, etc.), wellbore pressure measurements (e.g., mud pressure, formation pressure, etc.), directional survey data (e.g., inclination, azimuth, etc.), logging data (e.g., Gamma ray logs, sonic logs, etc.), and a variety of other data in various embodiments.

WITSML provides various benefits in the context of system 100. For example, real-time wellsite information such as drilling parameters, mud properties, pressure readings, and wellbore geometry can be communicated from the wellsite to computing system 110 and/or other components of system 100 via WITSML. Such communication is important because it allows for near-instantaneous monitoring of drilling operations, enabling timely decision-making to optimize drilling efficiency, mitigate risks, and make critical adjustments during the drilling process, ultimately leading to better well placement and cost savings. WITSML provides continuous updates on drilling parameters, allowing computing system 110 to identify potential issues such as stuck pipe, abnormal pressure gradients, or unexpected formations quickly. By using a standardized format, WITSML facilitates seamless data exchange between different companies and software systems involved in drilling operations, eliminating the need for complex data translations. Access to real-time WITSML data enables computing system 110 to make informed decisions regarding mud weight adjustments, drilling fluid management, and directional drilling strategies based on current well conditions. Monitoring critical drilling parameters through WITSML can help identify potential hazards early on, allowing preventative actions to be taken to minimize safety risks. By analyzing WITSML data, computing system 110 can accurately geo-steer the wellbore to reach the desired target zone, maximizing production or injection potential.

Another type of data source which can provide data from the wellsite is a log analysis system (LAS) file. LAS files (as well as the CSV files and XLS/XLSX files described below) can be retrieved from a client (e.g., client system 106), sent via a service provider, or otherwise obtained either directly or indirectly from the wellsite. These types of files can be structured or formatted in a manner that facilitates directly inputting the data contained in a computer program, into AI model 534, or other components of computing system 110. LAS data may include a comprehensive set of measurements taken from a wellbore during drilling, completing producing, or injecting, including pressure, temperature, resistivity, porosity, and other geological properties. Computing system 110 can use LAS data can for building an accurate model of the reservoir (e.g., AI model 534), allowing companies to optimize drilling locations, estimate recoverable reserves, and plan efficient extraction strategies, ultimately maximizing production or injection and minimizing costs. Additionally, the reservoir model may also be used to estimate pore volume, estimate fracture gradients, and plan efficient injection strategies, maximizing augmentation and minimizing costs.

Computing system 110 can use LAS data in a variety of ways including for geological interpretation, reservoir modeling, drilling optimization, production and injection forecasting, and cost reduction. For example, by analyzing the variations in LAS data throughout the wellbore, computing system 110 can identify different rock formations, determine their lithology (rock type), and understand the geological structure of the reservoir, which is useful for identifying potential oil and gas zones, or injection intervals. Computing system 110 can use LAS data to create detailed reservoir models (e.g., AI model 534) that simulate fluid flow within the reservoir, allowing computing system 110 to predict how much oil and gas can be extracted and the optimal production rate for a well, or how much fluid can be injected and the optimal injection rate for a well. Computing system 110 can analyze LAS data in real-time during drilling operations to help identify potential drilling problems, adjust drilling parameters, and optimize the well trajectory to reach the target reservoir more effectively. By understanding the reservoir characteristics based on LAS data, computing system 110 can estimate future production or injection volumes and plan for well interventions or workovers when necessary. Using LAS data effectively can also lead to significant cost savings by minimizing unnecessary drilling operations, optimizing well placement, and improving production or injection efficiency.

Another type of data source which can provide data from the wellsite is a comma-separated values (CSV) file. A CSV file may contain data such as well production or injection rates, pressure readings, fluid composition, and geological information which signifies the performance and characteristics of individual oil and gas production or injection wells. Specific data points in a petroleum industry CSV may include, for example, a well ID (e.g., a unique identifier for each well), date/time information (e.g., timestamps of data collection), depth information (e.g., depth of the producing zone), pressure information (e.g., reservoir pressure at the wellhead), flow rate information indicating a volume of oil or gas produced per unit time, fluid composition information (e.g., percentage of oil, gas, and water in the produced fluid), a gas-oil ratio (GOR) indicating a ratio of gas volume to oil volume produced, and/or temperature (e.g., wellbore temperature). Data contained in a CSV file may provide important insights into reservoir behavior, potential issues, and optimal extraction strategies. Computing system 110 can use the data contained in a CSV file for maximizing production or injection and optimizing drilling operations. For example, such data can be provided as inputs to AI model 534 and used by AI model 534 to analyze and predict future well performance.

Computing system 110 can use CSV data in a variety of ways including understanding reservoir dynamics, identifying potential problems, optimizing production or injection, and predictive modeling. For example, computing system 110 can analyze trends in pressure, fluid flow, and production or injection rates over time, as indicated in a CSV data file, to assess how the reservoir is depleting or pressurizing and adjust extraction or augmentation methods accordingly. Computing system 110 can use the CSV file to identify abnormal pressure drops, changes in fluid composition, or fluctuations in production or injection rates can indicate issues like water influx, gas breakthrough, or wellbore damage, allowing for timely intervention and preventative measures. Computing system 110 can analyze historical data contained in a CSV file to determine the optimal production or injection rate for each well, maximizing resource extraction or fluid injection while minimizing operational costs. By feeding data from a CSV file into predictive models (e.g., AI model 534), computing system 110 can forecast future well performance, plan drilling locations, and make informed decisions regarding well interventions or abandonment.

Another type of data source which can provide data from the wellsite is an XSL file or XLSX file. XLS and XLSX files may contain detailed well data such as production or injection volumes, pressure readings, fluid properties, geological information, or any other type of data described herein. Well production or injection data may include daily, monthly, or yearly production or injection volumes of fluid, which can be used by computing system 110 for understanding reservoir depletion or pressurization patterns and forecasting future trends. Pressure data may include wellhead and bottom hole pressures, which can be used by computing system 110 for evaluating reservoir pressure dynamics and identifying potential problems such as water coning, gas cap expansion, or formation damage. Fluid properties may include data such as oil gravity, gas gravity, and viscosity, which can be used by AI model 534 to model and predict the flow and behavior of fluids within the reservoir, impacting production or injection calculations. Geological data may include information such as formation tops, lithology descriptions, porosity, permeability, and reservoir thickness. Computing system 110 can use such geological data to create a 3D geological model of the reservoir, which is the foundation for simulation analysis.

In some embodiments, data contained in XLS and XLSX files can be used by computing system 110 to build accurate reservoir models (e.g., training AI model 534) that predict future production or injection performance, optimize drilling strategies, and inform decision-making regarding reservoir management. For example, by incorporating comprehensive well data into a reservoir simulation model (e.g., AI model 534), computing system 110 can accurately predict future production or injection behavior, identify potential issues, and optimize development plans. In some embodiments, computing system 110 uses production or injection forecasts derived from AI model 534 for evaluating the economic viability of a well or reservoir, which can be used by recommendation generator 538 to make recommendations regarding drilling locations and investment strategies. Computing system 110 can analyze the XLS and XLSX data from various wells to ensure effective reservoir management practices, such as water injection optimization and pressure maintenance strategies, to maximize recovery. Additionally, by incorporating uncertainties in the data, AI model 534 can be used to assess potential risks associated with reservoir development and plan mitigation strategies.

### Chemistry Sensors

In some embodiments, real-time wellsite data sources 510 include chemistry sensors. Chemistry sensors can be placed on or within the pits, flowlines, or tanks installed at the wellsite and configured to measure various properties of the fluids extracted or injected by the wellsite. Such properties may include, for example, total dissolved solids, viscosity, density, and/or chemical/elemental concentration. Data measured by chemistry sensors can be transmitted to computing system 110 either directly or indirectly (e.g., via client system 106) via network 126.

One type of chemistry sensor which can be installed at the wellsite is a total dissolved solids (TDS) sensor. A TDS sensor measures the collective amount of minerals, salts, and/or other dissolved substances present in produced water (e.g., water extracted alongside oil and gas). In some embodiments, a TDS sensor measures the concentration of inorganic and organic materials that can pass through a fine filter, including ions such as sodium, calcium, magnesium, chloride, sulfate, and bicarbonate, which are dissolved in the water and contribute to its conductivity. Measurements from a TDS sensor can be updated in real-time and may occur on a per-well basis. In some embodiments, TDS sensors can have a range of 0 to 100,000 mg/L, an accuracy of ±2.0% of full scale, and a resolution of ±1 mg/L, which may differ depending on application and sensor type.

While TDS itself is a significant metric in petroleum engineering, it can be used to derive further insights. For example, data collector 526 can be configured to calculate various derived metrics based on TDS measurements such as water quality, reservoir fluid properties, water injection efficiency, and environmental impact. For example, high TDS levels can indicate poor water quality, which can impact equipment and pipelines and can affect the efficiency of water injection processes. Monitoring TDS may allow computing system 110 to identify potential scaling, corrosion, or other water-related issues. TDS can also influence fluid properties like density, viscosity, and conductivity. These properties, in turn, affect reservoir performance and production or injection rates. Accordingly, by analyzing TDS trends, computing system 110 can assess changes in reservoir fluid composition and adjust production or injection strategies accordingly. High TDS levels in injection water can also reduce injectivity and reservoir permeability. Thus, monitoring TDS can help computing system 110 optimize water injection strategies and improve recovery factors. High TDS levels in produced water can also have adverse environmental consequences if the water is not properly treated and disposed. Accordingly, computing system 110 can use the measured TDS levels to generate effective water treatment and disposal strategies, including designing water treatment and disposal systems.

Computing system 110 can use TDS and its derived metrics to optimize production or injection, minimize environmental impact, reduce operational costs, and improve reservoir performance. For example, computing system can use TDS and its derived metrics to make informed decisions about production or injection rates, well spacing, and reservoir management. In some embodiments, computing system 110 uses TDS and its derived metrics to select and implement effective water treatment and disposal practices to protect the environment. Computing system 110 can use TDS and its derived metrics to prevent equipment failures and optimize water injection processes to reduce operational costs and improve reservoir performance by enhancing recovery factors and prolonging field life. Advantageously, by carefully monitoring and analyzing TDS data, computing system 110 can optimize operations and mitigate potential risks associated with water quality and reservoir performance.

In some embodiments, computing system 110 uses TDS data to predict subsurface fluid movement through its impact on fluid density and viscosity. Higher TDS levels generally increase the density and viscosity of water, which can affect fluid movement. For example, higher TDS water is denser than freshwater and density differences between fluids in a subsurface environment can create pressure gradients, driving fluid flow. Accordingly, in certain geological settings, density differences can lead to convective flow, where denser fluids sink and less dense fluids rise. Higher TDS water is also more viscous than freshwater and increased viscosity can increase the resistance to flow through porous media, reducing permeability. This can result in slower fluid movement and reduced production or injection rates from wells. High TDS levels can also lead to mineral precipitation, particularly in areas with high temperatures and pressures. Mineral scale formation can clog pore spaces, reducing permeability and hindering fluid flow. Additionally, certain ions in TDS can react with minerals in the subsurface, leading to dissolution or precipitation. These reactions can alter the porosity and permeability of the rock, affecting fluid flow.

Computing system 110 can use various models and relationships that relate to the fluid properties affected by TDS levels to predict flow behaviors and train AI model 534. Advantageously, computing system 110 can predict (e.g., using AI model 534) the impact of TDS on subsurface fluid movement based on the complex relationships between TDS and other factors that affect fluid flow, such as the specific geological setting, fluid composition, and reservoir conditions. By understanding the relationship between TDS and fluid properties, computing system 110 can optimize production or injection strategies, design effective water injection programs, and predict long-term reservoir performance.

Another type of chemistry sensor which can be installed at the wellsite is a viscosity sensor. Viscosity is a measure of a fluid's resistance to flow. A higher viscosity means the fluid is thicker and flows more slowly, while a lower viscosity means the fluid flows more readily. In the context of system 100, viscosity may indicate how easily a petroleum product such as crude oil or refined fuel can move through a pipeline. Accordingly, viscosity may be an important property for determining suitability of the petroleum product for different applications. Measurements from a viscosity sensor can be updated in real-time and may occur on a per-well basis. In some embodiments, viscosity sensors can have a range of 0.2 to 20,000 centipoise (cP), an accuracy of ±0.5% of the reading, and a resolution of ±1 ppm, which may differ depending on application and sensor type.

Data collector 526 can be configured to calculate a variety of derived metrics based on viscosity, such as flow rate, reservoir performance, pipeline design, and process design. For example, viscosity directly impacts the flow rate of fluids in pipes and reservoirs. Thus, computing system 110 can use viscosity for optimizing production and injection rates, designing efficient pipelines, and predicting pressure drops. Viscosity also affects fluid mobility in porous media, influencing reservoir performance and recovery factors. Accordingly, computing system 110 can analyze viscosity changes over time to provide insights into reservoir depletion and the effectiveness of enhanced oil recovery techniques. Viscosity is also a key parameter in designing pipelines and selecting appropriate pumps. For example, computing system 110 can use viscosity data to ensure the pipelines and pumps are designed appropriately (e.g., sufficient diameter, bend radii, pumping power, etc.) to ensure efficient and reliable transportation of oil and gas at the required viscosity level. Viscosity also affects the performance of various processing equipment, such as separators, heaters, and distillation columns. Accordingly, computing system 110 can use viscosity for optimizing process design and minimizing energy consumption.

Computing system 110 can use viscosity and metrics derived therefrom to optimize production or injection, reduce operational costs, improve reservoir performance, and ensure reliable transportation. For example, computing system 110 can use viscosity to make informed decisions about production and injection rates, well spacing, and reservoir management, reduce operational costs by minimizing energy consumption and equipment wear, improve reservoir performance by enhancing recovery factors and prolonging field life, and ensuring reliable transportation by designing efficient pipelines and optimizing flow rates. Advantageously, by carefully monitoring and analyzing viscosity data, computing system 110 can optimize operations and mitigate potential risks associated with fluid flow and processing.

In some embodiments, computing system 110 uses viscosity to model and predict subsurface fluid movement. For example, AI model 534 can be trained to accurately model and predict fluid flow based on viscosity data such that fluids with higher viscosity flow more slowly through porous rock formations. This can lead to lower production rates from wells or lower injection rates into wells with higher viscosity fluids. AI model 534 may predict that high-viscosity fluids reduce the effective permeability of a reservoir, making it more difficult to extract hydrocarbons. This can lead to lower ultimate recovery factors. Computing system 110 can use AI model 534 to predict when enhanced oil recovery (EOR) techniques such as thermal recovery or chemical injection can be employed to reduce the viscosity of heavy oils, improving their mobility and increasing oil recovery rates. AI model 534 can also predict that high-viscosity fluids cause significant pressure drops in wellbores, reducing production or injection rates. This can lead to flow assurance challenges, such as paraffin deposition and hydrate formation. Advantageously, by modeling and predicting fluid flow based on viscosity, AI model 534 can accurately determine the efficiency of subsurface fluid flow. Additionally, by understanding the relationship between viscosity and reservoir properties, computing system 110 can optimize production and injection strategies, design effective EOR techniques, and maximize hydrocarbon recovery.

Another type of chemistry sensor which can be installed at the wellsite is a chloride sensor. Chloride sensors can be configured to detect and measure the levels of negatively charged chlorine ions (Cl—) present in crude oil. Such ions are typically found as a salt compound, which can be a significant concern due to its corrosive nature, potentially damaging refinery equipment if concentrations are too high. Particularly problematic chlorine ions are organic chlorides which are chlorine atoms bonded to carbon chains. Such organic chlorides are often introduced through cleaning operations and are not easily removed during standard desalting processes. Measurements from a chloride sensor can be updated in real-time and may occur on a per-well basis. In some embodiments, chloride sensors can have a range of 0 to 1,000 parts per million (ppm), an accuracy of ±1.0% of full scale, and a resolution of ±0.5% of the reading, which may differ depending on application and sensor type.

While chloride content itself is a significant parameter, computing system 110 can also use chloride levels to derive further insights, particularly in the context of water injection and production operations. Data collector 526 can be configured to calculate a variety of derived metrics based on chloride levels including, for example, corrosion potential, water quality, reservoir performance, and environmental impact. For example, high chloride concentrations can accelerate corrosion, especially in metallic components like pipelines, pumps, and valves. Computing system 110 can monitor chloride levels and use such information to predict and mitigate corrosion risks, reducing maintenance costs and improving operational reliability. Additionally, chloride ions can affect water quality and its suitability for various applications, such as injection water and cooling water. Computing system 110 can use chloride levels to optimize water treatment processes and minimize negative impacts on equipment and the environment. Chloride ions can also interact with reservoir minerals, affecting permeability and porosity. Accordingly, computing system 110 can monitor chloride levels in produced water and use such information to provide insights into reservoir conditions and potential production or injection challenges. High chloride concentrations in produced water can also have adverse environmental consequences if the water is not properly treated and disposed. Computing system 110 can use the chloride levels to help design effective water treatment and disposal systems.

Computing system 110 can use chloride levels and metrics derived therefrom to optimize production or injection, minimize environmental impact, reduce operational costs, and improve reservoir performance. For example, computing system 110 can use chloride levels to make informed decisions about production or injection rates, well spacing, and reservoir management. Computing system 110 can implement effective water treatment and disposal practices to protect the environment. In some embodiments, computing system 110 uses chloride levels to prevent equipment failures, optimize water injection processes, and improve reservoir performance by enhancing recovery factors and prolonging field life. Advantageously, by carefully monitoring and analyzing chloride data, computing system 110 can optimize operations and mitigate potential risks associated with corrosion, water quality, and reservoir performance.

In some embodiments, computing system 110 uses the measured chloride levels to predict subsurface fluid movement. While chlorides are not a direct driver of subsurface fluid movement, the chloride concentration can indirectly influence fluid flow through their impact on mineral scaling and corrosion. For example, high chloride concentrations can contribute to the precipitation of minerals, such as calcium carbonate and barium sulfate. These mineral deposits can clog pore spaces, reducing permeability and hindering fluid flow. Chloride ions can also accelerate corrosion of metal components in equipment, such as pipelines and wellbores. Corrosion can lead to reduced well productivity and increased maintenance costs. High chloride concentrations in injection water can also lead to scaling and reduced injection rates. Scaling can damage the reservoir rock and reduce its permeability.

AI model 534 can be trained using chloride level information and can learn to predict the relationship between chlorine levels and fluid flow. While chloride content itself does not directly drive fluid movement, its impact on mineral scaling and corrosion can significantly affect the flow of fluids through the subsurface. By understanding the relationship between chloride concentration and these processes, computing system 110 can train AI model 534 to make predictions based on this relationship. The predictions from AI model 534 can be used to optimize production and injection strategies, design effective water treatment programs, and mitigate potential production or injection challenges.

Another type of chemistry sensor which can be installed at the wellsite is a density sensor. Density signifies the mass per unit volume of a fluid sample. The density of a fluid may provide information about its composition and may allow for calculations related to reservoir pressure, flow rates, and potential issues such as gas-liquid separation. Computing system 110 can use density information for accurate modeling of well performance and production or injection optimization strategies. Measurements from a density sensor can be updated in real-time and may occur on a per-well basis. In some embodiments, density sensors may have a measurement range from 700 to 950 kg/m³, an accuracy of ±0.1 kg/m³, and a resolution of ±0.001 kg/m³. Other density sensors may have a range of 0.6-1.0 g/cm³, an accuracy of ±0.0025 g/cm³, and an operating temperature range of −40° to 140° F. (−40° to 60° C.), which may differ depending on application and sensor type.

Computing system 110 can use density information in several ways including for reservoir characterization, production or injection forecasting, wellbore stability, pipeline design, and quality control. For example, by measuring the density of fluids from a reservoir, computing system 110 can estimate the fluid type (e.g., oil, gas, water) and its properties, which can then be used for determining reservoir pressure and calculating recoverable reserves. Computing system 110 can use fluid density data to predict how much fluid will be produced from a well or injected into a well under specific conditions, as it influences flow rates and wellhead pressure. In drilling operations, computing system 110 can use the density of drilling mud (i.e., a fluid used to control pressure) to prevent blowouts or formation damage, as the mud density needs to be carefully balanced against the formation fluid pressure. Computing system 110 can use fluid density to calculate the required pipeline size and pumping capacity to efficiently transport oil and gas mixtures. In refining processes, computing system 110 can monitor the density of products such as gasoline and diesel to ensure they meet quality standards.

Computing system 110 can use density information in combination with other data sources 502 when training and using AI model 534. For example, fluid density is highly sensitive to temperature and pressure changes. Thus, considering temperature and pressure in combination with density information can be useful to provide context to the density data. By combining density measurements with other analytical methods such as gas chromatography, computing system 110 can develop a more detailed understanding of the fluid composition. In some embodiments, computing system 110 converts density measurements into units of API gravity, which is used in the petroleum industry as a measure of density. API gravity is a derived scale where lower API numbers correspond to higher density fluids.

Data collector 526 can be configured to calculate a variety of derived metrics based on density. One derived metric which can be calculated from the injected water fluid density is the formation water density correction factor (FWDCF). FWDCF represents the adjusted density of the formation water based on measured pressure and temperature data from the reservoir. FWDCF can be used to accurately calculate reservoir fluid properties and optimizing injection strategies. Advantageously, because formation water density can vary depending on depth and temperature, using a corrected density value ensures more precise reservoir simulation and prediction of fluid flow dynamics. In some embodiments, computing system 110 uses the actual formation water density to evaluate injection well performance and identify potential issues such as water coning or channeling. By accurately accounting for formation water density, computing system 110 can fine-tune injection pressure to maintain desired reservoir pressure and maximize recovery efficiency.

Computing system 110 can calculate the FWDCF using pressure measurements from pressure gauges in the reservoir, temperature data from downhole sensors, and laboratory analysis of formation water samples to determine its base density at standard conditions. For example, computing system 110 can use established correlations based on pressure-temperature relationships and fluid properties to adjust the base formation water density to match the conditions at the reservoir depth. Other derived metrics which can be calculated by data collector 526 based on density include water salinity and water quality index. Water salinity can be calculated from conductivity measurements, which can impact the density of injected water and influence its behavior in the reservoir. Water quality index is a combined metric considering various water parameters such as dissolved solids, pH, and suspended particles, used to assess the overall suitability of injected water for reservoir operations.

In some embodiments, computing system 110 identifies correlations and connections between density and other data sources 502. Such correlations may include, for example, correlating density with water chemistry data (e.g., salinity, dissolved solids), pressure and temperature measurements at the injection wellhead, fluid composition analysis, reservoir fluid properties (especially salinity), and wellbore geometry as these factors significantly influence the calculated density of the injected water. For example, computing system 110 can develop a correlation between salinity and density, where higher salinity in the injected water leads to a higher density. Computing system 110 can develop a correlation between pressure and density because pressure can indirectly affect density due to its influence on dissolved gas content in the water. If the injected water is mixed with reservoir fluids, the salinity of the formation water can also impact the overall density of the mixture.

In some embodiments, computing system 110 uses density of the injected water in combination with other data sources 502 to train AI model 534. For example, computing system 110 can use water treatment plant data including detailed information on chemical additives, dissolved solids concentration, and water quality parameters. Computing system 110 can use injection wellhead data including pressure, temperature, flow rate measurements. Computing system 110 can use downhole pressure data including pressure readings from monitoring wells, which can provide insights into reservoir fluid interactions. In some embodiments, computing system 110 uses fluid analysis reports including laboratory analysis of water samples for salinity, dissolved gas content, and other relevant chemical components. Computing system 110 may also use geological data because formation porosity and permeability can influence how injected water flows through the reservoir.

Model trainer 530 can incorporate these and other data from different data sources 502 as input features for AI model 534 and can use well-measured injection water density data to calibrate AI model 534 and ensure accuracy. Model trainer 530 can validate AI model 534 by comparing model predictions with observed data from different wells and production or injection scenarios to assess model reliability. Advantageously, computing system 110 can ensure consistent data collection practices and quality checks to avoid inaccurate model results, account for potential variations in water quality and reservoir properties across the field, and account for dynamic conditions. For example, if reservoir pressure and temperature change over time, computing system 110 can incorporate such dynamic data into AI model 534 such that AI model 534 learns the relationship between these variables and the model predictions generated by AI model 534.

### Engineering Data Sources

Referring now to FIGS. 10A-10B, diagrams illustrating engineering data sources 512 in greater detail are shown, according to an exemplary embodiment. Engineering data sources 512 are shown to include a variety of data sources, some of which may overlap with real-time wellsite data sources 510 or other data sources 502. Engineering data sources 512 are shown to include well location, perforation intervals, % flow/zone, permit data, casing tests, seismic hazard analysis (SHA) data, production data, and injection data. In various embodiments, well location is included as part of the permit data or can be provided as a separate data source. Each of engineering data sources 512 is described in detail below.

Permit data may include information obtained from permits associated with various wells. Well operators may need to apply for permits prior to constructing and/or operating injection wells. The permits may define various attributes of the wells including attributes that describe the physical construction of the wells and/or attributes that indicate the permitted range of operation of the wells. In some embodiments, permit data is public information and can be obtained from public data sources (e.g., government records, regulatory agency records, etc.). For example, permit data can be obtained from paper historical records (e.g., scout tickets, well histories, etc.) from clients, regulatory offices, or libraries. Other permit data can be obtained from online regulatory or organization databases (e.g., Texas RRC, New Mexico OCD, University Lands, etc.). Other permit data can be obtained from online data vendors (e.g., S&P Global, Enverus, etc.).

In some embodiments, permit data includes well location such as a geographic datum, latitude and longitude coordinates, x/y coordinates in a region-specific coordinate system or grid, geographic location (e.g., survey, block, township, range, section, northing, easting, etc.), or any other location identifier. Computing system 110 can use well location data to determine the physical location of a well, while also being able to plot the location on a map. In some embodiments, permit data includes ground level information indicating the height above sea level of the well location. Ground level is typically a single datum (i.e., height value) and may be required in some permits, along with the potential measured datum for all drilled depths. In some embodiments, permit data includes a unique well identifier (UWI). The UWI may be an identifying number/letter series that is unique to the specific wellbore and location. In various embodiments, the UWI can be a unique identifier assigned to a well by computing system 110, or can be assigned by an external entity such as a regulatory agency (e.g., API number).

In some embodiments, the permit data includes other information about the well such as the lease name, well number, field name, operator(s), permit type, production or injection type, injection class, and date(s). The lease name may be part of the well label (e.g., lease name+well number) and may indicate on which lease the well was drilled. For example, the lease name may sometimes, but not always, name a land or mineral rights owner, which may change with operators or unitization. The well number may be the other part of the well label and may indicate which well is covered by the lease. In some cases, the well number is designated in order drilled or section grid, and may change with operator or unitization. The field name may identify the production/injection zone and the geometric boundaries it encompasses. The operator(s) may indicate one or more well operators at the time of operations, and may change based on sales or acquisitions. In some embodiments, computing system 110 uses the well operator information to infer other details about the well because the manner in which wells are drilled, cased, and completed are often based on the philosophies of the operator at the time of the permit.

The permit type may indicate the type of well to be drilled, recompleted, or abandoned. Permit type indicates the purpose of the well (e.g., oil, gas, secondary recovery, injection into producing formation, injection into non-producing formation, etc.). The production type indicates if the well's primary production purpose is oil, gas, or both. Production type information can be used by computing system 110 to establish what kind of production values to look for. Injection class data may indicate the class of injection well using a predefined set of well classes and associated descriptions. For example, using the underground injection control (UIC) classification system, Class I wells are for the injection of hazardous and non-hazardous wastes, Class II wells are for the injection of fluids associated with oil & gas, Class III wells are for the injection of fluids to dissolve and extract minerals, and Class VI wells are to inject carbon dioxide for sequestration. The date(s) may indicate the earliest date that wellsite operations are permitted to begin for the particular permit type.

In some embodiments, permit data indicates various operational parameters of the well such as the permitted range of operation in various attributes. For example, permit data may include perforated intervals, permitted intervals, permitted formation(s), fluid type, maximum pressure, maximum volume, well status, test date, and test type. Perforated intervals may indicate the broad depth intervals of where the subsurface is open to the surface and/or the production or injection intervals. The permitted intervals may indicate the broad depth intervals where operations are allowed. The permitted formations may indicate the names of the formations in which operations are allowed. The fluid type may indicate the type of fluid that is being injected and/or produced from the well. The maximum pressure may indicate the maximum allowable or permitted pressure as determined by the company or regulatory agency for a specific formation or operation. The maximum volume may indicate the maximum allowable or permitted volume (e.g., often in a time period such as volume per day) as determined by the company or regulatory agency for a specific formation or operation. The well status may indicate the current status of the well (e.g., active, inactive, plugged & abandoned (P&A), temporarily abandoned, etc.). The test date may indicate the date at which the well test was completed, whereas the test type may indicate the type of test that was completed on the well (e.g., production test for production wells, injection or casing test for injection wells).

In some embodiments, computing system 110 uses the permit data as the base data to which all other information is tied. For example, computing system 110 can use the permit data to generate a database of the wells within the geographic region and extract various information about the wells from the permit data. Computing system 110 can populate a database (e.g., stored within memory 524) of the wells and add other information from data sources 502 to the database to create a well profile for each well. The well profiles may include some or all of the permit data from engineering data sources 512, real-time wellsite data sources 510, geographical data sources 504, or any other data sources 502 that provide information pertinent to the wells. In some embodiments, the permit data includes information about the wells for a time period that encompasses the date the permit was issued (i.e., a time months or years in the past) as well as current operations. Advantageously, computing system 110 can use the permit data to develop a full well history to allow for analysis of operations and how they affected the formations of interest. Data collector 526 may collect permit data initially when a new wellsite is proposed or the permit is requested (e.g., at the beginning of the project) and then again whenever any changes are made to the permit(s) or new permitted activity is initiated.

In some embodiments, engineering data sources 512 include wellbore data. Wellbore data can be acquired from paper historical records (e.g., drill sheets, scout tickets, well histories, etc.) from clients, regulatory offices, or libraries. In some embodiments, wellbore data can be acquired from online regulatory or organization databases (e.g., Texas RRC, New Mexico OCD, University Lands, etc.) and/or online data vendors (e.g., S&P Global, Enverus, etc.). Wellbore data may include various information about the wellbore of the well such as a measurement datum, hole size(s), depth(s), and directional survey. The measurement datum may indicate the height above sea level that all wellbore data is calibrated (e.g., ground level, rotary table, Kelly bushing, etc.). The hole sizes may indicate the size of the bit used to drill the well, which may include multiple hole sections drilled with various types and sizes of bits. Computing system 110 can use the hole sizes in calculating cement volumes or pressure data for open-hole completions. The depth information may indicate the depths to which each section of the well was drilled and can be expressed in total depth (TD) and/or true vertical depth (TVD) depending on whether the well is drilled vertically or at a different direction (e.g., angled relative to true vertical). The directional survey data may include the direction and depths of the wellbore (e.g. northing, easting, measured depth, true vertical depth, azimuth, inclination, dog leg severity, etc.). Computing system 110 can use the directional survey data to ensure the accurate depiction of formation and perforation depths, which provides the proper depths used by computing system 110 for various calculations (e.g., bottomhole pressure).

In some embodiments, engineering data sources 512 include other wellbore data such as the plug type, plug depth(s), cement type, cement volume, cement depths, date(s), tubing size, tubing depth, packer depth, and abandon date. The plug type may indicate the type of plug used to shut off deeper parts of the well from upper parts of the well (e.g., in completions or abandonment operations). The plugs may be permanent or temporary and may include a cast iron bridge plug (CIBP), removable bridge plug (RBP), cement, or other plug types in various embodiments. The plug depth may indicate the top depth or depth range of the plug. Computing system 110 can use the plug depth to determine what depths are still exposed within the well. The cement type may indicate the type of cement, if required, used in shutting off part of the well. Computing system 110 can use cement type information to determine how hard the cement can be, and any chemical reactions that may take place dependent on the type of fluid within the well or wellbore. The cement volume and cement depth may indicate the total volume and depth of the cement used to shut off part of the well, if required. Computing system 110 can use the cement volume and depth to determine the calculated depth range of the plug, how much of the well is plugged off, and how strong the cement will be at holding back pressures under it.

The date information may indicate one or more dates that the plugs or tubing were installed. Computing system 110 can use the date information to establish a timeline of events and what formations were open during operations. The tubing size information may indicate the size of the tubing (e.g., tubing 162 in FIG. 3), which may be a smaller diameter pipe used for fluid flow in or out of the well to ensure that only the perforations of interest are affected with operations. Computing system 110 can use the tubing size to determine pressure regimes calculated from surface pressures. The tubing depth may indicate the total depth of the tubing, which can be used by computing system 110 in pressure calculations. The packer depth may indicate the depth of the packer, which is a tool used to shut off the perforated intervals from the rest of the well, and the tubing usually runs through it. Computing system 110 can use the depth of the packer in pressure calculations between the casing or open hole size and the tubing size. The abandon date may indicate the date at which the well was (or will be) no longer utilized and plugged. Computing system 110 can use the abandon date to determine when the well is no longer active and taken out of service.

In some embodiments, engineering data sources 512 include casing data. Casing data may be acquired from the same data sources as the wellbore data and may include various information describing the casing of the well such as type, size, depth(s), cement type, cement volume, cement height, test type, test date(s), and test result. The type of casing may indicate the material the casing is made of, as well as the grade of the material. Computing system 110 can use the type of casing to determine interactions between various chemicals or fluids. The size of the casing may indicate the inner and or outer diameter size of the casing. Computing system 110 can use the size of the casing when calculating cement volumes, fluid pressures, what size the next section can be drilled, and equipment that may be used within the well. The depth indicates the depth where the bottom (shoe) of the casing was set, which may be different than the drilled hole depth. Computing system 110 can use the depth of the casing as an input indicating the maximum depth that operations can take place.

The cement type data may indicate the type of cement used to set the casing in place.

Computing system 110 can use the cement type information to determine how hard the cement may be, as well as any chemical reactions that may take place dependent on the type of fluid within the well or wellbore. The cement volume data indicates the total volume of cement used to set the casing in place. Computing system 110 can use the cement volume to determine the maximum height of the cement based on volume calculations. The cement height may indicate the depth of where the cement starts around the outside of the casing. In various embodiments, the cement height is calculated (e.g., by computing system 110 or an outside system), but can also be determined by cased hole wireline logs. In some embodiments, the cement height may not extend to above the top of casing and may be determined based on regulations. The test type information may indicate the type of test to determine the quality of the casing and cement. Computing system 110 can use the test type information when determining maximum pressure allowed before breakdown, or the integrity of the casing at a certain pressure required to conduct operations. The test date and test result may indicate the date of each test conducted and the result of each test (e.g., the integrity of the casing or cement, usually given in a maximum pressure reached as required for the particular test) respectively. Computing system 110 may use the test dates and the test results to determine the timeline of these tests, and the integrity of the well over time.

In some embodiments, engineering data sources 512 include completion information. Completion information may be acquired from the same data sources as the wellbore data and may include various information describing the completion of the well such as type, perforated intervals, date(s), fluid type(s), fluid volume(s), proppant type, proppant volume, formation type, cased/open hole, pressure(s), and stage(s). The type of completion determines how and what kind of damage to the formation occurred (e.g., acid, frac, water, natural, etc.). The perforated intervals indicate at what depth and how many holes are opened into the formation that is exposed for completion fluids, production, or injection. The dates indicate the date that each completion type was completed. Computing system 110 can use the dates to determine when and how long the formation was exposed for operations. Various completion types and intervals may occur in the same well over time. The fluid type indicates the type of fluids used in the completion, which can be used by computing system 110 to determine the type of damage to the formation that can be caused. Similarly, the fluid volume indicates the total volume of each fluid used in the completion, which can be used by computing system 110 to determine how much damage was caused to the formation.

The proppant type may indicate the type and size of solid material used in to hold open the formation. Computing system 110 can use the proppant type to determine how it may react with the formation and fluids over time, and the permeability that was created (e.g. sand, ceramic, etc.). The proppant volume may indicate how much proppant was used in the completion. Computing system 110 can use the proppant volume to determine the extent and how well the formation is open, and the permeability that was created. The formation type may indicate the type of geological formation into which the well extends. Computing system 110 can use the formation type to determine why the completion method was used and/or how the damage would form from completion. The cased/open hole information indicates how much of the formation was exposed at the time of the completion method. Open-hole completion means that the full formation from the base of casing to the total depth was exposed, and usually requires larger volumes of fluid. Conversely, cased hole completion requires perforations to expose the formation, usually with smaller volumes, but higher pressures. The pressure information indicates the overall is required in order to break the formation, which can be used by computing system 110 to determine the fracture pressure required to damage the formation. The stages information may indicate one or more stages usually used in horizontal drilling. Computing system 110 can use the stages information for better pressure management and volume control in a small section of the wellbore. In some wells, multiple stages are shut off from the rest of the well so that completions operations become more strategic based on the formation properties.

In some embodiments, engineering data sources 512 include production or injection data. Production or injection data may include a variety of information that indicates the production or injection of the well. The production or injection data may identify each well using a unique identifier (e.g., a number/letter series that is unique to the specific wellbore and location), such as the API number or a different identifier assigned by computing system 110. Data collector 526 may acquire historical production or injection data from historical data sources such as Physical Media (e.g., clients, libraries, Lockwood production or injection books, etc.) or online public and private databases (e.g., Texas RRC, Enverus, S&P Global, etc.). Data collector 526 may acquire current production or injection data from various sensors placed on or within the wellbore/wellhead, flow lines, or tanks, such as any of the real-time wellsite data sources 510 previously described.

Production or injection data may include timeseries data that characterize the production or injection of various wells over time. Production or injection data may include information such as fluid type, volume, date(s)/time(s), fluid temperature, formation temperature, wellhead pressure, formation pressure, rates, and fluid properties. The fluid type may indicate the type of fluid being produced by the well (e.g., oil, gas, water, brine, etc.). The volume may indicate the volume of fluid being produced, measured at the surface. The dates/times may include timestamps or other attributes that indicate the times or time periods over which the production or injection occurs. Data collector 526 can use the dates/times to establish a timeseries or history of the production or injection of various wells over time to allow trends to be analyzed. The rates may indicate the rate at which fluid is being removed from the ground. Data collector 526 can either acquire the rate information directly or calculate the rate information by dividing the production or injection volume by a corresponding time period over which that volume was produced. The remaining types of production or injection data (i.e., fluid temperature, formation temperature, wellhead pressure, and formation pressure) may be the same as described with reference to real-time wellsite data sources 510.

In some embodiments, engineering data sources 512 include injection data. Injection data may include a variety of information that indicates the fluid injected into the reservoir by the well. The injection data may identify each well using a unique identifier (e.g., a number/letter series that is unique to the specific wellbore and location) such as the API number or a different identifier assigned by computing system 110. Data collector 526 may acquire historical injection data from historical data sources such as Physical Media (e.g., clients, libraries, Lockwood production books, etc.) or online public and private databases (e.g., Texas RRC, Enverus, S&P Global, etc.). Data collector 526 may acquire current injection data from various sensors placed on or within the wellbore/wellhead, flow lines, or tanks, such as any of the real-time wellsite data sources 510 previously described.

Injection data may include timeseries data that characterizes the fluids injected by various wells over time. Injection data may include information such as fluid type, volume, rates, date(s)/time(s), wellhead pressure, bottomhole pressure, differential pressure, pump pressure, casing pressure, tubing pressure, fluid temperature, bottomhole temperature, and formation temperature. The fluid type may indicate the type of fluid being injected into the ground (e.g., fresh water, brine, carbon dioxide, industrial waste, etc.). The volume may indicate the volume of fluid being injected into a formation. Computing system 110 can use the volume information to determine changes in wellhead and bottomhole pressure. The dates/times may include timestamps or other attributes indicate the times or time periods over which the injection occurs. Data collector 526 can use the dates/times to establish a timeseries or history of the injections of various wells over time to allow trends to be analyzed. The rates may indicate the rate at which fluid is being injected into the ground. Data collector 526 can either acquire the rate information directly or calculate the rate information by dividing the injection volume by a corresponding time period over which that volume was injected. The remaining types of injection data (i.e., wellhead pressure, bottomhole pressure, differential pressure, pump pressure, casing pressure, tubing pressure, fluid temperature, bottomhole temperature, and formation temperature) may be the same as described with reference to real-time wellsite data sources 510.

In some embodiments, engineering data sources 512 include fluid property data. Fluid property data may include various attributes, characteristics, or other properties of the fluids produced by various wells or injected into the ground by various wells over time. The fluid property data may identify each well using a unique identifier (e.g., a number/letter series that is unique to the specific wellbore and location) such as the API number or a different identifier assigned by computing system 110. Fluid property data may include historical fluid property data and/or current fluid property data for the identified wells. Historical fluid property data can be obtained from various reports that were analyzed and compiled in a laboratory or onsite analysis and transmitted via paper or electronic means. Current fluid property data may be obtained via various sensors placed on or within the pits, flowlines, or tanks at the wellsite, which can be transmitted to computing system 110 as described with reference to real-time wellsite data sources 510. In some embodiments, each element of fluid property data may include a timestamp (e.g., a date or time) indicating a time or time period to which that data pertains and a data value indicating the value of the corresponding fluid property. The fluid property data may include various attributes indicating fluid properties such as fluid type, fluid density, gravity (API), total dissolved solids (TDS), chloride(s), viscosity, chemistry, and gas/oil ratio (GOR). These fluid properties may be the same as described with reference to real-time wellsite data sources 510.

In some embodiments, engineering data sources 512 include percent (%) flow/zone data. Percent flow/zone data may include the results of various tests conducted at the wellsite such as an injection test, wireline test, or tracer test. Data collector 526 can collect historical % flow/zone data from Physical Media (e.g., client, libraries, etc.) or online public and private databases (e.g., Texas RRC, Enverus, S&P Global, etc.), whereas current % flow/zone data can be provided by the wellsite or client system 106. In some embodiments, data collector 526 collects % flow/zone data (e.g., a one-time initial data acquisition, additional collections as subsequent tests are performed).

In some embodiments, % flow/zone data include injection test data. Injection tests can be performed at the wellsite to better understand reservoir behavior, evaluate well performance, and optimize production or injection strategies. The data collected from these tests provide valuable insights into various aspects of reservoir engineering, for example, an injection test may result in test data including pressure data (e.g., reservoir pressure, wellbore pressure, injection rate, etc.), temperature data (e.g., reservoir temperature, heat transfer, etc.), and flow rate data (e.g., injection rate, wellbore flow, etc.). By analyzing these data, computing system 110 can characterize reservoir properties, optimize injection strategies, monitor well performance, predict future performance, calibrate reservoir simulation models, evaluate enhanced oil recovery (EOR) techniques, perform risk assessment, and evaluate economic performance of the well. The data collected from injection tests provides the foundation for informed decision-making in the petroleum industry. Computing system 110 can use the relationships between these data points and their impact on reservoir behavior to optimize production or injection strategies, maximize recovery, and minimize operational costs.

Computing system 110 can be configured to generate derived metrics based on the injection test data. Such derived metrics may include, for example, formation permeability, skin factor, reservoir pressure, injection efficiency, and the wellbore storage coefficient. Formation permeability is a measure of a rock's ability to transmit fluids and is a useful parameter for reservoir characterization and production or injection forecasting. Computing system 110 can estimate formation permeability from the analysis of pressure transient data, such as pressure buildup or drawdown tests. The skin factor quantifies the impact of wellbore damage or stimulation on well productivity. Computing system 110 can calculate values of the skin factor from the analysis of pressure transient data. Reservoir pressure is important for understanding fluid flow and production or injection potential and can be estimated by computing system 110 from pressure measurements during the injection test. Injection efficiency measures the effectiveness of the injection process in displacing oil from the reservoir. Computing system 110 can estimate injection efficiency by analyzing the distribution of injected fluid within the reservoir, which may be inferred from pressure and tracer data. The wellbore storage coefficient characterizes the compressibility and storativity (i.e., a measure of a formation's capacity to store and release fluid) of the wellbore and near-wellbore region. Computing system 110 can estimate the wellbore storage coefficient from the analysis of pressure transient data.

Computing system 110 can use the metrics derived from injection test data for several purposes such as reservoir characterization, well performance evaluation, production or injection optimization, enhanced oil recovery (EOR), and reservoir simulation. Reservoir characterization provides insights into the reservoir's properties, such as permeability, porosity, and fluid saturation. Well performance evaluation may include an assessment of the performance of individual wells and can be used to identify potential issues, such as wellbore damage or formation damage. Production or injection optimization may include optimizing production or injection strategies, such as well spacing and injection rates. Computing system 110 can use the metrics derived from injection test data to evaluate the effectiveness of EOR techniques, such as waterflooding, gas injection, and chemical flooding. In some embodiments, computing system 110 uses these metrics to calibrate and validate reservoir simulation models, improving their predictive capabilities. Advantageously, computing system 110 can use the metrics derived from injection test data to generate recommendations, control signals for wellsite equipment 546, and/or as outputs 552 for engineers or wellsite operators.

In some embodiments, computing system 110 identifies or generates correlations between injection test data and other data sources 502. For example, computing system 110 can generate a correlation between injection rate and wellhead pressure. Higher injection rates often lead to higher wellhead pressures due to increased resistance to flow. Variations in wellhead pressure can indicate changes in reservoir conditions or wellbore issues. In some embodiments, computing system 110 generates a correlation between injection rate and reservoir pressure. Increasing injection rates can help maintain or increase reservoir pressure, especially in declining reservoirs. The relationship between injection rate and reservoir pressure can provide insights into reservoir connectivity and fluid flow patterns. In some embodiments, computing system 110 generates a correlation between wellhead pressure and bottomhole pressure. The difference between these pressures represents the pressure drop across the wellbore, which can be influenced by factors such as friction, scaling, or formation damage. Monitoring this pressure difference can help identify potential wellbore issues and optimize injection strategies. In some embodiments, computing system 110 generates a correlation between injection rate and fluid properties. The viscosity and density of the injected fluid can affect injection rates and wellbore pressure. Understanding these relationships can help optimize injection strategies and minimize operational challenges. In some embodiments, computing system 110 generates a correlation between reservoir pressure and fluid production or injection. Reservoir pressure decline can lead to reduced production or injection rates. Maintaining reservoir pressure through injection can help sustain production and improve recovery factors.

Computing system 110 can use the correlations and derived metrics based on injection test data as inputs to AI model 534 during model training and post-training operation. For example, these parameters can be used as features to train AI model 534 for predicting reservoir performance, production or injection rates, and wellbore issues. Historical data on these parameters can be used to calibrate AI model 534 and improve its accuracy. Computing system 110 can also use input data such as injection rate, wellhead pressure, and bottomhole pressure as input parameters for reservoir simulation models (e.g., AI model 534) and can be used to history match reservoir simulation models, improving their predictive capabilities. In some embodiments, computing system 110 uses the injection test data for production optimization. For example, by analyzing the relationship between these parameters, computing system 110 can identify underperforming injection wells and optimize their operation. Computing system 110 can use these to optimize injection rates, well spacing, and injection patterns. Advantageously, by effectively utilizing injection test data and metrics/correlations derived therefrom, computing system 110 can optimize injection strategies, improve reservoir performance, and maximize hydrocarbon recovery.

In some embodiments, % flow/zone data include wireline test data. Wireline injection tests are a valuable tool for evaluating formation properties and well performance. Wireline injection rate tests typically involve pumping a radioactive tracer into the well, running a gamma ray log to determine initial receiving zones, then conducting another gamma ray log after normal injection operations have been conducted over a specified time period. This logging technique allows for the tracking of the volume and distance of the tracer over time, and determining such factors as flow paths, thief zones (highly permeable formations), cement channeling, perforated zones not receiving fluid. The data acquired during wireline injection tests can be used by computing system 110 to derive insights into reservoir characteristics and production or injection potential. Data collector 526 can gather wireline test data from various data sources 502 used to perform the wireline injection tests such as pressure gauges, temperature sensors, flow meters, and inclinometers. Computing system 110 can use the data collected from wireline injection tests to evaluate or estimate attributes of the formation (e.g., permeability, porosity, wellbore damage assessment, skin factor, stimulation effectiveness, etc.) and/or characterize the reservoir (e.g., reservoir heterogeneity, fluid saturation, etc.). Computing system 110 can use the data collected from wireline injection tests to make informed recommendations or predictions about well completion, stimulation, and production or injection strategies. This information can be used for optimizing field development plans and maximizing hydrocarbon recovery.

Computing system 110 can be configured to generate derived metrics based on the wireline test data. Such derived metrics may include, for example, formation permeability, skin factor, reservoir pressure, injection efficiency, and the wellbore storage coefficient. These derived metrics may be the same as described above with reference to the injection test data, with the exception that they are based on the wireline test data instead of the injection test data. Computing system 110 can be configured to use the metrics derived from wireline test data for several purposes such as reservoir characterization, well performance evaluation, production or injection optimization, enhanced oil recovery (EOR), and reservoir simulation, in the same manner as the metrics derived from the injection test data as previously described.

In some embodiments, computing system 110 identifies or generates correlations between wireline test data and other data sources 502. For example, computing system 110 can generate a correlation between injection rate and wellbore pressure. Higher injection rates can lead to increased wellbore pressure due to increased flow resistance. The relationship between injection rate and wellbore pressure can provide insights into formation permeability. In some embodiments, computing system 110 generates a correlation between wellbore pressure and formation pressure. The difference between wellbore pressure and formation pressure represents the pressure drop across the wellbore and formation. A significant pressure drop can indicate the presence of wellbore damage, such as skin or permeability reduction. In some embodiments, computing system 110 generates a correlation between injection rate and fluid properties. The viscosity of the injected fluid can affect injection rates and wellbore pressure. The density of the injected fluid can impact the pressure distribution within the formation. In some embodiments, computing system 110 generates a correlation between formation pressure and reservoir properties. Formation pressure is a key indicator of reservoir pressure and can be used to assess reservoir depletion. Formation pressure can be used to estimate reservoir permeability and porosity, which are important for understanding fluid flow and production or injection potential.

Computing system 110 can use the correlations and derived metrics based on wireline test data as inputs to AI model 534 during model training and post-training operation. For example, these parameters can be used as features to train AI model 534 for predicting reservoir performance and wellbore issues. Historical data from wireline injection tests can be used to calibrate AI model 534 and improve its accuracy. Computing system 110 can use data from wireline injection tests, such as permeability, porosity, and skin factor, as input parameters for reservoir simulation models. Wireline injection test data can also be used to history match reservoir simulation models, improving their predictive capabilities. Computing system 110 can analyze the relationship between injection rate and wellbore pressure to identify potential wellbore damage and implement appropriate remedial actions. Computing system 110 can also analyze pressure transient data to estimate formation permeability and optimize production and injection strategies. Advantageously, by effectively utilizing wirelines test data and metrics/correlations derived therefrom, computing system 110 can optimize injection strategies, improve reservoir performance, and minimize operational risks.

In some embodiments, % flow/zone data include tracer test data. Tracer tests are a tool for studying fluid flow patterns and reservoir connectivity. By injecting a tracer into the wellbore and monitoring its movement through the reservoir, engineers can gain valuable insights into reservoir heterogeneity, permeability distribution, and well interference. Data collector 526 can acquire tracer test data from various equipment used to conduct the tracer test and/or monitor the well operations during the tracer test. For example, data sources of the tracer test data may include tracer injection, production sampling, and pressure and flow rate measurements. Computing system 110 can use the data obtained from tracer tests to characterize attributes of the reservoir (e.g., permeability distribution, reservoir heterogeneity, etc.), evaluate well interference (e.g., inter-well communication, waterflood efficiency, etc.) and in enhanced oil recovery (EOR) techniques (e.g., chemical flood efficiency, miscible gas injection, etc.). Advantageously, computing system 110 can use the data collected from tracer tests to optimize production and injection strategies, improve recovery factors, and make informed decisions or recommendations about field development and management.

Computing system 110 can be configured to generate derived metrics based on the tracer test data. Such derived metrics may include, for example, porosity, permeability, dispersion coefficient, pore volume, and inter-well connectivity. Porosity measures the void space in a rock formation and influences fluid storage capacity. Computing system 110 can calculate porosity by analyzing the tracer breakthrough curve. Permeability measures the ability of a rock to transmit fluids and is an important parameter reservoir engineering. Computing system 110 can calculate permeability by analyzing the tracer breakthrough curve and pressure transient data. The dispersion coefficient quantifies the spreading of the tracer as it moves through the reservoir. Computing system 110 can estimate the dispersion coefficient by analyzing the tracer concentration profile. Pore volume is the total volume of pore space in a reservoir. Computing system 110 can estimate pore volume from the tracer breakthrough curve and injection volume. Inter-well connectivity measures the degree of communication between different wells. Computing system 110 can estimate inter-well connectivity by analyzing the arrival time of the tracer at different production wells.

Computing system 110 can be configured to use the metrics derived from tracer test data for several purposes such as reservoir characterization, well performance evaluation, production and injection optimization, enhanced oil recovery (EOR), and reservoir simulation, in the same manner as the metrics derived from the injection test data as previously described. Advantageously, computing system 110 can use the metrics derived from tracer test data to make informed decisions or recommendations about field development, production and injection optimization, and reservoir management.

In some embodiments, computing system 110 identifies or generates correlations between tracer test data and other data sources 502. For example, computing system 110 can generate a correlation between tracer concentration and time. The time it takes for the tracer to reach an injection or production well can provide information about the distance between injection and production wells and the permeability of the formation. The spread of the tracer over time can indicate the degree of dispersion within the reservoir. In some embodiments, computing system 110 generates a correlation between injection rate and tracer breakthrough time. Higher injection rates can lead to faster tracer breakthrough times. The relationship between injection rate and breakthrough time can be used to estimate reservoir permeability. In some embodiments, computing system 110 generates a correlation between tracer concentration and reservoir heterogeneity. Variations in tracer concentration can indicate the presence of heterogeneities, such as permeability variations or fractures. Tracer can preferentially flow through high-permeability zones, leading to early breakthrough in certain production wells. In some embodiments, computing system 110 generates a correlation between reservoir pressure and tracer movement. Pressure gradients within the reservoir can influence the direction and speed of tracer movement. Changes in reservoir pressure can affect fluid flow patterns and tracer transport.

Computing system 110 can use the correlations and derived metrics based on tracer test data as inputs to AI model 534 during model training and post-training operation. For example, tracer breakthrough time, tracer concentration, and injection rate can be used as features to train AI model 534 for predicting reservoir performance and fluid flow. Historical tracer test data can be used to calibrate machine learning models and improve their accuracy. Computing system 110 can also use tracer test data for reservoir simulation. For example, tracer test data can be used to calibrate reservoir simulation models, including parameters like permeability, porosity, and dispersion coefficients. By matching simulated tracer breakthrough curves with observed data, computing system 110 can improve the accuracy of reservoir simulation models (e.g., AI model 534). Computing system 110 can also use tracer test data for production optimization. For example, tracer test data can help identify inter-well interference and optimize well spacing, as well as production or injection rates. Tracer tests can be used to evaluate the effectiveness of EOR techniques, such as waterflooding and gas injection. Advantageously, by effectively utilizing injection test data and metrics/correlations derived therefrom, computing system 110 can optimize production or injection strategies, improve reservoir performance, and minimize operational risks.

In some embodiments, engineering data sources 512 include well history data. Data collector 526 can obtain well history data from physical media (e.g., clients, libraries, etc.) or online public and private databases (e.g., Texas RRC, Enverus, S&P Global, etc.). In some embodiments, well history data is uploaded directly by client system 106. Examples of well history data include dates, activities, and ownership. Dates may include the dates at which the activities occur and establish a timeline for operation purposes. Computing system 110 can use the description of well activities over time to identify wellsite operations and items such as new perforations, new stimulation, fluid movement from zones, etc. Computing system 110 can use the ownership history to infer various attributes or operational parameters of the well, for example, based on an established pattern or philosophy of various owners or companies with respect to well production and injection.

In some embodiments, engineering data sources 512 include daily activity. Daily activity data may indicate the current operational status of drilling rigs, production or injection wells, and processing facilities, including details such as fluid volumes extracted, pressure readings, equipment performance, and any operational incidents. Computing system 110 can use daily activity data as inputs to AI model 534 to allow for real-time monitoring, early detection of potential issues, optimization of production or injection strategies, and informed decision-making to maximize efficiency and profitability while minimizing safety risks. Daily activity data can be obtained from client system 106 or well histories kept by well operators. In some embodiments, daily activity data includes service/repair data, well test data, and/or downtime data. Example data points in a daily activity report may include the well ID, oil production or injection volume (barrels), gas production volume (MCF), water production volume (barrels), wellhead pressure, flow rate, pump status, equipment operating parameters (e.g., temperature, vibration), safety incidents reported, well tests, maintenance, downtime, etc.

Computing system 110 can use daily activity data to track daily oil and gas production volumes and identify trends, potential declines in production, and areas needing intervention. In some embodiments, computing system 110 uses daily activity data for well performance analysis. For example, monitoring wellhead pressure, flow rates, and fluid composition allows computing system 110 to make timely adjustments to optimize well performance and prevent issues like water breakthrough. In some embodiments, computing system 110 uses daily activity data for equipment health assessment. For example, data on equipment parameters such as vibration levels, temperature readings, and motor current can indicate potential equipment failures, enabling preventative maintenance. In some embodiments, computing system 110 uses daily activity data for safety monitoring. For example, tracking safety-related data such as safety incidents, near misses, and personnel movements helps computing system 110 identify high-risk areas and implement preventive measures. In some embodiments, computing system 110 uses daily activity data for environmental compliance. For example, monitoring emissions and discharge volumes allows computing system 110 to ensure adherence to environmental regulations.

Computing system 110 can use the daily activity data as inputs to AI model 534 during model training and post-training operation. AI model 534 can use the daily activity data for predictive analytics, to optimize wellsite operations, and to generate alerts or recommendations. For example, AI model 534 can analyze historical data to predict future trends, potential problems, and optimal operating conditions. AI model 534 can use real-time data to dynamically adjust operational parameters and optimize production or injection strategies. AI model 534 can generate alerts when critical parameters deviate from normal ranges, enabling prompt intervention.

In some embodiments, engineering data sources 512 include operation intervals. Data collector 526 can obtain operation interval data through physical copies (e.g., scout tickets, daily activity reports, etc.) gathered from the client or library. Operation interval data can also or alternatively be obtained from online data centers (e.g., TX RRC, University Lands, NM OCD, Enverus, S&P Global, etc.). Operation interval data may include a variety of different information about the well or wellbore such as perforated depths, casing intervals, tubing intervals, bridge plugs, and cemented intervals.

In some embodiments, the operation interval data includes perforated depth data. Perforated depth data may indicate the specific depth range within a wellbore where perforations (i.e., holes drilled through the casing) are allowed to be made. Perforated depths may define the productive or injective zone of the reservoir. Computing system 110 can use the perforated depths as an input to AI model 534 because such information directly influences the well's potential production or injection rate and helps optimize completion design. For example, ensuring perforations are placed within the most productive reservoir section helps in maximizing hydrocarbon recovery while minimizing potential damage to the formation.

Computing system 110 can use perforated depth data for various purposes such as reservoir targeting, production and injection optimization, well completion design, and risk mitigation. For example, computing system 110 can use the precise depth of the productive or injection zone as an input to AI model 534 to allow AI model 534 to accurately target the best reservoir intervals for perforation placement, maximizing contact with the hydrocarbon reservoir. By accurately placing perforations within the permitted depth range, AI model 534 can optimize well flow rates and minimize unwanted influx of water or gas from other formations. Computing system 110 can use the well completion design data designing the completion string (e.g., as a type of recommendation generated by computing system 110), including the number and spacing of perforations, which directly impact the efficiency of hydrocarbon extraction or injection. Computing system 110 can use the permitted perforation depth data to identify potential geological complexities or pressure variations within the reservoir, allowing for adjustments in the completion design to mitigate risks.

Computing system 110 can be configured to generate or calculate various derived metrics based on the perforated depths data in combination with other data sources 502. Such derived metrics may include calculated values that combine information from various well logging tools (e.g., pressure, temperature, porosity, resistivity, sonic logs, etc.) to provide a more comprehensive understanding of the reservoir's productivity potential and the effectiveness of the perforation design. Computing system 110 can use these derived metrics to generate insights beyond individual log data points, allowing for better decision-making regarding completion design and reservoir management. Examples of derived metrics for perforations include net pay thickness, effective permeability, perforation efficiency, hydraulic fracturing efficiency, and perforation damage factor. Computing system 110 can calculate net pay thickness by combining porosity and formation thickness data to determine the actual productive interval within a reservoir. Computing system 110 can derive effective permeability from pressure gradient, porosity, and formation resistivity data, providing a measure of the reservoir's ability to flow hydrocarbons. Computing system 110 can calculate perforation efficiency by comparing the actual flow rate from a perforated interval to the potential flow rate based on reservoir properties, indicating how well the perforations are accessing the reservoir. Computing system 110 can derive hydraulic fracturing efficiency from pressure data before and after a fracturing job, assessing the effectiveness of the stimulation treatment. Computing system 110 can calculate perforation damage factor by comparing pressure drop across the perforated interval to the pressure drop in an undamaged formation, identifying potential damage caused by the perforation process.

Computing system 110 can use the perforated depths data and/or derived metrics based on the perforated depths data to conduct various activities such as improved reservoir characterization, optimized completion design, identification of issues, and performance monitoring. For example, computing system 110 can use the derived metrics to provide a more holistic view of the reservoir, enabling better prediction of production or injection performance. Computing system 110 can use the derived metrics to design perforations that effectively access the reservoir and maximize production and injection potential. Computing system 110 can use the derived metrics to highlight potential problems such as formation damage, poor perforation placement, or inadequate stimulation treatments, facilitating corrective actions. Computing system 110 can track changes in derived metrics over time to monitor well performance and identify potential decline mechanisms.

Computing system 110 can be configured to identify or derive correlations between the perforated depths data and other data sources 502. Examples of such correlations include correlations between the perforated depths data and reservoir pressure, formation thickness, porosity, permeability, wellbore inclination, as well as production or injection data (e.g., flow rates, pressure drawdown), as these factors directly influence the optimal perforation placement and ultimately, the production or injection performance of a well. For example, computing system 110 can generate a correlation between formation thickness and perforation density. Thicker formations may require more perforation intervals to adequately access the reservoir, while thinner formations might need fewer perforations to avoid excessive fluid influx. Computing system 110 can generate a correlation between porosity and permeability. High porosity and permeability zones within a reservoir often correspond to locations where perforations should be concentrated to maximize production or injection potential. Computing system 110 can generate a correlation between reservoir pressure and perforation placement. Perforations should be positioned within the appropriate pressure gradient of the reservoir to ensure efficient fluid flow and prevent premature water influx. Computing system 110 can generate a correlation between wellbore inclination and perforation orientation. In deviated wells, the perforation orientation needs to be carefully designed to optimize fluid flow based on the wellbore angle. Computing system 110 can generate a correlation between production or injection data and perforation optimization. For example, computing system 110 can analyze production and injection data (e.g., flow rates, pressure drawdown) after perforation to refine future perforation designs in similar wells, identifying areas where adjustments to perforation placement or density could improve production or injection.

Computing system 110 can use the correlations and derived metrics based on perforated depths data as inputs to AI model 534 during model training and post-training operation. For example, incorporating these data sources into AI model 534 allows AI model 534 to make predictions about the optimal perforation depth and density for a new well based on its geological and reservoir characteristics. Computing system 110 can also integrate these correlations into optimization algorithms used by wellsite optimizer 540 to identify the most efficient perforation design for a specific well considering various production or injection constraints. In some embodiments, computing system 110 adjusts the correlations depending on specific geological formation and reservoir characteristics. Additionally, computing system 110 can combine perforation data with other relevant data such as drilling logs, seismic interpretations, and reservoir simulation results can further enhance the accuracy of AI model 534

In some embodiments, the operation interval data includes casing intervals. Casing intervals may indicate the depth ranges within a wellbore where casing pipes are installed. Casing intervals may provide information about the geological formations encountered during drilling and indicate potential challenges in production or injection. Computing system 110 can use casing intervals as an input to AI model 534 to optimize well design, predict drilling complications, and plan completion strategies.

Computing system 110 can use casing interval data for various purposes such as formation identification, ensuring well integrity, drilling optimization, production or injection planning, and risk mitigation. For example, the depth of casing intervals corresponds to different geological formations with varying pressure, temperature, and rock properties. Computing system 110 can use this information to identify zones requiring additional support or potential instability issues. With respect to well integrity, casing is typically installed to stabilize the wellbore and prevent fluid migration between formations. Computing system 110 can analyze casing intervals to assess the structural integrity of the well and identify potential areas where casing could be compromised. In some embodiments, computing system 110 uses the location and depth of casing intervals to plan appropriate drilling mud programs, select suitable drilling fluids, and determine the required casing sizes for each formation. Computing system 110 can use casing intervals to determine zones in which pressure changes and wellbore stability issues become problematic. In some embodiments, computing system 110 uses casing intervals to determine which formations and zones have been shut off or isolated from the rest of the well. Computing system 110 can use casing intervals for production or injection planning by determining the perforated zones within a well, which directly impact the production or injection from specific reservoir intervals. In some embodiments, computing system 110 analyzes casing intervals to identify potential hazards such as high-pressure zones, unstable formations, or gas migration, allowing for preventative measures to be taken during drilling and completion operations.

In some embodiments, computing system 110 uses casing interval data to train and operate AI model 534. For example, AI model 534 can use casing interval data to run a geomechanical model simulation of the stress distribution around the wellbore and predict potential instability issues. AI model 534 can use casing interval data to optimize drilling parameters such as mud weight, rotary speed, and bit selection depending on the formation properties. In some embodiments, AI model 534 can use the casing depths to generate model predictions or recommendations of appropriate completion strategies, including the placement of perforations within reservoir quality formations.

Computing system 110 can be configured to generate or calculate various derived metrics based on the casing interval data in combination with other data sources 502 such as production or injection logs, pressure gauges, reservoir simulations, and well test data. These derived metrics may allow for a more comprehensive understanding of a well's performance and may include metrics such as “net pay thickness” or “effective permeability” which cannot be directly measured from a single source. These derived metrics may include casing intervals that correspond to the specific depth range of the casing string in a well where the relevant data is being used for the calculation. Computing system 110 can be configured to generate these derived metrics by performing calculations using data pulled from multiple sources, such as pressure readings at different depths, formation tops, and fluid properties, to provide a holistic picture of a well's behavior.

Examples of derived metrics and their casing intervals include net pay thickness, effective permeability, and water cut. Computing system 110 can calculate net pay thickness by combining formation top data and porosity/permeability information within a specific casing interval to determine the productive thickness of a reservoir. Computing system 110 can derive effective permeability by utilizing pressure data from multiple depths within a casing interval, along with fluid properties, to calculate the permeability of the reservoir considering the specific conditions. Computing system 110 can compute water cut by analyzing fluid production or injection data at different depths within a casing interval to estimate the percentage of water produced relative to oil. In some embodiments, computing system 110 calculates these derived metrics within certain casing intervals to ensure the analysis is relevant to the targeted zone of the well, given that data is often collected at specific casing depths. Advantageously, by utilizing data only within the relevant casing interval, the derived metrics better reflect the conditions in that specific zone of the well, leading to more accurate analysis. Computing system 110 can use variations in derived metrics across different casing intervals to make informed decisions or recommendations about production and injection optimization, well interventions, and reservoir management strategies.

Computing system 110 can be configured to identify or derive correlations between the casing interval data and other data sources 502. Examples of such correlations include correlations between the casing interval data and well log data (e.g., gamma ray, resistivity, sonic, etc.), formation pressure data, drilling mud properties, casing design parameters (e.g., size, grade, weight, etc.), depth intervals, geological information (e.g., formation tops, lithology, etc.), and well completion details (e.g., perforation intervals, production or injection data, etc.). These elements can collectively provide insights into potential casing issues, such as stress concentrations, cement bond quality, and production and injection performance within specific depth ranges.

For example, computing system 110 can generate a correlation between formation properties and casing design. Computing system 110 can analyze the correlation between formation lithology (identified through well logs) and casing size/grade to predict potential casing failures due to high stress formations. In some embodiments, computing system 110 can generate a correlation between cement bond quality and well log data. Computing system 110 can compare cement bond logs to other well logs like gamma ray or resistivity to identify areas of poor cement bond, potentially impacting production, injection, or casing integrity. In some embodiments, computing system 110 can generate a correlation between drilling mud properties and casing wear. Computing system 110 can correlate variations in mud properties such as viscosity or density can with casing wear and potential damage during drilling operations. In some embodiments, computing system 110 can generate a correlation between production or injection data and casing intervals. For example, computing system 110 can analyze production or injection rates from different perforated intervals within a well to highlight issues related to casing placement or perforations within specific depth ranges. In some embodiments, computing system 110 can generate depth-related correlations. For example, computing system 110 can examine how different data points change with depth to identify trends and potential issues associated with certain casing intervals.

Computing system 110 can use the correlations and derived metrics based on casing interval data as inputs to AI model 534 during model training and post-training operation. For example, incorporating these data sources into AI model 534 allows AI model 534 to learn complex relationships between casing intervals and potential problems. Model trainer 530 can train AI model 534 to predict casing failures or production or injection issues based on the combined analysis of well log data, formation pressure, casing design, and other relevant parameters. AI model 534 can be trained to identify high-risk casing intervals through data analysis to facilitate proactive decision-making regarding well design and completion strategies.

In some embodiments, the operation interval data includes tubing intervals. Tubing intervals may indicate the specific depth ranges within a wellbore where the production or injection tubing is located. For example, tubing interval data may include the top and bottom depths of each tubing interval. In some embodiments, tubing interval data are paired with other measurements such as flow rate, pressure, and fluid composition for each interval. The design of the well completion, including the number and placement of perforations within each interval, significantly impacts production or injection performance. Accordingly, tubing intervals may provide information about the productive zones of a well and allow AI model 534 to accurately predict and optimize oil/gas production along with well injection operations by identifying which intervals contribute most to the overall flow rate. Tubing intervals may also allow AI model 534 to recommend targeted interventions such as pressure monitoring or stimulation treatments within those specific zones.

Computing system 110 can use tubing interval data for various purposes such as production or injection forecasting, well optimization, downhole pressure management, intervention planning, and reservoir characterization. For example, computing system 110 determine which tubing intervals are most productive and train AI model 534 to accurately predict future production or injection volumes and plan for necessary maintenance or upgrades. Computing system 110 can analyze tubing interval data to identify potential issues such as water influx or gas coning within specific zones, enabling targeted interventions to maximize production or injection efficiency. Computing system 110 can use the tubing interval data for downhole pressure management by monitoring and managing pressure at different levels within the wellbore, which can help prevent unwanted pressure fluctuations. When considering interventions such as acidizing or fracturing, computing system 110 can use the tubing interval data to pinpoint the exact location where these treatments should be applied for maximum impact. In some embodiments, computing system 110 uses the tubing interval data for reservoir characterization. For example, computing system 110 can analyze production or injection data across different tubing intervals to provide insights into the reservoir's characteristics (e.g., fluid contact and pressure gradients), which are important for reservoir management.

Computing system 110 can be configured to generate or calculate various derived metrics based on the tubing interval data. Such derived metrics may provide a comprehensive assessment of the overall health and performance of a wellbore section by combining tubing interval data with information from other data sources 502 such as pressure, temperature, production or injection rate, fluid analysis, and downhole logging data. This is significant because it allows for a more holistic understanding of potential issues within a specific tubing interval, enabling proactive maintenance and optimization strategies to maximize production or injection and minimize downtime.

Examples of derived metrics based on tubing intervals include pressure gradient, production efficiency factor (PEF), injection efficiency factor (IEF), fluid contact index (FCI), tubing wear index (TWI), and downhole flow profile. Computing system 110 can calculate the pressure gradient by combining pressure data at different depths. The pressure gradient indicates the pressure change per unit depth and can help identify potential pressure anomalies, leaks, or fluid level issues within the tubing interval. Computing system 110 can derive the PEF from production rate and flowing pressure. PEF measures how efficiently a well is producing oil and gas, allowing for comparison between different tubing intervals and identification of areas with lower efficiency requiring optimization. Computing system 110 can calculate the FCI using pressure and fluid analysis data. FCI provides insight into the interface between oil, gas, and water within the tubing, which is critical for managing wellbore dynamics and preventing problems like gas coning. Computing system 110 can estimate the TWI based on pressure, flow rate, and pipe material properties. TWI indicates the potential for wear and corrosion on the tubing string, helping to predict the need for tubing replacement or repair. Computing system 110 can derive the downhole flow profile from pressure and temperature data at different depths. This metric provides information about the flow pattern within the tubing, enabling identification of potential restrictions or uneven flow distribution.

Computing system 110 can use these and other derived metrics based on the tubing interval data for early detection of issues, data-driven decision making, and performance monitoring. For example, computing system 110 can use the derived metrics to identify potential problems within a tubing interval before they become major operational issues, allowing for preventative maintenance. Computing system 110 can use the derived metrics as a quantitative basis for making informed decisions regarding well interventions, production or injection optimization, and asset management strategies. Computing system 110 can track the derived metrics over time to monitor the health of a tubing interval and identify trends that may indicate declining performance or emerging problems.

In some embodiments, computing system 110 can be configured to identify or derive correlations between the tubing interval data and other data sources 502. Examples of such correlations include correlations between the tubing interval data and well log data (e.g., porosity, permeability, formation pressure, etc.), production or injection data (e.g., flow rate, pressure, fluid composition), pressure transient analysis results, downhole gauge data (e.g., pressure, temperature, etc.), and geological information (e.g., formation thickness, lithology). Computing system 110 can use these correlations to infer characteristics such as flow regime, pressure drop, and potential production or injection issues within specific tubing intervals, allowing for more accurate model predictions.

In some embodiments, computing system 110 can generate a correlation between production or injection data and well log data. Computing system 110 can analyze how production or injection rates and pressures at different depths within a well correlate with reservoir properties such as porosity and permeability to identify zones with high production or injection potential and potential flow restrictions within the tubing interval. In some embodiments, computing system 110 can generate a correlation between pressure transient analysis and tubing geometry. For example, computing system 110 can compare pressure transient data with the size and length of tubing sections to identify issues such as wellbore storage effects or potential for liquid loading within a specific tubing interval. In some embodiments, computing system 110 can generate a correlation between downhole gauge data and fluid composition. For example, computing system 110 can monitor pressure and temperature profiles along the tubing string, combined with fluid analysis, to identify flow regime transitions (e.g., gas-liquid, liquid-liquid) within specific tubing intervals, impacting production and injection optimization.

In some embodiments, computing system 110 ensures all data sources are accurate, consistent, and well-calibrated for meaningful correlations. Computing system 110 may consider the spatial resolution of each data source, as well as the depth intervals they represent, to accurately match data points for analysis. When analyzing production or injection data, computing system 110 may consider the temporal variations and trends to identify potential changes in flow characteristics within specific tubing intervals. For example, computing system 110 can predict pressure drop by correlating well log data (e.g., porosity, permeability) with production or injection data (e.g., flow rate, pressure) across multiple tubing intervals. Model trainer 530 can use this comparison or correlation to train AI model 534 to predict pressure drop within new wells based on their geological characteristics, enabling optimal production and injection planning.

In some embodiments, the operation interval data includes bridge plug data. Bridge plug data may indicate the pressure, depth, and integrity of the wellbore isolation created by the plug. For example, the pressure data may indicate the effectiveness of the plug in sealing off a specific zone. Computing system 110 can use the pressure data to ensure proper pressure control during operations in other zones of the well. The depth data may indicate the precise location of the bridge plug within the wellbore. Computing system 110 can use the depth data for targeted treatments and accurate interpretation of pressure readings. The bridge plug data may include a setting pressure which indicates the pressure required to set the plug. Computing system 110 may use the setting pressure to provide insights into formation pressure and potential challenges during plug deployment. In case of retrievable plugs, the bridge plug data may include data on the ease of retrieval. Computing system 110 can use the retrievability data to assess the potential for complications during well intervention operations.

Computing system 110 can use bridge plug data to train AI model 534. Advantageously, using bridge plug data to train AI model 534 allows AI model 534 to make accurate predictions of well performance, optimize drilling operations, and mitigate potential risks associated with pressure control and zonal isolation during various well interventions like testing, stimulation, or production or injection from different formations within a single well. For example, model trainer 530 can train AI model 534 using bridge plug data from multiple bridge plugs in different wells to enable AI model 534 to predict optimal plug placement and design to achieve efficient zonal isolation for specific formations and drilling conditions. Computing system 110 can use the bridge plug data to identify potential issues such as high setting pressure or difficulty in retrieving plugs and identify areas of concern in future drilling plans and mitigate associated risks. Computing system 110 can use the bridge plug data to determine pressure levels in isolated zones and generate more reliable predictions of production or injection rates and well behavior over time. In some embodiments, computing system 110 uses the bridge plug data to inform decisions about the type and volume of stimulation treatments needed in specific zones, optimizing treatment effectiveness.

Computing system 110 can be configured to generate or calculate various derived metrics based on the bridge plug data. Such derived metrics may include “estimated sealing pressure” which combines data from the plug design (e.g., diameter, length, material properties), wellbore pressure, and formation pressure to predict the pressure at which the plug will effectively seal against fluid flow. Computing system 110 can use this information to evaluate well integrity and safety during operations such as abandonment or isolation. Other examples of derived metrics for bridge plugs may include effective sealing area, shear strength factor, and expected setting time. Computing system 110 can calculate effective sealing area by considering the plug's contact area with the wellbore wall and assess the overall sealing capacity. Computing system 110 can derive the shear strength factor from the plug material properties and wellbore conditions. The shear strength factor may indicate the plug's resistance to shearing forces during pressure fluctuations. Computing system 110 can estimate the expected setting time for the plug to fully set based on the cementing fluid properties and wellbore temperature, which may be used for planning well operations.

Computing system 110 can use these and other derived metrics based on the bridge plug data for various purposes such as risk mitigation, optimized well completion, and data-driven decision making. For example, by estimating the sealing pressure, computing system 110 can identify potential issues such as insufficient plug design or high formation pressure that could lead to leaks or blowouts, allowing for necessary adjustments to the plug configuration before deployment. Computing system 110 can use the optimized well completion to select the appropriate bridge plug size and material for specific well conditions, ensuring effective isolation while minimizing unnecessary cost associated with oversized plugs. Computing system 110 can combine data from various sources to provide a more comprehensive understanding of the wellbore environment, enabling informed decisions regarding well control and plugging procedures.

In some embodiments, computing system 110 can be configured to identify or derive correlations between the bridge plug data and other data sources 502. Relevant data sources to connect for model training or operation include the type of bridge plug, bridge or cement plug depths, cement plug volume pumped, type of cement, etc. Computing system 110 can use this information to determine what intervals have been plugged of from active portions of the well, and how it was conducted. Computing system 110 can use this data to determine pressure regimes within the well, active operation intervals, and for well history analysis.

In some embodiments, the operation interval data includes cemented intervals. Cemented intervals may indicate the depth and quality of cement placement around the casing. Cemented intervals may be important for a well's integrity and production or injection efficiency because they prevent fluid migration between formations, protect the casing from pressure fluctuations, and ensure proper well control. Cemented interval data may include various attributes of cemented intervals within the well such as depth, cement bond quality, cement thickness, and anomalies. The depth may indicate the precise location of the cemented zone within the borehole and can be used by computing system 110 to determine where the well is properly secured and where potential risks might exist. The cement bond quality may be based on data from cement logging tools that indicate the strength of the cement bond to the formation. The cement bond quality may indicate areas where the cement may not be adequately adhering, potentially allowing fluid flow between formations. The cement thickness may indicate the thickness of the cement sheath and provides information on the level of protection offered to the casing, with thicker cement generally signifying better isolation. Anomalies may include irregularities in the cementing profile (e.g., voids or channels). Computing system 110 can identify such anomalies and initiate corrective actions to address potential problems before they cause major issues.

In some embodiments, computing system 110 uses cemented interval data as input to AI model 534 to allow AI model 534 to accurately predict potential issues such as cementing failures, which could lead to costly repairs or environmental damage. AI model 534 can use cementing data to generate model predictions indicating optimal placement of cement plugs and optimal casing designs based on the specific geological conditions. AI model 534 can integrate cement data with other well logs to identify high-risk zones with potential for cementing failures, allowing for preventative measures to be taken. AI model 534 can use the cement integrity to predict well production or injection performance, as poor cementing can lead to unwanted fluid influx or pressure imbalances.

Computing system 110 can be configured to generate or calculate various derived metrics based on the cemented intervals data. Derived metrics calculated from cemented intervals within a wellbore represent a comprehensive evaluation of the cement job quality by combining information from various logging tools, pressure tests, and other measurements. These derived metrics provide a more holistic understanding of the cement bond strength and integrity across the cemented section than the raw data alone. Computing system 110 can use these derived metrics for ensuring proper zonal isolation and preventing fluid migration and to identify potential issues with the cementing operation that may not be apparent from a single data source alone. Examples of derived metrics for cemented intervals include a cement bond index (CBI), cement quality factor (CQF), and casing-to-formation pressure gradient (CFPG). The CBI is a calculated value combining information from sonic and density logs to indicate the overall cement bond quality across an interval. The CQF is a metric that incorporates multiple parameters such as cement thickness, acoustic impedance contrast, and pressure test results to evaluate the overall cement integrity. The CFPG is a derived metric calculated from pressure tests at different depths, indicating potential zonal isolation issues based on pressure gradients across the cemented interval.

By incorporating data from various sources such as sonic logs, density logs, caliper logs, pressure tests, and cement bond logs, computing system 110 can generate these and other derived metrics that can reveal inconsistencies or anomalies that might indicate poor cement placement, channeling, or inadequate bonding to the casing and formation. In some embodiments, the derived metrics improve data interpretation by providing a single, quantitative value representing the overall cement quality within a specific interval. Such derived metrics may facilitate comparing different sections of the wellbore and identifying areas requiring further investigation or remedial actions. In some embodiments, computing system 110 uses the derived metrics to identify potential issues early and proactively address problems such as casing leaks, fluid migration between formations, and potential production or injection losses, thereby reducing the risk of wellbore complications.

In some embodiments, computing system 110 can be configured to identify or derive correlations between the cemented intervals data and other data sources 502. Relevant data sources to connect for model training or operation include the type of bridge plug, bridge or cement plug depths, cement plug volume pumped, type of cement, etc. Computing system 110 can use this information to determine what intervals have been plugged off from active portions of the well, and how it was conducted. Computing system 110 can use this data to determine pressure regimes within the well, active operation intervals, and for well history analysis.

Referring particularly to FIG. 10B, in some embodiments, engineering data sources 512 include seismic hazard analysis (SHA) data. SHA data may include seismic source characterization data such as magnitude frequency distribution, Gutenberg-Richter relationships, slip rates, and slip recurrence. Data collector 526 can obtain seismic source characterization data from broadband and borehole seismometers, which may provide a continuous recording of ground velocity in three components or orthogonal directions (e.g., N-S, E-W, up-down). Seismic source characterization data may capture seismic activity and source characteristics to understand earthquake mechanisms. In some embodiments, seismic source characterization data include various attributes of seismic events such as magnitude (Mw) representing total energy released, seismic moment indicating earthquake size, frequency of events indicating seismic activity rate, and/or a b-value indicating the relative frequency of small to large earthquakes. Computing system 110 can be configured to correlate seismic source characterization data with operational data and geological conditions to associate injection activities with resulting seismic responses.

In some embodiments, SHA data includes ground motion prediction equation (GMPE) data. GMPE data may provide an estimate of the intensity of ground shaking at a specific location based on the magnitude of an earthquake, distance from the epicenter, and local geological conditions. GMPE data may include attenuation relationships and weights indicated by ground motion data. Computing system 110 can use GMPE data to predict ground motion intensity based on source, path, and site effects for use in hazard assessment (e.g., as model predictions of AI model 534). In some embodiments, computing system 110 correlates GMPE data with other data sources 502 such as peak ground acceleration (PGA) indicating a maximum ground acceleration during shaking, spectral acceleration (Sa) indicating a maximum acceleration experienced by structures, and/or cumulative absolute velocity (CAV), which indicates potential for structural damage.

In some embodiments, SHA data includes site conditions. Site conditions may define site-specific conditions such as soil type, rock properties, and fault structures impacting seismic response.

Site conditions may include temporal evolution of seismic rates, topography, and soil classification. Site conditions can be obtained from geological and geophysical surveys, field surveys, borehole data, remote sensing, and/or MT surveys. In some embodiments, computing system 110 correlates site conditions with other data sources 502 or metrics such as a soil amplification factor indicating how local geology affects shaking intensity, seismic velocity profiles characterizing subsurface structure, and/or 3D conductivity models indicating subsurface fluid pathways.

In some embodiments, SHA data includes a logic tree structure. The logic tree structure captures epistemic uncertainty by considering multiple models and assumptions. In some embodiments, the logic tree structure includes integrated seismic hazard models using various GMPEs and source data. The logic tree structure may include alternate models and branch weights. In some embodiments, the logic tree structure is obtained from probabilistic models. In some embodiments, computing system 110 correlates the logic tree structure with other data sources 502 or metrics such as branching probabilities quantifying a likelihood of different model choices and/or alternative models for seismic source characterization and GMPEs, which represent a range of scientific interpretations.

In some embodiments, SHA data includes a time period of interest. The time period of interest provides a temporal context to assess changes in seismic activity over time. Data collector 526 can obtain the time period of interest from archives, real-time monitoring systems, or earthquake catalogs. Computing system 110 can use the time period of interest to identify induced events based on a temporal relationship between the injection site activities and subsequent seismic activities. Computing system 110 can use the time period of interest to generate a frequency-magnitude distribution which describes earthquake size distribution and/or temporal seismicity trends which identify changes in seismic patterns over time. Advantageously, computing system 110 can use the time period of interest to correlate operational changes with seismic activity temporally, which allows for attributing seismicity to human activities that occur prior in time.

In some embodiments, SHA data includes probability levels. Probability levels quantify seismic risks based on defined probability levels of exceedance. In some embodiments, the probability levels are expressed as a likelihood of a seismic event occurring within a given time period (e.g., % per year). Data collector 526 can obtain the probability levels from a statistical analysis of historical seismicity and GMPE predictions. In some embodiments, computing system 110 uses the probability levels to generate derived data or other outputs such as hazard curves and return periods. Hazard curves relate ground motion levels to annual exceedance probabilities, whereas return periods indicate an average time between events of a given size. Advantageously, computing system 110 can use probabilistic models (e.g., AI model 534) to connect seismicity data to risk assessments, which allows for decision-making in induced seismicity contexts.

### Aerospace Data Sources

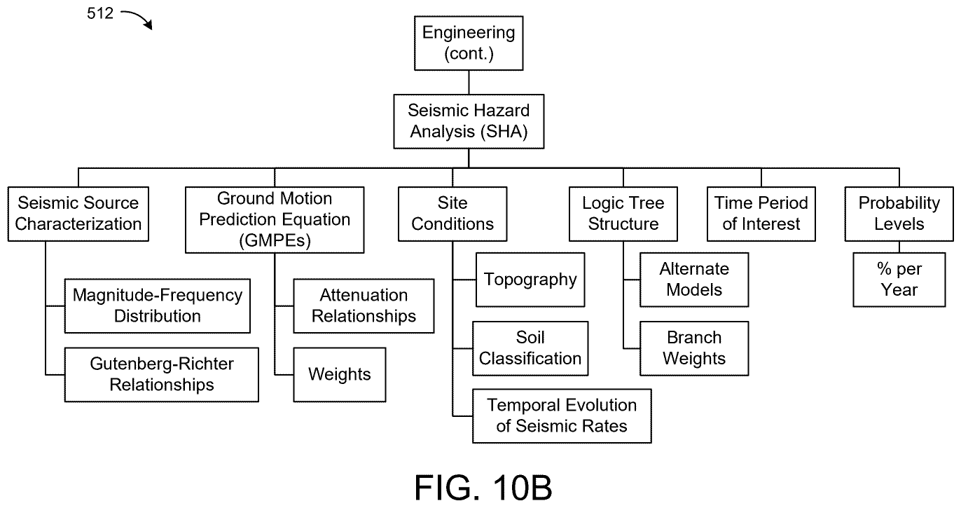

Referring now to FIG. 11, a diagram illustrating aerospace data sources 514 in greater detail is shown, according to an exemplary embodiment. Aerospace data sources may include various sensors, equipment, or other devices located above the earth's surface and configured to observe a wellsite or geographic region from an aerial perspective. Aerospace data sources 514 are shown to include light detection and ranging (LiDAR) systems, cameras (e.g., photogrammetry), and gas detection systems.

LiDAR systems can be located in a satellite, drone, balloon, plane, or other aerial platform above a wellsite or geographic region of the earth. LiDAR systems emit laser pulses to measure distances to the earth's surface, capturing precise elevation data. The platform (e.g., satellite, drone, balloon, or plane) determines the area of coverage and resolution. LiDAR data provides topographical information, mapping terrain with high precision. LiDAR data can be used for environmental monitoring, construction planning, forestry management, and disaster response. LiDAR data can be combined with imagery, photogrammetry, or multispectral data to enhance spatial understanding, such as vegetation analysis or flood modeling.

In some embodiments, computing system 110 uses LiDAR data to generate derived metrics or outputs such as digital elevation models (DEMs), canopy height models, and volume calculations. In some embodiments, computing system 110 uses LiDAR data to determine elevation changes in the earth's surface over time. For example, as shown in FIGS. 1-2, the growth of plume 120 as a result of injection well operations can cause surface deformation 128 which can be detected using LiDAR data. Computing system 110 can be configured to compare surface elevation data from one time period against surface elevation data from a subsequent time period and determine a change in surface elevation over time. In some embodiments, the LiDAR data and/or surface elevation data are used as an input to AI model 534 to allow AI model 534 to learn a relationship between injection well operations and resulting surface deformation 128.

In some embodiments, aerospace data sources 514 include cameras. Cameras may include photogrammetry equipment configured for use in surveying and mapping to measure the distances between objects. In some embodiments, cameras include red-green-blue (RGB) cameras configured to capture visible light wavelengths and form images comprising matrices of RGB pixels. Computing system 110 can receive high-resolution images from cameras and process such images to generate 3D models and maps using photogrammetry software. Data collector 526 can be configured to process overlapping image sets from the cameras to create a composite image, map, 3D model, or other representation of a geographic region for detailed reconstruction. Data from the cameras may provide computing system 110 with visual and spatial insights, allowing computing system 110 to create accurate 3D models, surface maps, and orthomosaics. Computing system 110 can use images from the cameras as inputs for land surveys, urban planning, and construction.

In some embodiments, computing system 110 uses images from the cameras to generate derived metrics or other outputs 552 such as maps 554. Such metrics may include area measurements, volume estimations, and detailed structural models. Computing system 110 can combine data from cameras with other data sources 502 by integrating camera data with LiDAR measurements or data from multispectral sensors (e.g., infrared, ultraviolet, microwave, etc.). Combining photogrammetry with LiDAR enhances the ability of AI model 534 to generate maps 554 with accurate depths and captures both visual and elevation data. Data from cameras can also be correlated with satellite imagery for broader contextual analysis.

In some embodiments, aerospace data sources 514 include gas detection sensors. Gas detection involves sensing specific gas concentrations in the atmosphere using specialized sensors. Similar to LiDAR sensors, gas detection sensors can be located in a satellite, drone, balloon, plane, or other aerial platform above a wellsite or geographic region of the earth. Drones and satellites collect spatially distributed data, while LiDAR aids in visualizing gas plumes. Satellite data provides broad-scale trends, while drones capture localized, high-resolution data. Gas detection sensors may provide data that identifies gas types, concentrations, and emission sources. For example, gas detection sensors can be configured to detect various types of gasses such as hydrogen sulfide (H₂S), methane, light natural gas (LNG, C₁-C₄), carbon dioxide (CO₂), or any other type of gas which can be emitted or affected by operation of various wellsites.

Computing system 110 can use gas detection sensors for monitoring air quality, industrial emissions, and environmental hazards. In some embodiments, computing system 110 generates derived metrics or other outputs 552 based on the gas detection data. Such metrics or outputs 552 may include gas dispersion models, emission rates, and/or pollution impact assessments. Computing system 110 may combine gas detection data with LiDAR and other data sources 502 to improve spatial accuracy. Combining gas detection data with other data sources 502 enables cross-verification and detailed spatial-temporal analysis.

### Other Data Sources

Referring now to FIG. 12, a diagram illustrating other data sources 516 in greater detail is shown, according to an exemplary embodiment. Other data sources 516 may include any of data sources 502 that provide input to computing system 110 in addition to geographical data sources 504, geological data sources 506, seismic/earthquake data sources 508, real-time wellsite data sources 510, engineering data sources 512, and aerospace data sources 514. Other data sources 516 are shown to include well leaks/blowouts, gas monitoring, biology/ecology, and critical infrastructure.

### Well Leaks and Blowouts

Well leaks/blowouts may include any data that characterizes blowouts and leaks from various wells or reservoirs. Data collector 526 can obtain well leaks/blowouts data from paper historical records (e.g., scout tickets, well histories, etc.) from clients, regulatory offices, or libraries, from online regulatory or organization databases (e.g., Texas RRC, New Mexico OCD, University Lands, etc.), and/or from online data vendors (e.g., S&P Global, Enverus, etc.). Well leaks/blowouts data may include various components such as location, occurrence, fluid type, pressures, duration, and solution or control.

The location component of well leaks/blowouts may signify pressure dynamics and fluid movement. For example, blowouts and leaks provide insights into the pressure dynamics within the reservoir. Computing system 110 can use this information for accurately modeling the pressure distribution and flow characteristics of the reservoir. Leaks can alter the intended flow paths of injected fluid, leading to inefficient reservoir sweep and reduced recovery rates. Computing system 110 can use leak information to adjust the injection strategy to optimize fluid distribution.

Computing system 110 may generate or calculate various derived metrics based on the location component of well leaks/blowouts data. For example, computing system 110 may calculate derived metrics such as the frequency of events, volume of fluids released, duration of events, pressure data, and environmental impact. The frequency of events indicates the number of blowouts or leaks per number of wells drilled or operated. The volume of fluids released indicates the amount of oil, gas, or water released during a blowout or leak, typically measured in barrels or cubic meters. The duration of events indicates the length of time the blowout or leak occurred, typically measured in hours or days. The pressure data indicates pressure at the wellhead and within the reservoir during the leak or blowout event. The environmental impact data indicates the extent of contamination or damage caused by the blowout or leak, including for example, soil, water, and air quality metrics.

Computing system 110 can be configured to correlate the locations of well blowouts or leaks with other data sources 502 to build a robust and reliable model (e.g., AI model 534) for injection wells that enhances safety, efficiency, and environmental protection. For example, computing system 110 can be configured to correlate historical well blowouts and leaks events with other contemporaneous information or temporally/causally related information from data sources 502 to determine correlations between the well leaks and blowouts and other data sources 502. AI model 534 can be trained to learn this correlation or relationship and thus can predict whether a well leak or blowout has occurred based on other data sources 502. Advantageously, this allows computing system 110 to predict downhole leaks and estimate the depth of such leaks using surface measurements or other data sources 502 without halting production or injection operations.

The occurrence component of well leaks/blowouts may include detailed records of past blowouts and leaks (i.e., blowout occurrences, leak occurrences). Model trainer 530 can use such occurrence data to train AI model 534 to predict the pressure dynamics in the well or reservoir and validate AI model 534 against real-world scenarios. Advantageously, data on well leaks and blowouts may provide computing system 110 with inputs for calibrating and validating pressure dispersion models (e.g., AI model 534 or other models).

Computing system 110 can be configured to calculate or generate various derived metrics based on the well leaks/blowouts occurrence data. Such derived metrics may include a volume of fluids released, which can be expressed in units of barrels (bbl) for oil and water, in units of cubic meters (m³) for other fluid volumes, or in units of million standard cubic feet (MMscf) for gas releases such as methane. Other derived metrics based on the well leaks/blowouts occurrence data may include pressure data (psi) indicating pressure at the wellhead and within the reservoir, a duration of events (hours or days) indicating the length of time a blowout or leak occurs, environmental impact concentration levels measured in parts per million (ppm) or parts per billion (ppb) for contaminants in air, water, or soil, an area affected (e.g., square kilometers (km²) or hectares (ha)) for the extent of environmental impact, and/or a frequency of events indicating a number of leaks or blowouts per number of wells (e.g., one blowout per 300 wells drilled).

Computing system 110 can be configured to generate or derive correlations between the well leaks/blowouts data and other data sources 502. One type of correlation which computing system 110 can generate is the Pearson correlation coefficient (r) which measures the linear relationship between two continuous variables. The Pearson correlation coefficient may have values that range from −1 to ±1 where ±1 indicates a perfect positive linear relationship (i.e., a type of positive correlation), −1 indicates a perfect negative linear relationship (i.e., a type of negative correlation), and 0 indicates no linear relationship (i.e., no correlation). The Pearson correlation coefficient is commonly used when both variables are normally distributed and have a linear relationship. Another type of correlation which computing system 110 can generate is Spearman's rank correlation coefficient (p or rs), which measures the strength and direction of the monotonic relationship between two ranked variables. Spearman's rank correlation coefficient may have values that range from −1 to ±1, similar to Pearson's, but is more commonly used when the data is not normally distributed or when the relationship is not linear. Another type of correlation which computing system 110 can generate is Kendall's tau (t), which measures the strength and direction of the association between two variables based on the ranks. Kendall's tau may have values that range from −1 to ±1 and can be used for smaller sample sizes or when there are many tied ranks. It is contemplated that these or other types of correlation metrics can be used to quantify any or all of the various correlations or relationships between data sources 502 described throughout the present disclosure.

The fluid type component of well leaks/blowouts may indicate the type of fluid which has leaked or escaped from the well or reservoir as a result of the leak or blowout. The fluid type component may indicate the type of fluid (e.g., oil, gas, water, gas condensate, etc.), properties of that fluid, and/or risks associated with that fluid as a result of the leak or blowout. For example, the fluid type information for oil may indicate that crude oil can vary in viscosity and density, affecting how it flows and disperses during a leak or blowout. Heavy oils are more viscous and flow more slowly, while light oils are less viscous and spread more rapidly. The fluid type information for gas may indicate that natural gas, primarily methane, is highly volatile and can create explosive hazards. Gas blowouts can lead to rapid pressure changes and significant environmental impacts. The fluid type information for water may indicate that produced water or formation water can contain various dissolved salts and chemicals. Water leaks can lead to contamination of freshwater resources. The fluid type information for gas condensate may indicate that the gas condensate includes a mixture of hydrocarbon liquids that can form when gas is produced. Gas condensate behaves differently from both oil and gas and can pose unique challenges.

Computing system 110 may generate or calculate various derived metrics based on the fluid type component of well leaks/blowouts data. Such derived metrics may include the viscosity and density of the fluid, which influence how pressure is distributed and dissipated in the reservoir. For example, heavier, more viscous fluids like heavy oil will have different pressure dispersion characteristics compared to lighter fluids like gas. Other derived metrics include flow dynamics dependent on the type of fluid. For example, gas tends to expand rapidly and can cause more abrupt pressure changes, whereas liquids such as oil and water flow more steadily.

Computing system 110 can be configured to correlate the fluid type of the leaked or blown out fluid with other data sources 502 using statistical analysis. For example, computing system 110 can use statistical analysis methods to correlate fluid properties (e.g., viscosity, density, etc.) with the frequency and severity of leaks and blowouts. This can involve regression analysis, correlation coefficients, and other statistical tools. In some embodiments, computing system 110 uses or develops simulation models (e.g., AI model 534) that incorporate fluid properties to predict the behavior of leaks and blowouts under different scenarios. Computing system 110 can use these models to predict the impact of fluid type on well integrity and pressure dynamics.

The pressure component of well leaks/blowouts may indicate the pressures at various locations within the reservoir, wellbore, or other locations at or around the wellsite during a time period surrounding the well leak or blowout occurrence. Computing system 110 can use the pressure information for several purposes including detection and diagnosis early warning, well integrity and safety structural integrity, reservoir management pressure dispersion, and environmental and economic impact. For example, abnormal pressure readings can serve as early indicators of potential leaks or blowouts. Computing system 110 can use sudden pressure drops or spikes as an indicator of a breach in well integrity. Computing system 110 can use pressure data to determine the precise location and severity of leaks. By analyzing pressure gradients, computing system 110 can identify where the fluid is escaping. Additionally, monitoring pressure helps ensure the structural integrity of the wellbore and casing. Computing system 110 may determine that consistent pressure readings indicate the well is maintaining its integrity, whereas pressure fluctuations can suggest weaknesses. In some embodiments, computing system 110 uses pressure data to prevent blowouts by ensuring that the wellsite is operated to maintain pressure within safe limits (e.g., based on pressures associated with historical blowout events).

In some embodiments, computing system 110 uses information on how pressure disperses through the reservoir to optimize injection and production strategies. Accurate pressure data ensures that the reservoir is being managed efficiently and safely. Computing system 110 can also use pressure data to determine the flow dynamics of fluids within the reservoir, helping to predict and manage the movement of oil, gas, and water. In some embodiments, computing system 110 monitors pressure to prevent environmental contamination by detecting leaks early and allowing for prompt response. This minimizes the impact on surrounding ecosystems. Preventing blowouts and managing leaks also effectively reduces operational costs associated with repairs, downtime, and lost production or injection.

Computing system 110 may generate or calculate various derived metrics based on the pressures associated with well blowouts or leaks. Such derived metrics may include the volume of fluids released, the duration of events, and environmental impact, which may be the same as described above with reference to the occurrence component of the well leaks/blowouts. Computing system 110 may also correlate the pressures associated with well blowouts or leaks with emissions rates. Emissions rates may quantify the rate of gas emissions during a blowout and can be expressed in units of metric tons per hour (tons/hr) or kilograms per second (kg/s).

Computing system 110 can be configured to correlate the pressures associated with well blowouts or leaks with other data sources 502. For example, computing system 110 can generate a correlation between pressure and fluid volume. Higher pressure often correlates with increased fluid volume release during a blowout or leak. This relationship helps in predicting the severity of a blowout based on pressure readings. For example, a sudden spike in pressure can indicate a significant release of fluids. In some embodiments, computing system 110 generates a correlation between pressure and fluid type. Different fluids (e.g., oil, gas, water) respond differently to pressure changes. For example, gas is highly compressible and can lead to rapid pressure changes and potential blowouts, whereas oil is less compressible and can result in more gradual pressure changes, and water is substantially incompressible and can cause significant pressure buildup due to its incompressibility. Computing system 110 can use this correlation to design or recommend appropriate safety measures and response strategies for different fluid types.

In some embodiments, computing system 110 generates a correlation between pressure and leak rate. The rate of leakage often increases with higher pressure. Accordingly, computing system 110 can monitor pressure to estimate the leak rate based on the correlation. In some embodiments, computing system 110 generates a correlation between pressure and well integrity. Sustained high pressure can compromise well integrity, leading to leaks or blowouts. Computing system 110 can monitor pressure for early detection of integrity issues, allowing for timely interventions. In some embodiments, computing system 110 generates a correlation between pressure and environmental impact. Higher pressure blowouts tend to have more severe environmental impacts due to the larger volume and higher velocity of fluid release. Computing system 110 can use pressure data to assess the potential environmental risks and planning mitigation strategies based on the correlation.

The duration component of well leaks/blowouts may indicate the duration over which the leak or blowout occurs. Computing system 110 can use the duration information to perform an environmental impact assessment which evaluates the extent of contamination and plans an appropriate response. For example, the longer a blowout lasts, the more fluids (e.g., oil, gas, or water) are released into the environment, increasing the extent of contamination. Computing system 110 can use the duration information to assess the environmental damage, plan remediation efforts, and execute effective response strategies to minimize environmental impact. In some embodiments, computing system 110 uses the duration information for safety and risk management emergency response. For example, the duration of a blowout affects the urgency and type of emergency response required. Longer blowouts may need more extensive resources and prolonged efforts to control. Computing system 110 can use the duration to evaluate the risk and potential consequences of blowouts, leading to better preparedness and mitigation strategies.

In some embodiments, computing system 110 uses the duration information for economic impact cost estimation. For example, the duration of a blowout directly impacts the cost of containment, cleanup, and lost production or injection. Computing system 110 can use the duration information to estimate these costs and manage financial risks. Computing system 110 may also use the duration information for evaluating insurance claims and determining liability, as longer events typically result in higher claims and more significant legal implications. In some embodiments, computing system 110 uses the duration information to generate operational insights regarding well control. For example, measuring the duration provides insights into the effectiveness of well control measures and helps in improving future well designs and safety protocols.

Computing system 110 may generate or calculate various derived metrics based on the duration component of well leaks/blowouts data. Such derived metrics may include the total duration indicating the total time from the start to the end of the blowout or leaking, usually measured in hours or days. Computing system 110 can use the total duration to evaluate the overall impact of the leak or blowout and generate a recommended response and remediation effort. Another derived metric based on the duration information is flow rate duration indicating the duration over which fluids are released at specific flow rates. The flow rate duration can be expressed in units of hours or days, often segmented by different flow rates (e.g., a flow rate of X barrels/hour for two days, followed by a flow rate of Y barrels/hour for the next three days, etc.). Computing system 110 can use the flow rate duration metric to provide detailed insights into the intensity and variability of the blowout over time.

In some embodiments, computing system 110 calculates peak flow duration as another derived metric based on the duration information. The peak flow duration may indicate the time period during which the blowout reaches its maximum flow rate and may be expressed in units of hours or days. Computing system 110 can use the peak flow duration to quantify the most severe phase of the blowout and its potential impact. Another derived metric based on the duration information is response time duration indicating the time taken to initiate and implement control measures after the blowout begins. Response time duration can be expressed in units of minutes, hours, or days, and can be used by computing system 110 to evaluate the effectiveness of emergency response protocols and improving future response strategies.

Computing system 110 can be configured to generate or derive correlations between the duration of the well leaks/blowouts and other data sources 502. In some embodiments, computing system 110 generates a correlation between the duration and the fluid volume released. Longer blowout durations typically result in larger volumes of fluids being released. Computing system 110 can use this relationship to estimate the total environmental impact and the scale of the cleanup efforts required. In some embodiments, computing system 110 generates a correlation between duration and flow rate correlation. The duration of a blowout can influence the average and peak flow rates. Longer durations may see variations in flow rates due to changing reservoir pressures and well conditions. Computing system 110 can use this correlation to design or recommend effective containment and control measures.

In some embodiments, computing system 110 generates a correlation between duration and pressure change. Extended blowout durations can lead to significant changes in reservoir pressure, affecting the overall stability of the well and surrounding formations. Computing system 110 can monitor pressure changes over time and use this correlation to assess the risk of further well integrity issues and plan appropriate interventions. In some embodiments, computing system 110 generates a correlation between duration and environmental impact. The longer the blowout lasts, the greater the potential for environmental damage, including soil, water, and air contamination. Computing system 110 can use this correlation to assess environmental risk and develop long-term remediation strategies. In some embodiments, computing system 110 generates a correlation between duration and economic costs. Longer blowouts generally incur higher economic costs due to prolonged response efforts, greater volumes of lost production or injection, and more extensive environmental remediation. Computing system 110 can use duration information to perform financial planning and risk management operations based on this correlation.

The solution or control component of well leaks/blowouts data may include sampling the other components described above at various time intervals or frequencies. In some embodiments, computing system 110 performs continuous monitoring and high-frequency sampling. For real-time monitoring of critical parameters such as pressure, temperature, and flow rates, high-frequency sampling (e.g., every second or minute) may be advantageous to prevent or mitigate the impact of leaks and blowouts for volatile fluids like gas, where rapid changes can occur. In some embodiments, computing system 110 performs periodic sampling at longer intervals (e.g., daily to weekly). For less volatile fluids like oil or water, periodic sampling can be sufficient to track changes in fluid properties and well performance. In some embodiments, computing system 110 performs periodic sampling at significantly longer intervals such as monthly to quarterly. For long-term reservoir management and environmental monitoring, sampling on a monthly or quarterly basis can provide insights into trends and cumulative impacts. In some embodiments, computing system 110 performs event-based sampling during specific events. For example, computing system 110 can trigger increased sampling frequency during specific events such as well testing, maintenance operations, or suspected leaks to obtain detailed data on fluid behavior and well integrity. The increased sampling frequency may generate data that has a higher resolution or granularity than the lower sampling frequency at which the data points are normally sampled and thus may provide computing system 110 with higher resolution data for subsequent analyses.

Computing system 110 can be configured to calculate or generate various derived metrics based on the well leaks/blowouts control or solution data. One type of derived metrics are pressure metric indicating wellhead pressure (WHP) or bottomhole pressure (BHP). WHP can be measured in pounds per square inch (psi) or pascals (Pa) and indicates the pressure at the surface of the well, whereas PHP is also measured in psi or Pa and represents the pressure at the bottom of the wellbore. Computing system 110 can use these pressure metrics for maintaining well control. Another type of derived metrics are mud metrics such as mud weight (density), mud volume, and mud flow rate. Mud weight can be measured in pounds per gallon (ppg) or kilograms per cubic meter (kg/m³) and may provide computing system 110 with the necessary hydrostatic pressure to balance formation pressure. Mud volume can be measured in barrels (bbl) or cubic meters (m³) and can be monitored by computing system 110 to detect kicks or losses based on changes in mud volume. Mud flow rate can be measured in barrels per minute (bpm) or liters per second (L/s) and can be used by computing system 110 to identify abnormal flow conditions.

Another type of derived metrics which can be generated by computing system 110 based on the solution or control data are flow rate metrics such as inflow and outflow rates and the gas-to-oil ratio (GOR). Inflow and outflow rates can be measured in barrels per day (bpd) or cubic meters per day (m³/d) and can be used by computing system 110 to detect discrepancies that could indicate a blowout. The GOR can be measured in standard cubic feet per barrel (scf/bbl) and can be used by computing system 110 to detect gas influx in response to detecting an increase in GOR. Another type of derived metric is wellbore temperature which can be measured in degrees Celsius (° C.) or Fahrenheit (° F.). Computing system 110 can use wellbore temperature to predict fluid properties and pressure dynamics that depend on wellbore temperature. Another type of derived metrics are well integrity metrics such as casing pressure and cement bond quality. Casing pressure can be measured in psi or Pa and used by computing system 110 to estimate the integrity of the well casing. Cement bond quality can be assessed using acoustic logs to ensure the cement is properly sealing the wellbore. Another type of derived metric are blowout preventer (BOP) metrics such as BOP activation time and BOP pressure rating. BOP activation time can be measured in seconds or minutes and indicates how quickly the BOP can be activated to shut in the well. BOP pressure rating can be measured in psi or Pa and indicates the maximum pressure the BOP can withstand.

In some embodiments, computing system 110 can be configured to connect the well control techniques with other data sources 502. For example, computing system 110 can use techniques such as adjusting the mud weight, using kill fluids, and activating BOPs to manage both leaks and blowouts.

These measures help maintain well integrity and control pressure. Computing system 110 can use multiple safety barriers, including mechanical barriers (e.g., BOPs) and procedural barriers (e.g., well monitoring protocols) to prevent and control leaks and blowouts.

### Gas Monitoring

In some embodiments, other data sources 516 include gas monitoring data sources. Gas monitoring data sources may include real-time monitoring systems, portable gas analyzers, and/or fixed monitoring stations. Real-time monitoring systems may include sensors that continuously monitor various gas levels and transmit the measurements in real-time to provide immediate alerts and ensure safety. Portable gas analyzers may include devices used for on-site measurements and are useful for temporary monitoring needs. Fixed monitoring stations may include permanent installations at critical points, such as wellheads or processing facilities, and may provide continuous data and help in long-term monitoring. Gas monitoring data sources can be configured to measure a variety of different types of gases such as hydrogen sulfide (H₂S), methane (CH4), carbon dioxide (CO₂), nitrogen (N2), and oxygen (O2).

Hydrogen sulfide sensors can be used by computing system 110 to provide safety and environmental impact immediate alerts. For example, computing system 110 may act as a real-time monitoring system configured to provide immediate alerts if H₂S levels exceed safe thresholds. Computing system 110 may perform continuous monitoring of H₂S levels for use in detecting leaks or emissions early, minimizing environmental impact and ensuring compliance with regulations. Computing system 110 can be configured to correlate H₂S levels with pressure changes. For example, changes in pressure within the well can influence the release and movement of H₂S. By monitoring H₂S levels, computing system 110 can correlate these changes with pressure transients to better understand the behavior of the reservoir. In some embodiments, computing system 110 uses data on H₂S levels to characterize the reservoir, as the presence and concentration of H₂S can indicate specific geological formations and fluid interactions.

In some embodiments, computing system 110 uses the relationship between pressure changes and H₂S levels to optimize injection strategies to minimize the release of H₂S and maintain safe operating conditions. For example, computing system 110 can monitor H₂S and control wellsite equipment 546 to reduce the corrosion and damage to equipment, which can be exacerbated by pressure changes. This ensures the longevity and reliability of the infrastructure. Computing system 110 may also integrate H₂S data with pressure transient data to provide a more comprehensive view of well performance and reservoir dynamics. This holistic approach aids in making informed decisions and improving overall operational strategies. In some embodiments, computing system 110 uses continuous data collection to facilitate predictive maintenance, where potential issues can be identified and addressed before they lead to significant problems.

Methane sensors can be used by computing system 110 to characterize the reservoir. For example, methane is often the primary component of natural gas. Computing system 110 can monitor the methane concentration of gas composition to assess the behavior of the reservoir. Computing system 110 can also use methane data to estimate reservoir properties such as permeability and porosity, which can be used for predicting gas flow and storage capacity. In some embodiments, computing system 110 uses methane concentration to determine flow regimes and dynamic flow behavior. For example, methane concentration changes can indicate different flow regimes (e.g., radial, linear). Computing system 110 can use this information to identify how gas moves through the reservoir and the wellbore. Computing system 110 can also use methane data during pressure transients to determine the dynamics of gas production and the impact of pressure changes on gas flow.

In some embodiments, computing system 110 uses the methane data to adjust injection strategies. For gas injection wells, methane data can guide the adjustment of injection rates and pressures to enhance recovery and minimize risks. Computing system 110 can use the methane levels for safety and environmental impact leak detection. For example, monitoring methane levels can be important in detecting leaks and preventing hazardous situations because methane is highly flammable. Computing system 110 can also use the methane levels for environmental monitoring. Because methane is a potent greenhouse gas, accurate monitoring of methane levels helps in minimizing environmental impact and ensuring regulatory compliance. In some embodiments computing system 110 integrates the methane data with pressure transient data to provide a more complete picture of reservoir performance and generate recommendations or control signals for wellsite equipment 546 regarding well management and injection strategies.

Carbon dioxide sensors can be used by computing system 110 to obtain measurements of CO₂ concentration. CO₂ concentration is typically measured in parts per million (ppm) or parts per billion (ppb) using sensors such as infrared (IR) sensors or tunable diode laser absorption spectroscopy (TDLAS). CO₂ sensors may include ground-based sensors (e.g., infrared sensors, catalytic bead sensors, electrochemical sensors, etc.) installed at fixed locations or used in portable devices for on-site measurements. Other techniques for obtaining CO₂ concentration measurements include aerial surveys (e.g., aircraft or drones equipped with CO₂ sensors) for large-scale monitoring and detecting CO₂ emissions over wide areas, satellite monitoring (e.g., satellites equipped with spectrometers) for global coverage and long-term monitoring of CO₂ emissions, and mass balance techniques (e.g., measuring the total CO₂ gas entering and leaving a defined area.

Computing system 110 can calculate various derived metrics based on the measured CO₂ concentration. For example, computing system 110 can calculate emission rate (e.g., kg/hr or g/s) by measuring the flow rate of CO₂ and its concentration. Computing system 110 can directly measure the flow rate (e.g., m³/hr or L/min) to provide a direct reading of the gas flowing per unit time. In some embodiments, computing system 110 calculates a CO₂ intensity metric based on the CO₂ concentration (e.g., g CO₂e/MJ), which measures the greenhouse gas emissions per unit of energy produced. Computing system 110 can use the CO₂ concentration data to perform a pressure transient analysis (PTA) including a build-up test which analyzes pressure recovery after shutting in the well, a drawdown test which analyzes pressure decline during production, and/or a Horner plot used to estimate reservoir pressure and permeability from build-up data. In some embodiments, computing system 110 uses the CO₂ concentration data to conduct a rate transient analysis (RTA) including a decline curve analysis which uses historical production data to predict future performance and/or type-curve matching which compares actual production data with theoretical models to estimate reservoir properties. In some embodiments, computing system 110 integrates the CO₂ concentration data with other data sources 502 such as flow rate, and pressure data to provide a holistic view of reservoir dynamics. Computing system 110 can use the CO₂ concentration data for predictive maintenance. For example, continuous data collection and analysis of CO₂ concentration data allows computing system 110 to identify potential issues before they become significant problems and perform predictive maintenance.

In some embodiments, computing system 110 generates or derives correlations between the CO₂ concentration and other data sources 502. For example, computing system 110 can correlate CO₂ concentration data from ground-based sensors and aerial surveys. Ground-based sensors provide detailed, localized data on gas concentrations and flow rates, while aerial surveys offer broader spatial coverage. Combining these data sources allows computing system 110 to validate ground-based measurements and identify larger-scale emission patterns. In some embodiments, computing system 110 correlates CO₂ concentration from satellite monitoring and ground-based sensors. Satellite monitoring offers global coverage and long-term trends, while ground-based sensors provide high-resolution, real-time data. Satellites can identify areas with high methane emissions, prompting more detailed ground-based investigations. This integration allows computing system 110 to track emissions over time and ensure that localized measurements align with broader trends. In some embodiments, computing system 110 correlates CO₂ concentration data from mass balance techniques and flow rate measurements. Mass balance techniques measure the total gas entering and leaving a defined area, while flow rate measurements provide detailed data on the volume of gas passing through specific points. By combining mass balance data with flow rate measurements, computing system 110 can verify the accuracy of flow rates and ensure that all sources and sinks of gas are accounted for. Advantageously, this allows computing system 110 to ensure accurate emission inventories and develop accurate gas dynamics within the reservoir.

In some embodiments, computing system 110 correlates the pressure transient analysis (PTA) and gas concentration data. PTA provides insights into reservoir pressure and permeability, while gas concentration data indicates the presence and movement of gases like methane and CO₂. Correlating pressure data with gas concentration allows computing system 110 to determine how pressure changes affect gas release and movement. Computing system 110 can use this correlation to optimize injection strategies and predict gas production rates. In some embodiments, computing system 110 correlates the rate transient analysis (RTA) and emission rate data. RTA uses historical production data to predict future performance, while emission rate data quantifies the amount of gas being emitted. Combining RTA with emission rate data allows computing system 110 to assess the efficiency of production processes and identify opportunities to reduce emissions. Computing system 110 can use this correlation to support both operational optimization and environmental compliance.

Advantageously, correlating CO₂ concentration data with other data sources 502 provides several benefits to the various analyses and processes performed by computing system 110. For example, cross-referencing data from multiple sources improves the accuracy and reliability of measurements. Integrating different data types provides a holistic view of reservoir behavior and gas dynamics. Correlated data supports better decision-making by providing a more complete understanding of the system. Identifying correlations helps in optimizing production or injection strategies and improving overall operational efficiency. Computing system 110 may ensure that CO₂ emissions are accurately tracked and managed, supporting regulatory compliance and environmental protection.

In some embodiments, other data sources 516 include nitrogen sensors. Nitrogen sensors may include flow meters installed at the surface or downhole to measure the flow rate of nitrogen and provide data on the volume of nitrogen injected. Nitrogen sensors may include gas analyzers such as infrared (IR) sensors and mass spectrometers configured to measure nitrogen concentration in the produced gas, which can be used for evaluating nitrogen breakthrough and mixing with reservoir fluids. In some embodiments, nitrogen sensors may include downhole pressure gauges installed in the wellbore to provide continuous pressure data during nitrogen injection.

Nitrogen sensors can be used by computing system 110 to characterize the reservoir. For example, computing system 110 can analyze how nitrogen moves through the reservoir rock to gain insights into reservoir properties such as permeability and porosity. Computing system 110 can use the nitrogen data to develop a model of flow dynamics within the reservoir, including how different zones interact and how fluids are displaced. Computing system 110 can evaluate how nitrogen injection affects the pressure distribution within the reservoir. Monitoring these changes allows computing system 110 to manage reservoir pressure effectively, ensuring optimal injection and production strategies. In some embodiments, computing system 110 uses the nitrogen data to evaluate well integrity and prevent issues such as wellbore collapse or fracturing. Computing system 110 can use the nitrogen for enhanced oil recovery (EOR) to displace oil and other fluids. Monitoring nitrogen helps in evaluating the efficiency of this displacement process, optimizing recovery rates. Additionally, by monitoring nitrogen levels, computing system 110 can detect breakthrough events where nitrogen reaches production wells, indicating the effectiveness of the injection process.

Computing system 110 can use the nitrogen measurements to operational efficiency injection optimization. For example, monitoring nitrogen allows for the optimization of injection rates and pressures, ensuring that the injection process is efficient and effective. Additionally, computing system 110 can use the real-time nitrogen levels to make immediate adjustments to injection parameters based on the observed data, improving overall operational efficiency. Computing system 110 can use the nitrogen measurements to evaluate environmental and safety considerations. For example, monitoring nitrogen helps in detecting leaks, preventing environmental contamination, and ensuring that nitrogen levels remain within safe limits to protect personnel and equipment. Computing system 110 may use the nitrogen levels to ensure compliance with environmental regulations and safety standards.

Computing system 110 can calculate various derived metrics based on the measured nitrogen levels or pressure from nitrogen sensors. For example, computing system 110 can evaluate pressure changes by determining the changes in measured pressure. Computing system 110 can determine the flow rate (e.g. m³/hr or L/min) which can be measured using flow meters that detect the volume of nitrogen passing through a point over time. The flow meter provides a direct reading of the volume of nitrogen gas flowing per unit time. Computing system 110 can use this information to calculate the volume of nitrogen injected and for modeling pressure transient behavior. In some embodiments, computing system 110 calculates the nitrogen concentration (e.g., in units of ppm or % by volume). Nitrogen concentration can be measured using gas analyzers such as infrared (IR) sensors or mass spectrometers. The sensor detects the amount of nitrogen in the gas mixture and converts it into a concentration value. Computing system 110 can use the nitrogen concentration information to evaluate the extent of nitrogen breakthrough and mixing with reservoir fluids.

In some embodiments, computing system 110 uses the nitrogen measurements to derive a reservoir permeability (k) metric. For example, computing system 110 can derive the reservoir permeability from pressure transient data using techniques such as drawdown and buildup tests. The reservoir permeability indicates the ability of the reservoir rock to transmit fluids, which can be used by computing system 110 for predicting gas flow and storage capacity. Computing system 110 can use the nitrogen data to perform a pressure transient analysis (PTA) including a build-up test which analyzes pressure recovery after shutting in the well, a drawdown test which analyzes pressure decline during production, and/or a Horner plot used to estimate reservoir pressure and permeability from build-up data. In some embodiments, computing system 110 uses the nitrogen data to conduct a rate transient analysis (RTA) including a decline curve analysis which uses historical production data to predict future performance and/or type-curve matching which compares actual production data with theoretical models to estimate reservoir properties. In some embodiments, computing system 110 integrates the nitrogen data with other data sources 502 such as flow rate, and pressure data to provide a holistic view of reservoir dynamics. Computing system 110 can use the nitrogen data for predictive maintenance. For example, continuous data collection and analysis of nitrogen data allows computing system 110 to identify potential issues before they become significant problems and perform predictive maintenance.

In some embodiments, computing system 110 generates or derives correlations between the nitrogen data and other data sources 502. For example, computing system 110 can correlate measurements from downhole pressure gauges and flow meters. Downhole pressure gauges provide continuous pressure data, while flow meters measure the volume of nitrogen injected. Combining these data sources allows computing system 110 to determine how changes in injection rates affect reservoir pressure. Computing system 110 can use this information for optimizing injection strategies and ensuring efficient nitrogen use. In some embodiments, computing system 110 develops a correlation between surface and subsurface data. Surface data (e.g., flow rates, injection volumes) and subsurface data (e.g., pressure, nitrogen concentration) provide a complete picture of the injection process. Integrating surface and subsurface data allows computing system 110 to perform a comprehensive analysis of nitrogen injection, helping to identify any discrepancies and optimize the overall injection strategy. In some embodiments, computing system 110 develops a correlation between real-time monitoring and historical data. Real-time monitoring systems provide immediate data on nitrogen levels and pressure changes, while historical data offers insights into long-term trends and patterns. Combining real-time and historical data allows computing system 110 to identify trends, predict future behavior, and make informed decisions about injection strategies and reservoir management.

In some embodiments, other data sources 516 include oxygen sensors. Oxygen sensors may include flow meters installed at the surface or downhole to measure the flow rate of oxygen and provide data on the volume of oxygen injected. Oxygen sensors may include gas analyzers such as electrochemical sensors and paramagnetic sensors configured to measure oxygen concentration in the produced gas, for use in evaluating oxygen levels and their impact on reservoir performance and safety. In some embodiments, oxygen sensors include downhole pressure gauges installed in the wellbore and configured to provide continuous pressure data for real-time monitoring of pressure changes during oxygen injection.

Oxygen sensors can be used by computing system 110 for a variety of purposes such as corrosion prevention, reservoir characterization, operational efficiency, and safety and regulatory compliance. For example, oxygen can cause corrosion in wellbore equipment and pipelines. Accordingly, monitoring O₂ levels helps computing system 110 to prevent corrosion-related damage (e.g., leaks, equipment failure, etc.), ensuring the longevity and integrity of the infrastructure and reducing maintenance costs. With respect to reservoir characterization, computing system 110 can determine the effect of the presence of oxygen on chemical reactions within the reservoir. Computing system 110 can use this type of reservoir characterization for optimizing injection strategies and improving recovery rates. Oxygen can also influence the efficiency of certain injection processes, such as enhanced oil recovery (EOR) techniques. Computing system 110 can monitor O₂ levels to ensure that the injection process is optimized for maximum efficiency, which can lead to better resource utilization and improved production rates. Additionally, high levels of oxygen can pose safety risks, including the potential for fire or explosion in certain environments. Computing system 110 can monitor O₂ levels to help maintain safe operating conditions, protect personnel, and comply with environmental and safety regulations.

Computing system 110 can calculate various derived metrics based on the measured oxygen levels or pressure from oxygen sensors. For example, computing system 110 can evaluate pressure changes by determining the changes in the measured pressure over time. Computing system 110 can determine the flow rate (e.g., m³/hr or L/min) which can be measured using flow meters that detect the volume of oxygen passing through a point over time. The flow meter provides a direct reading of the volume of oxygen gas flowing per unit time. Computing system 110 can use this information to calculate the volume of oxygen injected and for modeling pressure transient behavior. In some embodiments, computing system 110 calculates the oxygen concentration (e.g., in units of ppm or % by volume). Oxygen concentration can be measured using gas analyzers such as infrared (IR) sensors or mass spectrometers. The sensor detects the amount of oxygen in the gas mixture and converts it into a concentration value. Computing system 110 can use the oxygen concentration information to evaluate the extent of oxygen breakthrough and mixing with reservoir fluids.

In some embodiments, computing system 110 uses the oxygen measurements to derive a reservoir permeability (k) metric. For example, computing system 110 can derive the reservoir permeability from pressure transient data using techniques such as drawdown and buildup tests. The reservoir permeability indicates the ability of the reservoir rock to transmit fluids, which can be used by computing system 110 for predicting gas flow and storage capacity. Computing system 110 can use the oxygen data to perform a pressure transient analysis (PTA) including a build-up test which analyzes pressure recovery after shutting in the well, a drawdown test which analyzes pressure decline during production, and/or a Horner plot used to estimate reservoir pressure and permeability from build-up data. In some embodiments, computing system 110 uses the oxygen data to conduct a rate transient analysis (RTA) including a decline curve analysis which uses historical production data to predict future performance and/or type-curve matching which compares actual production data with theoretical models to estimate reservoir properties. In some embodiments, computing system 110 integrates the oxygen data with other data sources 502 such as flow rate, and pressure data to provide a holistic view of reservoir dynamics. Computing system 110 can use the oxygen data for predictive maintenance. For example, continuous data collection and analysis of oxygen data allows computing system 110 to identify potential issues before they become significant problems and perform predictive maintenance.

In some embodiments, computing system 110 generates or derives correlations between the oxygen data and other data sources 502. For example, computing system 110 can correlate oxygen concentration and corrosion rates. Higher oxygen concentrations can lead to increased corrosion rates in wellbore equipment and pipelines. Computing system 110 can use the monitored oxygen levels and the correlation with corrosion rates to predict and prevent corrosion-related damage, ensuring the longevity and integrity of the infrastructure. In some embodiments, computing system 110 develops a correlation between pressure changes and oxygen concentration. Changes in reservoir pressure can affect the solubility and movement of oxygen within the reservoir. Computing system 110 can use this relationship to manage reservoir pressure effectively and optimize injection strategies to control oxygen levels. In some embodiments, computing system 110 develops a correlation between flow rate and oxygen distribution. The flow rate of injected gas influences the distribution and mixing of oxygen within the reservoir. Computing system 110 can use this correlation to ensure uniform oxygen distribution, which is important for both operational efficiency and safety.

In some embodiments, computing system 110 develops a correlation between oxygen concentration and chemical reactions. The presence of oxygen can affect various chemical reactions within the reservoir, such as oxidation processes. Computing system 110 can use the monitored oxygen levels to control these reactions, which can impact reservoir properties and fluid behavior. In some embodiments, computing system 110 develops a correlation between pressure transients and reservoir permeability. Pressure transient data provides insights into reservoir permeability, which can influence how oxygen moves through the reservoir. Computing system 110 can correlate pressure data with oxygen concentration to develop a model of the flow dynamics and optimize injection processes. In some embodiments, computing system 110 develops a correlation between oxygen levels and safety risks. High oxygen levels can pose safety risks, including the potential for fire or explosion in certain environments. Accordingly, continuous monitoring of oxygen levels ensures that they remain within safe limits, protecting personnel and equipment.

### Ecology and Biology

In some embodiments, other data sources 516 include ecology or biology data sources. The biology/ecology data sources may include surveys such as species occurrence and distribution. Such surveys can be obtained by recording the presence or absence of species in different locations for use in understanding their distribution patterns. This can be done through field surveys, camera traps, and acoustic monitoring. In some embodiments, the surveys include population density and abundance (e.g., estimating the number of individuals of a species in a given area) through techniques such as transect sampling, quadrat sampling, and mark-recapture methods. In some embodiments, the surveys include habitat characteristics, which can be obtained by collecting data on the physical and biological characteristics of habitats, such as soil type, vegetation cover, water quality, and climate conditions. In some embodiments, the surveys include behavioral observations documenting the behavior of species, including feeding, mating, and migration patterns. This can be done through direct observation or using tracking devices.

In some embodiments, the surveys include genetic sampling such as collecting tissue or DNA samples to study genetic diversity and population structure. This helps in understanding the genetic health and connectivity of populations. In some embodiments, the surveys include environmental data, which can be obtained by measuring environmental variables such as temperature, humidity, light levels, and pollution. These factors can influence species distribution and ecosystem health. In some embodiments, the surveys include remote sensing and GIS such as using satellite imagery and geographic information systems (GIS) to map and analyze large-scale ecological patterns and changes over time. In some embodiments, the surveys include community surveys, which can be obtained by engaging local communities to gather traditional ecological knowledge and observations about changes in the environment and species behavior.

Computing system 110 can use the survey data for various purposes such as risk assessment, conservation planning, ecosystem services, resilience building, and policy and management. For example, computing system 110 can use survey information indicating how earthquakes affect flora and fauna to assess the overall risk to an ecosystem. Such a risk assessment may include predicting which areas are most vulnerable and which species are at greatest risk. Computing system 110 can use the survey information to identify the potential impacts on biodiversity and develop effective conservation strategies to ensure that efforts are focused on protecting the most vulnerable species and habitats. Computing system 110 can use the survey data to determine how earthquakes disrupt ecosystem services provided by flora and fauna (e.g., pollination, water purification, and soil stabilization) for use in estimating the broader ecological and economic impacts. In some embodiments, computing system 110 uses the survey data to determine how ecosystems recover and adapt to seismic events to inform strategies to enhance resilience (e.g., habitat restoration, creating wildlife corridors, implementing sustainable land-use practices, etc.). Computing system 110 can use the survey data to provide a more complete estimate of seismogenic risk, including its ecological impacts, to support informed decision-making and policy development. This ensures that risk mitigation measures are comprehensive and effective.

Computing system 110 can calculate various derived metrics based on the survey data. For example, computing system 110 can generate a habitat disruption metric indicating an area of habitat lost or affected by landslides, ground ruptures, and other disruptions. Computing system 110 can calculate a fragmentation index indicating the degree of habitat fragmentation using metrics such as patch size and connectivity. Computing system 110 can calculate various population decline metrics such as population density (e.g., by counting the number of individuals per unit area before and after an earthquake) and survival rate (e.g., by tracking the percentage of individuals that survive in the affected area over time). In some embodiments, computing system 110 calculates ecosystem imbalance metrics such as species richness by counting the number of different species present in the ecosystem and/or trophic level change by monitoring shifts in the abundance of species at different trophic levels (e.g., herbivores, predators, etc.). Computing system 110 can calculate soil and water quality metrics such as soil erosion rate indicating the amount of soil lost per unit area over time and various water quality indicators (e.g., tests for pollutants, sediment levels, and changes in pH or nutrient concentrations in water bodies). In some embodiments, computing system 110 calculates recovery and adaptation metrics such as a vegetation regrowth rate indicating the rate at which plant life returns to the affected area after a seismic event and/or a species recolonization indicating the return of species to the area over time, noting which species are able to recolonize and which are not.

Computing system 110 can identify or derive various correlations between the survey data and other data sources 502. For example, computing system 110 can develop a correlation between species occurrence and distribution vs. habitat characteristics by evaluating the presence and distribution of species in combination with habitat characteristics such as soil type, vegetation cover, and water availability. In some embodiments, computing system 110 develops a correlation between population density and abundance vs. environmental data. For example, computing system 110 can determine the influence on population density and abundance caused by environmental factors such as temperature, humidity, and light levels. In some embodiments, computing system 110 develops a correlation between behavioral observations vs. habitat characteristics. For example, computing system 110 can determine the effect of habitat features on the behavior of species, such as feeding and mating patterns.

In some embodiments, computing system 110 develops a correlation between genetic sampling vs. species distribution. For example, computing system 110 can develop a relationship between genetic diversity within a population and its distribution and connectivity between habitats. In some embodiments, computing system 110 develops a correlation between environmental data vs. soil and water quality. For example, environmental conditions can directly impact soil and water quality, which in turn affects plant growth and animal health. In some embodiments, computing system 110 develops a correlation between remote sensing and GIS vs. species occurrence and distribution. For example, computing system 110 can use remote sensing data to map species distribution and identify habitat changes over time.

In some embodiments, the biology/ecology data sources include photography data. Photography data can be obtained from cameras (e.g., high-resolution digital cameras for detailed images), drones (e.g., unmanned aerial vehicles (UAVs) equipped with cameras for aerial photography), GPS devices for accurate geolocation tagging of photographs, tripods and stabilizers to ensure stable and clear images, especially in low-light conditions, and/or software such as image processing and GIS software for analyzing and integrating photographic data.

Computing system 110 can use the photography data for various purposes such as risk assessment and mitigation, regulatory and policy development, evaluating economic considerations, evaluating environmental impact, and for community engagement and trust. For example, computing system 110 can use photography data indicating hazards for identifying and understanding the seismic hazards associated with human activities such as hydraulic fracturing, geothermal energy production, and wastewater injection. By understanding the mechanisms behind induced seismicity, computing system 110 can develop effective mitigation strategies to minimize the risk of earthquakes triggered by industrial activities. Computing system 110 can use the photography data for regulatory and policy development for informed decision-making by providing the data needed for policymakers to create regulations that ensure the safe operation of activities that might induce seismicity. Regulations based on scientific studies can also help protect public safety by setting limits on activities that could trigger significant seismic events.

Computing system 110 can use photography data to evaluate economic considerations by performing a cost-benefit analysis of the risks and potential costs associated with induced seismicity. This allows computing system to perform better economic planning and risk management for industries involved in activities like oil and gas extraction. Computing system 110 can also use accurate risk assessments to determine insurance premiums and liability for companies, ensuring they are prepared for potential seismic events. Computing system 110 can evaluate the environmental impact of induced seismic events by determining how earthquakes affect local ecosystems, helping to develop strategies to protect flora and fauna from seismic disturbances. Insights from these studies may also promote the adoption of more sustainable industrial practices that minimize environmental impact. In some embodiments, computing system 110 uses the photography data to enhance community engagement and trust. For example, transparency may provide communities with clear, scientific information about the risks and impacts of induced seismicity, which helps build trust and ensures that public concerns are addressed. Engaging with stakeholders, including local communities, industry representatives, and policymakers, also ensures that diverse perspectives are considered in risk management strategies.

Computing system 110 can calculate various derived metrics based on the photography data. For example, computing system 110 can calculate a seismic activity index from the frequency and magnitude of recorded earthquakes in a given area. In some embodiments, computing system 110 calculates a risk exposure metric by combining population density and infrastructure vulnerability to estimate potential impacts. Computing system 110 can calculate a recovery rate metric indicating the speed at which an ecosystem or community recovers post-seismic event. The data sources used by computing system 110 for seismogenic risk studies may include seismological data (e.g., seismic/earthquake data sources 508) which may provide metrics such as earthquake magnitude, depth, location, and frequency. The data sources may include geological and geophysical data (e.g., geological data sources 506) such as geological surveys, satellite imagery, and remote sensing data, which computing system 110 can use to generate metrics such as fault lines, soil composition, and ground deformation.

In some embodiments, the data sources may include environmental data (e.g., from environmental monitoring stations, satellite data, etc.) which computing system 110 can use to generate metrics such as soil moisture, vegetation cover, and water quality. In some embodiments, the data sources include socioeconomic data (e.g., census data, economic reports, infrastructure databases, etc.) which computing system 110 can use to generate metrics such as population density, building types, and economic activity. The data sources may include photographic records obtained from field surveys, drone imagery, historical photographs, etc., which computing system 110 can use to generate metrics such as visual documentation of landscape changes, infrastructure damage, and habitat disruption.

Computing system 110 can identify or derive various correlations between the photography data and other data sources 502. For example, computing system 110 can develop a correlation between the seismic activity index vs. environmental data. Higher seismic activity often correlates with increased ground deformation and changes in soil and water quality. In some embodiments, computing system 110 develops a correlation between risk exposure vs. population density and infrastructure vulnerability. For example, higher population density and infrastructure vulnerability typically correlate with greater risk exposure. In some embodiments, computing system 110 develops a correlation between recovery rate vs. habitat characteristics and environmental data. The recovery rate of ecosystems can be influenced by habitat characteristics and environmental conditions. In some embodiments, computing system 110 develops a correlation between photographic records vs. damage assessment and monitoring. For example, photographic records may provide visual evidence that can be correlated with quantitative damage assessments and environmental monitoring data. In some embodiments, computing system 110 develops a correlation between genetic sampling vs. species distribution and habitat characteristics. For example, genetic diversity within species populations often correlates with their distribution and the characteristics of their habitats.

In some embodiments, the biology/ecology data sources include dead zones data. Dead zones refer to areas or zones with low seismic activity. Computing system 110 can use data on dead zones for various purposes such as risk mitigation, infrastructure planning, and public safety. For example, identifying dead zones helps allow computing system 110 to identify areas with potential stress accumulation, which could lead to future seismic activity. Dead zones data can be used for planning and designing infrastructure to withstand potential seismic events and provides valuable information for emergency preparedness and response planning.

Data collector 526 can collect dead zones data from a variety of data sources. For example, seismic surveys (e.g., onshore and offshore seismic surveys) may use sources such as dynamite, weight drop, vibratory sources, or marine sources to identify subsurface structures and fault lines. Seismometer networks can also provide dead zone data by deploying a network of seismometers to continuously record seismic activity over a wide area to ensure comprehensive data collection. Dead zone data sources may include geological and geophysical data. For example, geological mapping may include performing detailed geological mapping to identify surface expressions of faults and other geological features. Geophysical methods may include gravity surveys, magnetic surveys, and electrical resistivity to complement seismic data and provide a more complete picture of subsurface structures. In some embodiments, dead zone data sources include GPS and alignment arrays. For example, GPS monitoring may include installing GPS stations to monitor crustal movements and deformation and gather data indicating the stress accumulation and release patterns in the earth's crust. Alignment arrays can be used to measure slow crustal movements and detect any changes over time.

In some embodiments, dead zone data sources include remote sensing and satellite data. For example, computing system 110 can use satellite imagery and remote sensing techniques to identify surface deformations and changes in landforms. Computing system 110 may use interferometric synthetic aperture radar (InSAR) data to detect ground displacement with high precision, which is useful for identifying areas of strain accumulation. Dead zone data sources may include paleoseismology data such as trenching (e.g., excavating trenches across active faults to study past earthquake events) to describe and date sedimentary layers affected by earthquakes and/or radiocarbon dating to determine the age of sediment layers and constrain the history of seismic activity. In some embodiments, dead zone data sources include data integration and analysis such as 3D geological modeling to integrate seismic, geological, and geophysical data into a 3D geological model to visualize subsurface structures and identify dead zones. Dead zone data sources may further include seismic hazard assessments which analyze the integrated data to assess seismic hazards and identify areas with low seismic activity.

Computing system 110 can calculate various derived metrics based on the dead zones data. For example, computing system 110 can generate subsurface structure identification metrics such as the depth, orientation, and extent of subsurface structures and fault lines. Computing system 110 can calculate a seismic activity level metrics indicating a frequency, magnitude, and/or distribution of seismic events recorded by the seismometer network. In some embodiments, computing system 110 uses the dead zones data to determine crustal movement and deformation rates as measured by GPS stations and alignment arrays. Computing system 110 can use the dead zones data to determine surface deformation such as changes in landforms and ground displacement detected by satellite imagery and InSAR. In some embodiments, computing system 110 calculates a historical seismic activity metric indicating an age and frequency of past earthquake events determined through trenching and radiocarbon dating. Computing system 110 may generate a seismic hazard assessment metric identifying areas with low seismic activity (dead zones) and potential seismic hazards. In some embodiments, computing system 110 uses the dead zones data to perform calculations such as 3D geological modeling by integrating seismic, geological, and geophysical data into a 3D model to visualize subsurface structures. In some embodiments, computing system 110 performs a seismic hazard analysis (e.g., analysis of integrated data to assess seismic hazards and identify dead zones), including statistical analysis of seismic activity levels and historical earthquake events.

Computing system 110 can identify or derive various correlations between the dead zones data and other data sources 502. For example, computing system 110 can develop a correlation between seismic surveys and seismometer networks. Both provide data on seismic activity. Seismic surveys help identify subsurface structures, while seismometer networks continuously record seismic events. Together, they offer a comprehensive view of seismic activity and fault lines. In some embodiments, computing system 110 develops a correlation between geological mapping and geophysical methods. For example, geological mapping identifies surface expressions of faults, while geophysical methods (e.g., gravity, magnetic, and electrical resistivity surveys) provide additional data on subsurface structures. These methods complement seismic data to give a fuller picture of the geological environment.

In some embodiments, computing system 110 develops a correlation between GPS monitoring and alignment arrays. These tools measure crustal movements and deformation. GPS stations track large-scale movements, while alignment arrays detect slower, more subtle changes. Computing system 110 can use data from these sources to determine an estimated stress accumulation and release patterns in the earth's crust. In some embodiments, computing system 110 develops a correlation between satellite imagery and InSAR data. Satellite imagery provides visual data on surface deformations, while InSAR detects ground displacement with high precision. Computing system 110 can use such data to identify areas of strain accumulation and surface changes over time.

In some embodiments, computing system 110 develops a correlation between paleoseismology data such as trenching and radiocarbon dating. For example, trenching involves excavating across faults to study past earthquake events, while radiocarbon dating determines the age of sediment layers. Computing system 110 can use this type of data to evaluate the frequency and magnitude of past seismic activity. In some embodiments, computing system 110 develops a correlation using 3D Geological modeling and seismic hazard assessment, for example, by integrating data from all the above methods into a 3D geological model to visualize subsurface structures and identify dead zones. Seismic hazard analysis may include using this integrated data to evaluate potential risks and identify areas with low seismic activity.

In some embodiments, the biology/ecology data sources include biodiversity data. Biodiversity data may include baseline biodiversity data such as flora and fauna surveys which provide information on the presence, abundance, and distribution of plant and animal species and/or habitat mapping data providing a mapping of critical habitats and biodiversity hotspots. Computing system 110 can use the baseline biodiversity data to assess the biodiversity value of the area and identify species that need protection. Computing system 110 can use the habitat mapping data to guide the placement of seismic monitoring equipment and help in planning mitigation measures to avoid or minimize habitat disruption. In some embodiments, biodiversity data include ecosystem health indicators such as water quality data (e.g., measurements of water quality parameters in rivers, lakes, and other water bodies) and vegetation cover data (e.g., information on the extent and health of vegetation cover). Computing system 110 can use the ecosystem health indicators to monitor the impact of seismic activities on water bodies, ensuring that seismic operations do not degrade water quality. Computing system 110 can use the ecosystem vegetation cover data to detect changes in vegetation cover due to seismic activities, helping to identify areas that may need restoration.

Biodiversity data may include environmental impact data such as impact assessments (e.g., data on the potential impacts of seismic activities on biodiversity, including habitat loss and fragmentation) and/or mitigation measures (e.g., information on strategies to mitigate negative impacts on biodiversity). Computing system 110 can use the ecosystem impact assessments to inform the development of strategies to mitigate negative impacts and ensure that seismic activities are conducted in an environmentally responsible manner. Computing system 110 can use the mitigation measures to implement practical steps to protect biodiversity, such as creating buffer zones, restoring habitats, and monitoring affected areas. In some embodiments, biodiversity data include community and stakeholder data such as traditional ecological knowledge (e.g., insights from local communities about biodiversity and ecosystem health) and stakeholder consultations (e.g., data from consultations with conservation organizations, government agencies, and other stakeholders). Computing system 110 can use the traditional ecological knowledge to enhance scientific data with local knowledge, ensuring that conservation efforts are culturally appropriate and effective. Computing system 110 can use the stakeholder consultations to ensure that all relevant parties are involved in the planning and decision-making process, promoting collaboration and support for biodiversity conservation efforts.

Computing system 110 can calculate various derived metrics based on the biodiversity data. For example, computing system 110 can use flora and fauna surveys to generate a species richness and abundance metric indicating a number of different species (richness) and the population size of each species (abundance). Computing system 110 can use the habitat mapping and remote sensing data to generate a habitat integrity metric indicating the extent and condition of critical habitats by measuring the area of habitats and assessing their condition using indicators like vegetation cover and presence of invasive species. In some embodiments, computing system 110 uses the water quality measurements from field surveys to generate a water quality index (WQI). The WQI may be a composite index based on multiple water quality parameters (e.g., pH, turbidity, dissolved oxygen, etc.) and can be calculated using a weighted formula to combine individual water quality parameters into a single index. Computing system 110 can use satellite imagery and field surveys to generate a vegetation health index (VHI) metric indicating the health of vegetation cover. The VHI can be calculated using remote sensing indices such as the normalized difference vegetation index (NDVI) to assess vegetation health.

In some embodiments, computing system 110 uses seismometer networks and seismic surveys to calculate a seismic activity levels metric indicating the frequency and magnitude of seismic events. Computing system 110 may use data from the GPS monitoring and alignment arrays to calculate a crustal deformation rate metric indicating the rate of crustal movement and deformation. For example, computing system 110 may measure the displacement of GPS stations over time and calculate the rate of movement. In some embodiments, computing system 110 uses the paleoseismology data from trenching and radiocarbon dating to calculate a historical seismic activity metric indicating the frequency and magnitude of past earthquakes. Computing system 110 may use the environmental impact assessments to generate an impact assessment score, which may be a composite score assessing the potential impact of seismic activities on biodiversity. Computing system 110 can calculate the impact assessment score by combining scores from various impact indicators (e.g., habitat loss, species displacement, etc.) into a single impact score.

Computing system 110 can identify or derive various correlations or connections between the biodiversity data and other data sources 502. For example, computing system 110 can develop a connection between flora and fauna surveys. These surveys provide baseline data on species presence, abundance, and distribution. Computing system 110 can use this information to identify biodiversity hotspots and determine the ecological dynamics of an area. Additionally, flora and fauna surveys can be used to guide habitat mapping efforts by highlighting areas of high biodiversity value. In some embodiments, computing system 110 uses the habitat mapping data to identify and delineate critical habitats and biodiversity hotspots. Computing system 110 may use data from flora and fauna surveys to ensure accurate representation of ecological zones. Habitat maps can also be used for planning conservation strategies and assessing the potential impacts of seismic activities on different habitats.

In some embodiments, computing system 110 uses the water quality measurements to provide insights into the health of aquatic ecosystems. Computing system can connect the water quality measurements to flora and fauna surveys to determine the relationship between water quality and species health. Good water quality is vital for maintaining healthy populations of aquatic species, which in turn supports overall biodiversity. Computing system 110 may use the vegetation cover data to determine the extent to which healthy vegetation cover supports diverse animal species and contributes to ecosystem stability. In some embodiments, computing system 110 uses the environmental impact assessments to develop mitigation measures to protect biodiversity from the adverse effects of seismic activities. Computing system 110 may use traditional ecological knowledge to fill gaps in scientific data and offer culturally appropriate conservation strategies. Computing system 110 may use stakeholder consultations to prioritize conservation actions and ensure that they are supported by the community. In some embodiments, computing system 110 uses the remote sensing and GIS data to monitor large areas, making it easier to detect changes in biodiversity and habitat conditions. Computing system 110 may integrate and analyze data from a variety of data sources 502 to support the development of effective conservation strategies and ensure that seismic risk studies consider the full spectrum of biodiversity impacts.

### Critical Infrastructure

In some embodiments, other data sources 516 include critical infrastructure data sources. Critical infrastructure data sources may provide information on critical infrastructure such as important buildings, power plants, power supply networks, water treatment plants, water supply systems, communications networks, or other infrastructure which may be critical or important to the operation of a city, county, state, or other geographic or geopolitical region. In some embodiments, critical infrastructure data sources provide data such as the location, layout, and type of critical infrastructure components.

Critical infrastructure data can be obtained from a variety of data sources such as seismic hazard maps (e.g., maps showing the seismic hazard levels in the area, including fault lines and historical earthquake data), seismic event records (e.g., data from seismometer networks on the frequency, magnitude, and location of seismic events), and ground motion data (e.g., information on expected ground motion and shaking intensity during seismic events). In some embodiments, critical infrastructure data include vulnerability data such as structural vulnerability assessments (e.g., valuations of the infrastructure's ability to withstand seismic forces, including potential failure points) and functional vulnerability assessments (e.g., analysis of how seismic events could impact the functionality of the infrastructure). Critical infrastructure data may include dependency and interdependency data. Dependency data may include data on the dependencies between different infrastructures (e.g., power plants relying on water supply systems). Interdependency data may include information on how the failure of one infrastructure could affect others (e.g., a power outage impacting hospitals and communication networks). In some embodiments, critical infrastructure data includes community and stakeholder data. For example, stakeholder consultations may include input from local communities, government agencies, and infrastructure operators. Traditional ecological knowledge may be provided by local communities about the natural environment and its resilience to seismic events. Critical infrastructure data may include monitoring and maintenance data such as sensor data (e.g., continuous monitoring data from sensors installed on critical infrastructure to detect structural health and performance), maintenance records (e.g., historical data on maintenance activities, repairs, and upgrades).

In some embodiments, data collector 526 gathers critical infrastructure data from geographic information systems (GIS), for example, by using GIS to map and analyze the spatial distribution of critical infrastructure and seismic hazards. In various embodiments, critical infrastructure data can be provided by remote sensing (e.g., using satellite imagery and aerial surveys to gather data on infrastructure and environmental conditions), field surveys (e.g., conducting on-site inspections and surveys to collect detailed structural and operational data). Critical infrastructure data may be obtained from seismometer networks (e.g., by deploying seismometers to continuously record seismic activity) and/or GPS monitoring (e.g., using GPS stations to monitor crustal movements and deformation).

In some embodiments, the critical infrastructure data includes location data. Location data may indicate proximity to fault lines. Computing system 110 can use the location data to determine a risk of damage. For example, infrastructure located near active fault lines may be at a higher risk of experiencing severe ground shaking and potential structural damage during an earthquake. Computing system 110 can also such data for mitigation planning by designing and implementing appropriate mitigation measures, such as retrofitting buildings to withstand seismic forces. In some embodiments, location data indicates ground conditions such as soil liquefaction and site-specific design. For example, areas with loose, water-saturated soils may be prone to liquefaction during an earthquake, which can cause significant damage to foundations and structures. Site-specific design may allow computing system 110 to develop site-specific engineering solutions, such as deep foundations or soil stabilization techniques.

In some embodiments, location data indicate accessibility and evacuation routes. The location affects the accessibility of critical infrastructure for emergency response teams. Computing system 110 may use the location data to determine that infrastructure in remote or hard-to-reach areas may face delays in receiving aid. Computing system 110 can use the location data to plan effective evacuation routes considering the location to ensure safe and quick evacuation of people during a seismic event. In some embodiments, the location data indicate interdependencies with other infrastructure. For example, computing system 110 can use the location data to determine the interdependencies between different infrastructures and predict cascading failures as a result of interdependent infrastructure components failing. Computing system 110 can use these interdependencies to plan for redundancies and backup systems to maintain functionality during and after an earthquake.

In some embodiments, the location data indicates environmental and biodiversity impact. For example, infrastructure located in environmentally sensitive areas or biodiversity hotspots may face additional challenges in balancing seismic risk mitigation with environmental conservation. Computing system 110 may use the location data to develop strategies to minimize the environmental impact of seismic activities, such as creating buffer zones or implementing conservation measures. In some embodiments, the location data indicate socioeconomic factors. For example, computing system 110 may determine that infrastructure in densely populated areas poses a higher risk to human life and requires more robust emergency preparedness and response plans. Computing system 110 may determine that the economic significance of the infrastructure's location affects the prioritization of resources for seismic risk mitigation. For example, critical infrastructure in economically vital areas may receive more attention and funding for resilience measures. In some embodiments, the location data indicate historical seismic activity. Computing system 110 can use the locations with a history of seismic activity as data for predicting future events and assessing the vulnerability of infrastructure. Computing system 110 can also use historical seismic activity data for refining risk assessments and improving the accuracy of seismic hazard models.

Computing system 110 can calculate various derived metrics based on the location data. For example, computing system 110 can generate a proximity to fault lines metric indicating the distance between the infrastructure component and the nearest fault line. Computing system 110 can use geotechnical surveys and soil sampling data to generate a ground conditions metric indicating soil liquefaction potential. Computing system 110 may use transportation network data and emergency response plans to generate an accessibility and evacuation routes metric which provides an accessibility score and evacuation time. For example, computing system 110 can analyze road networks and calculate the time required for emergency services to reach the infrastructure and for evacuation.

In some embodiments, computing system 110 uses infrastructure network data and operational data to calculate an interdependency index indicating a dependency between a given infrastructure component and other infrastructure. For example, computing system 110 may identify and map dependencies between infrastructures using network analysis tools, and calculate an index based on the number and criticality of dependencies. In some embodiments, computing system uses census data and economic reports to calculate a socioeconomic factors metric indicating population density and economic impact score. For example, computing system 110 can calculate population density using census data and assess the economic impact based on the infrastructure's role in the local economy. In some embodiments, computing system 110 uses historical earthquake records and seismometer data to generate a historical seismic activity metric indicating seismic activity frequency and magnitude. For example, computing system 110 can analyze historical data to calculate the frequency and average magnitude of seismic events in the area.

Computing system 110 can identify or derive various correlations between the location data and other data sources 502. For example, computing system 110 can determine a correlation between proximity to fault lines and ground conditions. The distance to fault lines and the type of ground conditions (e.g., soil type, liquefaction potential) both influence the seismic vulnerability of infrastructure. Computing system 110 may determine that infrastructure closer to fault lines and in areas with poor ground conditions is more likely to experience severe damage during an earthquake. In some embodiments, computing system 110 develops a correlation between accessibility and evacuation routes. For example, the location of infrastructure affects its accessibility for emergency response and evacuation. Computing system 110 may determine that areas with good road networks and clear evacuation routes can better handle emergencies, reducing the risk to human life and ensuring quicker recovery.

In some embodiments, computing system 110 develops a correlation based on the location information and interdependencies with other infrastructure. For example, computing system 110 may determine that the location determines the interdependencies between different infrastructures. In some embodiments, computing system 110 develops a correlation using socioeconomic factors. The population density and economic significance of the location influence the prioritization of resources for seismic risk mitigation. Computing system 110 may determine that densely populated and economically vital areas require more robust infrastructure and emergency planning. In some embodiments, computing system 110 develops a correlation using historical seismic activity. Historical seismic activity data helps in understanding the seismic risk of a location. Computing system 110 may determine that areas with a history of frequent and severe earthquakes require more stringent building codes and preparedness measures.

In some embodiments, the critical infrastructure data includes layout data. Layout data may indicate the structural integrity and resilience of various infrastructure components based on their design and layout. Layout data may include the layout of infrastructure, including the arrangement of buildings, equipment, and utilities, which affects its ability to withstand seismic forces. A well-planned layout can enhance structural integrity and resilience by ensuring that seismic loads are distributed evenly across the structure and reduces the risk of localized failures, whereas a poor layout may make the infrastructure component more susceptible to damage from seismic events by concentrating seismic loads at certain points. In some embodiments, computing system 110 uses the layout data for planning accessibility and emergency response. For example, the layout determines the accessibility of critical infrastructure for emergency response teams. Computing system 110 can use an existing layout or recommend changes to the layout to ensure well-planned access routes for quick and efficient emergency response. In some embodiments, computing system 110 plans layouts of infrastructure components by designating evacuation routes and assembly points to facilitate the safety of personnel during a seismic event.

In some embodiments, the layout information indicates interdependencies and redundancies between infrastructure components. For example, the proximity of power supply systems to communication networks can influence their mutual resilience. Computing system 110 can use the layout information for redundancy planning by developing a strategic layout that incorporates redundancies, such as backup power supplies and alternative communication routes, to ensure continued operation during and after an earthquake. In some embodiments, the layout information indicates environmental and biodiversity considerations. Computing system 110 can generate a layout that considers environmental and biodiversity impacts, ensuring that critical infrastructure does not disrupt sensitive ecosystems or biodiversity hotspots. Computing system 110 may incorporate green spaces and natural buffers in the layout to help mitigate environmental impacts and enhance the overall sustainability of the infrastructure.

In some embodiments, the layout data includes risk mitigation and management information. For example, the layout information may indicate or may be based on seismic zoning regulations. Computing system 110 may use this information to recommend or design a layout that places critical components in areas with lower seismic risk when possible. Computing system 110 may use the layout to facilitate the implementation of seismic mitigation measures, such as base isolators and shock absorbers, to protect critical infrastructure. In some embodiments, the layout data includes operational efficiency information such as a functional layout of safety protocols. Computing system 110 can use or develop a layout that enhances operational efficiency by optimizing the placement of equipment and facilities, reducing downtime and improving maintenance access. Computing system 110 may ensure that the layout supports safety protocols, ensuring that critical systems are easily accessible for inspection and maintenance.

Computing system 110 can calculate various derived metrics based on the layout data. For example, computing system 110 can use engineering assessments and structural analysis reports to generate a structural integrity and resilience metric indicating a structural resilience score. Computing system 110 can evaluate the design and materials used and calculate the resilience score based on factors such as load distribution, redundancy, and compliance with seismic building codes. In some embodiments, computing system 110 uses transportation network data and emergency response plans to generate an accessibility and emergency response metric including an accessibility index and evacuation time. For example, computing system 110 can analyze road networks and calculate the time required for emergency services to reach the infrastructure and for evacuation using GIS tools.

In some embodiments, computing system 110 uses infrastructure network data and operational data to generate an interdependencies and redundancies metric including an interdependency index and redundancy score. For example, computing system 110 may identify and map dependencies between infrastructures using network analysis tools and calculate an index based on the number and criticality of dependencies. Computing system 110 can assess redundancy by evaluating backup systems and alternative routes. In some embodiments, computing system 110 uses seismic hazard maps and mitigation plans to generate a risk mitigation and management metric indicating a seismic risk mitigation score. For example, computing system 110 may evaluate the implementation of seismic mitigation measures (e.g., base isolators, shock absorbers) and calculate a score based on their effectiveness and coverage. In some embodiments, computing system 110 uses operational data and maintenance records to generate an operational efficiency metric indicating an operational efficiency index. For example, computing system 110 can assess the layout's impact on operational efficiency by analyzing the placement of equipment and facilities, maintenance access, and downtime.

Computing system 110 can identify or derive various correlations between the layout data and other data sources 502. For example, computing system 110 can determine a correlation between structural integrity and resilience. The design and layout of infrastructure influence its structural resilience. Proper layout ensures even load distribution and enhances the ability to withstand seismic forces. In some embodiments, computing system 110 develops a correlation between accessibility and emergency response. The layout affects the accessibility of infrastructure for emergency response teams and the efficiency of evacuation routes. Clear access routes and well-planned evacuation paths are crucial for safety. In some embodiments, computing system 110 develops a correlation between interdependencies and redundancies. The layout determines the interdependencies between different infrastructure components and the effectiveness of redundancies. Proximity and connectivity influence how one infrastructure's failure impacts others. In some embodiments, computing system 110 develops a correlation between risk mitigation and management. The layout facilitates the implementation of seismic mitigation measures, such as base isolators and shock absorbers, to protect critical infrastructure. In some embodiments, computing system 110 develops a correlation between layout and operational efficiency. A functional layout enhances operational efficiency by optimizing the placement of equipment and facilities, reducing downtime, and improving maintenance access.

In some embodiments, the critical infrastructure data includes type data. Type data may indicate different vulnerabilities of infrastructure components based on structural differences and operational sensitivity. For example, different types of infrastructure (e.g., hospitals, power plants, bridges) have varying structural designs and materials, which affect their vulnerability to seismic forces.

The operational requirements and sensitivity to disruptions may vary for different infrastructure types. In some embodiments, the type data indicates the impact on public safety and services. For example, critical infrastructure provides essential services such as healthcare, electricity, water supply, and transportation. Disruptions to critical infrastructure can have severe consequences for public safety and well-being. Additionally, infrastructure such as fire stations and emergency response centers are vital during and after a seismic event. Their functionality directly impacts the effectiveness of emergency response efforts.

In some embodiments, the type data indicates economic significance. For example, the type data may indicate the economic impact caused by damage to economically significant infrastructure, such as ports, airports, and industrial facilities. Damage to these types of infrastructure components can have widespread economic repercussions, affecting trade, employment, and economic stability. The cost of repairing and rebuilding critical infrastructure can be substantial, impacting local and national economies. In some embodiments, the type data indicates interdependencies between infrastructure components. For example, network systems may include systems in which many critical infrastructures are interconnected. Interdependency information may also indicate redundancy and backup information to ensure resilience. Computing system 110 can use these interdependencies to evaluate effective risk management.

In some embodiments, the type data indicates regulatory and compliance requirements. For example, the type data may include building codes and standards. Different types of infrastructure are subject to specific building codes and standards, especially regarding seismic resilience. The type data may indicate the specific types of regulations that apply to different types of infrastructure components. Additionally, each type of infrastructure may have sector-specific guidelines and best practices for seismic risk mitigation. In some embodiments, the type data includes environmental and social considerations such as environmental impact (e.g., the environmental impact of infrastructure damage varies) and social impact (e.g., the social impact of infrastructure failure also varies).

Computing system 110 can calculate various derived metrics based on the type data. For example, computing system 110 can use engineering assessments and structural analysis reports to generate a structural integrity and resilience metric indicating a structural resilience score. Computing system 110 can calculate the structural resilience score by evaluating the design, materials, and construction methods used, based on factors such as load distribution, redundancy, and compliance with seismic building codes. In some embodiments, computing system 110 uses operational data and maintenance records to generate an operational continuity metric such as an operational continuity index. For example, computing system 110 can assess the ability of the infrastructure to maintain operations during and after a seismic event and consider factors such as backup systems, redundancy, and emergency response plans. In some embodiments, computing system 110 uses economic reports and industry data to generate an economic impact metric including an economic impact score. For example, computing system 110 can estimate the potential economic losses due to infrastructure damage including direct costs (e.g., repair and replacement) and indirect costs (e.g., economic disruption, loss of services).

In some embodiments, computing system 110 uses infrastructure network data and operational data to generate an interdependencies and redundancies metric including an interdependency index and redundancy score. For example, computing system 110 can identify and map dependencies between infrastructures using network analysis tools. Computing system 110 can calculate an index based on the number and criticality of dependencies and assess redundancy by evaluating backup systems and alternative routes. In some embodiments, computing system 110 uses environmental impact assessments (EIA) and social impact studies to generate an environmental and social impact metric including an environmental impact score and social impact index. For example, computing system 110 can combine data on environmental sensitivity, species richness, and habitat types to calculate an environmental impact score. Computing system 110 can use social impact indices to assess the effect on local communities.

In some embodiments, critical infrastructure data include operations data. Data collector 526 can obtain operations data from seismic monitoring networks. For example, seismometers and accelerometers may be deployed to measure ground motion and vibrations and may provide real-time data on seismic activity. Computing system 110 can use the information from seismic monitoring networks to determine the intensity and frequency of earthquakes. Seismic monitoring networks may also include GPS stations configured to monitor ground deformation, which can indicate tectonic movements and stress accumulation in the earth's crust. In some embodiments, operations data includes structural health monitoring (SHM) data. Data collector 526 can obtain SHM data from sensors on infrastructure (e.g., includes strain gauges, tiltmeters, and displacement sensors). Installing sensors on critical infrastructure (e.g., bridges, dams, pipelines) helps monitor their response to seismic events.

In some embodiments, operations data includes geotechnical investigations such as borehole data and geophysical surveys. For example, drilling boreholes and collecting soil and rock samples may help assess the subsurface conditions. Computing system 110 can use such operations data to determine how seismic waves will propagate through different geological layers. Additionally, techniques like seismic refraction and reflection surveys may provide detailed images of the subsurface, which computing system 110 can use for identifying faults and other geological features. In some embodiments, operations data includes remote sensing and GIS data. For example, satellite imagery can detect changes in the earth's surface such as land deformation and fault movements. GIS integrates various data sources, allowing for spatial analysis and visualization of seismic risks and infrastructure vulnerabilities.

In some embodiments, operations data includes historical and instrumental seismic data such as earthquake catalogs and intensity maps. Earthquake catalogs may provide information on past seismic events and may provide context for use by computing system 110 in identifying patterns and trends. Intensity maps may show the distribution of shaking intensity from past earthquakes, aiding in risk assessment. In some embodiments, operations data includes fragility and vulnerability assessments. For example, fragility curves may represent the probability of different damage states for infrastructure under varying seismic intensities. Vulnerability models may assess the potential impact of seismic events on infrastructure, considering factors like construction type, age, and maintenance. In some embodiments, operations data includes early warning systems such as earthquake early warning (EEW) systems. EEW systems may detect initial seismic waves and provide alerts before the more damaging waves arrive. This can help mitigate damage and enhance preparedness.

In some embodiments, computing system 110 uses operations data for risk assessment and mitigation. For example, computing system 110 can identify hazards such as active faults and areas prone to liquefaction using seismic monitoring networks and geotechnical investigations. Computing system can evaluate vulnerability using structural health monitoring and vulnerability assessments to determine how susceptible critical infrastructure is to seismic damage. Computing system can use operations data to develop mitigation strategies. For example, computing system 110 can design and implement measures to reduce the impact of seismic events, such as retrofitting buildings and reinforcing infrastructure. In some embodiments, computing system 110 uses operations data to improve preparedness and response. For example, computing system 110 can use data from seismic networks to develop and enhance earthquake early warning systems, providing crucial seconds to minutes of warning before strong shaking occurs. Computing system 110 can use GIS and remote sensing data to develop detailed emergency response plans, including evacuation routes and resource allocation.

In some embodiments, computing system 110 uses operations data to enhance design and construction standards. For example, computing system 110 can use geotechnical and structural data to inform the design of new infrastructure, ensuring it can withstand expected seismic forces. Computing system 110 can use continuous data collection and analysis to develop improvements in building codes and construction practices, enhancing overall safety. In some embodiments, computing system 110 uses operations data to conduct an economic and social impact analysis. For example, computing system 110 can conduct a cost-benefit analysis based on the potential damage and economic impact of seismic events and recommend prioritizing investments in mitigation and preparedness based on the cost-benefit analysis. Computing system 110 can use data-driven risk assessments to support community resilience planning, ensuring that critical services and infrastructure can recover quickly after an earthquake. In some embodiments, computing system 110 uses operations data for scientific research and knowledge advancement. For example, continuous data collection allows computing system to develop a scientific understanding of seismic processes and earthquake mechanics. Computing system 110 can use such information to improve predictive models and enhance the accuracy of predictive models, leading to better forecasts of seismic activity and potential impacts.

Computing system 110 can calculate various derived metrics based on the operations data. For example, computing system 110 can generate seismic hazard metrics such as peak ground acceleration (PGA) indicating the maximum acceleration of the ground during an earthquake (e.g., in units of gravity (g)). Computing system 110 can use data obtained from seismometers and accelerometers to calculate PGA from ground motion records. Computing system 110 can calculate a spectral acceleration (SA) metric representing the maximum acceleration of a structure at different periods of vibration using response spectra from ground motion records. In some embodiments, computing system 110 generates seismic vulnerability metrics such as fragility curves indicating the probability of a structure reaching or exceeding a certain damage state given a level of ground shaking. Computing system 110 can derive the fragility curves from empirical data, experimental results, and analytical models. For example, computing system 110 can develop the fragility curves using statistical methods to fit data from observed damage during past earthquakes. Computing system 110 can generate damage probability matrices (DPMs) which provide the probability of different damage levels for various types of structures. For example, computing system 110 can use historical earthquake damage data and expert judgment to calculate the DPMs by analyzing damage data and fitting probability distributions.

In some embodiments, computing system 110 generates seismic risk metrics such as annualized loss representing the expected annual economic loss due to earthquakes. For example, computing system 110 may calculate the annualized loss metric using probabilistic seismic risk models that integrate seismic hazard curves, exposure data (e.g., building inventory), and vulnerability functions. Another seismic risk metric which can be calculated by computing system 110 is the probable maximum loss (PML), which estimates the maximum loss that could occur with a specified probability over a given time period. Computing system 110 can use probabilistic seismic risk assessments and loss exceedance curves to determine the loss corresponding to a specific return period.

In some embodiments, computing system 110 generates structural health metrics such as inter-story drift ratio which measures the relative displacement between floors of a building. For example, computing system 110 may obtain measurements from displacement sensors and structural monitoring systems and calculate the inter-story drift ratio as the difference in displacement between two consecutive floors divided by the height of the story. Another structural health metric which can be generated by computing system 110 is the cumulative absolute velocity (CAV) which quantifies the cumulative effect of ground motion on a structure. For example, computing system 110 can use accelerometer data to integrate the absolute value of ground acceleration over the duration of the earthquake.

In some embodiments, computing system 110 generates geotechnical metrics such as shear wave velocity (Vs30) representing the average shear wave velocity in the top 30 meters of soil. For example, computing system 110 may use geophysical surveys and borehole data to calculate the shear wave velocity by averaging shear wave velocities measured at different depths. In some embodiments, computing system 110 generates early warning metrics such as a lead time metric indicating the time between the detection of initial seismic waves and the arrival of more damaging waves. For example, computing system 110 can use data from seismic monitoring networks to calculate the lead time metric based on the difference in arrival times of P-waves and S-waves.

Computing system 110 can identify or derive various correlations between the operations data and other data sources 502. For example, computing system 110 can determine a correlation between seismic hazard and structural response. Seismic hazard metrics (e.g., PGA, SA) directly impact the structural response of critical infrastructure. Higher ground accelerations and spectral accelerations can lead to greater structural demands. Additionally, structural health metrics (e.g., inter-story drift ratio, CAV) measure how the infrastructure responds to seismic forces. Computing system 110 can determine that the severity of the seismic hazard influences the extent of structural response and potential damage. In some embodiments, computing system 110 develops a correlation between geotechnical conditions and seismic vulnerability. For example, geotechnical metrics (e.g., Vs30, borehole data, etc.) Provide information about the subsurface conditions, which affect how seismic waves propagate and amplify. Computing system 110 can use seismic vulnerability metrics (e.g., fragility curves, DPMs) to determine the influence of geotechnical conditions on such metrics. In some embodiments, computing system 110 develops a correlation between operational continuity and risk metrics. For example, seismic risk metrics (e.g., annualized loss, PML) quantify the potential economic and operational impacts of seismic events. Computing system 110 can use these risk metrics to predict the potential downtime and service disruptions, which can be used for planning and maintaining operational continuity.

In some embodiments, computing system 110 develops a correlation between early warning systems and emergency response. For example, early warning metrics (e.g., lead time) may determine the effectiveness of early warning systems. The lead time provided by early warning systems is crucial for initiating emergency response actions, reducing casualties, and ensuring efficient evacuation. In some embodiments, computing system 110 develops a correlation between data integration and decision-making. For example, GIS and remote sensing data integrate various metrics and provide a spatial context for decision-making. Computing system 110 can integrate seismic hazard, vulnerability, risk, and operational metrics into GIS platforms to support informed decision-making for risk mitigation and emergency planning. In some embodiments, computing system 110 develops a correlation between resilience and recovery. For example, resilience metrics (e.g., recovery time, redundancy) assess the ability of infrastructure to recover from seismic events. Computing system 110 can use such metrics to develop maintenance and retrofit strategies. For example, computing system 110 can use data on structural health and vulnerability to inform maintenance and retrofit strategies to enhance resilience.

In some embodiments, critical infrastructure data include assessments data. Assessments data may include seismic hazard data. Data collector 526 can obtain seismic hazard data from seismic monitoring networks which use seismometers and accelerometers to measure ground motion and vibrations. Data collector 526 can also obtain seismic hazard data from historical seismic data sources such as historical earthquake records and catalogs to understand past seismic activity and trends. Data collector 526 can also collect seismic hazard data from geophysical surveys conducted using seismic refraction and reflection surveys to map subsurface geological structures and identify active faults. In some embodiments, assessments data include geotechnical data such as borehole data and shear wave velocity (Vs30) data. Borehole data can be obtained by drilling boreholes and collecting soil and rock samples to assess subsurface conditions. Computing system 110 can use data from standard penetration tests (SPT) and cone penetration tests (CPT) for detailed soil characterization. Vs30 data measures shear wave velocities in the top 30 meters of soil to evaluate site-specific ground motion amplification.

In some embodiments, assessments data include structural health data. Structural health data can be obtained from strain gauges, tiltmeters, displacement sensors, and accelerometers installed on critical infrastructure (e.g., bridges, dams, pipelines) to monitor their response to seismic events. Data collector 526 can continuously collect and store data from installed sensors. In some embodiments, assessments data include remote sensing and GIS data. For example, data collector 526 can acquire high-resolution satellite images to detect land deformation and fault movements. Data collector 526 can use GIS to integrate various data sources and perform spatial analysis of seismic risks and infrastructure vulnerabilities. In some embodiments, assessments data include vulnerability and fragility data. For example, computing system 110 can compile detailed inventories of critical infrastructure, including construction type, age, materials, and maintenance history. Computing system 110 can develop or obtain fragility curves that represent the probability of different damage states for infrastructure under varying seismic intensities.

In some embodiments, assessments data include operational and socio-economic data. Data collector 526 can collect data on the operational status, capacity, and redundancy of critical infrastructure. Data collector 526 can gather data on the potential economic and social impacts of seismic events, including population density, economic activities, and critical services. In some embodiments, assessments data include early warning and emergency response data. For example, data collector 526 can obtain data from early warning systems to provide alerts before strong shaking occurs. Data collector 526 can collect and integrate data on existing emergency response plans, evacuation routes, and resource allocation.

In some embodiments, data collector 526 combines all collected data into a centralized database or GIS platform for comprehensive analysis. Computing system 110 can use probabilistic seismic risk models to integrate hazard, vulnerability, and exposure data, and to calculate risk metrics such as annualized loss and probable maximum loss (PML). Computing system 110 can perform scenario-based analyses to evaluate the impact of different earthquake scenarios on critical infrastructure. In some embodiments, data collector 526 continuously monitors and collects data from real-time data sources to ensure continuous real-time monitoring of seismic activity and structural health. Data collector 526 may regularly update the data acquisition plan and risk assessment models based on new data and technological advancements.

In some embodiments, computing system 110 uses the assessments data to calculate various derived metrics. For example, computing system 110 may generate seismic hazard metrics such as peak ground acceleration (PGA) indicating the maximum acceleration of the ground during an earthquake (e.g., in units of gravity (g)). Computing system 110 can use data obtained from seismometers and accelerometers to calculate PGA from ground motion records. Computing system 110 can calculate a spectral acceleration (SA) metric representing the maximum acceleration of a structure at different periods of vibration using response spectra from ground motion records calculated using response spectra from ground motion records. In some embodiments, computing system 110 generates geotechnical metrics such as shear wave velocity (Vs30) representing the average shear wave velocity in the top 30 meters of soil. For example, computing system 110 may use geophysical surveys and borehole data to calculate the shear wave velocity by averaging shear wave velocities measured at different depths. Computing system 110 can use borehole drilling and sampling data to generate a borehole data metric which provides detailed information about subsurface conditions. The borehole data metric can be calculated based on laboratory tests and in-situ measurements.

In some embodiments, computing system 110 generates structural health metrics such as inter-story drift ratio which measures the relative displacement between floors of a building. For example, computing system 110 may obtain measurements from displacement sensors and structural monitoring systems and calculate the inter-story drift ratio as the difference in displacement between two consecutive floors divided by the height of the story. Another structural health metric which can be generated by computing system 110 is the cumulative absolute velocity (CAV) which quantifies the cumulative effect of ground motion on a structure. For example, computing system 110 can use accelerometer data to integrate the absolute value of ground acceleration over the duration of the earthquake.

In some embodiments, computing system 110 generates vulnerability and fragility metrics such as fragility curves and damage probability matrices (DPMs). Fragility curves show the probability of a structure reaching or exceeding a certain damage state given a level of ground shaking. Computing system 110 can calculate the fragility curves based on empirical data, experimental results, and analytical models. For example, computing system 110 can use statistical methods to fit data from observed damage during past earthquakes. DPMs provide the probability of different damage levels for various types of structures. Computing system 110 can use historical earthquake damage data and expert judgment to analyze damage data and fit probability distributions. In some embodiments, computing system 110 generates early warning metrics such as lead time indicating the time between the detection of initial seismic waves and the arrival of more damaging waves. For example, computing system 110 can use data from seismic monitoring networks to calculate the lead time based on the difference in arrival times of P-waves and S-waves.

In some embodiments, computing system 110 generates seismic risk metrics such as annualized loss representing the expected annual economic loss due to earthquakes. For example, computing system 110 may calculate the annualized loss metric using probabilistic seismic risk models that integrate seismic hazard curves, exposure data (e.g., building inventory), and vulnerability functions. Another seismic risk metric which can be calculated by computing system 110 is the probable maximum loss (PML), which estimates the maximum loss that could occur with a specified probability over a given time period. Computing system 110 can use probabilistic seismic risk assessments and loss exceedance curves to determine the loss corresponding to a specific return period.

Computing system 110 can identify or derive various correlations between the assessments data and other data sources 502. For example, computing system 110 can determine a correlation between seismic hazard and structural response. Computing system 110 can use seismic hazard metrics (e.g., PGA, SA) to determine the intensity of ground shaking. Computing system 110 can use structural health metrics (e.g., inter-story drift ratio, CAV) to determine how infrastructure responds to the shaking. For example, computing system 110 may determine that higher seismic hazard metrics typically lead to greater structural responses, indicating potential damage. In some embodiments, computing system 110 develops a correlation between geotechnical conditions and seismic vulnerability. Geotechnical metrics (e.g., Vs30, borehole data) provide information about soil and rock properties, whereas vulnerability metrics (e.g., fragility curves, DPMs) indicate how likely the infrastructure is to be damaged. Computing system 110 may determine that poor geotechnical conditions (e.g., soft soils) can increase vulnerability, leading to higher probabilities of damage.

In some embodiments, computing system 110 develops a correlation between operational continuity and risk metrics. Seismic risk metrics (e.g., annualized loss, PML) quantify potential economic and operational impacts. Operational metrics (e.g., downtime, service disruption) measure the impact on infrastructure functionality. Computing system 110 may determine that higher risk metrics often correlate with greater operational disruptions, highlighting the need for robust mitigation strategies. In some embodiments, computing system 110 develops a correlation between early warning systems and emergency response. Early warning metrics (e.g., lead time) determine the effectiveness of early warning systems. Emergency response metrics (e.g., response time, evacuation efficiency) measure the efficiency of emergency actions. Computing system 110 may determine that effective early warning systems can significantly improve emergency response metrics by providing crucial time for evacuation and preparation.

In some embodiments, computing system 110 develops a correlation between data integration and decision-making. GIS and remote sensing data integrate various data sources for spatial analysis. Decision support systems use integrated data to inform risk mitigation and emergency planning. Computing system 110 may determine that comprehensive data integration supports better decision-making, enhancing the overall resilience of critical infrastructure. In some embodiments, computing system 110 develops a correlation between resilience and recovery. Resilience metrics (e.g., recovery time, redundancy) assess the ability of infrastructure to recover from seismic events. Maintenance and retrofit strategies may include structural health and vulnerability data to inform these strategies. Computing system 110 may determine that improved resilience metrics indicate effective maintenance and retrofitting, reducing recovery time and enhancing overall infrastructure robustness.

### Models and Equations

In some embodiments, other data sources 516 include models and equations. Computing system 110 can be configured to use various models and equations when processing the raw input data from data sources 502, calculating derived metrics, training AI model 534, and/or during online operation of AI model or other portions of computing system 110. For example, computing system 110 can use the models and equations to predict the fluid flows, pressures, and other physical states or conditions that will result from potential control strategies for wellsite equipment 546 and assess the potential impacts on induced seismicity, land subsidence, well integrity, or other predictions generated by computing system 110.

In some embodiments, training data generator 528 uses the models and equations to generate training data for model trainer 530. For example, training data generator 528 can generate a set of input-output data for model trainer 530 using the models and equations, where the input data are inputs to one or more of the models and equations and the output data are outputs of one or more of the models and equations. Model trainer 530 can use the input-output data to train AI model 534 such that AI model 534 learns the relationships between variables provided by the models and equations, and consequently learns to make predictions that are consistent with the physical phenomena described by the models and equations. In some embodiments, AI model 534 uses the models and equations as part of a retrieval-augmented generation (RAG) technique that enhances the capabilities of AI model 534 by referencing the models and equations as types of external data sources. AI model 534 can use the models and equations to generate the model predictions, provide context to the model predictions, or otherwise support the various types of predictions and recommendations described throughout the present disclosure.

### a) Hydrologic Equations

In some embodiments, the models and equations include hydrologic equations for flow modeling. Hydrology is the branch of science concerned with properties of the earth's water, and especially its movement in relation to land. Computing system 110 can use hydrologic equations in injection well modeling for several reasons. For example, hydrologic equations can be used to predict fluid flows such as groundwater flow and fluid movement within injection zones. With respect to groundwater flow, computing system 110 can use hydrologic equations to understand the natural groundwater flow patterns (e.g., direction, velocity, residence time, etc.) that result from injection wells introducing fluids into the subsurface. Computing system 110 can use hydrologic equations to assess contamination risk (e.g., if injected fluids migrate towards drinking water sources, pose risks to ecosystems, or induce other environmental impacts) and/or to ensure proper well spacing and design (e.g., by predicting how injected fluids will move within the aquifer system to avoid interference with other wells or induce unwanted pressure changes). With respect to fluid movement within the injection zone, computing system 110 can use hydrologic equations to predict how the injected fluid will interact with the surrounding rock formations (e.g., fractures, permeability variations, etc.), which influences the distribution and potential for fluid migration.

In some embodiments, computing system 110 uses hydrologic equations to assess the potential impacts of various control strategies for wellsite equipment 546 (e.g., injection rates, injection volumes, pressures, locations, etc.) such as induced seismicity, land deformation, well integrity. For example, computing system 110 can use hydrologic equations to predict how injecting fluids can increase pore pressure in the subsurface, potentially triggering earthquakes, or how injecting fluids can lead to ground deformation. Computing system 110 can use hydrologic equations to model and predict the hydrogeology of the injection zone and assess the long-term integrity of the well (e.g., potential for corrosion, erosion, or wellbore stability). The following models and equations are examples that can be used by computing system 110 as part of a hydraulic model that establishes how a fluid flows within the subsurface and/or in a gridded model to determine how fluid moves through the model that is based on real-world data.

In some embodiments, computing system 110 uses Darcy's law of fluid flow to model or predict the movement of water or other fluids through an aquifer. Computing system 110 can use Darcy's law of fluid flow to determine how much fluid will flow through an aquifer based on the pressure difference and the permeability of the material through which the fluid flows. Darcy's law of fluid flow is represented in the following equations:

$$Q = \frac{k A}{η} \times \frac{Δ P}{L}$$

where Q is the fluid flow rate, k is the matrix permeability, A is the cross-sectional area through which the fluid passes, n is the fluid viscosity, and ΔP/L is a pressure gradient over a distance,

$$v = \frac{k Δ P}{η ϕ L}$$

where v is the interstitial pore velocity (m/s), L is the lateral distance, and φ is the porosity,

$${τ}_{D} = \frac{ηϕ {L}^{2}}{k Δ P}$$

where τ_{D} is the time frame (seconds), and

$$Δ {P}_{D} = \vert {F}_{D} - {H}_{D} \vert$$

where ΔP_{D} is the maximum pressure differential, F_{D} is the fracture gradient at a specified depth, and H_{D} is the original reservoir pressure gradient or hydrostatic gradient evaluated at the specified depth. This relation assumes that the formation is not already fractured due to over-pressuring and that ΔP is always positive. In some embodiments, computing system 110 uses the following simplified version of Darcy's law of fluid flow:

$$k = \frac{Δ d}{Δ t}$$

where Δd is the change in distance and Δt is the change in time.

In some embodiments, computing system 110 uses a hydraulic diffusivity model to predict how quickly pressure disturbances (e.g., changes in water level) propagate through an aquifer. In other words, the hydraulic diffusivity model can be used to predict the speed at which the disturbance will spread within the groundwater system. One example of a hydraulic diffusivity model which can be used by computing system 110 is represented in the following equations:

$$α = \frac{k}{η ( \frac{ϕ β}{1 - ϕ} + {β}_{f} )}$$

where α is the hydraulic diffusivity, k is the permeability in square meters (m²), η is the fluid viscosity of the fluid (e.g., CO₂) in kilograms per meter-second, φ is the fractional porosity (dimensionless), β is the bulk compressibility of the formation (1/MPa), and β_{f} is the fluid compressibility (1/MPa),

$${τ}_{h d} = \frac{{L}^{2}}{2 α}$$

where L is the lateral distance in meters (m) and τ_{hd} is the time scale of hydraulic diffusivity in seconds(s) , and

$${V}_{p} = \sqrt{\frac{K + \frac{4}{3} μ}{ρ}}$$

where Vₚ is the compressional-wave velocity, K is the fluid bulk modulus, u is the shear modulus, and p is the fluid density.

In some embodiments, computing system 110 uses a pore volume model to predict the pore volume of a grid that may be transferable to other grids nearby. One example of a pore volume model which can be used by computing system 110 is represented by the following equation:

$$P V = C G V \times P O R O \times N T G \times ACTNUM$$

where PV is the pore volume of a cell, CGV is the gross volume (or bulk volume) calculated from the structural parameters of the cell (also known as the cell gross volume), PORO is the cell porosity, NTG is the cell net-to-gross ratio, and ACTNUM is the active and inactive cell indicator.

In some embodiments, computing system 110 uses a transmissibility model to predict the flow between two cell faces which are not block centered, also known as transmissibility. One example of a transmissibility model which can be used by computing system 110 is represented by the following equation:

$${T}_{{x}_{i + \frac{1}{2} , j}} = {[ \frac{{k}_{x} h ( Δ y )}{μ ( Δ x )} ]}_{i + \frac{1}{2} j}$$

where:

$${T}_{{x}_{i + \frac{1}{2} , j}}$$

is the transmissibility of the cell face in the x-direction, kₓ is the permeability in the x direction, Δy is the grid block size in the y direction, u is the fluid viscosity, and Δx is the grid block size in the x direction.

### b) Geotechnical Seismic Equations

In some embodiments, the models and equations include geotechnical seismic models or equations. Computing system 110 can use geotechnical seismic models or equations to perform seismic hazard analysis, which is useful for a variety of purposes, particularly in regions prone to induced seismicity. For example, computing system 110 can use geotechnical seismic models or equations for safety and risk assessment by evaluating seismic hazards (e.g., simulating different earthquake scenarios to assess the potential for damage and loss of life).

In some embodiments, computing system 110 uses geotechnical seismic models or equations for emergency preparedness. For example, computing system 110 can use geotechnical seismic models or equations to assess the vulnerability of critical infrastructure (e.g., hospitals, power plants, transportation networks) to earthquakes and develop effective emergency response and disaster recovery plans. Computing system 110 can use geotechnical seismic models or equations to assist in the development and improvement of early warning systems, which can provide valuable seconds or minutes of warning before the strongest shaking arrives. In some embodiments, computing system 110 uses geotechnical seismic models or equations for research and development. For example, computing system 110 can use geotechnical seismic models or equations to predict earthquake ground motion and the complex interactions between ground shaking and structures. In some embodiments, computing system 110 uses geotechnical seismic models or equations to develop new modeling technologies such as more accurate and efficient seismic response models that incorporate more complex factors such as soil-structure interaction and non-linear material behavior. Advantageously, computing system 110 can use geotechnical seismic models or equations for protecting human life and property, improving the safety and resilience of built environments, and developing effective earthquake preparedness and emergency response strategies. The following are examples of geotechnical seismic models or equations that can be used by computing system 110.

In some embodiments, computing system 110 uses the Gutenberg-Richter recurrence law to relate the magnitude and number of earthquakes in a region. The Gutenberg-Richter recurrence law states that the number of earthquakes of a particular magnitude or greater is negatively correlated with the magnitude via a negative exponential relationship. In other words, the Gutenberg-Richter recurrence law provides that a given geographic region is likely to experience many more small earthquakes than large earthquakes. The Gutenberg-Richter recurrence law is represented in the following equations:

$$log {λ}_{m} = a - bm or {λ}_{m} = 1 {0}^{a - b m}$$

where m is the earthquake magnitude, λₘ is the mean annual rate of exceedance of magnitude m, a is the mean yearly number of earthquakes of magnitude greater than or equal to zero, and b is the likelihood of large and small earthquakes.

In some embodiments, computing system 110 uses a return period model to predict the likelihood of an earthquake exceeding a particular magnitude. One example of a return period model which can be used by computing system 110 is represented in the following equation:

$${T}_{R} = \frac{1}{{λ}_{m}}$$

where TR is the return period in years and λₘ is the mean annual rate of exceedance of magnitude m.

In some embodiments, computing system 110 uses one or more attenuation models to predict peak horizontal acceleration. Many attenuation models are known in the art and can be used by computing system 110, of which a few are provided as examples in the following equations. For example, computing system 110 can use the following equation to model or predict that the number of earthquakes decreases exponentially with increasing magnitude:

$$log Y = {b}_{1} + {b}_{2} {M}_{L} + {b}_{3} log R$$

where Y is the cumulative number of earthquakes with a magnitude greater than or equal to M, M is the earthquake magnitude, a is a constant that represents the total seismic activity in a region, and b is a constant that describes the relative number of earthquakes of a different magnitude. A higher ‘b’ value indicates fewer large earthquakes.

Another example of an attenuation model which can be used by computing system to predict peak ground acceleration (PGA) is shown in the following equation:

$$ln ( P G A ) = a + bM - c * ln ( R + d )$$

where PGA is the peak ground acceleration (i.e., the maximum ground acceleration that occurs during earthquake shaking at a specific location), M is the earthquake magnitude, R is the distance from the earthquake source, and a, b, c, and d are region-specific coefficients.

### c) Geomechanics and Pore Pressure Equations

In some embodiments, the models and equations include pore pressure models or equations. Computing system 110 can use pore pressure models or equations for several purposes when monitoring and controlling injection well operations. For example, computing system 110 can use pore pressure models or equations to ensure wellbore stability and integrity and prevent wellbore failure. Injecting water into a formation increases pore pressure, which can reduce the effective stress on the wellbore and increase the risk of wellbore collapse. Increased pore pressure can also lead to lost circulation. For example, if injection pressure exceeds formation fracture pressure, injected water can leak into surrounding formations, leading to lost circulation and potentially compromising well integrity.

In some embodiments, computing system 110 uses pore pressure models or equations to increase sweep efficiency and oil recovery. For example, computing system 110 can use pore pressure models or equations to predict how injected water will move through the reservoir. Computing system 110 can use such predictions to control water movement and optimize injection strategies. Computing system 110 can use pore pressure models and equations to improve sweep efficiency by ensuring that injected water effectively displaces oil from the reservoir rock. Poorly controlled pore pressure can lead to early water breakthrough at production or injection wells, reducing oil recovery. Computing system 110 can also use pore pressure models and equations to operate wellsite equipment 546 in a manner that maintains reservoir pressure and drives oil production. For example, modeling pore pressure helps ensure that injection rates are sufficient to maintain desired pressure levels without causing excessive pressure buildup.

In some embodiments, computing system 110 uses pore pressure models or equations to assess and mitigate the risk of induced seismic events. For example, in some cases, water injection can increase pore pressure to the point where it can trigger earthquakes. Computing system 110 can use the pore pressure models or equations to assess the risk of induced seismicity by identifying areas where injection-induced pressure changes are most likely to trigger seismic events. Computing system 110 can use the pore pressure models or equations to develop mitigation strategies (e.g., strategies predicted to reduce the risk of induced seismic events) by implementing measures to control injection rates and minimize the risk of induced seismicity. In some embodiments, computing system 110 uses pore pressure models or equations to assess the potential for injected water to migrate into surrounding aquifers or other sensitive environmental areas, which could lead to groundwater contamination.

Advantageously, computing system 110 can use pore pressure models or equations for ensuring safe and efficient injection operations, optimizing oil recovery, mitigating the risk of induced seismicity, and protecting the environment. By carefully modeling pore pressure changes using pore pressure models or equations, computing system 110 can design, recommend, and/or implement water injection programs that maximize oil recovery while minimizing risks to well integrity, the environment, and public safety. The following are examples of pore pressure models or equations that can be used by computing system 110.

In some embodiments, computing system 110 uses Terzaghi's effective stress principle to model the behavior of a saturated soil as being primarily controlled by the effective stress, which is the difference between the pore water pressure. Terzaghi's effective stress principle is represented in the following equation:

$${σ}^{′} = σ - {P}_{p}$$

where Pₚ is the pore pressure, σ′ is the effective stress, and σ is the total stress.

In some embodiments, computing system 110 employs overburden integration to calculate overburden pressure. Overburden pressure refers to the stress exerted on a subsurface formation by the weight of the overlying material, which includes different densities of fluid, sediment, and rock. This pressure increases with depth as the cumulative weight of the overlying layers grows. By integrating data from various sources and considering the diverse densities of materials, computing system 110 provides precise measurements of overburden pressure, a key calculation in accurately pore pressure in the subsurface. Computing system 110 can use the following equation to calculate overburden pressure:

$$σ = {\int }_{0}^{h} p ( z ) g d z$$

In some embodiments, computing system 110 uses Eaton's method to predict pore pressure. Eaton's method provides an empirical relationship between pore pressure and other variables as shown in the following equation:

$${P}_{p} = {P}_{h} + ( σ - {P}_{h} ) \times {( \frac{{V}_{obs}}{{V}_{norm}} )}^{n}$$

where Pₚ is the pore pressure, Pₕ is the hydrostatic pressure, σ is the overburden stress, V_{obs} is the observed velocity, Vₙₒᵣₘ is the normal velocity, and n is an exponent (typically between 3 and 5).

In some embodiments, computing system 110 uses Bower's method for undercompaction to predict pore pressure. Bower's method provides an empirical relationship between pore pressure and other variables as shown in the following equation:

$${P}_{p} = {P}_{h} + ( σ - {P}_{h} ) {e}^{- a ( {V}_{obs} - {V}_{norm} )}$$

where a is an empirical constant and the other variables are the same as described above.

In some embodiments, computing system 110 uses Bower's method for unloading to predict pore pressure. Bower's method for unloading provides an empirical relationship between pore pressure and other variables as shown in the following equation:

$${σ}_{ma x}^{′} = {( \frac{{V}_{m ax} - 5000}{A} )}^{\frac{1}{B}}$$

where σ′ₘₐₓ represents the effective stress at the onset of unloading, Vₘₐₓ denotes the velocity at the onset of unloading and A and B are empirical parameters obtained from offset well velocity versus effective stress relationship.

In some embodiments, computing system 110 uses Wyllie's equation to relate the velocity of sound in a porous rock to the porosity of the rock and the velocities of sound in the solid matrix and the fluid filling the pores. Wyllie's equation is defined as follows:

$$\frac{1}{{V}_{p}} = \frac{ϕ}{{V}_{f}} + \frac{1 - ϕ}{{V}_{m}}$$

where Vₚ is the P-wave velocity, V_{f} is the fluid velocity, Vₘ is the matrix velocity, and φ is the porosity.

In some embodiments, computing system 110 uses Eaton's fracture gradient to estimate the pressure required to initiate a hydraulic fracture in a rock formation. Eaton's fracture gradient can be represented using the following equation:

$$F = {P}_{h} + ( σ - {P}_{h} ) \times {( \frac{{P}_{p}}{σ} )}^{m}$$

where F is the fracture pressure, m is an exponent, and the other variables are the same as described above.

In some embodiments, computing system 110 calculates the fracture gradient (FG) of intact rock using the unconfined compressive strength (UCS) of the rock formation and the friction angle (q) over depth (D):

$$FG = \frac{UCS \times ( \frac{1 + sin φ}{1 - sin φ} )}{D}$$

In some embodiments, computing system 110 calculates stress coupling, which refers to the relationship between different stress components within a material or geological formation and involves the interaction between vertical, horizontal, and shear stresses. The coupled stress-strain relationships in the context of linear poroelasticity can be described by the following equations:

$${σ}_{v} = λ ( {ε}_{x} + {ε}_{y} + {ε}_{z} ) + 2 G {ε}_{v} + α {P}_{p}$$

$${σ}_{h} = λ ( {ε}_{x} + {ε}_{y} + {ε}_{z} ) + 2 G {ε}_{h} + α {P}_{p}$$

where σᵥ and σₕ are the respective vertical and horizontal stresses, λ is the first Lamé parameter (related to the material's bulk modulus), G is the shear modulus, εₓ, ε_{y}, ε_{z} are the strains in the respective directions, εᵥ and εₕ are the respective vertical and horizontal strains, α is the Biot's coefficient (representing the contribution of pore pressure to the stress), and Pₚ is the pore pressure.

In some embodiments, computing system 110 addresses stress coupling in seismic hazard analysis through the relationships between stress and strain in the earth's crust, as described by the seismic wave equations and the stress-strain relationships. The seismic wave equation accounts for the propagation of seismic waves through the earth's crust, which involves the interaction between different stress components. The equation can be expressed as follows:

$${σ}_{ij , j} + {f}_{i} = ρ \frac{{\partial }^{2} {u}_{i}}{\partial {t}^{2}}$$

This equation describes how the displacement (μᵢ) is influenced by the stress tensor (O_{ij,j}), density (φ, and body forces (fᵢ). The stress tensor itself is a result of coupled stress components in different directions.

The stress-strain relationship, given by Hooke's Law, describes the relationship between stress and strain in an elastic medium. The equation can be expressed as follows:

$${σ}_{ij} = {λδ}_{ij} {ε}_{k k} + 2 μ {ε}_{i j}$$

This equation shows how the stress components (σᵢⱼ) are related to the strain components (εᵢⱼ) through the Lamé parameters (λ and μ). The stress-strain relationship inherently includes the coupling between different stress components, as it accounts for the deformation of the material in multiple directions.

In some embodiments, computing system 110 uses the following equation to calculate the mud weight at a specific subsurface depth:

$$M W = \frac{{P}_{p} + σ t}{0.052 \times D}$$

where MW is the mud weight, σt is the tensile stress, and D is the true vertical depth (e.g., in feet).

In some embodiments, computing system 110 uses the following equation to calculate the pressure change of a fluid due to temperature:

$$Δ {P}_{p} = β \times V \times Δ T$$

where β is the coefficient of volumetric thermal expansion (a material property), V is the initial volume, ΔT is the change in temperature, and ΔPₚ is the change in pore pressure.

In some embodiments, computing system 110 uses the Hoop stress equation to access the wellbore strength that results in a localized pore pressure increase around a borehole. The Hoop stress equation can be expressed as follows:

$${σ}_{h} = \frac{{P}_{p} \times d}{2 \times t}$$

where: σₕ is the hoop stress, Pₚ is the formation pressure, d is the borehole diameter, and t is the wall thickness including mud filtrate.

In some embodiments, computing system 110 uses the Biot consolidation equation to predict the time dependent deformation of saturated soils under pressure. The Biot consolidation equation can be expressed as follows:

$$Δ d = \frac{α \times Δ {P}_{p}}{E \times ( 1 - 2 v )}$$

where: Δd is the surface deformation, a is the Biot coefficient, E is Young's modulus, and v is Poisson's ratio.

### d) Well Log Analysis

In some embodiments, the models and equations include well log analysis models or equations. Well log analysis is useful in modeling, particularly in the oil and gas industry, because it provides detailed information about the subsurface rock properties and fluid content within a reservoir. Well log analysis allows for accurate characterization of the geological formations and enabling precise predictions of reservoir behavior, production or injection potential, and optimal recovery strategies in reservoir models. In some embodiments, computing system 110 uses well log analysis as the foundational data to build a realistic representation of the underground reservoir. The following equations are examples that can be used by computing system 110 when performing a well log analysis of LAS and similar files. Advantageously, the information provided by well log analysis can be used to fill in the gaps in other data sources and create a more robust geological model.

In some embodiments, computing system 110 uses the following porosity equation to determine the pore space within a rock matrix:

$$∅ = \frac{{V}_{p}}{{V}_{t}}$$

where Vₚ is the volume of pores, Vₜ is the total volume of rock, and Ø is the porosity.

In some embodiments, computing system 110 uses the following water saturation equation to determine the amount of water within a rock:

$${S}_{w} = \frac{{V}_{f w}}{∅}$$

where S_{w} is the water saturation, V_{fw} is the volume of formation water occupying pores, and Ø is the porosity.

In some embodiments, computing system 110 uses the Archie equation to determine the water saturation within a given formation as a decimal. The Archie representation can be expressed as follows:

$${S}_{w} = {( \frac{a \times {R}_{w}}{{R}_{t} \times {∅}^{m}} )}^{1 / n}$$

where R_{w} is the resistivity of formation water, Rt is the resistivity of the formation, a is the tortuosity factor (typically a=1), m is the cementation exponent (typically m=2, and n is the saturation exponent (typically n=2).

In some embodiments, computing system 110 uses the following equation to calculate the formation temperature increase based on the depth into the subsurface from surface:

$$M = \frac{y - c}{d}$$

where M is the slope (i.e., geothermal gradient), y is the bottomhole temperature, d is the depth, and c is a constant (e.g., mean annual surface temperature).

In some embodiments, computing system 110 uses the following shale volume equation to calculate the amount of clay minerals as compared to other minerals, based on the gamma ray well log:

$${V}_{Shale} = {I}_{G R} = \frac{G {R}_{l og} - G {R}_{m i n}}{G {R}_{ma x} - G {R}_{m i n}}$$

where I_{GR} is the gamma ray index, GR_{log} is the gamma ray reading of formation, GRₘᵢₙ is the minimum gamma ray reading (clean sand or carbonate), GRₘₐₓ is the maximum gamma ray reading (shale), and Vₛₕₐₗₑ is the volume of shale.

In some embodiments, computing system 110 uses the following clay volume equation to calculate the amount of clay minerals as compared to other minerals, based on the gamma ray well log. The equation is a linear transformation of the gamma ray index to estimate the volume of clay:

$${V}_{clay} = {I}_{G R} \times \frac{1}{1 + \frac{{I}_{G R}}{2}}$$

In some embodiments, computing system 110 uses either or both of the following Wyllie equations to calculate sonic porosity, which is defined as the amount of porosity within a rock based on the amount of time required for sound to travel:

$${∅}_{S} = \frac{Δ {t}_{l o g} - Δ {t}_{m a}}{Δ {t}_{l o g} - Δ {t}_{f l}}$$

$${∅}_{S} = ( \frac{5}{8} ) \times \frac{Δ {t}_{l o g} - Δ {t}_{m a}}{Δ {t}_{l o g}}$$

where Ø_{S} is the sonic porosity, Δt_{log} is the interval transit time in the formation, Δtₘₐ is the interval transit time in the matrix, and Δt_{fl} is the interval transit time in the fluid in the formation (e.g., freshwater mud=189 μsec/ft, saltwater mud=185 μsec/ft).

In some embodiments, computing system 110 uses the following equation to calculate a compaction factor which indicates how easily a formation can be compacted:

$${C}_{p} = \frac{Δ {t}_{s h} \times C}{100}$$

where Cₚ is the compaction factor, Δtₛₕ is the interval transit time in a shale adjacent to the formation of interest, and C is a constant (typically C=1.0).

In some embodiments, computing system 110 uses the following bulk density equation to calculate the mass of a rock's particles divided by total volume:

$${∅}_{D} = \frac{{P}_{m a} - {P}_{b}}{{P}_{m a} - {P}_{f l}}$$

where Ø_{D} is the density derived porosity, Pₘₐ is the matrix density, P_{b} is the formation bulk density (log reading), and P_{fl} is the fluid density.

In some embodiments, computing system 110 uses the following equation to calculate the true resistivity of the formation from induction logs:

$${R}_{t m i n} = {R}_{i} \times \frac{{R}_{W}}{{R}_{m f}}$$

where R_{t min} is the true resistivity (also called R_{t minimum}), Rᵢ is the resistivity tool measuring in the invaded zone (e.g., usually laterolog-8 or spherically focused log), R_{W} is the resistivity of the formation water at formation temperature, and R_{mf} is the resistivity of mud filtrate at formation temperature.

In some embodiments, computing system 110 uses the following nuclear magnetic resonance (NMR) permeability equation to calculate the effective permeability of a formation from NMR:

$$k = {( \frac{{∅}_{NMR}}{C} )}^{4} {( \frac{FFI}{BVI} )}^{2}$$

where k is the NMR-derived permeability, Ø_{NMR} is the NMR-derived porosity, C is a constant (depending on formation), FFI is the proportion of moveable fluids occupying effective porosity, and BVI is the proportion of capillary-bound fluids occupying effective porosity.

In some embodiments, computing system 110 uses the following equation to calculate the apparent matrix volumetric photoelectric factor, which is used to characterize the mineral composition of rock formations:

$${U}_{m a a} = \frac{( {ρ}_{e} \times {ρ}_{b} ) - ( {∅}_{N D} \times {U}_{fl} )}{1 - {∅}_{ND}}$$

where Uₘₐₐ is the apparent matrix volumetric photoelectric factor, ρₑ is the photoelectric-effect, ρ_{b} is the bulk density (from log), Ø_{ND} is the porosity from the neutron-density cross plot, and U_{fl} is the fluid volumetric cross-section (e.g., 0.398 barns/cm³ for freshwater, 1.36 barns/cm³ for saltwater).

In some embodiments, computing system 110 uses log analysis tables to obtain the values of one or more coefficients, parameters, variables, or other values used in the various equations and models throughout the present disclosure. Several examples of log analysis tables which can be used by computing system 110 are provided as Tables 1-4 below.

TABLE 1
Different Coefficients and Exponents
Used to Calculate Formation Factor (F)

| a | m | Comments |
|---|---|---|
| 1 | 2 | Carbonates |
| 0.81 | 2 | Consolidated Sandstone |
| 0.62 | 2.15 | Unconsolidated Sands (Humble Formula) |
| 1.45 | 1.54 | Average Sands (after Carothers, 1968) |
| 1.65 | 1.33 | Shaly sands (after Carothers, 1968) |
| 1.45 | 1.7 | Calcareous sands (after Carothers, 1968) |
| 0.85 | 2.14 | Carbonates (after Carothers, 1968) |
| 2.45 | 1.08 | Pliocene sands, southern California |
| | | (after Carothers and Porter, 1970) |
| 1.97 | 1.29 | Miocene sands, Texas-Louisiana Gulf Coast |
| | | (after Carothers and Porter, 1970) |
| 1 | Φ ^{(2.05-Φ)} | Clean granual formations (after Sethi, 1979) |

TABLE 2
Sonic Velocities and Interval Transit Times for Different Matrixes

| | | Δtₘₐₜᵣᵢₓ or | |
|---|---|---|---|
| | | Δt_{fluid} | Δtₘₐₜᵣᵢₓ |
| | Matrix | (Wyllie) | (RGH) |
| Lithology/ | velocity | μ_{sec/ft} | μ_{sec/ft} |
| Fluid | (ft/sec) | [μ_{sec/m}] | [μ_{sec/m}] |
| Sandstone | 18000 to 19500 | 55.5 to 5.10 | 56 [184] |
| | | [182 to 168] | |

| | | | | |
|---|---|---|---|---|
| Limestone | 21000 to 23000 | 47.6 | [156] | 49 [161] |
| Dolomite | 23000 to 26000 | 43.5 | [143] | 44 [144] |
| Anhydrite | 20000 | 50.0 | [164] | — |
| Salt | 15000 | 66.7 | [219] | — |
| e | 17500 | 57.0 | [187] | — |
| Freshwater | 5280 | 189 | [620] | — |
| mud | | | | |
| filtrate | | | | |
| Saltwater | 5980 | 185 | [607] | — |
| mud | | | | |

filtrate

TABLE 3
Matrix Density and Fluid Density for Different Matrices

| | Pₘₐ or P_{fl} | | Pₑ |
|---|---|---|---|
| Lithology/Fluid | g/cm³ [Kg/m³] | | (b/e) |
| Sandstone | 2.644 | [2644] | 1.81 |
| Limestone | 2.710 | [2710] | 5.08 |
| Dolomite | 2.877 | [2877] | 3.14 |
| Anhydrite | 2.960 | [2960] | 5.05 |
| Salt | 2.040 | [2040] | 4.65 |
| Fresh water | 1.0 | [1000] | — |
| Salt water | 1.15 | [1150] | — |

| | | |
|---|---|---|
| Barite (mud additive) | — | 267 |

TABLE 4
Typical NMR Properties of Reservoir Fluids

| | Polarization | Relaxation | |
|---|---|---|---|
| | Time T1 | Time T2 | Viscosity |
| | (msec) | (Msec) | (cp) |
| Brine | 1-500 | 1-500 | 0.2-0.8 |
| Oil | 3000-4000 | 300-1000 | 0.2-1000 |
| Gas | 4000-5000 | 30-60 | 0.011-0.014 |
| | | | (methane) |

### e) Reservoir Characterization and Dynamic Flow Modeling

In some embodiments, the models and equations include reservoir characterization and dynamic flow models or equations. Computing system 110 can use reservoir characterization and dynamic flow modeling equations for several purposes. For example, computing system 110 can use reservoir characterization models to determine or predict reservoir geometry and properties. Computing system 110 can use reservoir characterization models to construct a 3D model of the reservoir, including its shape, size, and the distribution of key properties such as porosity, permeability, and fluid saturation. Computing system 110 can use such reservoir characterization information to model and predict how fluids flow within the reservoir. Computing system 110 can also use reservoir characterization models to identify productive zones. For example, reservoir characterization models may allow computing system 110 to identify specific areas with high hydrocarbon saturation and favorable flow characteristics to optimize well placement for maximum production. Computing system 110 can also use reservoir characterization models to estimate the amount of recoverable hydrocarbons in the reservoir for use in economic evaluation and project planning.

Computing system 110 can use dynamic flow modeling to predict reservoir behavior with respect to how fluids (e.g., oil, gas, water, etc.) move within the reservoir under different production or injection scenarios. For example, computing system 110 can use dynamic flow models to optimize production strategies (e.g., determine optimal well placement, spacing, and production rates to maximize oil recovery and minimize costs), evaluate enhanced oil recovery (EOR) techniques (e.g., assess the effectiveness of different EOR methods such as waterflooding and gas injection in improving oil recovery), predict reservoir performance (e.g., forecast future production rates, pressure changes, and fluid saturations over time), and manage reservoir pressures (e.g., control injection rates to maintain reservoir pressure and optimize production).

Advantageously, computing system 110 can use reservoir characterization and dynamic flow modeling as interconnected processes that provide valuable insights into the behavior of subsurface reservoirs. By integrating geological, geophysical, and engineering data using reservoir characterization and dynamic flow modeling, computing system 110 can enable oil and gas companies to reduce exploration and development risks, optimize production or injection operations, increase oil and gas recovery, and improve profitability. The following equations are examples that can be used by computing system 110 for reservoir characterization and dynamic flow modeling.

In some embodiments, computing system 110 uses the Klinkenberg effect equation to model the influence of confining stress and the Klinkenberg effect. The Klinkenberg effect is a phenomenon that affects how gas flows through porous media (also known as slip flow or Knudsen diffusion). The Klinkenberg effect equation can be represented as follows:

$${k}_{gas} = {k}_{liquid} ( 1 + \frac{4 c L}{r} ) = {k}_{liquid} ( 1 + b / P )$$

where k_{gas} is the gas permeability at pore pressure, k_{liquid} the liquid permeability, c is the proportionality constant (approximately =1), L is the mean free path of gas molecule at pore pressure, r is the pore radius, b is the proportionality constant (e.g., a function of c, L, and r), and P is the pore pressure (atm). General values for b can be estimated from the empirical correlation for air such as:

$$b = 0.7 \; 77 {k}_{liquid}^{- 0.39} or b = 0.867 {k}_{liquid}^{- 0.33}$$

In some embodiments, computing system 110 uses the following equation to calculate the principal pore throat diameter (PPTD):

$$P P T D = 2.2 {k}_{ik}^{0.42}$$

where kᵢₖ is the in-situ Klinkenberg permeability and PPTD is the principal pore throat diameter.

In some embodiments, computing system 110 uses the following equation to calculate volumetric CO₂ storage:

$${M}_{{CO}_{2}} = {A}_{t} \times {h}_{g} \times {ϕ}_{t} \times E \times {ρ}_{{CO}_{2}}$$

where E is an efficiency coefficient, ρ_{CO}_{₂} is the density of CO₂, M_{CO}_{₂} is the mass of CO₂ that could be stored in a target formation, Aₜ is the pore volume, h_{g} is the gross thickness, and φₜ is the effective porosity.

In some embodiments, computing system 110 uses the following equation to calculate compressibility efficiency:

$${E}_{comp} = Δ P \times ( {c}_{w} + {c}_{f} )$$

where E_{comp} is the compressibility efficiency, c_{w} is the compression of the formation fluids, c_{f} is the dilation of the pores, and ΔP is the difference between the final pressure and the initial pressure.

### Outputs

Referring now to FIGS. 13-18B, diagrams illustrating outputs 552 in greater detail are shown, according to an exemplary embodiment. Outputs 552 may be generated by computing system 110 or by external systems or devices (e.g., client system 106, user devices, etc.) based on the recommendations and model predictions generated by computing system 110. For example, outputs 552 may include or may be based on the model predictions generated by AI model 534, the optimal control actions and/or wellsite locations generated by wellsite optimizer 540, the recommendations generated by recommendation generator 538, and/or the outputs or user interface elements generated by output/UI generator 544. Outputs are shown to include maps 554, flow models 556, pressure tracking 558, charts 560, alerts 562, analytics 564, and user interfaces 566, each of which is described below.

### Maps

Referring particularly to FIG. 13, a diagram illustrating maps 554 in greater detail is shown, according to an exemplary embodiment. Maps 554 may include any of a variety of depictions of a geographic area (e.g., a city, a county, a state, a region, a country, etc.), a wellsite, a wellbore, or other locations of interest. Maps 554 may include geographic maps, geopolitical maps, geologic maps, topographic maps, or any other type of map. In various embodiments, maps 554 may include 2D maps (e.g., top-down or aerial views of the earth's surface, cross-sectional views of a section of the earth) or 3D maps (e.g., showing the earth's surface and one or more subterranean layers from an isometric perspective).

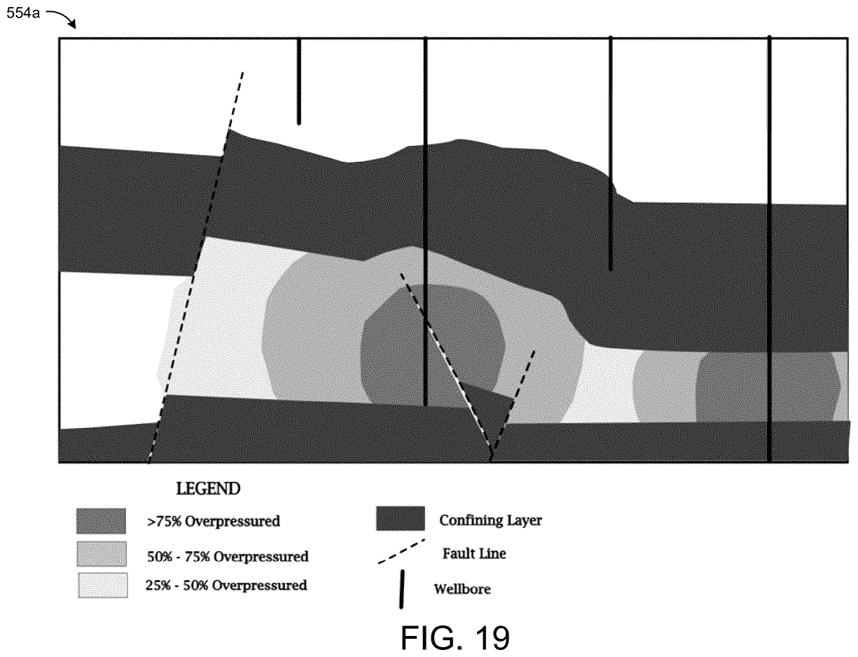

Maps 554 may visually display the model predictions, recommendations, and other outputs of AI model 534 and computing system 110 for presentation to a user via client system 106 or other user device. For example, maps 554 may include views of a geographic region with graphics, icons, or other markers (e.g., shading, lines, points, etc.) indicating wellsite locations, fault lines, seismic station locations, pressure fronts, surface deformation, fault activations, earthquakes, leaking wells, well labels, or any other information provided as inputs from data sources 502 to computing system 110 or generated by computing system 110. As shown in FIG. 13, maps 554 may include information relating to ground deformation, earthquake activity, risk assessment (e.g., fault activation, pressure fronts, real-time risk, propagation, etc.), temporal information (e.g., activity vs. time, plume migration, etc.) and well leaks or issues (e.g., blowouts, etc.). In some embodiments, maps 554 include compilation maps with multiple layers that can be selectively turned on or off (e.g., by interacting with user interface elements) to show or hide different types of information. Several examples of these and other types of maps 554 are shown in greater detail in FIGS. 19-25, 35-37, and 56-58.

In some embodiments, maps 554 may include various map types such as seismic hazard maps, fault activation maps, ground motion intensity maps, induced seismicity risk maps, or any other type of map. Seismic hazard maps may provide a geographic distribution of peak ground acceleration (PGA) (e.g., in a GIS-based raster format) and can be used to visualize seismic risk. Computing system 110 can generate seismic hazard maps by integrating multiple hazard models and applying smoothing algorithms to generate the data presented in such maps. AI model 534 can be configured to predict seismic hazards using AI-driven pattern recognition to generate the hazard information shown in seismic hazard maps. Fault activation maps may provide information on known faults and potential activation zones (e.g., as vector overlays) and can be used to identify high-risk fault areas. Computing system 110 can generate the information shown in the fault activation maps by analyzing fault characteristics and correlating such information with injection data (e.g., from historical databases or real-time wellsite data sources 510). In some embodiments, AI model 534 generates the fault activation likelihood information shown in fault activation maps as an output or prediction of AI model 534.

Ground motion intensity maps may display a Modified Mercalli Intensity (MMI) distribution or information based on a MMI distribution (e.g., as color-coded overlays) to provide a visualization of potential earthquake impacts. Computing system 110 can generate the information shown in ground motion intensity maps by interpolating ground motion data. In some embodiments, AI model 534 generates an enhanced ground motion prediction for display in the ground motion intensity maps as an output or prediction of AI model 534. Induced seismicity risk maps may include a spatial distribution of induced seismicity risk over a geographic region (e.g., as a heat map) to highlight areas at risk of induced seismic events. Computing system 110 can generate the information shown in induced seismicity risk maps by correlating injection data (e.g., from historical databases or real-time wellsite data sources 510) with seismic events (e.g., from historical databases or seismic/earthquake data source 508). In some embodiments, AI model 534 generates the information shown in induced seismicity risk maps by performing an AI-driven risk assessment based on operational and geological factors provided as inputs via data sources 502.

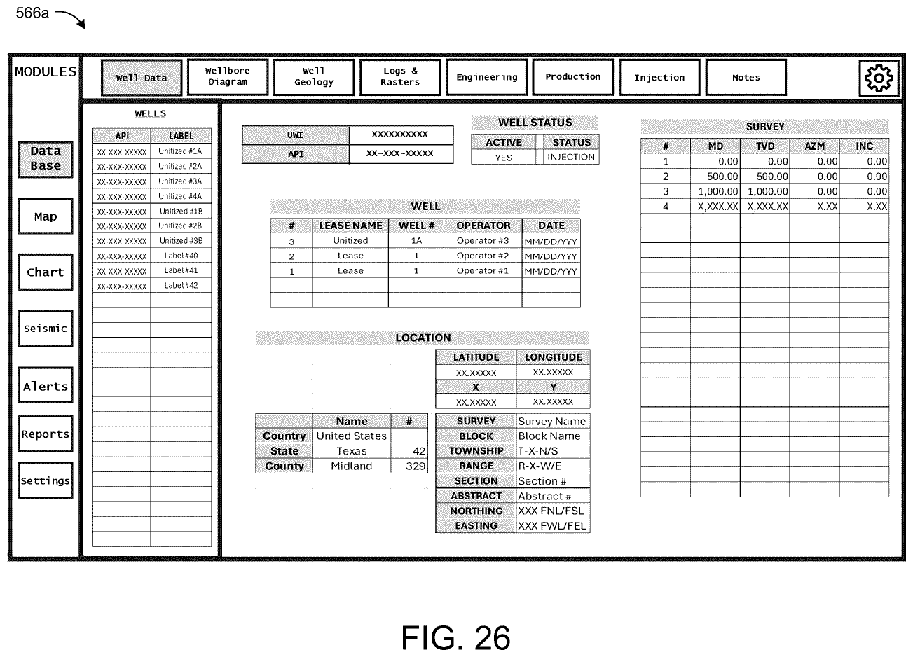

Referring now to FIGS. 19-25, several examples of maps 554a-554g (collectively maps 554) which can be generated by computing system 110 are shown, according to exemplary embodiments. In some embodiments, maps 554 can be presented as part of monitoring and control application for an injection well or other wellsite equipment 546 via a user interface. Several examples of user interfaces within which maps 554 can be presented are shown and described in greater detail with reference to FIGS. 26-58.

Map 554a shown in FIG. 19 depicts a cross-sectional view of the earth showing multiple layers (e.g., a surface layer, a confining layer, an injection zone, etc.) and wellbore locations. Map 554a also shows fault lines and is shaded to indicated different pressure zones (e.g., >75% over pressurized, 50%-75% over pressurized, and 25%-50% over pressurized). Map 554a can be generated by computing system 110 based on the information received via data sources 502, generated by AI model 534, or other components of computing system 110. For example, the pressure levels and flow boundaries shown in map 554a can be generated by AI model 534 as types of pressure tracking outputs 558 and flow model outputs 556 respectively.

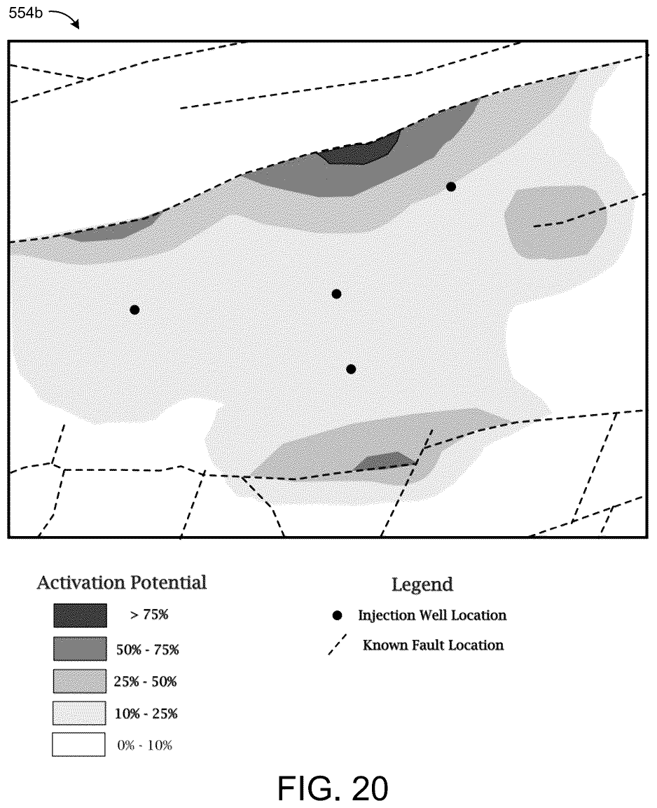

Map 554b shown in FIG. 20 depicts a top-down view of a geographic region of the earth showing injection well locations and known fault lines. Map 554b also shows activation potential information as shaded regions with different colors or patterns to indicate different activation potential levels. For example, the darkest shaded region in map 554b indicates an activation potential of>75% whereas the successively lighter shaded regions indicate activation potentials of 50%-75%, 25%-50%, 10%-25%, and 0%-10%. Map 554b can be generated by computing system 110 based on the information received via data sources 502, generated by AI model 534, or other components of computing system 110. For example, the well locations shown in map 554b may be based on the location information provided by geographical data sources 504 or real-time wellsite data sources 510, whereas the known fault locations shown in map 554b may be based on the information provided by geological data sources 506. The activation potentials shown in map 554b may be generated by AI model 534 as types of model predictions.

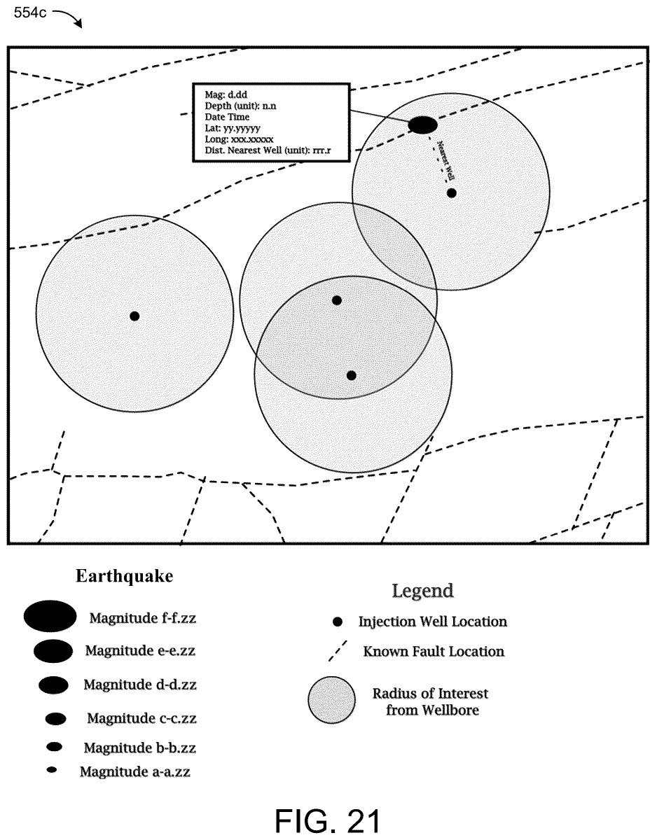

Map 554c shown in FIG. 21 depicts a top-down view of a geographic region of the earth showing injection well locations and circles marking radii of interest around the well locations. Map 554c also shows the locations of fault lines and earthquakes along with the magnitudes of the earthquakes. Map 554c can be generated by computing system 110 based on the information received via data sources 502, generated by AI model 534, or other components of computing system 110. For example, the well locations and circles marking the radii around the well locations shown in map 554c may be based on the location information provided by geographical data sources 504 or real-time wellsite data sources 510, whereas the known fault locations shown in map 554c may be based on the information provided by geological data sources 506. The earthquakes and magnitudes shown in map 554c may be based on information obtained from seismic/earthquake data sources 508.

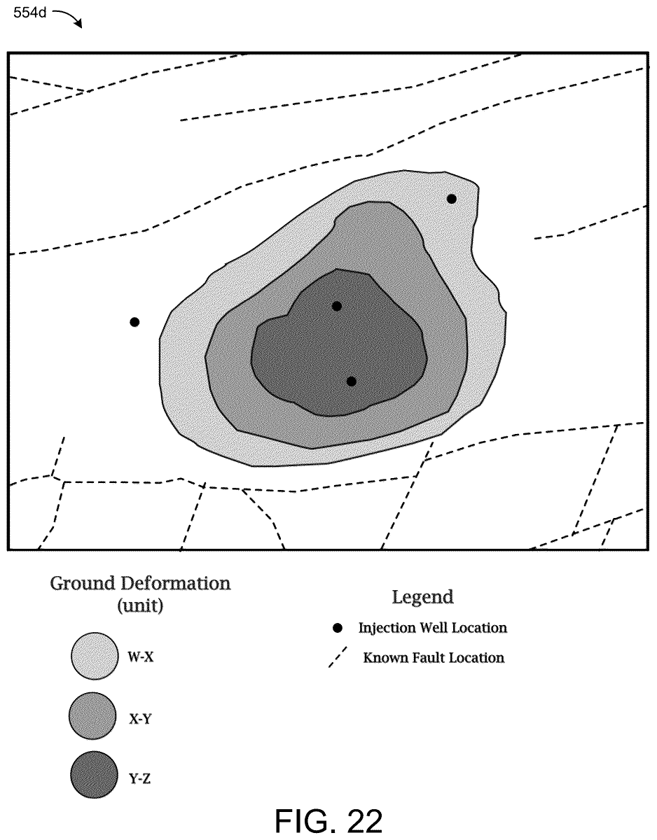

Map 554d shown in FIG. 22 depicts a top-down view of a geographic region of the earth showing injection well locations and known fault lines. Map 554d also shows ground deformation levels within the depicted regions using different colors or patterns to indicate different activation potential levels. For example, the lightest shaded region in map 554d indicates a ground deformation level between w-x units of deformation, whereas the successively darker shaded regions indicate ground deformation levels between x-y units of deformation and γ-z units of deformation respectively, where w, x, y, and z are threshold levels of deformation. Map 554d can be generated by computing system 110 based on the information received via data sources 502, generated by AI model 534, or other components of computing system 110. For example, the well locations shown in map 554d may be based on the location information provided by geographical data sources 504 or real-time wellsite data sources 510, whereas the known fault locations shown in map 554d may be based on the information provided by geological data sources 506. The ground deformation levels shown in map 554d may be based on information obtained from aerospace data sources 514 or measured at the wellsite by real-time wellsite data sources 510.

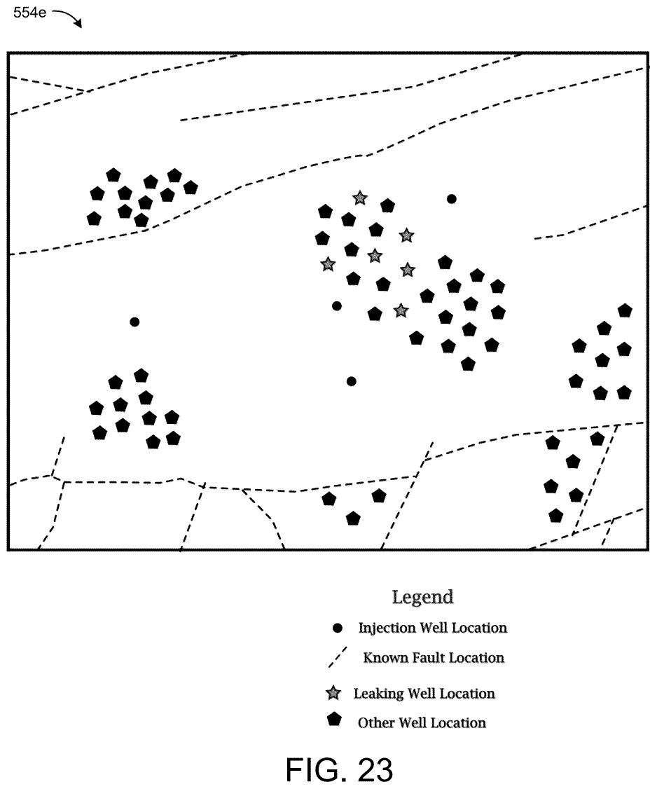

Map 554e shown in FIG. 23 depicts a top-down view of a geographic region of the earth showing injection well locations and known fault lines. Map 554e also includes graphics or icons indicating leaking well locations (shown as stars in map 554e) and other well locations (shown as pentagons in map 554e). Map 554e can be generated by computing system 110 based on the information received via data sources 502, generated by AI model 534, or other components of computing system 110. For example, the well locations shown in map 554e may be based on the location information provided by geographical data sources 504 or real-time wellsite data sources 510, whereas the known fault locations shown in map 554e may be based on the information provided by geological data sources 506. The leaking well locations and other well locations shown in map 554e may be based on information obtained from other data sources 516 (e.g., well leaks/blowouts information) or measured at the wellsite by real-time wellsite data sources 510.

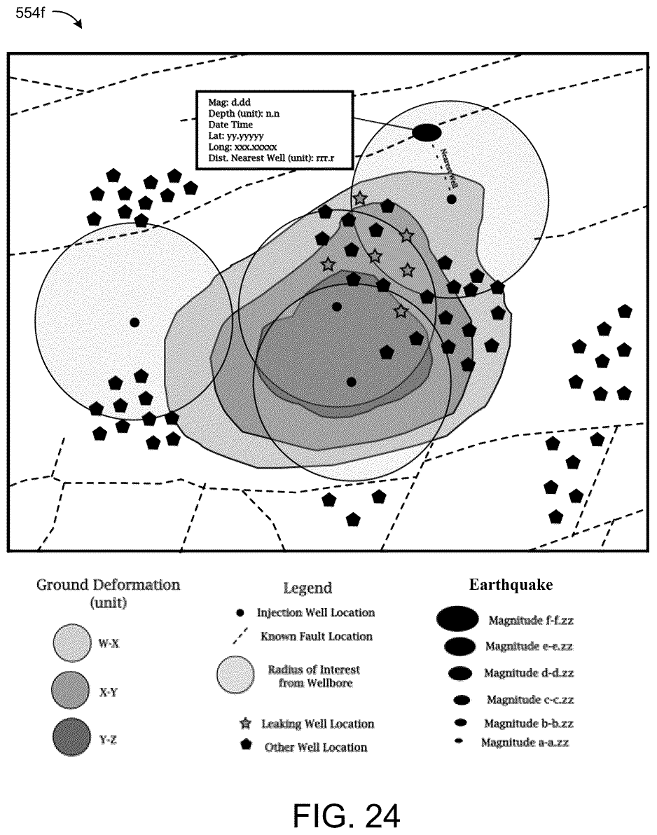

Map 554f shown in FIG. 24 is a compilation map which combines or compiles information from other maps 554a-554e. For example, map 554f is shown to include injection well locations, circles marking radii of interest around the well locations, the locations of fault lines, and the locations of earthquakes along with the magnitudes of the earthquakes, similar to map 554c. Map 554f also shows ground deformation levels within the depicted regions using different colors or patterns to indicate different activation potential levels, similar to map 554d. Map 554f also includes graphics or icons indicating leaking well locations (shown as stars in map 554f) and other well locations (shown as pentagons in map 554f). In some embodiments, map 554f includes selectable elements that allow a user to turn on/off (e.g., show/hide) certain layers. For example, a user can click or select various elements or labels in the ground deformation section, legend section, or earthquake section shown below map 554f to turn on/off the corresponding items or layers in map 554f.

Map 554f can be generated by computing system 110 based on the information received via data sources 502, generated by AI model 534, or other components of computing system 110. For example, the well locations and circles marking the radii around the well locations shown in map 554f may be based on the location information provided by geographical data sources 504 or real-time wellsite data sources 510, whereas the known fault locations shown in map 554f may be based on the information provided by geological data sources 506. The earthquakes and magnitudes shown in map 554f may be based on information obtained from seismic/earthquake data sources 508. The ground deformation levels shown in map 554f may be based on information obtained from aerospace data sources 514 or measured at the wellsite by real-time wellsite data sources 510. The leaking well locations and other well locations shown in map 554f may be based on information obtained from other data sources 516 (e.g., well leaks/blowouts information) or measured at the wellsite by real-time wellsite data sources 510.

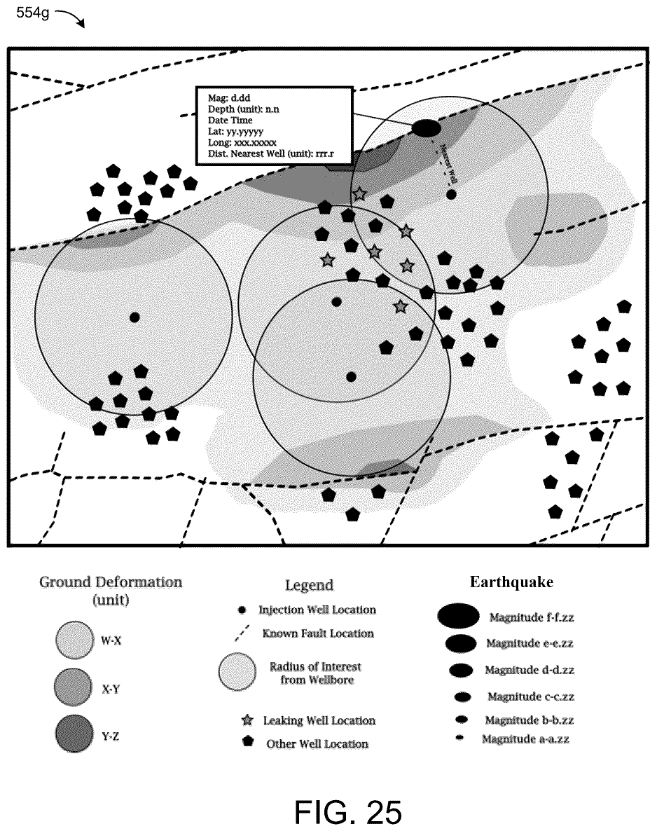

Map 554g shown in FIG. 25 is another compilation map which combines or compiles information from other maps 554a-554e. For example, map 554g is shown to include injection well locations, circles marking radii of interest around the well locations, the locations of fault lines, and the locations of earthquakes along with the magnitudes of the earthquakes, similar to map 554c. Map 554g also shows ground deformation levels within the depicted regions using different colors or patterns to indicate different levels of ground deformation, similar to map 554d. Map 554g also includes graphics or icons indicating leaking well locations (shown as stars in map 554g) and other well locations (shown as pentagons in map 554g). In some embodiments, map 554g includes selectable elements that allow a user to turn on/off (e.g., show/hide) certain layers. For example, a user can click or select various elements or labels in the ground deformation section, legend section, or earthquake section shown below map 554g to turn on/off the corresponding items or layers in map 554g.

Map 554g can be generated by computing system 110 based on the information received via data sources 502, generated by AI model 534, or other components of computing system 110. For example, the well locations and circles marking the radii around the well locations shown in map 554g may be based on the location information provided by geographical data sources 504 or real-time wellsite data sources 510, whereas the known fault locations shown in map 554g may be based on the information provided by geological data sources 506. The earthquakes and magnitudes shown in map 554g may be based on information obtained from seismic/earthquake data sources 508. The ground deformation levels shown in map 554g may be based on information obtained from aerospace data sources 514 or measured at the wellsite by real-time wellsite data sources 510. The leaking well locations and other well locations shown in map 554g may be based on information obtained from other data sources 516 (e.g., well leaks/blowouts information) or measured at the wellsite by real-time wellsite data sources 510.

In some embodiments, various elements depicted in maps 554 can be color-coded, shaded, or otherwise visually marked to indicate different values of the variables or information represented by such elements. For example, the fault lines shown in maps 554 can be color-coded to indicate the fault slip potentials (e.g., in units of pressure such as PSI) along each fault line, where lower values of the fault slip potential indicate a higher risk of an earthquake occurring along the fault line (i.e., less pressure required to induce a fault slip). Different ranges of fault slip potentials (e.g., less than 500 PSI, between 500 and 1,000 PSI, between 1,000 PSI and 2,000 PSI, between 2,000 and 4,000 PSI, between 4,000 and 6,000 PSI, and above 6,000 PSI) can be represented using different colors for the corresponding fault lines in maps 554. Similarly, the earthquake locations depicted in maps 554 can be color-coded to represent different magnitudes of earthquakes. For example, different colors can be used to represent earthquakes of magnitudes below 2.5, between 2.5 and 2.9, between 3.0 and 3.9, between 4.0 and 4.9, and 5.0 or above.

In some embodiments, maps 554 may use different colors to represent the circles marking radii of interest from the wellbores (e.g., in maps 554c, 554f, and 554g). For example, the circles marking the radii of interest can be color-coded based on the corresponding levels of coulomb stress (Δσ) caused by the pressure fronts as a result of operating the controlled wells. In some embodiments, maps 554 may use a range or scale of colors (e.g., a gradient from white to yellow to orange to red) to represent a corresponding range or scale of coulomb stress values (e.g., from low to high). In some embodiments, maps 554 use a different color falling outside the range or scale (e.g., purple) to represent anomalies occurring as a result of the pressure front propagating outward from the controlled wells. For example, the perimeters of the circles marking the radii of interest may be colored purple to indicate an anomaly occurred or is predicted to occur at a time depicted by maps 554.

In various embodiments, computing system 110 can generate and present maps 554 as static maps or dynamic maps. Static maps may include snapshots of the geographic region and other information depicted in maps 554 (e.g., well locations, fault lines, ground deformation, ground stresses, fault slip potentials, historical or predicted earthquake locations and magnitudes, etc.) at a single time, whereas dynamic maps may show the evolution of the information depicted in maps 554 over a time period. The time period spanned by a dynamic map may be a historical time period, current time period, future time period, or any combination thereof. For example, computing system 110 can generate a historical dynamic map that illustrates the various information depicted in maps 554 over a historical time period based on historical data from data sources 502 corresponding to different historical times. Similarly, computing system 110 can generate a future dynamic map using predicted future values of the information shown in maps 554 based on the results of the simulations performed by computing system 110 over a future time period.

In some embodiments, computing system 110 presents dynamic maps as videos where each frame of the video corresponds to a different snapshot or moment in time (e.g., different days, different hours, etc.). Dynamic maps may include interactive user interface elements (e.g., a play button, a pause button, a time selector, etc.) that allow a user to start/stop the video and/or select a particular time for presentation in maps 554. A user can select the play button to cause a dynamic map to begin animating or evolving to represent changing values of the information shown in maps 554 as the time depicted in the dynamic map progresses forward in time. For example, map 554c shown in FIG. 21 can be presented as a dynamic map in which the information shown in map 554c (e.g., well locations, earthquake locations and magnitudes, radii of interest around the wellbores, etc.) evolves over time. As map 554c evolves (e.g., as the video is played), additional dots may appear in map 554c to represent additional well locations that were constructed or began operating during the time period, the radii of interest around the wellbore locations may increase (i.e., expand outward from the wellbore locations) as the pressure front expands propagates through the earth, and/or circles or other markers representing earthquake locations may appear in map 554c as new earthquakes occur or are predicted by computing system 110.

For embodiments in which elements of maps 554 are color-coded to indicate the values of the corresponding variables or information depicted in maps 554, the colors may also change as a dynamic map evolves to represent changing values of the variables over time. For example, the colors of the fault lines may change to represent changing fault slip potentials, the colors of the earthquake location markers may change to represent updated magnitude predictions or measurements, and/or the colors of the circles marking radii of interest from the wellbore locations may change to represent changing values of coulomb stress levels and/or anomalies occurring over time.

In some embodiments, computing system 110 uses the evolving conditions of the geographic region represented in dynamic maps to predict when and where earthquakes will occur. For example, as the radii of interest shown in maps 554 expand outward over time, computing system 110 may predict when and where the perimeters of the circles marked by the radii of interest will meet or intersect. Computing system 110 may predict that an earthquake will occur at the location where the perimeters of the circles intersect (or at a fault line closest to that location) at the time the perimeters first intersect each other. In some embodiments, computing system 110 uses the information depicted in maps 554 to train AI model 534 as described above.

### Flow Models

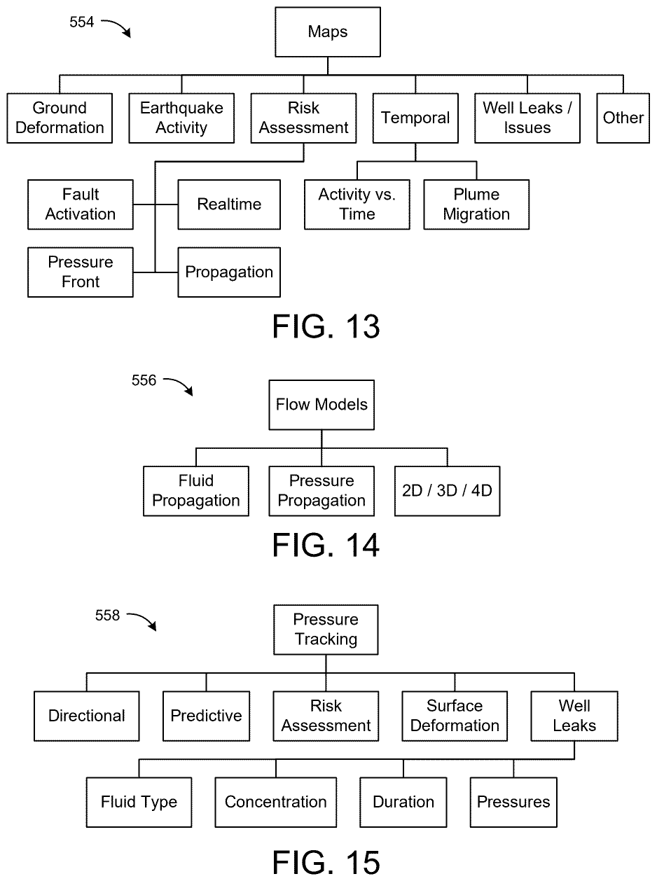

Referring now to FIG. 14, a diagram illustrating flow models 556 in greater detail is shown, according to an exemplary embodiment. Flow models 556 may include any of a variety of information (e.g., graphics, visualizations, models, etc.) indicating the flow of fluids within a reservoir below an injection well or adjacent geological formations. In some embodiments, flow models 556 may be combined with other outputs 552 such as maps 554 or pressure tracking outputs 558 as part of a comprehensive model or prediction of fluid flows and pressure levels at various locations. Flow models 556 may visually display the model predictions (e.g., flow boundaries, plumes, etc.), recommendations, and other outputs of AI model 534 and computing system 110 for presentation to a user via client system 106 or another user device.

As shown in FIG. 14, flow models 556 may include a fluid propagation model, a pressure propagation model, and/or various 2D models (e.g., top-down models, cross-sectional models, etc.), 3D models (e.g., isometric or perspective views of a section of the earth), or 4D models (e.g., 3D models+time) depicting fluid flow. In some embodiments, flow models 556 include a subsurface fluid flow model which depicts or simulates fluid movement in subsurface layers of the earth. The subsurface fluid flow model may include a 2D or 3D reservoir model and may be animated to indicate fluid flow over time. Computing system 110 can generate the information presented in the subsurface fluid flow model by integrating geological, well log, and production or injection data. AI model 534 can generate the fluid flow predictions shown in a subsurface fluid flow model as an output of AI model (e.g., a type of model prediction) and can update the fluid flow predictions based on new data from real-time wellsite data sources 510.

In some embodiments, flow models 556 include an injection-induced pressure front model. The injection-induced pressure front model may track pressure front propagation over time as a result of past injection well operations (e.g., injection rates, volumes, locations, etc.) and/or may predict pressure front propagation into the future predicted to result from current or future injection well operations. The injection-induced pressure front model may depict spatial and temporal pressure changes in a 4D format (e.g., 3D+time). Computing system 110 can generate the information shown in the injection-induced pressure front model by normalizing pressure data and integrating the pressure data with a geological model. Historical and current pressure data can be measured by sensors, whereas AI model 534 may operate to predict future pressure values at various locations into a future time period.

In some embodiments, flow models 556 include a fracture network flow model. The fracture network flow model may simulate flow through fractures within a discrete fracture network within the reservoir below an injection well and/or in adjacent geological formations. The fracture network flow model may provide a graph-based visualization of pressure levels. Computing system 110 can be configured to generate the information shown in the fracture network flow model by processing micro-seismic data and integrating such data with a geological model. AI model 534 can generate predictions of the flow information used to generate the fracture network flow model and/or may operate to enhance the fracture network characterization as outputs of AI model 534.

### Pressure Tracking

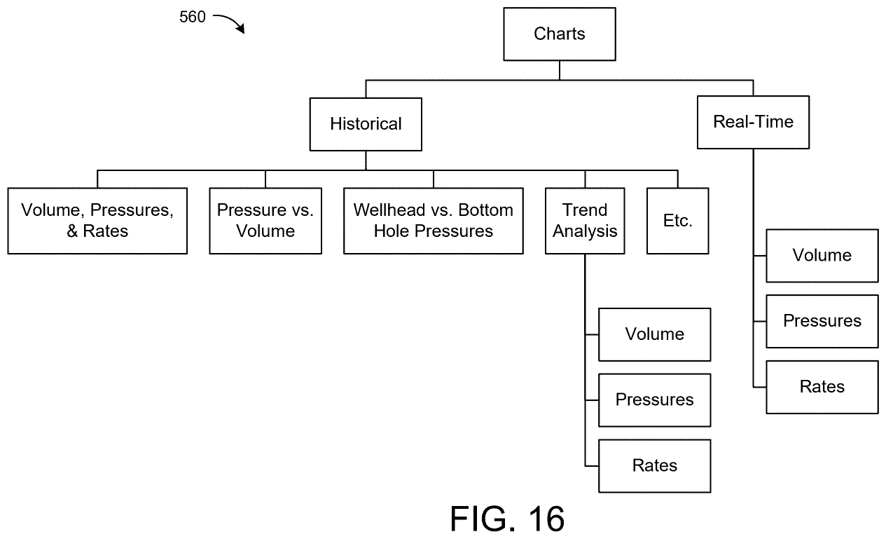

Referring now to FIG. 15, a diagram illustrating pressure tracking outputs 558 in greater detail is shown, according to an exemplary embodiment. Pressure tracking outputs 558 may include any of a variety of information (e.g., graphics, visualizations, models, etc.) indicating the measured or predicted pressure levels within a reservoir below an injection well, within adjacent geological formations, and/or at other locations within or around a wellsite. Pressure tracking outputs 558 may further include other information based on the pressure levels such as associated risks, surface deformation, and well leaks. In some embodiments, pressure tracking outputs 558 may be combined with other outputs 552 such as maps 554 or flow models 556 as part of a comprehensive model or prediction of fluid flows and pressure levels at various locations. Pressure tracking outputs 558 may visually display the model predictions (e.g., pressure levels, surface deformation, well leaks, risks, etc.), recommendations, and other outputs of AI model 534 and computing system 110 for presentation to a user via client system 106 or other user device.

As shown in FIG. 15, pressure tracking outputs 558 may include directional pressure information, predicted pressure levels, risk assessments, subsurface deformation information, and well leak information. Well leak information may indicate various attributes of the well leak such as fluid type, concentration, duration, and pressures, as described about with reference to other data sources 516 (e.g., well leaks/blowout information). In some embodiments, pressure tracking outputs 558 include bottomhole pressure tracking. Bottomhole pressure tracking information may monitor injection pressures at the bottom of the wellbore of an injection well and can be measured, for example, by bottomhole pressure sensor 166 shown in FIG. 3. Future values of the bottomhole pressure can be predicted by AI model 534 as a result of current or future injection well operations. Bottomhole pressure tracking information can be presented as timeseries plots. Computing system 110 can use the bottomhole pressure tracking information to perform AI-based anomaly detection, for example, by using AI model 534 to predict or detect problems (e.g., leaks, blowouts, etc.) based on the bottomhole pressure.

In some embodiments, pressure tracking outputs 558 include pore pressure evolution. Pore pressure evolution may track pore pressure changes over time within a reservoir-wide region. Pore pressure evolution information may include a 3D timelapse visualization of pore pressure over time. Computing system 110 can be configured to generate the information used to provide the pore pressure evolution by integrating well data with a geological model. AI model 534 can also predict pore pressure trends into the future (e.g., as a type of model prediction or output of AI model 534) to enable the pore pressure evolution to span into a future time period as predicted values.

In some embodiments, pressure tracking outputs 558 include stress field monitoring. Stress field monitoring information may track stress changes within a region at or around a wellsite or a larger geographic region. In some embodiments, the stress field monitoring is presented as a 3D tensor field visualization based on the pressure information measured by various data sources 502 or predicted by computing system 110. For example, computing system 110 can process seismic data from seismic/earthquake data sources 508 and real-time wellsite data from real-time wellsite data sources 510 to generate the stress field data. In some embodiments, AI model 534 operates to enhance the stress field modeling by generating predicted stress fields as an output of AI model 534 (e.g., as a type of model prediction).

### Charts

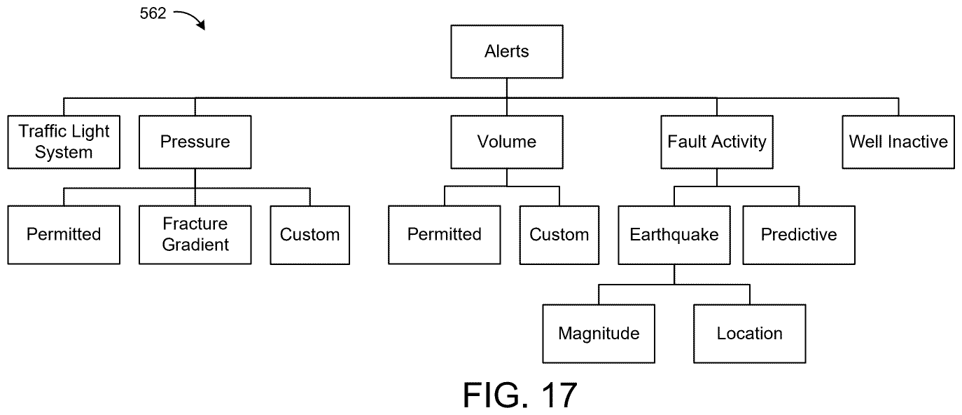

Referring now to FIG. 16, a diagram illustrating charts 560 in greater detail is shown, according to an exemplary embodiment. Charts 560 may include any of a variety of charts, graphs, plots, infographics, or other types of visual or graphical representation of the information provided by data sources 502 and/or generated by computing system 110. Charts 560 may be based on historical data, current data (e.g., real-time or live data), and/or predicted future data generated by computing system 110. In some embodiments, charts 560 may be combined with other outputs 552 such as maps 554, flow models 556, and/or pressure tracking 558 as part of a user interface or program for monitoring and controlling wellsite equipment 546.

As shown in FIG. 16, charts 560 may include historical charts or graphs of various information such as injection volumes, pressures, and rates, pressure vs. volume, wellhead pressure vs. bottomhole pressure, and trend analysis of volumes, pressures, and injection rates. Charts 560 may further include real-time information such as volumes, pressures, and rates. In some embodiments, charts 560 include a chart of injection rate vs. seismicity. The injection rate vs. seismicity chart may display a time series of injection rates and earthquake occurrences as an interactive line chart or other format. The injection rate vs. seismicity chart can be used to correlate injection well operations with seismic events. Computing system 110 can generate the data included in the injection rate vs. seismicity chart by synchronizing the injection rate data from real-time wellsite data sources 510 with the seismicity data from seismic/earthquake data sources 508 and calibrating the magnitude of seismic events. AI model 534 can enhance the injection rate vs. seismicity chart by deriving or identifying correlations between the depicted data.

In some embodiments, charts 560 include a magnitude-frequency distribution. The magnitude-frequency distribution may characterize seismic behavior by displaying earthquake magnitudes and frequencies (e.g., as a log-log plot or other format). Computing system 110 can generate the information included in the magnitude-frequency distribution by performing a homogenization on the magnitude information from seismic/earthquake data sources 508. AI model 534 can generate some of the information displayed in the magnitude-frequency distribution by predicting future seismic events along with their magnitudes and locations. In some embodiments, AI model 534 predicts a future magnitude-frequency distribution to enable the presentation of both historical and future magnitude-frequency distributions.

In some embodiments, charts 560 include an operational parameters dashboard. The operational parameters dashboard may present various operational metrics such as injection rates, injection volumes, pressures, temperatures, or any other data that characterizes the operation of a wellsite (e.g., any real-time wellsite data sources 510). In some embodiments, the operational parameters dashboard is presented as a multi-panel dashboard that allows a user or client to monitor key operational indicators. Computing system 110 can generate the information presented in the operational parameters dashboard by performing data normalization and unit conversion on the data obtained from real-time wellsite data sources 510 or generated by AI model 534 (e.g., predicted future injection rates, volumes, temperatures, pressures, etc.). AI model 534 can generate some of the information presented in the operational parameters dashboard by performing AI-based predictive analytics to generate future predicted values of the displayed data points.

In some embodiments, charts 560 include seismic velocity changes over time. The seismic velocity changes over time may represent temporal changes in seismic velocity and can be presented in the form of a heat map or other graph or chart. The seismic velocity changes over time can be used to detect subsurface changes. Computing system 110 can generate the information presented in the seismic velocity changes over time by processing ambient noise data. In some embodiments, AI model 534 detects velocity changes and/or predicts future velocity changes as an output of AI model 534 (e.g., as a type of model prediction) to allow the seismic velocity changes over time to span from historical to predicted future times.

### Alerts

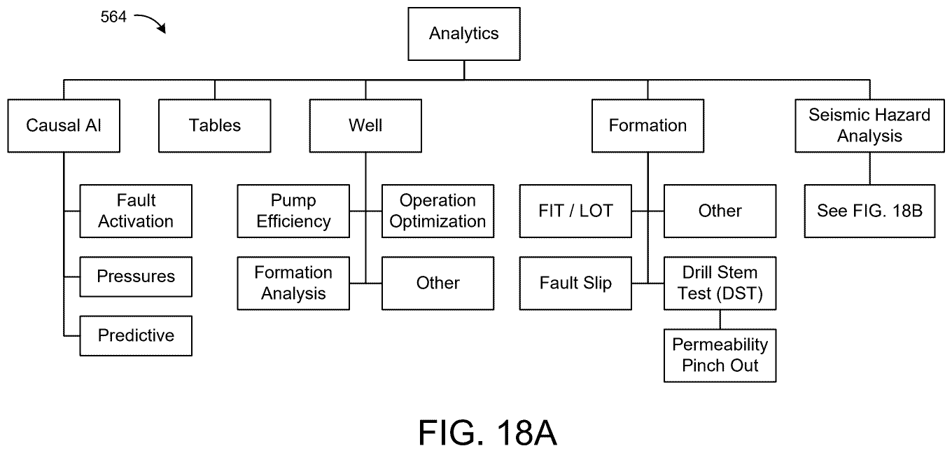

Referring now to FIG. 17, a diagram illustrating alerts 562 in greater detail is shown, according to an exemplary embodiment. Alerts 562 may include any of a variety of alerts, alarms, notifications, warnings, messages, or other information generated by computing system 110 to inform users or other data consumers of the current or predicted future conditions of a wellsite, reservoir, or geographic region. Alerts 562 can be based on any of the input data sources 502 and/or derived metrics generated by computing system 110. Alerts 562 may be based on historical data, current data (e.g., real-time or live data), and/or predicted future data generated by computing system 110. In some embodiments, alerts 562 may be combined with other outputs 552 such as maps 554, flow models 556, pressure tracking 558, and/or charts 560 as part of a user interface or program for monitoring and controlling wellsite equipment 546.

As shown in FIG. 17, alerts 562 may include a traffic light system (e.g., green for normal, yellow for warnings, red for high priority alarms) based on the values of various metrics monitored or calculated by computing system 110. For example, the value of the data point or metric can be compared to threshold levels and assigned a color depending on the value of the data point or metric relative to the thresholds. Alerts 562 may include pressure alerts (e.g., permitted pressures, fracture gradients, custom pressure alerts, etc.), volume alerts (e.g., permitted volumes, custom volume alerts, etc.), fault activity alerts (e.g., earthquake alerts including magnitudes and durations, predictive alerts, etc.), and/or inactive well alerts.

In some embodiments, alerts 562 include a seismic activity threshold alert. Computing system 110 may trigger the seismic activity threshold alert in response to determining that a detected or predicted earthquake has a magnitude or frequency exceeding a threshold. In some embodiments, the seismic activity threshold alert is provided in the form of a push notification, email, pop-up notification, or any other format. The seismic activity threshold alert may prompt a user to take action, which may differ depending on whether the seismic activity threshold alert is warning a user of a detected earthquake or predicting a future earthquake. In some embodiments, computing system 110 processes the incoming seismic activity data from seismic/earthquake data sources 508 and calculates the magnitude of a detected earthquake. In some embodiments, computing system 110 processes the model predictions generated by AI model 534 to determine the predicted time and magnitude of an earthquake. In addition to predicting future seismic events, AI model 534 can also be used to perform adaptive thresholding to generate the threshold values used to trigger the seismic activity threshold alert.

In some embodiments, alerts 562 include an anomalous pressure trend alert. Computing system 110 may trigger the anomalous pressure trend alert in response to detecting an unexpected pressure change in any of the pressures measured by real-time wellsite data sources 510 or other pressure data sources. In some embodiments, the anomalous pressure trend alert is based on the predicted pressures generated by AI model 534 or as derived metrics based on the incoming data from data sources 502. The anomalous pressure trend alert can be provided in the form of an in-app alert, email, SMS message, or other format to inform a user of the anomalous pressure and prevent potential issues. In some embodiments, computing system 110 generates the anomalous pressure trend alert by monitoring real-time pressures from data sources 502 or predicted pressures generated by AI model 534 and issues the anomalous pressure trend alert in response to a detected or predicted pressure deviating from the expected pressure trend. AI model 534 can be used to detect anomalies in pressure levels and may trigger the anomalous pressure trend alert based on an anomalous pressure level detected or predicted by AI model 534.

In some embodiments, alerts 562 include a fault slip risk alert. Computing system 110 may trigger the fault slip risk alert in response to predicting an increased risk of fault activation as a result of injection well operations. The fault slip risk alert can be provided as a color-coded alert on a map or presented in other formats to a user. The fault slip risk alert may allow a user or an automated system to take action to mitigate fault slip risk, for example, by adjusting the injection volumes, pressures, locations, etc. in order to reduce the predicted fault slip risk. Computing system 110 can generate the information used to trigger the fault slip risk alert by integrating seismic, pressure, and geological data to determine the likelihood or probability of a fault slip occurring as a result of current or planned injection site operations. In some embodiments, the fault slip risk is generated as an output of AI model 534 (e.g., as a type of model prediction) and compared against a threshold to determine whether to trigger the fault slip risk alert.

In some embodiments, alerts 562 include a regulatory compliance warning. Computing system 110 can trigger the regulatory compliance warning in response to determining that a detected or predicted value monitored or controlled by computing system 110 is approaching a regulatory limit. Such values may include, for example, carbon emissions, injection volumes, injection rates, injection pressures, etc., which can be compared against threshold values defined by permits, regulations, or other limits. The regulatory compliance warning can be presented in the form of an automated report or any other format to inform a user of the regulatory limits and help ensure regulatory compliance. In some embodiments, computing system 110 monitors injection well operations against limits defined by a regulatory framework or permit for the injection well to determine whether the regulatory limit is close to being reached. AI model 534 can assist by predicting the future value of the regulated item to determine whether the injection well is likely to reach the regulatory limit if operated according to the current or planned control strategy.

### Analytics

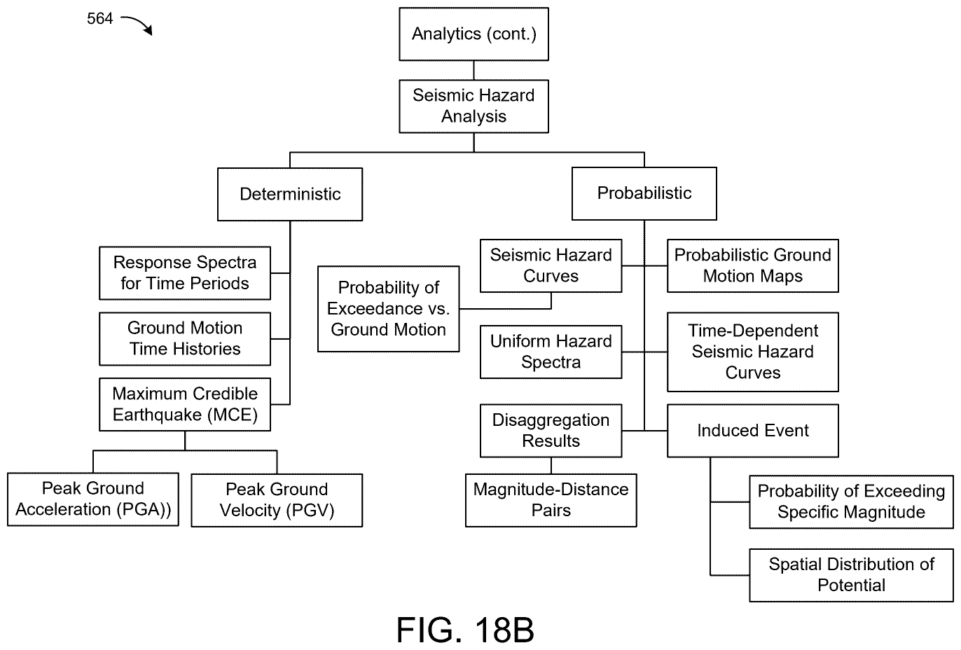

Referring now to FIGS. 18A-18B, a diagram illustrating analytics 564 in greater detail is shown, according to an exemplary embodiment. Analytics 564 may include any of the derived metrics, calculated values, correlations, predictions, risks, or other information generated by computing system 110. Computing system 110 can generate various analytics 564 by analyzing historical or live data from data sources 502, predicting future values of derived metrics or monitored variables (e.g., pressures, temperatures, fault activation risk, etc.), modeling future pressures or flows, predicting future seismic events, or recommending operational values for various injection wells to mitigate the predicted risks. In some embodiments, computing system 110 generates analytics 564 using AI model 534 or other predictive models to generate various model predictions.

As shown in FIG. 18A, analytics 564 may include causal AI analytics such as fault activations (e.g., activation risks, predicted seismic events, etc.), pressures, and various predicted values (e.g., predicted pressures, temperatures, flows, etc.). In some embodiments, the causal AI analytics are generated by AI model 534, for example, by configuring AI model 534 to function as a causal AI model. Analytics 564 are shown to further include tables and well analytics such as pump efficiency, formation analysis, operation optimization, and others. Pump efficiency can be calculated by computing system 110 based on the various pump pressures, pressure differentials, and pumping power inputs received from real-time wellsite data sources 510. Operation optimization analytics can be generated by wellsite optimizer 540 and may include, for example, optimal injection rates, optimal injection volumes, optimal injection pressures, optimal injection locations, or any other analytics or outputs that achieve one or more optimality criteria (e.g., minimize seismic activity risk, minimize operating cost, maximize well production or injection, etc.).

In some embodiments, analytics 564 include formation analytics such as formation integrity test (FIT) and leak-off test (LOT) analytics, fault slip analytics, drill stem test (DST) analytics such as permeability pinch out, and others. FIT and LOT are tests conducted to assess the pressure integrity of a formation. FIT measures the pressure a formation can sustain, while LOT determines the point at which the formation begins to leak. Computing system 110 can be configured to generate FIT and LOT analytics using the information obtained from geological data sources 506 in combination with pressure information and other information from real-time wellsite data sources 510. Fault slip analytics may include fault slip pressures or other measured or derived metrics associated with fault slips and may be important for understanding fault stability, mitigating risks of induced seismicity, and ensuring safe subsurface operations. Computing system 110 may generate DST analytics by running DSTs and analyzing the data generated from the DST, as described in detail with reference to FIG. 7 and geological data sources 506.

Referring now to FIG. 18B, analytics 564 are shown to include seismic hazard analysis. Seismic hazard analysis may include any of the processes executed by computing system 110 to analyze past seismic events, predict future seismic events, and/or quantify the attributes or metrics associated with such events. In some embodiments, computing system 110 performs the seismic hazard analysis using the input data from seismic/earthquake data sources 508 in combination with operational data from real-time wellsite data sources 510. For example, the seismic hazard analysis may include performing a deterministic analysis to generate analytics such as response spectra for various time periods, ground motion time histories, and maximum credible earthquake (MCE) including peak ground acceleration (PGA) and peak ground velocity (PGV). In some embodiments, the seismic hazard analysis includes performing a probabilistic analysis to generate seismic hazard curves, probabilistic ground motion maps, uniform hazard spectra, time-dependent seismic hazard curves, deaggregation results such as magnitude-distance pairs, and predicting induced seismic events. Predicting induced seismic events may include determining the probability of exceeding a specific magnitude and/or a spatial distribution of potential.

In some embodiments, analytics 564 include a seismic source characterization to understand earthquake mechanisms. Computing system 110 may perform the seismic source characterization by processing and analyzing earthquake catalog data and waveforms from seismic/earthquake data sources 508 (e.g., waveform processing, source inversion, etc.) and generating a statistical report or 3D visualization. In some embodiments, AI model 534 is used when performing the seismic source characterization to enhance source parameter estimation.

In some embodiments, analytics 564 include an operational optimization. Computing system 110 may perform the operational optimization by analyzing injection rates, pressures, and other historical or real-time wellsite data sources 510 in combination with seismicity information from seismic/earthquake data sources 508 to determine an optimal set of wellsite operations that minimize induced seismic events (e.g., minimize number of events, minimize magnitudes, etc.) while still achieving the goals of the injection well. For example, wellsite optimizer 540 may perform an optimization subject to constraints on wellsite operations (e.g., minimum required injection volume, minimum required injection rates, etc.) to determine a set of operational parameters that minimize the likelihood or impact of induced seismic events. In some embodiments, AI model 534 is used in the optimization process by predicting the seismic events that will result from a given set of operating decisions for the injection well. Wellsite optimizer 540 can iteratively or repeatedly adjust the operational parameters for wellsite equipment 546 and use AI model 534 to predict the resulting seismic events and attributes thereof.

In some embodiments, analytics 564 include a risk assessment. The risk assessment performed by computing system 110 may include quantifying seismic risk based on any of the input data from data sources 502. In some embodiments, computing system 110 performs a statistical analysis of historical data to generate probabilistic risk curves that relate seismic risk to injection site operations and locations. In some embodiments, the risk assessment includes using scenarios generator 536 to generate various scenarios (e.g., different combinations of injection well operations, estimated injection operations of third parties, control decisions for wellsite equipment 546, etc.) and analyzing each scenario using AI model 534 to generate a predicted seismic risk for each scenario. The scenario associated with the minimum seismic risk may be recommended by recommendation generator 538 as the recommended scenario and provided as an output of computing system 110.

In some embodiments, analytics 564 include predictive maintenance. Predictive maintenance may include analyzing the equipment performance data provided by real-time wellsite data sources 510 and the seismic activity data generated by seismic/earthquake data sources 508 to generate maintenance schedules for wellsite equipment 546 that prevent equipment failure or reduce the probability of equipment failure. Predictive maintenance may include using sensor data from real-time wellsite data sources 510 and other data indicating past equipment failures to predict future equipment failures or the probability thereof. In some embodiments, AI model 534 can be used to predict equipment failures and generate a set of maintenance decisions predicted to mitigate or prevent equipment failures.

### User Interfaces

Referring now to FIGS. 26-58, several examples of user interfaces 566a-566g (collectively user interfaces 566) are shown, according to various exemplary embodiments. User interfaces 566 may include one or more graphical user interfaces, dashboards, widgets, graphs, plots, data tables, annotated maps, or other user interface elements configured to present any of the information from data sources 502, any of outputs 552 generated by computing system 110, any of the recommendations generated by recommendation generator 538, any of the model predictions generated by AI model 534, or any other information generated or processed by computing system 110 as described throughout the present disclosure. User interfaces 566 may include any of maps 554, flow models 556, pressure tracking outputs 558, charts 560, alerts 562, analytics 564 as previously described. User interfaces 566 can be presented via one or more user devices (e.g., monitors, displays, desktop computers, laptop computers, smartphones, tablets, etc.) of client system 106, computing system 110, or any other user device.

In some embodiments, user interfaces 566 allow users to download and upload data. User interfaces 566 may include interactive chart layouts and/or dashboards that synthesize relevant data for the user. The graphs can include historical graphs and/or real-time graphs displaying injection/production data from specified wellsite(s) along with any specified limits and alarms. User interfaces 566 may include dashboards that can be used to view the pressures, volumes, fluid flows, fronts, earthquake potential, leaking wells, known faults, surface deformation, and/or other predictions generated by computing system 110. User interfaces 566 may also be used to present recommendations and receive user input to execute operational adjustments to maximize injected volumes and minimize risk of induced seismic events.

In some embodiments, user interfaces 566 include interactive user interface elements (e.g., buttons, selectors, sliders, checkboxes, etc.) configured to receive user input to adjust the information shown in user interfaces 566, execute control actions based on the information shown in user interfaces 566 (e.g., adjust the control signals for wellsite equipment 546), or otherwise facilitate user interaction with computing system 110. For example, user interfaces 566 are shown to include a modules panel along the left edge. Clicking or selecting the buttons representing the different modules (e.g., database, maps, charts, seismic, alerts, reports, and settings) may cause user interfaces 566 to transition between the database user interface 566a, maps user interface 566b, charts user interface 566c, seismic user interface 566d, alerts user interface 566e, reports user interface 566f, and a settings user interface (not shown), and an optimization user interface 566g. Within each of user interfaces 566a-566g, clicking or selecting the buttons in the top panel may cause the user interface to transition between the different views shown in FIGS. 26-58.

Referring particularly to FIG. 26, a first view of database user interface 566a is shown, according to an exemplary embodiment. Database user interface 566a may be displayed in response to selecting the database button in the modules panel. In the view shown in FIG. 26, the well data button is selected in the top panel which causes database user interface 566a to show data pertaining to various wells. For example, the wells panel may list all of the wells associated with a particular customer or in a selected geographic region. Each well may be identified with a unique identifier (e.g., API number) and label. Selecting a well in the wells panel may cause the main panel of user interface 566a to show data associated with the selected well. For example, the well data is shown to include a unique well identifier (UWI), API number, a well status indicating whether the well is active and whether the well is operating as an injection well or production well, lease information associated with the well (e.g., lease name, well #, operator, date, etc.), location information associated with the well (e.g., country, state, county, latitude and longitude, survey name, block name, township, range, section, abstracting, northing, and easting), and survey information associated with the well.

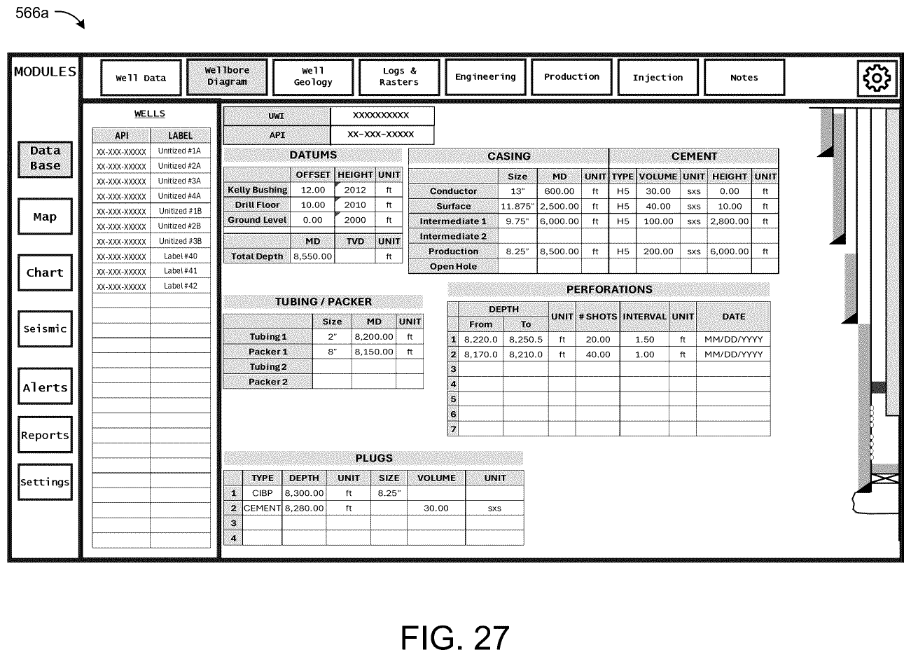

Referring now to FIG. 27, a second view of database user interface 566a is shown, according to an exemplary embodiment. In the view shown in FIG. 27, the wellbore diagram button is selected in the top panel which causes database user interface 566a to show data pertaining to the wellbore. Database user interface 566a is shown to include the same wells panel as shown in FIG. 26. However, the main panel is shown to include different data associated with the selected well such as various data associated with the wellbore. In particular, database user interface 566a is shown to include information on datums (e.g., Kelly bushing, drill floor, ground level, and total depth) such as the offset, height, and units. Database user interface 566a may include information on the casing used in the wellbore (e.g., conductor, surface, intermediate 1, intermediate 2, production, and open hole) such as the size, MD value, and units. Database user interface 566a may further include information on the cement of the wellbore (e.g., conductor, surface, intermediate 1, intermediate 2, production, and open hole) such as the type, volume, units of volume, height, and units of height. database user interface 566a may include information on the tubing/packer of the wellbore such as the size, MD value, and units for each tubing and packer (e.g., tubing 1, packer 1, tubing 2, packer 2). Database user interface 566a may include information on perforations of the wellbore such as the depth of each perforation (e.g., from depth A to depth B), units of the depth, a number of shots, an interval, units of the interval, and a date associated with each perforation. Database user interface 566a may include information on plugs of the wellbore such as the type of plug, depth, units of depth, size, volume, and units of size or volume.

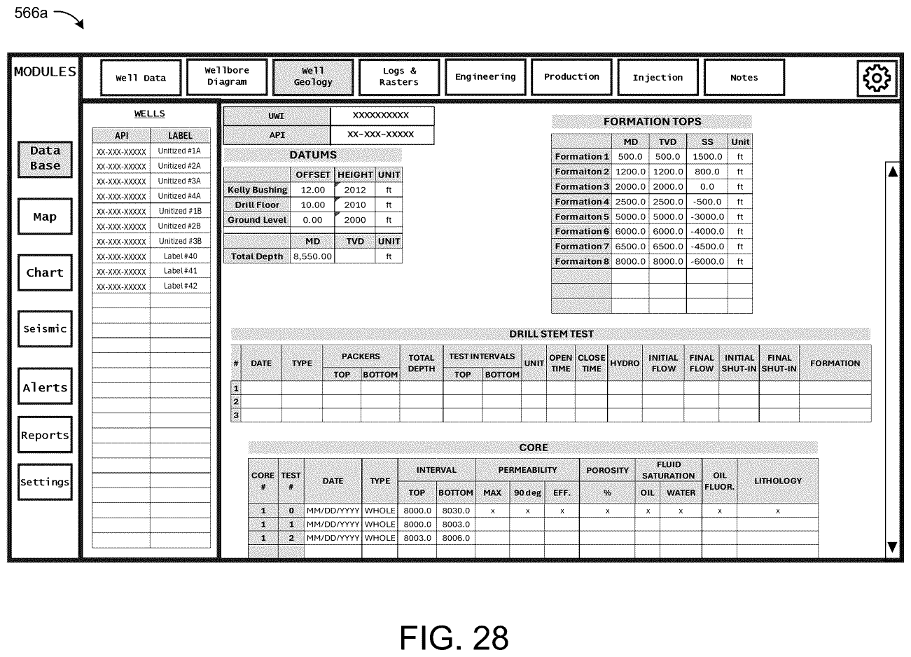

Referring now to FIG. 28, a third view of database user interface 566a is shown, according to an exemplary embodiment. In the view shown in FIG. 28, the well geology data button is selected in the top panel which causes database user interface 566a to show data pertaining to the geology of various wells. Database user interface 566a is shown to include the same wells panel as shown in FIG. 25 and the same information regarding datums shown in FIG. 26. However, the main panel is shown to include different data associated with the selected well such as the well geology. In particular, database user interface 566a is shown to include information on various formation tops including the MD value, TVD value, SS value, and corresponding units. Database user interface 566a may include information on any drill stem tests conducted such as the date, type of test, packers (top and bottom), total depth, test intervals (top and bottom), units, open time, close time, hydro, initial flow, final flow, initial shut-in, final shut-in, and formation. Database user interface 566a may include the results of any core tests conducted such as the date, type of test, interval (top and bottom), permeability, porosity, fluid saturation, oil fluorescence, and lithology.

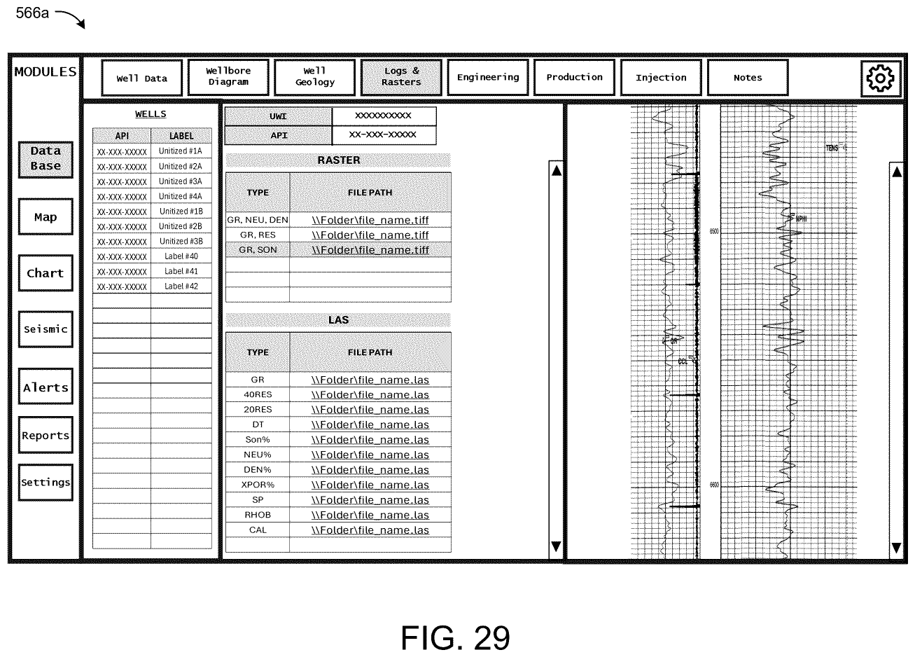

Referring now to FIG. 29, a fourth view of database user interface 566a is shown, according to an exemplary embodiment. In the view shown in FIG. 29, the logs & raster data button is selected in the top panel which causes database user interface 566a to show data pertaining to the logs and rasters of various wells. Database user interface 566a is shown to include the same wells panel as shown in FIG. 25. However, the main panel is shown to include different data associated with the well such as raster information and log analysis system (LAS) information. Both the raster information and LAS information may include the locations (file paths) of corresponding raster files and LAS files associated with the well. Such files may contain various information such as gamma ray resistivity, sonics, or other measurements or test results associated with the well. In some embodiments, the file paths are provided as selectable links which cause the corresponding file to be opened in response to selecting the link via database user interface 566a. For example, the right panel shown in FIG. 29 may include a graph or other depiction of the selected raster file or LAS file.

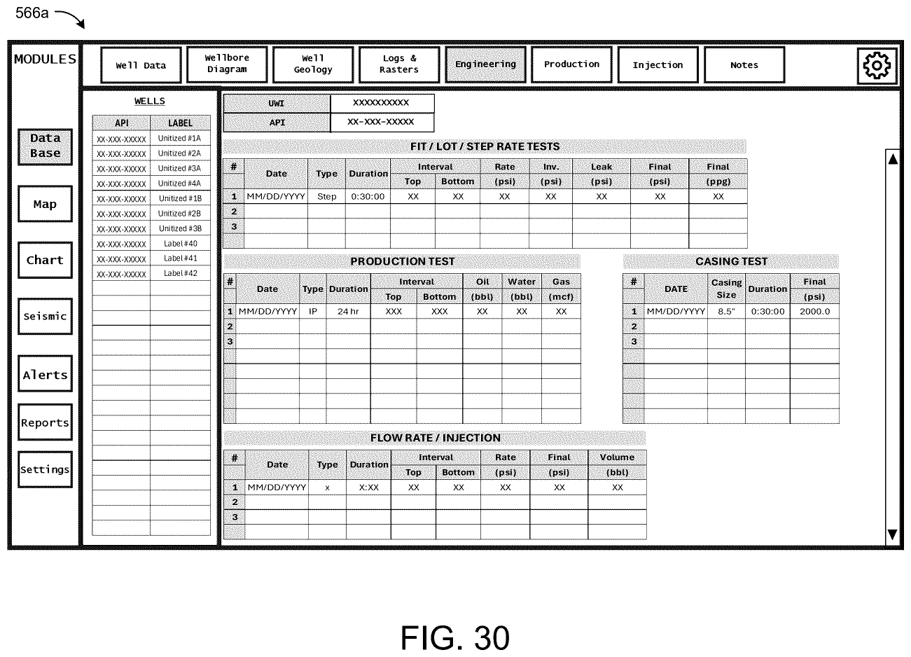

Referring now to FIG. 30, a fifth view of database user interface 566a is shown, according to an exemplary embodiment. In the view shown in FIG. 30, the engineering button is selected in the top panel which causes database user interface 566a to show engineering data pertaining to one or more wells. Database user interface 566a is shown to include the same wells panel as shown in FIG. 26. However, the main panel is shown to include different data associated with the selected well such as various types of engineering data. The engineering data shown in FIG. 30 may include any of the data obtained from engineering data sources 512 as described with reference to FIGS. 10A-10B and/or geological data sources 506 as described with reference to FIG. 7. For example, database user interface 566a is shown to include a table indicating the results of any FIT, LOT, step rate tests, or any other tests conducted on the selected well such as the date, type of test, duration, interval (top and bottom), rate, etc. Database user interface 566a is shown to a production test table indicating the results of any production tests conducted on the selected well such as date, type, duration, interval (top and bottom) oil volume, water volume, and gas volume for production tests. Database user interface 566a is shown to a casing test table indicating the results of any casing tests conducted on the selected well such as the date, casing size, duration, and final pressure. Database user interface 566a is shown to a flow rate or injection table indicating the attributes of various flow rate or injection activities of the well such as date, type, duration, interval (top and bottom), pressure rate, final pressure, and volume.

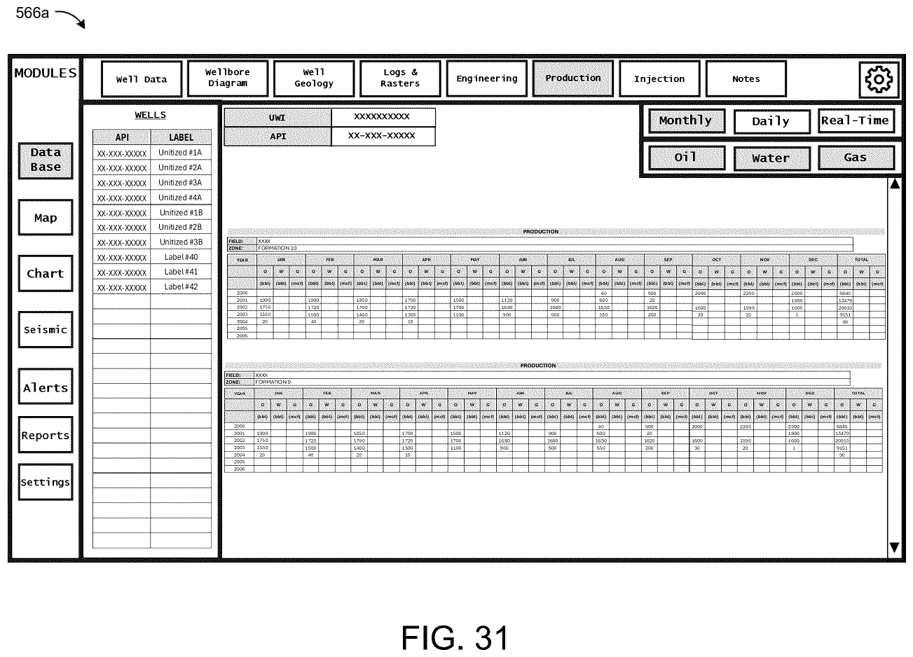

Referring now to FIG. 31, a sixth view of database user interface 566a is shown, according to an exemplary embodiment. In the view shown in FIG. 31, the production button is selected in the top panel which causes database user interface 566a to show production data pertaining to one or more wells. Database user interface 566a is shown to include the same wells panel as shown in FIG. 26. However, the main panel is shown to include production data associated with the selected well. The production data can be presented as a data table as shown in FIG. 31 or as a graph or chart indicating the production of the well over time (e.g., a line graph or bar graph with different lines or bars for each well and/or each type of fluid produced by the well).

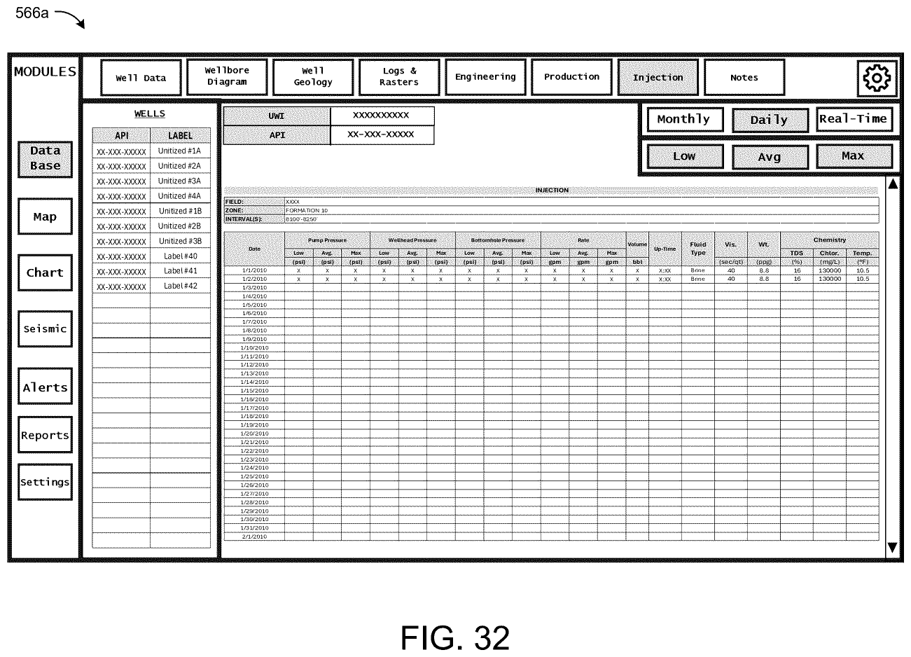

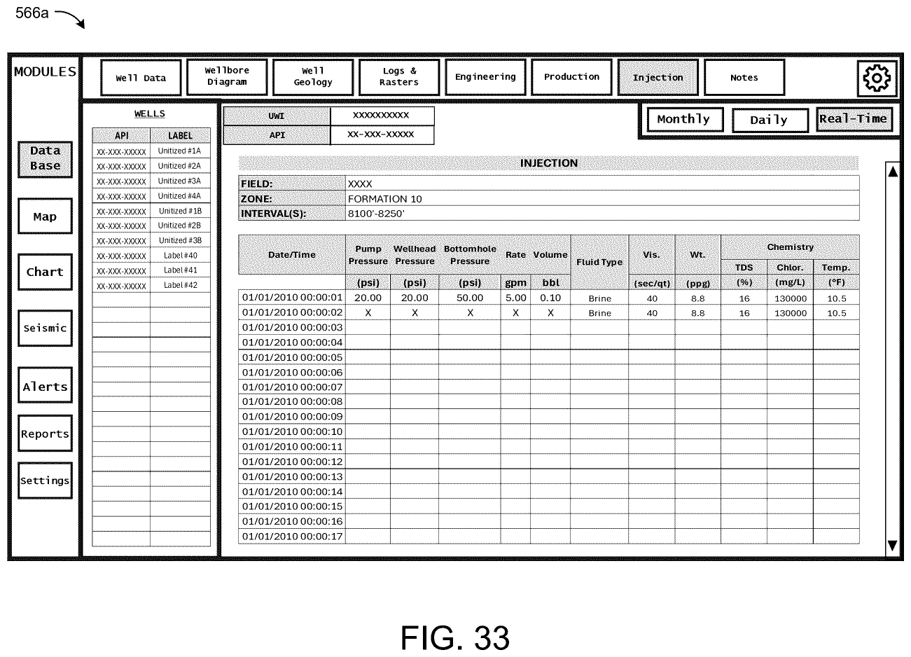

Database user interface 566a may include time range selector buttons that can be selected to cause database user interface 566a to switch between showing monthly, daily, and real-time production data (e.g., production data aggregated into monthly or daily intervals, or presented as real-time values of the production rate). When the monthly interval button is selected as shown in FIG. 31, database user interface 566a may include the production data aggregated into monthly intervals. Examples of data tables showing the data in daily aggregation intervals and in real-time are shown in FIGS. 32 and 33 respectively. Database user interface 566a may include production type selector buttons that can be selected to cause database user interface 566a to switch between showing different types of production (e.g., oil, water, gas), for example, by selectively toggling on/off production of the selected types.

Referring now to FIG. 32, a seventh view of database user interface 566a is shown, according to an exemplary embodiment. In the view shown in FIG. 32, the injection button is selected in the top panel which causes database user interface 566a to show injection data pertaining to one or more wells. Database user interface 566a is shown to include the same wells panel as shown in FIG. 26. However, the main panel is shown to include injection data associated with the selected well. The injection data can be presented as a data table as shown in FIG. 32 or as a graph or chart indicating the injection into the well over time (e.g., a line graph or bar graph with different lines or bars for each well and/or each type of fluid injected into the well).

Database user interface 566a may include time range selector buttons that can be selected to cause database user interface 566a to switch between showing monthly, daily, and real-time injection data (e.g., injection data aggregated into monthly or daily intervals, or presented as real-time values of the injection rate). Database user interface 566a may include data selector buttons (shown as low, average, and maximum in FIG. 32) that can be selected to cause database user interface 566a to switch between showing the minimum or lowest values of the data points for the selected interval (daily in FIG. 32), the average values of the data points for the selected interval, or the highest or maximum values of the data points for the selected interval. Such data points are shown to include pump pressure, wellhead pressure, bottomhole pressure, injection rate, injection volume, up-time, fluid type, viscosity, density or weight, and chemistry data (e.g., total dissolved solids (TDS), chlorine concentration, etc.) and temperature.

Referring now to FIG. 33, an eighth view of database user interface 566a is shown, according to an exemplary embodiment. In the view shown in FIG. 33, the injection button is selected in the top panel which causes database user interface 566a to show injection data pertaining to one or more wells. Database user interface 566a is shown to include the same wells panel as shown in FIG. 26 and the same injection information shown in FIG. 32. However, the real-time selector button is selected in FIG. 33, which causes database user interface 566a to show the injection data as real-time values. For example, each row of the data table shown in FIG. 33 may correspond to a different second, minute, or other real-time data aggregation interval and may include the values of the data points at that time. In alternative embodiments, the data table can be replaced with a graph or chart (e.g., line graph, bar graph, etc.) which plots the values of the data points over time. In addition to the data points shown in FIG. 32, the real-time data points are shown to include a rate (e.g., gallons per minute (GPM)) which indicates the rate at which the fluid is being injected by the well at the corresponding time. If the real-time button is selected in the production interface of FIG. 31, a similar data table or graph may be shown with data points that indicate the various pressures, fluid properties, and rate of the fluid being produced from the well.

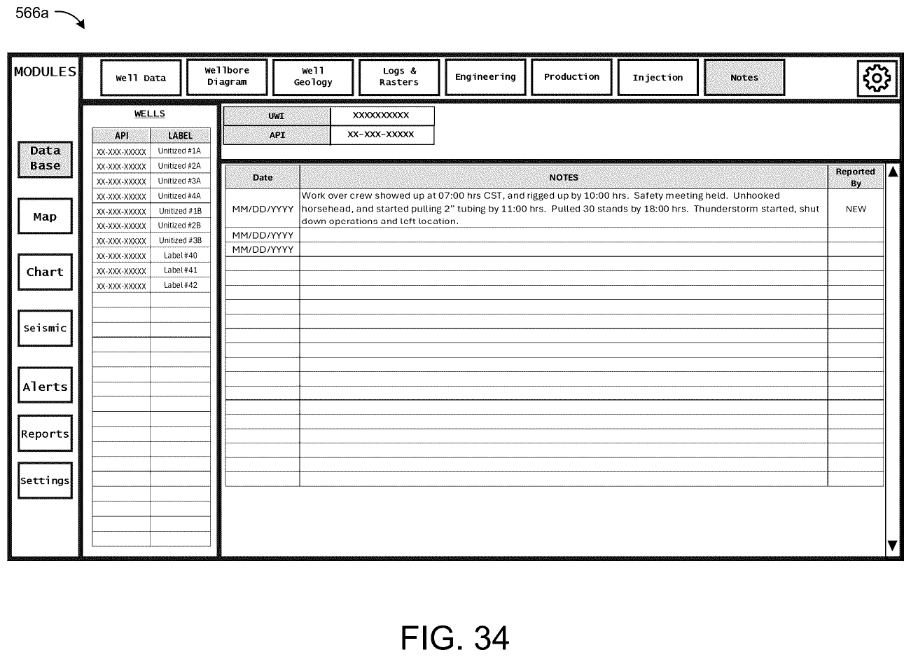

Referring now to FIG. 34, a ninth view of database user interface 566a is shown, according to an exemplary embodiment. In the view shown in FIG. 34, the notes button is selected in the top panel which causes database user interface 566a to show notes pertaining to one or more wells. Database user interface 566a is shown to include the same wells panel as shown in FIG. 26. However, the main panel is shown displaying notes (e.g., time the work crew started work, any observations during the day, etc.). The notes may be entered by a user or automatically generated by computing system 110 in various embodiments. The notes are shown as elements of a data table including multiple rows for different notes. The columns of the data table are shown to include headings for the date, the text content of the note, and the name of the person or system that added the note.

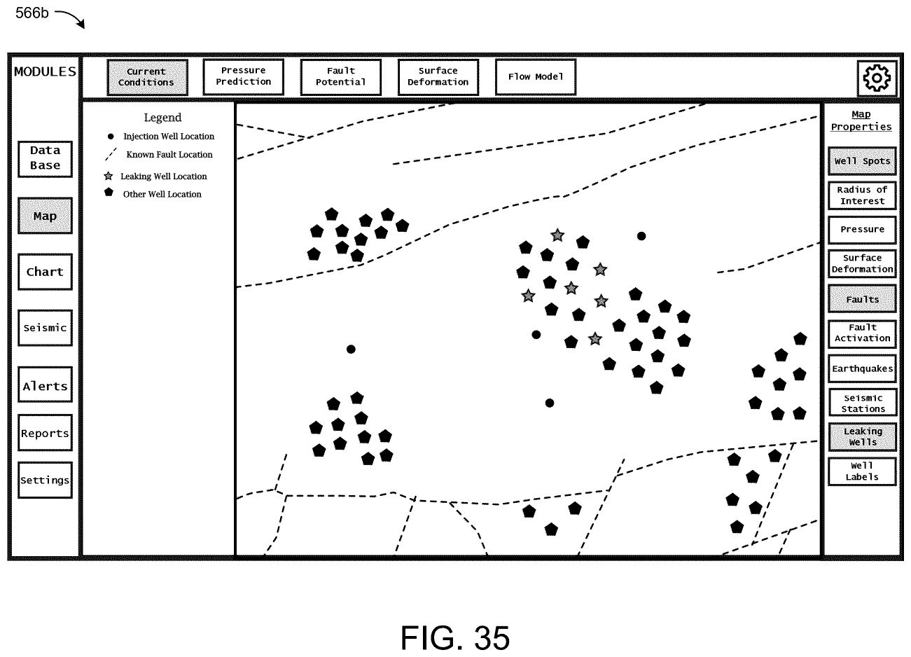

Referring now to FIG. 35, a first view of maps user interface 566b is shown, according to an exemplary embodiment. Maps user interface 566b may be displayed in response to selecting the maps button in the modules panel. Maps user interface 566b may be configured to present any of maps 554 as described with reference to FIG. 13. The maps shown in maps user interface 566b may include any of a variety of depictions of a geographic area (e.g., a city, a county, a state, a region, a country, etc.), a wellsite, a wellbore, or other locations of interest. For example, the maps may include geographic maps, geopolitical maps, geologic maps, topographic maps, or any other type of map. In various embodiments, the maps may include 2D maps (e.g., top-down or aerial views of the earth's surface, cross-sectional views of a section of the earth) or 3D maps (e.g., showing the earth's surface and one or more subterranean layers from an isometric perspective). In FIG. 35, maps user interface 566b is shown displaying the same map 554e of FIG. 23 as an element of a graphical user interface.

The top panel of maps user interface 566b is shown to include selectable buttons that allow a user to switch between showing current conditions, pressure predictions, fault potential, surface deformation, and a flow model. In the view shown in FIG. 35, the current conditions button is selected which causes maps user interface 566b to show the current conditions of the various wells and other items within the geographic region shown in the map. Other elements of maps user interface 566b include a legend panel that explains the various markings shown in the map and a map properties panel that allows the user to toggle on/off different items shown in the map. For example, the legend panel in FIG. 35 indicates that the circles shown in the map represent injection well locations, the dashed lines represent the locations of known faults, the stars represent leaking well locations, and the pentagons represent other well locations. Other items which can be shown in the map but are not selected in the view shown in FIG. 35 include a radius of interest around each well location, pressure information, surface deformation information, fault activation information, earthquakes, seismic station locations, and well labels.

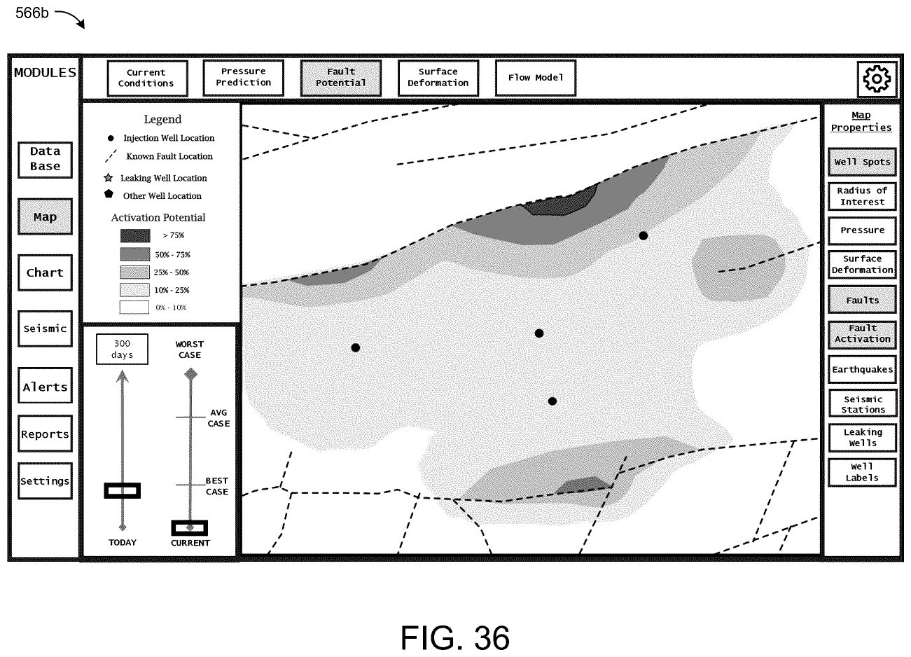

Referring now to FIG. 36, a second view of maps user interface 566b is shown, according to an exemplary embodiment. Maps user interface 566b is shown displaying the map 554b of FIG. 20 as an element of a graphical user interface. Other elements of maps user interface 566b are shown to include the legends panel and map properties panel, which may be the same as described with reference to FIG. 35. However, in the view shown in FIG. 36, the fault potential button is selected in the top panel of maps user interface 566b, which causes maps user interface 566b to show the activation potential of various regions shown in the map. The legend panel is shown displaying activation potentials which correspond to the different shaded regions in the map. For example, the darkest shaded region on the map indicates an activation potential of >75% whereas the successively lighter shaded regions indicate activation potentials of 50%-75%, 25%-50%, 10%-25%, and 0%-10%.

Maps user interface 566b is shown to include a sliders panel below the legend panel. The sliders panel is shown to include a time slider which ranges from a start time to an end time. In the view shown in FIG. 36, the time slider ranges from the current time (“today”) to a future time (“300 days”). In some embodiments, the time period represented by the time slider can be adjusted or set to any desired time period. For example, the start time and end time shown in the time slider can be replaced with any future, current, or past time (e.g., 2 years in the future, 1 week in the future, 1 month in the past, 2 years in the past, the current time, etc.) to allow the time slider to span any desired time range. A user can change the position of the time slider within the selected time range to cause the information shown in the map portion of maps user interface 566b to change to the conditions at the selected time. If the selected time is a past time or the current time, the conditions shown in maps user interface 566b may be based on historical measurements, actual measured conditions, or predicted conditions for the selected time (e.g., predictions generated by AI model 534). If the selected time is a future time, the conditions shown in maps user interface 566b may be based on the predictions generated by AI model 534 for the future time.

The sliders panel in maps user interface 566b is shown to include a scenarios slider. The scenarios slider may allow a user to switch between the different scenarios generated by scenarios generator 536 as described with reference to FIG. 5. The scenarios are shown in FIG. 36 as including a current scenario, a best case scenario, an average case scenario, and a worst case scenario. In some embodiments, the different scenarios correspond to different combinations of control actions (e.g., injection volumes, injection rates, production volumes, production rates, pressures, etc.) at one or more wells within a given geographic region. For example, the worst case scenario may correspond to all of the injection wells in the geographic region operating at maximum capacity (e.g., injecting at the maximum permitted volume, maximum permitted rate, and maximum permitted pressure) or otherwise taking actions that maximize the risk of induced seismic events. Conversely, the best case scenario may correspond to all of the injection wells in the geographic region being inactive or operating at minimum capacity (e.g., injecting at the minimum permitted volume, minimum permitted rate, and minimum permitted pressure) or otherwise taking actions that minimize the risk of induced seismic events. The average case scenario may correspond to an average of the best case scenario and worst case scenario. The scenarios slider can be adjusted to cause the information shown in the map portion of maps user interface 566b to change to predictions from AI model 534 when the injection wells are assumed to operate in accordance with the selected scenario. The time slider and scenarios slider can be set to different positions to cause the map to display the corresponding measurements or model predictions for different combinations of selected times and scenarios.

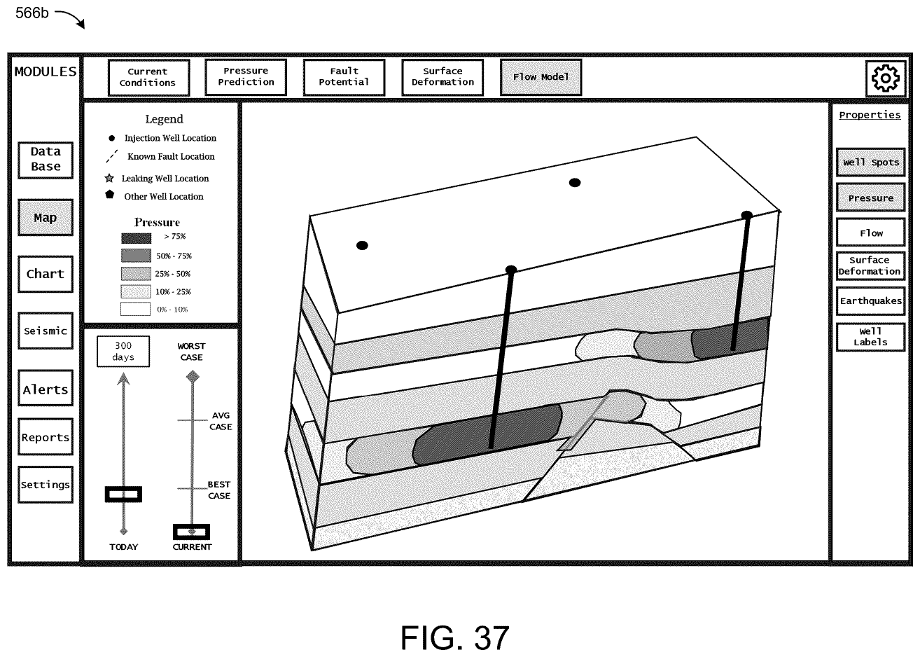

Referring now to FIG. 37, a third view of maps user interface 566b is shown, according to an exemplary embodiment. Maps user interface 566b is shown displaying a 3D map of a geographic region or a wellsite as an element of a graphical user interface. The 3D map includes a section of the earth showing various layers and formations, as well as the pressure and/or flow within each formation. For example, the different colored or shaded regions within the 3D map may correspond to different pressure levels within the formations or reservoirs as indicated by the pressure legend shown in the legend panel. In some embodiments, a user can select (e.g., click, hover over, etc.) the formations or regions within the 3D map to view the pressure levels or flow levels associated with each region. The 3D map also indicates the injection well locations, known fault locations, leaking well locations, and other well locations (if any) using the corresponding markings or icons indicated in the legend panel.

Other elements of maps user interface 566b are shown to include the legends panel, the sliders panel, and the properties panel, which may be the same as or similar to the corresponding elements shown in FIGS. 35-36. However, in the view shown in FIG. 37, the flow model button is selected in the top panel of maps user interface 566b, which causes maps user interface 566b to show the pressures and flows within the subterranean regions shown in the 3D map. The properties panel may include selectable buttons that allow the user to toggle on/off different items shown in the 3D map. For example, the properties panel is shown to include selectable buttons for well spots, pressure, flow, surface deformation, earthquakes, and well labels. Selecting any of the selectable buttons in the properties panel may cause the corresponding items to be added to the 3D map or removed from the 3D map, along with corresponding legends within the legends panel.

The legend panel is shown displaying pressure levels which correspond to the different shaded regions in the 3D map. For example, the darkest shaded region in the 3D map indicates a pressure of >75% (e.g., of a maximum permitted pressure) whereas the successively lighter shaded regions indicate pressures of 50%-75%, 25%-50%, 10%-25%, and 0%-10%. Alternatively, the pressure levels may be indicated in units of pressure such as psi, kPa, etc. The sliders panel is shown to include the time slider and the scenarios slider, which may function in the same manner as described with reference to FIG. 36. For example, changing the position of the time slider may cause the information shown in the 3D map (e.g., pressure levels, flow levels, surface deformation) to change to the measured or predicted levels for the corresponding time. Similarly, changing the position of the scenarios slider may cause the information shown in the 3D map to change to the measured or predicted levels for the corresponding scenario. The time slider and scenarios slider can be set to different positions to cause the 3D map to display the corresponding information for different combinations of selected times and scenarios.

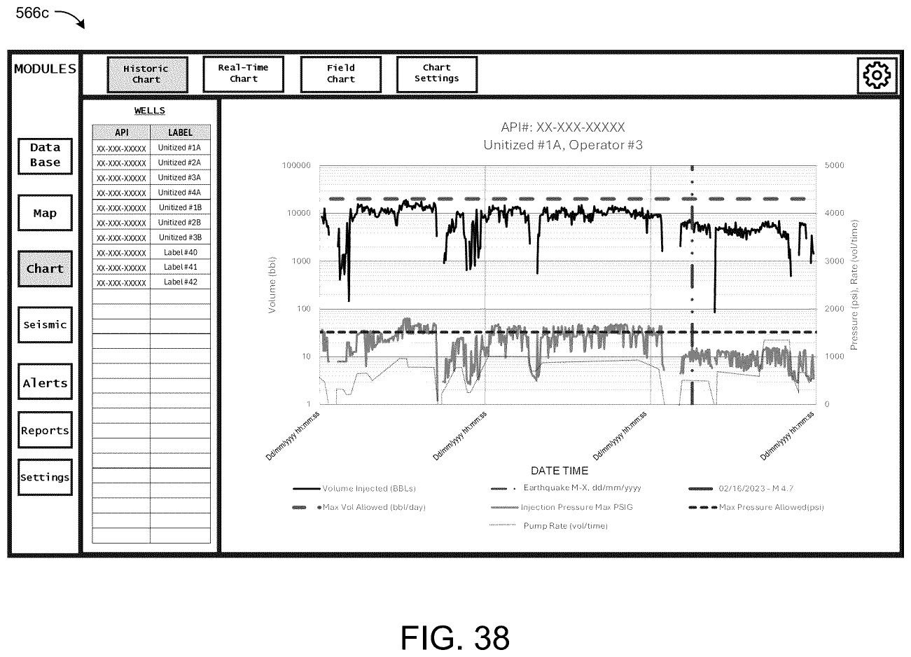

Referring now to FIG. 38, a first view of charts user interface 566c is shown, according to an exemplary embodiment. Charts user interface 566c may be displayed in response to selecting the charts button in the modules panel. Charts user interface 566c may be configured to display any of charts 560, as described with reference to FIG. 16. The charts shown in charts user interface 566c may include any of a variety of charts, graphs, plots, infographics, or other type of visual or graphical representation of the information provided by data sources 502 and/or generated by computing system 110. The charts shown in charts user interface 566c may be based on historical data, current data (e.g., real-time or live data), and/or predicted future data generated by computing system 110. In some embodiments, charts user interface 566c may also include other outputs 552 such as maps 554, flow models 556, pressure tracking information 558, or any other information processed or generated by computing system 110. Charts user interface 566c is shown to include a wells panel, which may be the same as described with reference to FIGS. 26-34.

Charts user interface 566c is shown to include several buttons in the top panel including a historic chart button, a real-time chart button, a field chart button, and a chart settings button. Selecting any of the buttons in the top panel may cause charts user interface 566c to display the corresponding type of chart or settings in the main panel (i.e., the large panel in the bottom right of charts user interface 566c). In the view shown in FIG. 38, the historic charts button is selected in the top panel, which causes charts user interface 566c to display one or more historic charts associated with one or more selected wells. The historic charts may plot historic values of the volume injected (bbls), injection pressure (psi), injection pump rate (vol/time), maximum permitted injection volume (bbl/day), maximum permitted injection pressure (psi) over the historical time period. For production wells, the injection-specific variables can be replaced with production-specific variables such as volume produced (bbls), production pressure (psi), production pump rate (vol/time), maximum permitted production volume (bbl/day), maximum permitted production pressure (psi), etc.

The historic charts may also include vertical lines indicating the times at which seismic events (e.g., earthquakes) occurred during the historical time period. In some embodiments, the historical time period can be adjusted by setting the start time and end time. In some embodiments, the end time can be set to a past time, the current time, or a future time. Accordingly, the time period shown in the historic chart may span from a first historical time to a second historical time, from the first historical time to the current time, or from the first historical time a future time, depending on the selected end time. The historic charts may allow a user to see the historic operations of a well along with any seismic events that occurred within the depicted time period.

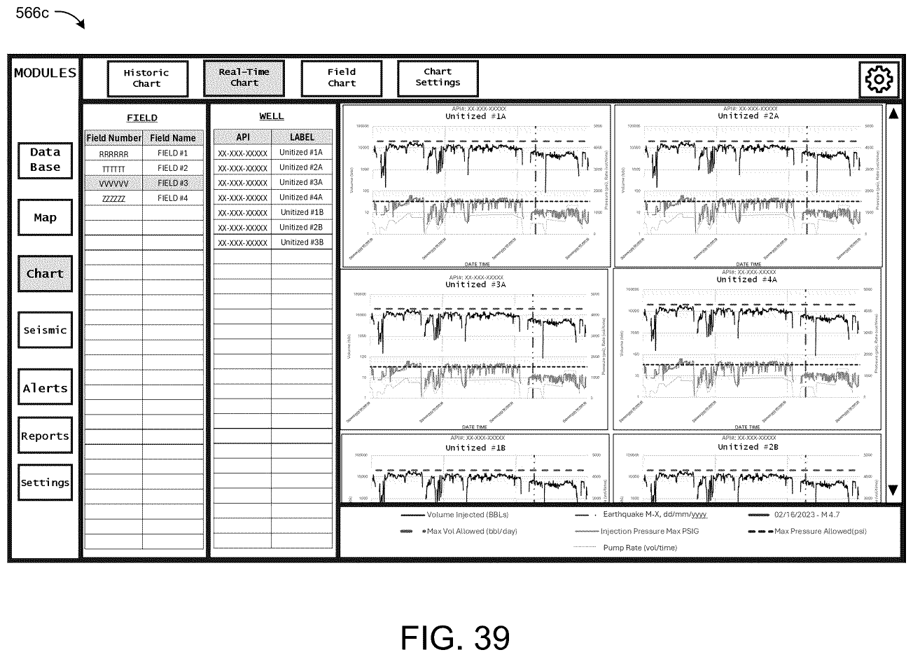

Referring now to FIG. 39, a second view of charts user interface 566c is shown, according to an exemplary embodiment. In the view shown in FIG. 39, the real-time button is selected in the top panel, which causes charts user interface 566c to display real-time charts associated with one or more selected wells. Charts user interface 566c is shown to include a fields panel which may include a list of different fields or well sites (e.g., geographic regions, facilities, or areas containing one or more wells) which can be selected. Charts user interface 566c is also shown to include a wells panel, which may be the same as described with reference to FIG. 38. In some embodiments, selecting a particular field in the fields panel causes the wells panel to display the wells located within the selected field.

Selecting the real-time button in the top panel may cause charts user interface 566c to display one or more real-time charts associated with the selected fields and/or wells. For example, the main panel in charts user interface 566c is shown to include several real-time charts, each of which corresponds to a selected well and plots various information associated with the corresponding well. The real-time charts may plot historic and/or real-time values of the volume injected (bbls), injection pressure (psi), injection pump rate (vol/time), maximum permitted injection volume (bbl/day), maximum permitted injection pressure (psi) over the time period spanned by the real-time charts. The real-time charts shown in FIG. 39 may allow a user to track the current operation or performance of one or more selected wells in real-time.

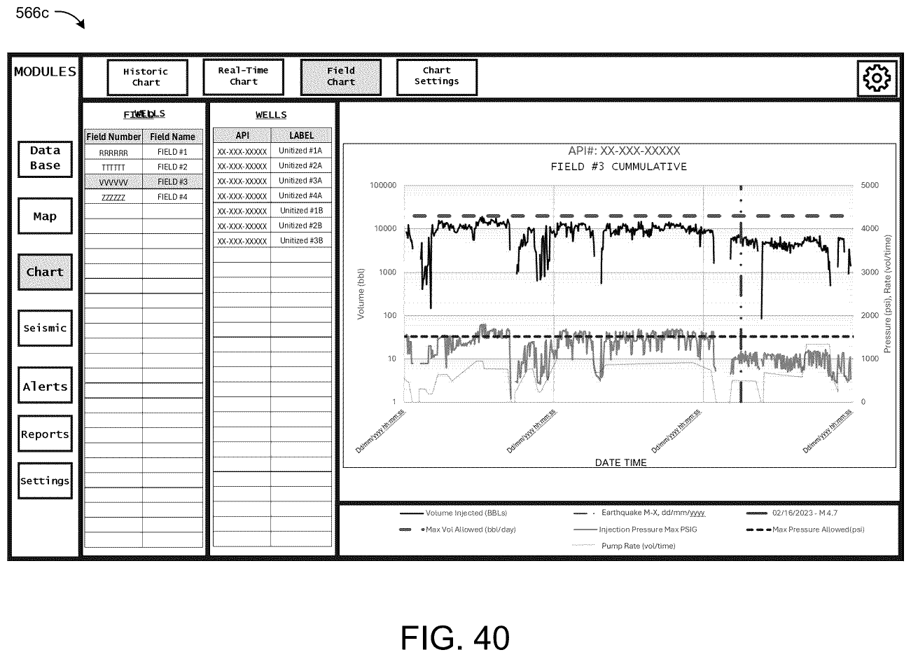

Referring now to FIG. 40, a third view of charts user interface 566c is shown, according to an exemplary embodiment. Charts user interface 566c is shown to include the same fields panel and wells panel described with reference to FIG. 38. However, in the view shown in FIG. 40, the field button is selected in the top panel, which causes charts user interface 566c to display a field chart associated with the selected field in the main panel. The field chart may present cumulative or aggregated information associated with all of the wells located within the selected field. The field chart may allow a user to monitor the aggregate performance of an entire field of wells via a single screen or chart.

In some embodiments, the field chart may plot cumulative values of the volume injected (bbls), injection pump rate (vol/time), maximum permitted injection volume (bbl/day), or other variables which can be aggregated across the wells within the selected field by summing their values. The field chart may also plot maximum or average values of injection pressure (psi), maximum permitted injection pressure (psi), or other variables which do not add cumulatively. For fields that include production wells instead of injection wells, the injection-specific variables can be replaced with production-specific variables such as volume produced (bbls), production pressure (psi), production pump rate (vol/time), maximum permitted production volume (bbl/day), maximum permitted production pressure (psi), etc.

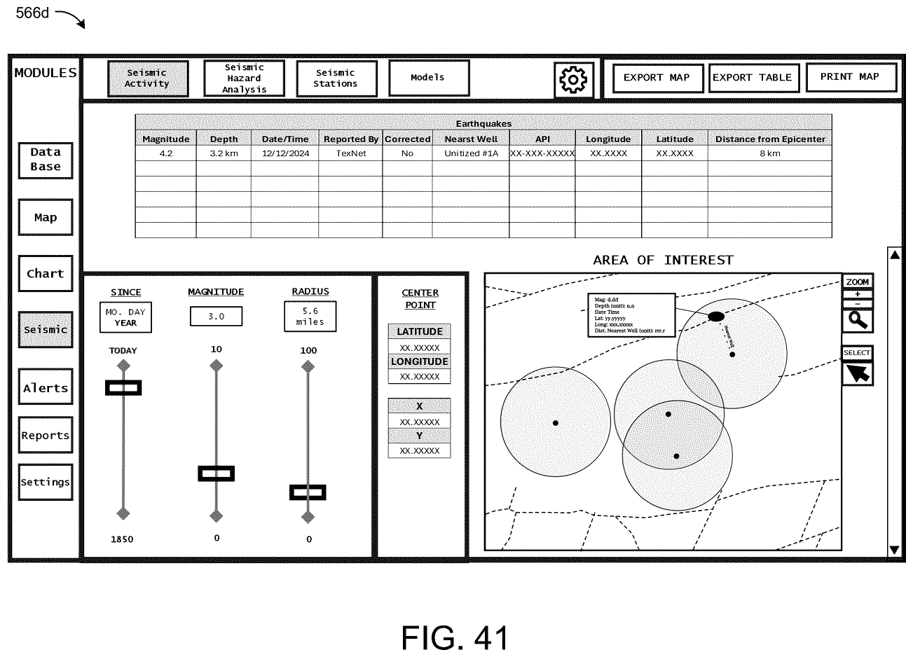

Referring now to FIG. 41, a first view of seismic user interface 566d is shown, according to an exemplary embodiment. Seismic user interface 566d may be displayed in response to selecting the seismic button in the modules panel. Seismic user interface 566d may be configured to present any of the various types of seismic or earthquake information provided by seismic/earthquake data sources 508, as described with reference to FIG. 8. The information shown in seismic user interface 566d may include information on historical seismic events, as well as predictions of future seismic events. For example, the information shown in seismic user interface 566d may include any of the model predictions generated by AI model 534 or other components of computing system 110 relating to predicted future seismic events.

Seismic user interface 566d is shown to include several buttons in the top panel including a seismic activity button, a seismic hazard analysis button, a seismic stations button, and a models button. In the view shown in FIG. 41, the seismic activity button is selected, which causes seismic user interface 566d to present information describing various seismic events for a geographic region (e.g., city, state, county, etc.) or other area of interest. Seismic user interface 566d is shown to include an earthquakes table which lists one or more seismic events (e.g., earthquakes) occurring within the area of interest within a selected time period. Each seismic event is listed with several attributes characterizing the seismic event such as magnitude, depth, date/time, an identifier of the seismic monitoring station that reported the event, whether the data was corrected, the nearest well, the identifier of the nearest well (e.g., API number), the location (e.g., latitude and longitude, X/Y coordinates, etc.) of the epicenter of the seismic event and/or the nearest well, and the distance between the epicenter and the nearest well.

A user can select a particular seismic event in the earthquakes table to cause seismic user interface 566d to present the details of the selected seismic event in other panels of seismic user interface 566d. For example, the center point panel may display the latitude and longitude or other coordinates of the selected seismic event. The area of interest panel may show a map of the geographic region or other area of interest. A user can zoom in/out, pan, or otherwise adjust the geographic region shown in the area of interest panel by interacting with the user interface options shown in seismic user interface 566d. In some embodiments, the map shown in the area of interest panel includes icons or other markers depicting the well locations, fault lines, or other information described with reference to maps user interface 566b. In some embodiments, each well shown in the map is marked with a well location and a radius surrounding the well location. Seismic user interface 566d is shown to include buttons that allow the map or earthquakes table to be exported or printed.

Seismic user interface 566d is shown to include a sliders panel including a date slider, a magnitude slider, and a radius slider. The date slider may allow a user to adjust the time period used to filter the set of seismic events depicted in seismic user interface 566d. For example, a user can set the start date and end date of the time period (e.g., by adjusting the minimum and maximum values of the date slider), which may cause seismic user interface 566d to filter or search a database of seismic events for only the seismic events occurring within the selected time period. Similarly, the magnitude slider may allow a user to adjust the magnitude used to filter the set of seismic events depicted in seismic user interface 566d. For example, a user can set the minimum and maximum values of the magnitude, which may cause seismic user interface 566d to filter or search the database of seismic events for only the seismic events having a magnitude between the minimum and maximum values. The radius of interest slider may allow a user to adjust the radius of interest around the well locations depicted in seismic user interface 566d. For example, a user can set the radius of interest to a selected value, which may cause seismic user interface 566d to filter or search the database of seismic events for only the seismic events having epicenters within the radius of interest from the nearest well location. In some embodiments, selecting a seismic event in the earthquakes table or in the map shown in seismic user interface 566d may cause the positions of the sliders within the slider panel to move to the corresponding date, magnitude, and radius of the selected seismic event.

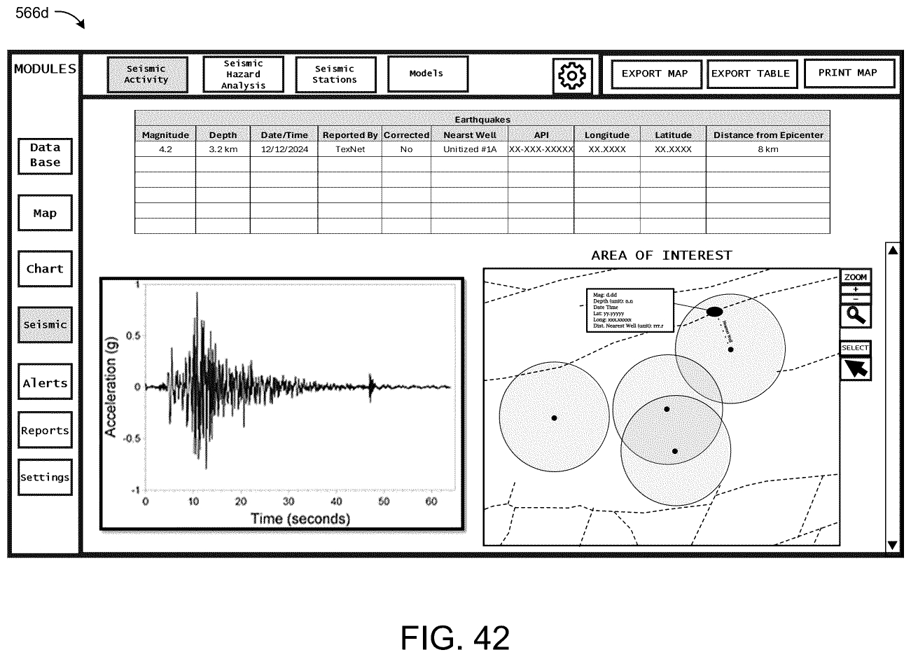

Referring now to FIG. 42, a second view of seismic user interface 566d is shown, according to an exemplary embodiment. The view of seismic user interface 566d shown in FIG. 42 includes the same earthquakes table and area of interest panel shown in FIG. 41. However, the sliders panel and center point panel have been replaced with a seismograph in FIG. 42. The seismograph may present acceleration measurements (e.g., peak ground acceleration), velocity measurements (e.g., peak ground velocity), or other information provided by seismic monitoring stations for a selected seismic event. In some embodiments, the seismograph shown seismic user interface 566d presents data from a selected seismic monitoring station, which can be selected by clicking an icon or marker representing the seismic monitoring station in the map shown in the area of interest panel. A user can switch between seismographs generated by different seismic monitoring stations by selecting different seismic monitoring stations in the map.

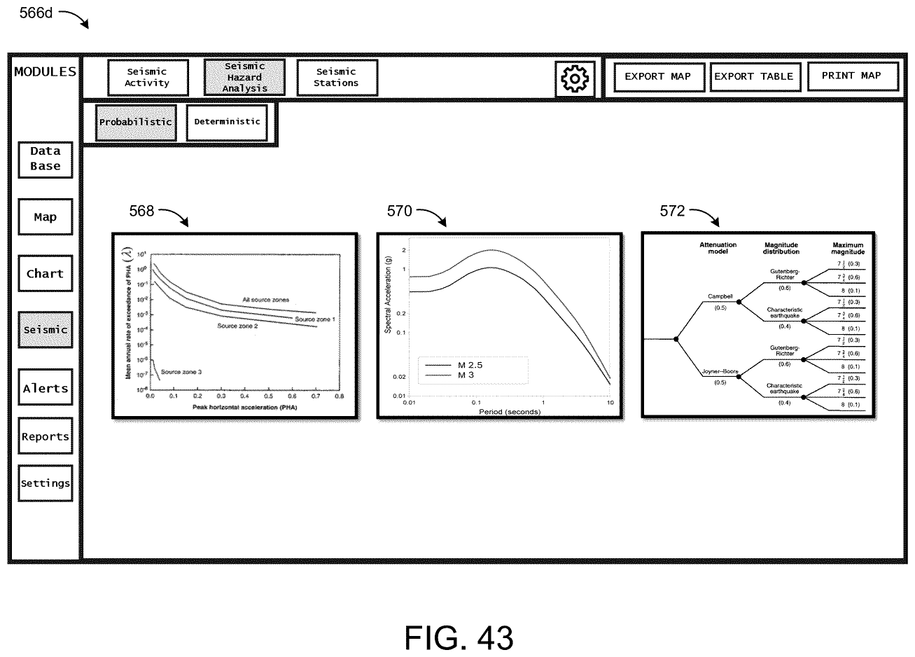

Referring now to FIG. 43, a third view of seismic user interface 566d is shown, according to an exemplary embodiment. In the view shown in FIG. 43, the seismic hazard button is selected in the top panel, which causes seismic user interface 566d to present the results of the seismic hazard analysis performed by computing system 110. The results of the seismic hazard analysis may include any of analytics 564, as described with reference to FIGS. 18A-18B. In some embodiments, the seismic hazard analysis includes both a probabilistic seismic hazard analysis and a deterministic seismic hazard analysis. Seismic user interface 566d may include buttons that allow a user to select or switch between the results of the probabilistic seismic hazard analysis and a deterministic seismic hazard analysis.

In the view of seismic user interface 566d shown in FIG. 43, the probabilistic button is selected, which causes seismic user interface 566d to present the results of the probabilistic seismic hazard analysis. The results of the probabilistic seismic hazard analysis may include, for example, probabilistic ground motion maps, uniform hazard spectra, time-dependent seismic hazard curves, disaggregation results such as magnitude-distance pairs, and predictions of induced seismic events. The predictions of induced seismic events may include the probability of exceeding a specific magnitude and/or a spatial distribution of potential for induced seismic events.

In some embodiments, the results of the probabilistic seismic hazard analysis include the model predictions generated by AI model 534 and/or other predictions generated using different models, equations, or other probabilistic means. For example, computing system 110 can analyze a set of historical seismic events (e.g., from seismic/earthquake data sources 508) in combination with data indicating the injection well operations (e.g., from real-time wellsite data sources 510) and fault locations within the geographic region (e.g., from geographical data sources 504 or geological data sources 506) to calculate or predict the contribution of each source to a seismic event. A “source” in the context of the probabilistic seismic hazard analysis may include both natural sources or causes of seismic events (e.g., faults) as well as human-induced sources or causes of seismic events (e.g., injection well operations).

In FIG. 43, seismic user interface 566d is shown to include several graphs 568-572 indicating the results of the probabilistic seismic hazard analysis for a set of historical seismic events. For example, seismic user interface 566d is shown to include a first graph 568 which plots the peak horizontal ground acceleration (PHA) against the mean annual rate of exceedance of the PHA (2) for several sources of seismic events (e.g., faults or injection wells) as well as the total contribution of all sources. Seismic user interface 566d is shown to include a second graph 570 which plots the spectral acceleration (g) of seismic events against the period (seconds) for various magnitudes of seismic events (e.g., historical seismic events represented in the historical data). Seismic user interface 566d is shown to include a third graph 572 which uses different attenuation models and magnitude distribution models or approaches (e.g., the Campbell attenuation model, the Joyner-Boore attenuation model, the Gutenberg-Richter magnitude distribution approach, the characteristic earthquake approach, etc.) to determine the maximum magnitude of historical seismic events. In some embodiments, the different models or approaches can be assigned different weights in the probabilistic analysis.

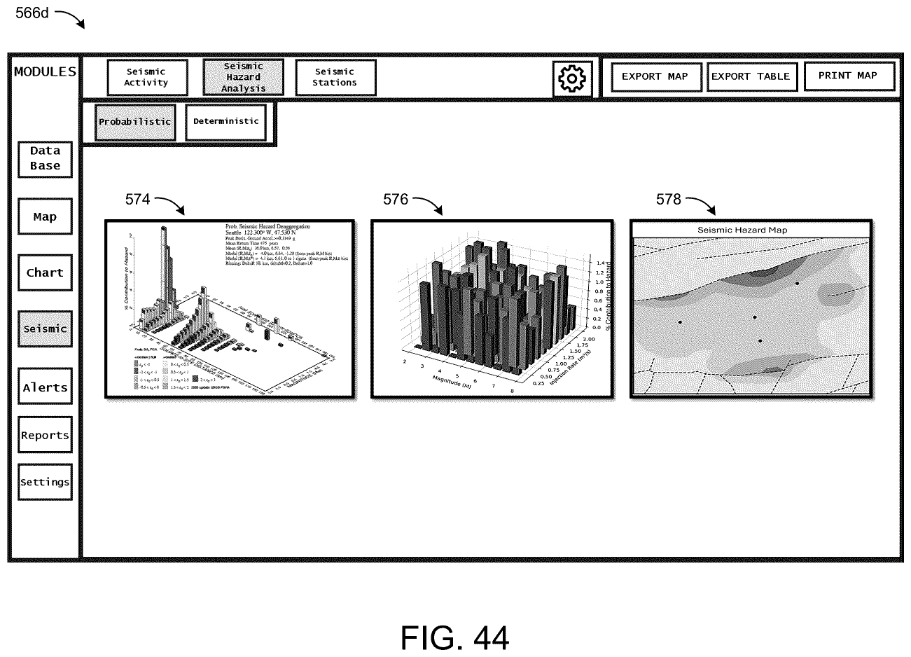

Referring now to FIG. 44, a fourth view of seismic user interface 566d is shown, according to an exemplary embodiment. In FIG. 44, seismic user interface 566d is shown to include two additional graphs 574-576 indicating the results of the probabilistic seismic hazard analysis for a set of historical seismic events. Graph 574 is a probabilistic seismic hazard disaggregation plot which shows the contribution of various sources to seismic events that occur within a given geographic region. As noted above, “sources” in the context of the probabilistic seismic hazard analysis include both natural sources of seismic events such as faults, as well as induced sources of seismic events such as injection wells. Graph 574 is shown as a 3D bar graph in which the first dimension or axis represents the source-to-site distance (i.e., the distance between the source and the site at which the seismic event is detected or measured), the second dimension or axis represents the magnitude of the seismic event (e.g., Mw), and the third dimension or axis represents the contribution toward the seismic hazard (i.e., the percentage attributable to each source). Accordingly, the height of each bar in graph 574 represents the amount or percentage that each source contributes toward the occurrence of seismic events having various magnitudes based on the source-to-site distance.

Graph 576 is another probabilistic seismic hazard disaggregation plot which shows the contribution of various injection rates to seismic events that occur within a given geographic region. Like graph 574, two of the dimensions or axes in graph 576 indicate the magnitude of seismic events and the contribution toward the seismic hazard respectively. However, the final dimension or axis in graph 576 indicates the injection rate of nearby injection wells (e.g., all injection wells located within a threshold distance of various seismic events) instead of the source-to-site distance. Accordingly, the height of each bar in graph 576 represents the amount or percentage that nearby injection wells contribute toward the occurrence of seismic events having various magnitudes based on the injection rates of the injection wells.

In some embodiments, computing system 110 generates the disaggregation information shown in graphs 574 and 576 by performing a probabilistic analysis on a set of historical seismic events in combination with data indicating the injection well operations and fault locations within the geographic region. In some embodiments, computing system 110 uses AI model 534 to analyze such data and determine the percentage contribution of each source and/or injection rate to the occurrence of the seismic events. For example, model trainer 530 can train AI model 534 to predict the percentage that various injection rates, injection site locations, and/or other injection well attributes or operations (e.g., injection pressures, injection volumes, etc.) contribute to seismic events based on a set of training data including historical seismic events and historical injection well operations. Once trained, computing system 110 can use AI model 534 to analyze new (e.g., real-time, proposed, etc.) injection well locations or operations to determine the risk that the new injection well locations or operations will cause a seismic event.

Seismic hazard map 578 depicts the results of the probabilistic seismic hazard analysis performed by computing system 110, either for a set of historical seismic events or for new injection well locations or operations. Seismic hazard map 578 shows activation potential information as shaded regions with different colors or patterns to indicate different activation potential levels. For example, the darkest shaded region in map 578 may indicate an activation potential of >75% whereas the successively lighter shaded regions may indicate activation potentials of 50%-75%, 25%-50%, 10%-25%, and 0%-10%. The points (circles) in map 578 indicate the well locations and may be based on the location information provided by geographical data sources 504 or real-time wellsite data sources 510. The dashed lines in map 578 indicate known fault locations and may be based on the information provided by geological data sources 506. The activation potentials shown in map 578 may be generated by AI model 534 and/or as results of the probabilistic seismic hazard analysis. For example, for a given set of well locations and operating parameters (e.g., injection rates, injection volumes, injection pressures, etc.), AI model 534 may predict the risk that fault activation will occur at the various locations shown in map 578.

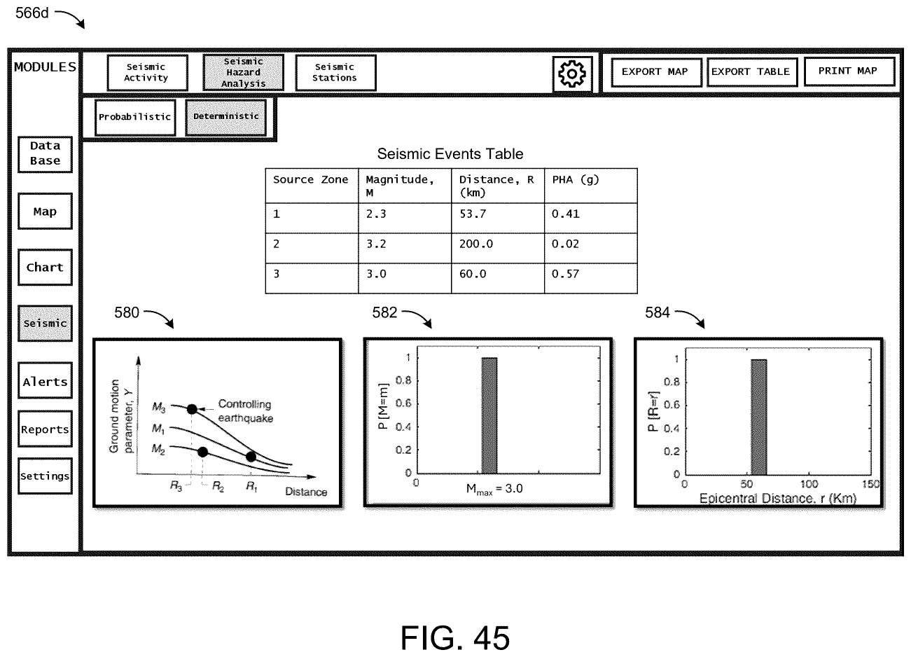

Referring now to FIG. 45, a fifth view of seismic user interface 566d is shown, according to an exemplary embodiment. In the view shown in FIG. 45, the deterministic button is selected, which causes seismic user interface 566d to present the results of the deterministic seismic hazard analysis. The results of the deterministic seismic hazard analysis may include, for example, response spectra for various time periods, ground motion time histories, maximum credible earthquake (MCE) predictions, peak ground acceleration (PGA) and peak ground velocity (PGV) predictions, and/or peak horizontal acceleration (PHA) predictions for various combinations of injection well locations and operating parameters.

Seismic user interface 566d is shown to include a seismic events table indicating the predicted magnitudes, distances, and PHA values of seismic events induced by various sources (shown as source zones 1-3). In some embodiments, computing system 110 is configured to perform the deterministic seismic hazard analysis by analyzing the well location and operating parameters of a given or proposed injection well using one or more deterministic models and/or AI model 534. Computing system 110 can predict the probability that an induced seismic event will occur and/or various attributes of the induced seismic event (e.g., magnitude, distance from injection well, PHA, etc.) as a result of the injection well operations at the given location. Seismic user interface 566d may present the results of the deterministic seismic hazard analysis in the form of one or more graphs 582-584. For example, graph 580 plots a ground motion parameter (e.g., PGA, PGV, PHA) as a function of the distance to the injection well location for various magnitudes of earthquakes. Graph 582 plots the probability of the induced seismic event based on the selected magnitude, whereas graph 584 plots the probability of the induced seismic event occurring based on the epicentral distance from the injection well location or fault.

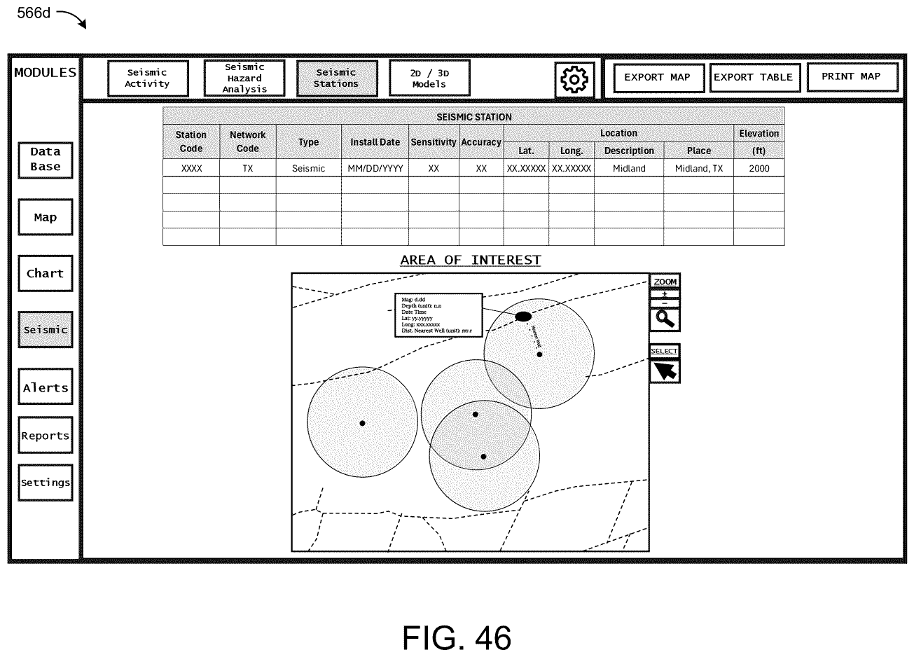

Referring now to FIG. 46, a sixth view of seismic user interface 566d is shown, according to an exemplary embodiment. In the view shown in FIG. 46, the seismic stations button is selected in the top panel, which causes seismic user interface 566d to present information pertaining to various seismic stations. For example, seismic user interface 566d is shown to include a seismic stations table which lists the seismic monitoring stations located within a selected area of interest along with various attributes of the seismic monitoring stations such as the station code, network code, type, install date, sensitivity, accuracy, location (e.g., latitude, longitude, description, place, etc.), and elevation. Seismic user interface 566d is also shown to include a map depicting the area of interest with the locations of the seismic monitoring stations marked (e.g., as ovals in FIG. 46). In some embodiments, selecting a seismic monitoring station in the map causes a pop-up or text box to be displayed indicating the information pertaining to the seismic monitoring station (e.g., the same information shown in the seismic stations table).

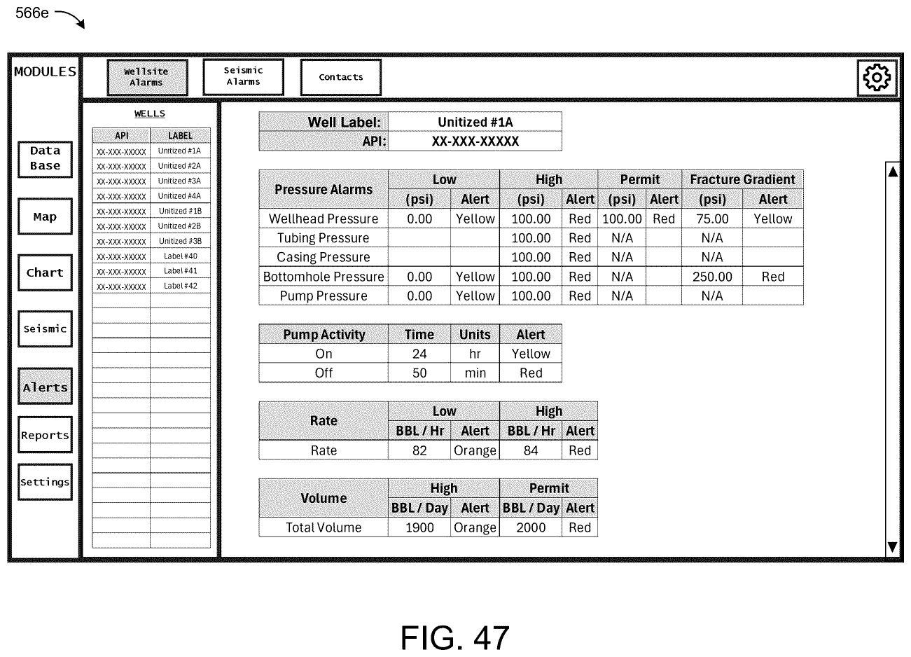

Referring now to FIG. 47, a first view of alerts user interface 566e is shown, according to an exemplary embodiment. Alerts user interface 566e may be displayed in response to selecting the alerts button in the modules panel. Alerts user interface 566e may be configured to present any of the alerts, notifications, alarms or other generated by computing system 110, wellsite equipment 546, or other systems or devices configured to monitor or control wellsite operations (e.g., on-site controllers, on-site monitoring systems, etc.). Alerts user interface 566e is shown to include a wells panel, which may be the same as described with reference to FIGS. 26-34.

Alerts user interface 566e is shown to include a top panel with several buttons including a wellsite alarms button, a seismic alarms button, and a contacts button. In the view shown in FIG. 47, the wellsite alarms button is selected, which causes alerts user interface 566e to display alarms, alerts, or other information associated with a selected well. The information may include a well label, well ID (e.g., API number), an alarms table, a pumps table, a rate table, and a volume table. The alarms table is shown to include several pressure alarms which apply to different pressures at the well (e.g., wellhead pressure, tubing pressure, casing pressure, bottomhole pressure, and pump pressure). The alarms table is shown to include a low pressure value, high pressure value, permit pressure value, and fracture gradient for each of the different pressures. Computing system 110 can be configured to compare the measured or predicted pressures at the wells to the corresponding values shown in the alarms table to determine whether to trigger an alarm. For example, computing system 110 may trigger a pressure alarm if a measured or predicted pressure value is below the low value provided in the alarms table or above the high value provided in the alarms table.

The pumps table is shown to include the pump activity of various pumps at the selected well including an amount of time the pumps are on and an amount of time the pumps are off. Computing system 110 can be configured to compare the actual pump status at the wells to the corresponding values shown in the pumps table to determine whether to trigger an alarm. For example, computing system 110 may trigger a pumps alarm if the pumps remain on for longer than the on time provided in the pumps table or remain off for longer than the off time provided in the pumps table. The rates table is shown to include low and high values for the flow rate of the fluid injected by the well or produced by the well (e.g., bbl/hour), whereas the volume table is shown to include high and permit values for the total volume injected by the well or produced from the well (e.g., bbl/day). Computing system 110 can be configured to compare the actual rates and volumes reported by the wells to the corresponding values shown in the rates table and volume table to determine whether to trigger an alarm. For example, computing system 110 may trigger a rate alarm if the actual injection or production rate of a well is lower than the low rate value or higher than the high rate value indicated in the rates table.

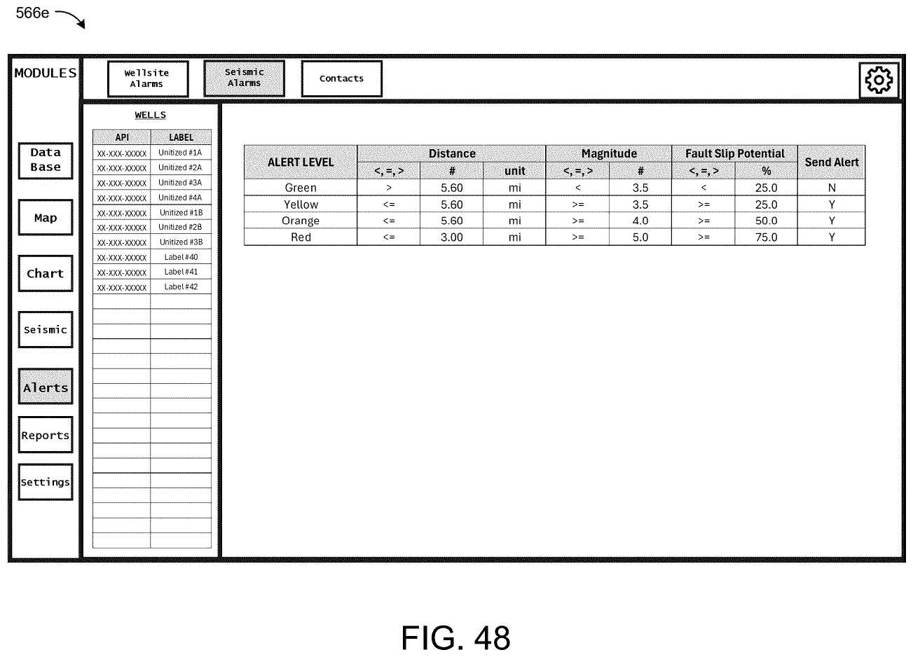

Referring now to FIG. 48, a second view of alerts user interface 566e is shown, according to an exemplary embodiment. In the view shown in FIG. 48, the seismic alarms button is selected in the top panel, which causes alerts user interface 566e to display alert information associated with seismic events. For example, alerts user interface 566e is shown to include an alert level table which allows a user to configure the various alerts which can be generated based on detected or predicted seismic events. The alert level table is shown to include several color-coded alert levels (e.g., green, yellow, orange, red) with corresponding trigger logic and threshold values for seismic event metrics.

Computing system 110 can be configured to compare the attributes of detected or predicted seismic events to the threshold values provided in the alert level table to determine whether to trigger an alert and the appropriate alert level. For example, if a seismic event is detected or predicted to occur at a distance of greater than 5.6 miles with a magnitude of less than 3.5 and a fault slip potential of less than 25%, computing system 110 may classify the seismic event as a green level alert and may not send an alert, based on the thresholds and logic provided in the alert level table. However, if a seismic event is detected or predicted to occur at a distance of less than or equal to 5.6 miles with a magnitude of greater than or equal to 3.5 and a fault slip potential of greater than or equal to 25%, computing system 110 may classify the seismic event as a yellow level alert and may send an alert, based on the thresholds and logic provided in the alert level table. Computing system 110 may perform similar logic based threshold comparisons to determine whether to send an orange level alert and/or red level alert using the information provided in the alert level table.

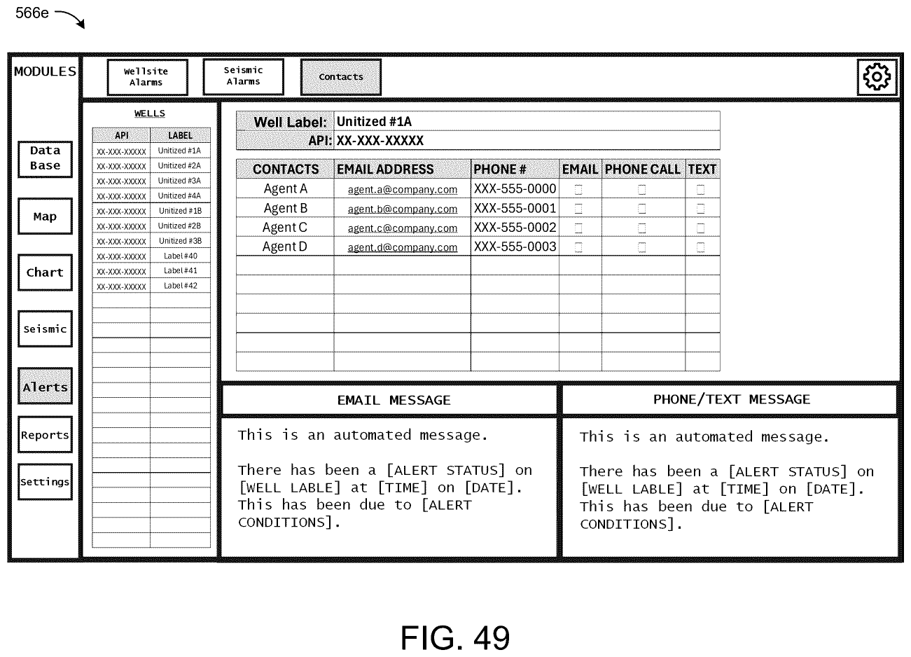

Referring now to FIG. 49, a third view of alerts user interface 566e is shown, according to an exemplary embodiment. In the view shown in FIG. 49, the contacts button is selected in the top panel, which causes alerts user interface 566e to display contact information for the alerts generated by computing system 110. The contact information is shown to include a list of contacts (e.g., agent A, agent B, etc.) along with their email addresses, phone numbers, and/or other contact information. Alerts user interface 566e may allow a user to customize which types of communications are sent to the contacts (e.g., email, phone, text, etc.) in response to various alarms or alerts being triggered. Alerts user interface 566e may also allow the user to provide a customized email message and phone/text message which is sent in response to the alarms or alerts being triggered. The message may specify the type or status of the alert (e.g., alert level), the well associated with the alert, the time/date the alert was triggered, and/or the conditions that caused the alert to be triggered.

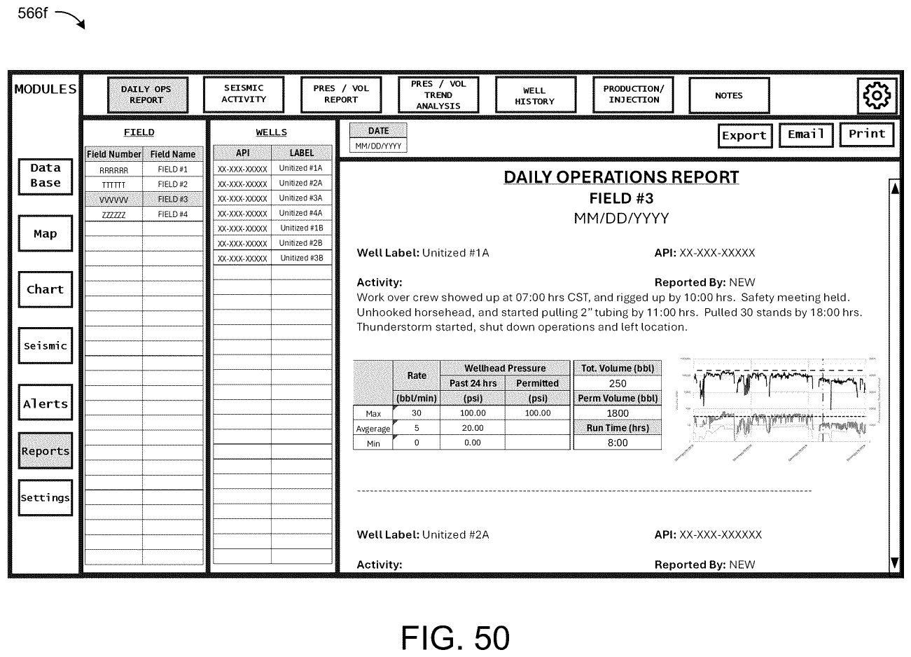

Referring now to FIG. 50, a first view of reports user interface 566f is shown, according to an exemplary embodiment. Reports user interface 566f may be displayed in response to selecting the reports button in the modules panel. The top panel of reports user interface 566f is shown to include several buttons including a daily operations report button, a seismic activity button, a pressure/volume report button, a well history button, a production/injection button, and a notes button. Reports user interface 566f is shown to include a fields panel and a wells panel, which may include a list of the different fields and the wells located with the fields, as described with reference to FIGS. 38-39.

In the view shown in FIG. 50, the daily operations report button is selected in the top panel, which causes reports user interface 566f to present a daily operations report. The daily operations report may pertain to a selected field or well and may include the date, field ID, well label, and well ID (e.g., API number) of the selected well. The daily operations report may include a description of activity or operations that occurred at the field or well during the day (e.g., times at which work started, ended, notable events, etc.). The daily operations report is shown to include a table indicating the maximum, average, and minimum values of several operating parameters that characterize the operations of wells at the field during the day. The operating parameters are shown to include rate (e.g., production rate or injection rate), wellhead pressure (e.g., in the past 24 hours and permitted), total volume injected or produced, permitted volume, and run time. In some embodiments, the daily operations report includes a chart or graph (e.g., any of charts 560) plotting the values of the operating parameters over the course of the day. Although the report shown in FIG. 50 is described as a daily operations report, it is contemplated that the report can be provided for other time periods (e.g., weekly, monthly, yearly, etc.) in addition to daily.

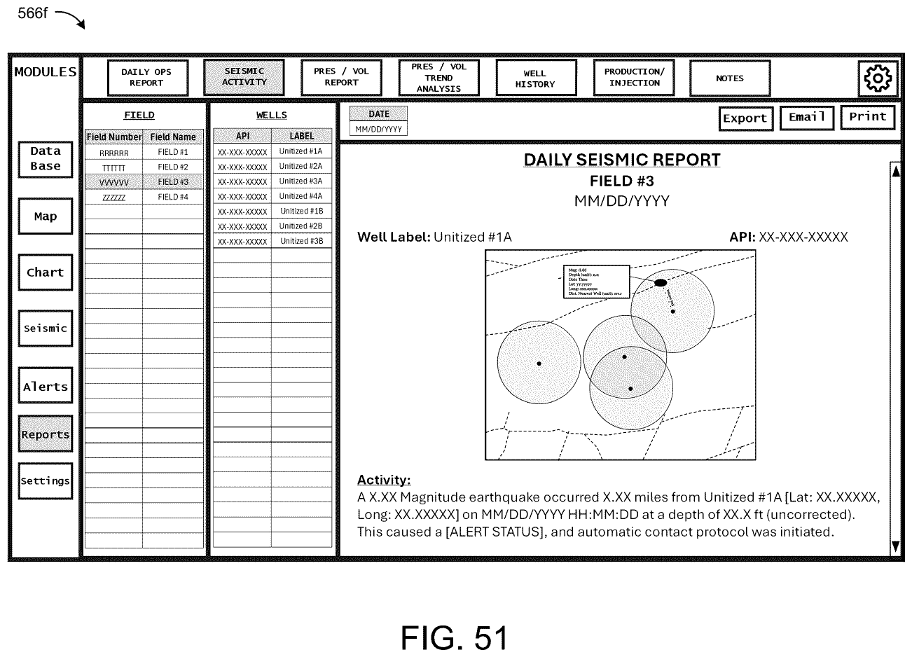

Referring now to FIG. 51, a second view of reports user interface 566f is shown, according to an exemplary embodiment. In the view shown in FIG. 51, the seismic activity button is selected in the top panel, which causes reports user interface 566f to present a seismic activity report. The seismic activity report is shown to include many of the same details as the daily operations report (e.g., field ID, date, well label, well ID, etc.) along with a description of seismic activity that occurred within the corresponding time period (i.e., daily in FIG. 51). The description may indicate the magnitude of the seismic event, the location of the seismic event, the distance of the seismic event from the nearest well, the date or time of the seismic event, any alerts generated in response to the seismic event, and/or any actions performed in response to the seismic event. The seismic activity report may include a map of an area of interest along with the location of the seismic event marked on the map, along with the locations of the wells and fault lines within the area of interest. Although the report is shown in FIG. 51 as a daily report, it is contemplated that the report can be provided for other time periods (e.g., weekly, monthly, yearly, etc.) in addition to daily.

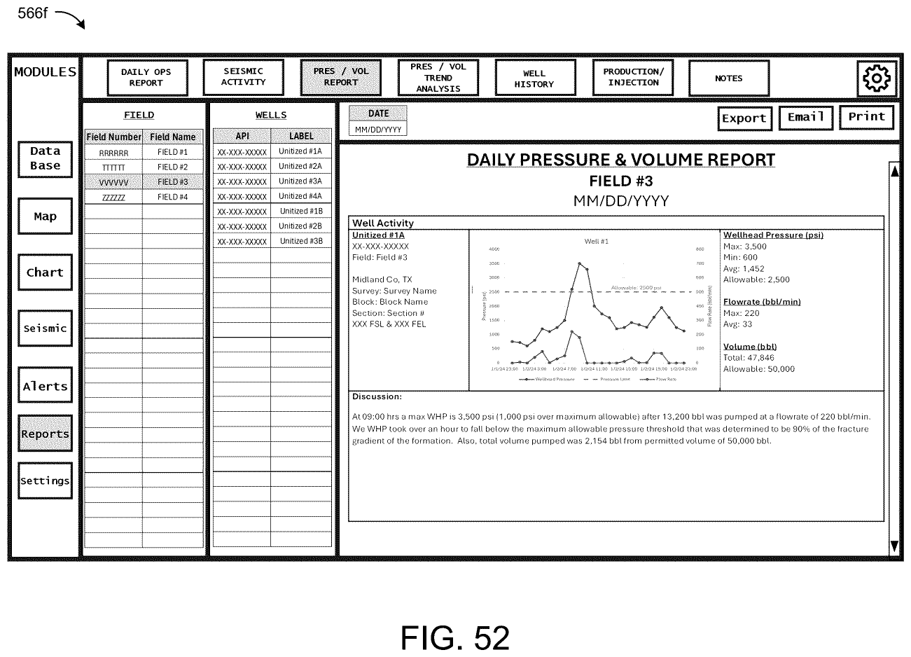

Referring now to FIG. 52, a third view of reports user interface 566f is shown, according to an exemplary embodiment. In the view shown in FIG. 52, the pressure/volume report button is selected in the top panel, which causes reports user interface 566f to present a pressure and volume report. The pressure and volume report is shown to include many of the same details as the daily operations report (e.g., field ID, date, well label, well ID, etc.) along with a description of activity that occurred at the selected field or well within the corresponding time period (i.e., daily in FIG. 52). The pressure and volume report may include a graph, plot, or data table indicating the pressures and volumes injected or produced by the well at various times throughout the time period. In some embodiments, the pressure and volume report indicates various measured or calculated pressures, flow rates, or volumes at the well or field (e.g., wellhead pressure, bottomhole pressure, production rate, injection rate, production volume, injection volume, etc.) along with their maximum, minimum, and average values during the time period. The pressure and volume report may further include the permitted or allowable values for each of the metrics shown in the report. Although the report is shown in FIG. 52 as a daily report, it is contemplated that the report can be provided for other time periods (e.g., weekly, monthly, yearly, etc.) in addition to daily.

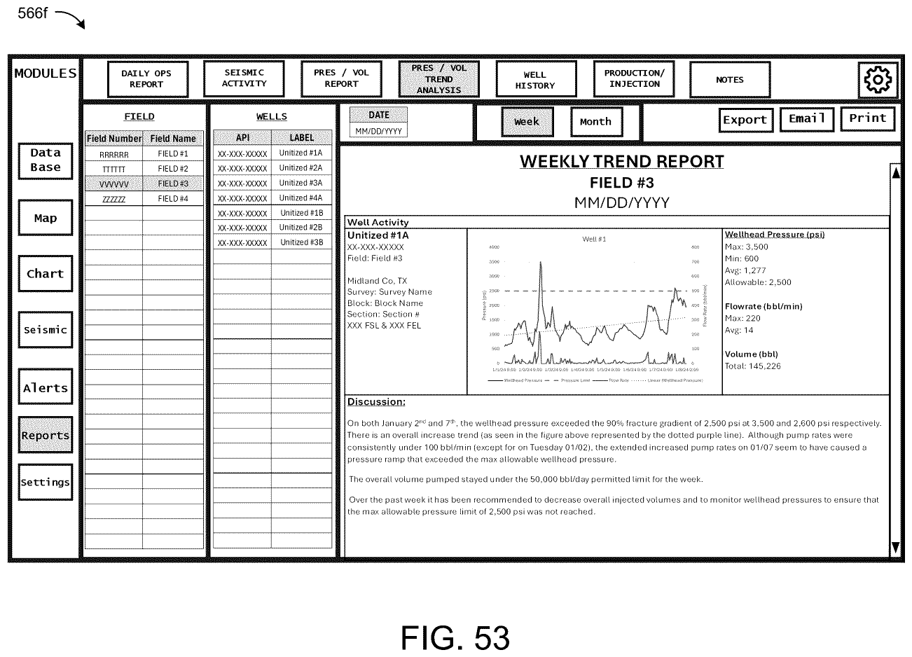

Referring now to FIG. 53, a fourth view of reports user interface 566f is shown, according to an exemplary embodiment. In the view shown in FIG. 53, the pressure/volume trend analysis button is selected in the top panel, which causes reports user interface 566f to present a trend report. The trend report is shown to include many of the same details as the daily operations report (e.g., field ID, date, well label, well ID, etc.) along with a description of activity that occurred at the selected field or well within the corresponding time period (i.e., weekly in FIG. 53). The trend report may include a graph, plot, or data table indicating the pressures and volumes injected or produced by the well at various times throughout the time period. In some embodiments, the trend report indicates various measured or calculated pressures, flow rates, or volumes at the well or field (e.g., wellhead pressure, bottomhole pressure, production rate, injection rate, production volume, injection volume, etc.) along with their maximum, minimum, and average values during the time period. The trend report may further include the permitted or allowable values for each of the metrics shown in the report. Although the report is shown in FIG. 53 as a weekly report, it is contemplated that the report can be provided for other time periods (e.g., daily, monthly, yearly, etc.) in addition to weekly.

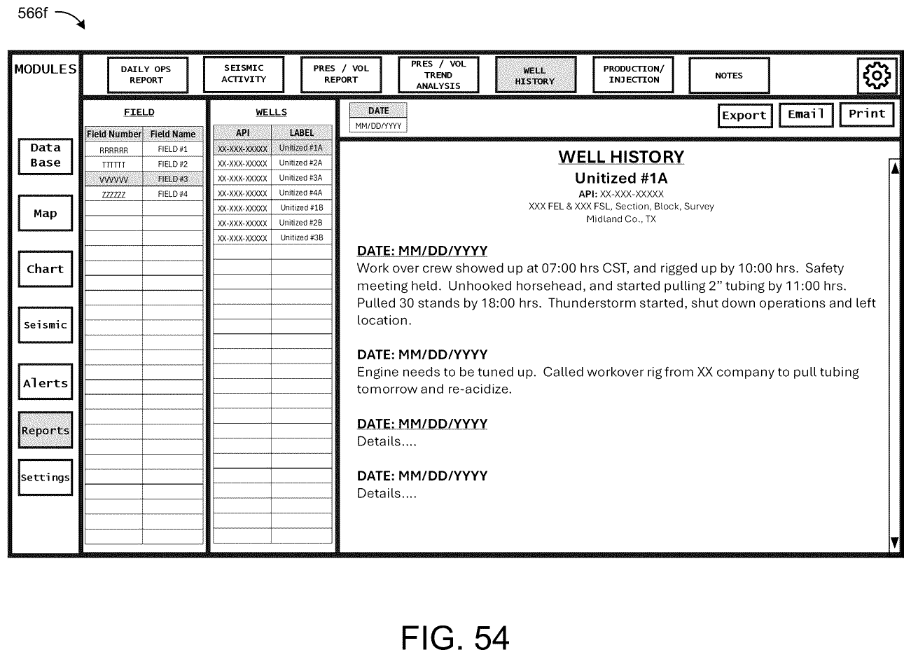

Referring now to FIG. 54, a fifth view of reports user interface 566f is shown, according to an exemplary embodiment. In the view shown in FIG. 54, the well history button is selected in the top panel, which causes reports user interface 566f to present a well history report. The well history report is shown to include many of the same details as the daily operations report (e.g., date, well label, well ID, etc.) along with a description of activity that occurred at the selected well within the corresponding time period (i.e., daily in FIG. 53). The well history report may include notes or other text characterizing well activity or operations during the time period. In some embodiments, the well history report includes multiple entries for different time periods (e.g., different days) to allow a user to see a complete history of the well via a single screen or interface.

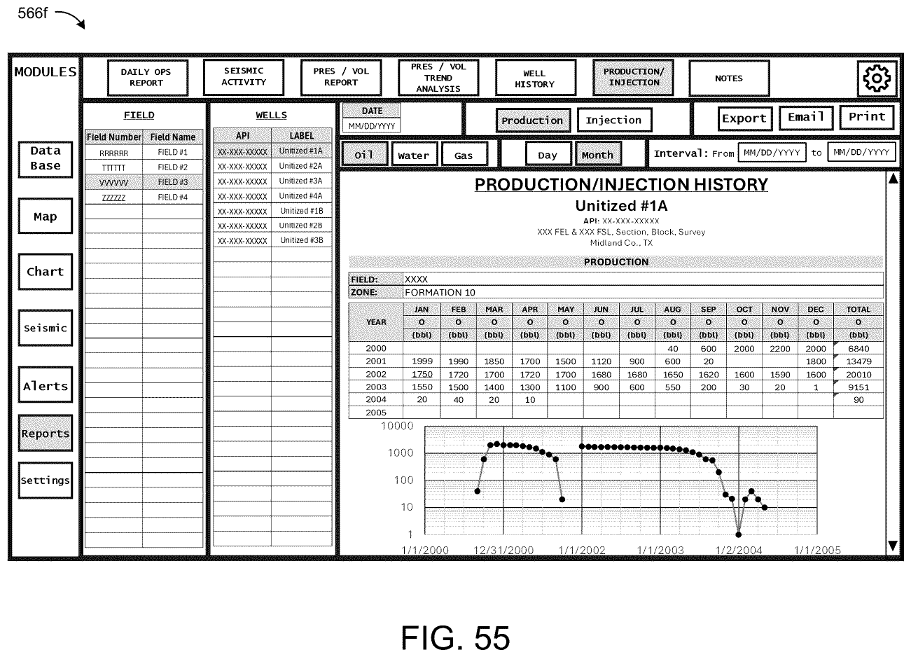

Referring now to FIG. 55, a sixth view of reports user interface 566f is shown, according to an exemplary embodiment. In the view shown in FIG. 55, the production/injection button is selected in the top panel, which causes reports user interface 566f to present a production/injection history report. The production/injection history report is shown to include many of the same details as the daily operations report (e.g., field ID, date, well label, well ID, etc.) along with data indicating the production or injection operations of the selected field or well over a given time period. For example, the production/injection history report is shown to include a production table indicating the amounts of fluid (e.g., bbl) produced by the well during each time period. In the example shown in FIG. 55, the production table shows aggregate monthly production amounts for each month within a selected time interval. In addition to presenting such information in the form of a table, the production/injection history report may include a graph (e.g., line graph, bar graph, etc.) presenting the information graphically.

The production/injection history report is shown to include various selectable buttons that allow a user to switch between different fluids (e.g., oil, water, gas, etc.), different aggregation intervals (e.g., daily, monthly, etc.), different time periods (e.g., by specifying a start time and an end time), and different modes of operation (e.g., production, injection, etc.). In response to selecting any of the selectable buttons, reports user interface 566f may modify or update the production/injection history report to present the production/injection data for the selected fluid type, aggregation interval, time period, and/or mode of operation. In some embodiments, two or more of the fluids can be selected concurrently such that the production/injection history report presents the data for multiple selected fluids in the same data table or graph. Similarly, two or more modes of the well can be selected concurrently such that the production/injection history report presents the data for multiple modes of operation in the same data table or graph.

Referring now to FIG. 56, a first view of an optimization user interface 566g is shown, according to an exemplary embodiment. Optimization user interface 566g may be configured to facilitate user interaction with AI model 534, wellsite optimizer 540, scenarios generator 536, recommendation generator 538, and other components of computing system 110. Optimization user interface 566g may allow a user to configure the optimization processes performed by computing system 110 and may present the results of the optimization processes (e.g., optimal well locations, optimal well operating parameters, etc.). Advantageously, optimization user interface 566g may provide the user with detailed information on how to optimize the injection well locations and operations to minimize the risk, damage, or impact of induced seismic events.

Optimization user interface 566g may include any of the components or functionality of any other user interface 566 described throughout the present disclosure. For example, optimization user interface 566g is shown to include a sliders panel including a time slider and a scenarios slider, which may be the same as described with reference to FIG. 36. However, in the context of optimization user interface 566g, the time slider can be used to set the time range over which the optimization is performed (e.g., from the current time to a selected time in the future). The scenarios slider may function the same as described with reference to FIG. 36, allowing a user to select between different scenarios for other wells in the geographic region (e.g., assuming the wells operate at minimum capacity, operate at maximum capacity, etc.). In the context of optimization user interface 566g, the scenarios slider may configure the optimization processes performed by computing system 110 to account for the injection/production activities of other wells outside the control of the particular user or customer to which optimization user interface 566g is presented. Advantageously, this feature allows computing system 110 to account for the activities of other users or wells, even if such activities cannot be controlled by computing system 110 or the user to which optimization user interface 566g is presented, when generating the optimal well locations and operating parameters for the wells that can be controlled by computing system 110 and/or the user to which optimization user interface 566g is presented.

Optimization user interface 566g is shown to include a proposed parameters table. The proposed parameters table may allow a user to enter proposed well locations and/or operating parameters for a well or set of wells to be added or operated within the area of interest. For example, the proposed parameters table is shown to include a row for each well and columns that indicate the proposed parameters of each well. The proposed parameters are shown to include location (e.g., latitude and longitude), perforated interval (e.g., top and bottom), maximum pressure (e.g., psi), maximum volume (e.g., injection volume, production volume, etc.), and maximum rate (e.g., injection rate, production rate, etc.). In some embodiments, the proposed parameters include one or more constraints on the well's operation such as minimum required production or injection volume, minimum required production or injection rate, geographic area constraints (e.g., bounded by area, contained within lease, etc.).

Optimization user interface 566g is shown to include a constraints panel including buttons for aerial constraints, lease constraints, and drawn constraints. Aerial constraints may be constraints imposed on the optimization processes performed by computing system 110 based on aerial imagery, LiDAR, satellite imagery, drone imagery, or any other aerospace data sources 514. In some embodiments, aerial constraints are based on geographical data sources 504 or geological data sources 506. For example, aerial constraints may indicate that a new well cannot be located within certain areas that are already occupied by existing buildings or geological formations that would make a new well at that location commercially or practically infeasible. Lease constraints may indicate the area of a lease that defines the perimeter or boundary within which new wells can be constructed. For example, the dot-dash line in map 590 represents the boundary defined by a lease, which may be based on one or more land leases imported from data sources 502. Drawn constraints may be similar to lease constraints, but based on a user-defined (e.g., drawn) boundary rather than imported from data sources 502. For example, a user can click to draw a boundary within map 590 to define the area within which new wells must be located. The user can select or deselect any of the aerial constraints, lease constraints, or drawn constraints buttons in optimization user interface 566g to toggle on/off the corresponding type of constraints.

Optimization user interface 566g is shown to include a well locations panel. The well locations panel may allow a user to define the proposed well locations using an alternative method than entering the locations into the proposed parameters table. For example, the user can select the “place” button within the well locations panel and then drag and drop proposed well location icons 586 onto map 590 to define the proposed well locations. The user can select the “adjust” button in the well locations panel to adjust the proposed well locations after they have been initially placed, either via the well locations panel or by entering the locations into the proposed parameters table. The well locations panel may also allow the user to toggle on/off the optimized well locations and/or the alternate well locations. For example, in response to selecting the optimized injection well location button in the well locations panel, optimization user interface 566g may display the optimal well location icons 588 in map 590. Similarly, in response to selecting the alternate injection well location button in the well locations panel, optimization user interface 566g may display the alternate well location icons 589 in map 590.

In some embodiments, selecting or deselecting any of the proposed injection well location button, the optimized injection well location button, or the alternate injection well location button in the well locations panel may cause computing system 110 to include or exclude the corresponding wells from the optimization processes performed by computing system 110. For example, selecting the proposed injection well location button may cause computing system 110 to treat the proposed injection well locations as constraints (i.e., the injection wells are fixed at the proposed locations) and optimize only the operating parameters for the injection wells as decision variables in the optimization process. Conversely, deselecting the proposed injection well location button and/or selecting the optimized injection well location button may cause computing system 110 to treat the injection well locations as free variables which can be optimized when performing the optimization process. Selecting the alternate injection well locations button may cause computing system 110 to generate both the optimal well locations and an alternative set of well locations which are suboptimal but sufficiently close to optimal in terms of minimizing seismic risk, damage, etc.

Optimization user interface 566g is shown to include an optimized parameters panel. The optimized parameters table may be similar to the proposed parameters table, with the exception that the parameters in the optimized parameters table are generated by computing system 110 (e.g., by wellsite optimizer 540) rather than entered by a user. The optimized parameters table is shown to include a row for each well and columns that indicate the optimized parameters of each well. The optimized parameters are shown to include location (e.g., latitude and longitude), perforated interval (e.g., top and bottom), maximum pressure (e.g., psi), maximum volume (e.g., injection volume, production volume, etc.), and maximum rate (e.g., injection rate, production rate, etc.). In some embodiments, the optimized parameters table includes rows for each optimal well location and each alternative well location, depending on the user selections made in the well locations panel. For example, as shown in FIG. 56, the optimized parameters panel includes parameters for the two optimal well locations (i.e., row #1 and row #2) as well as the two alternative well locations (i.e., row #A1 and row #A2).

Optimization user interface 566g is shown to include a map 590 and a map selection panel. Map 590 may include markers for injection well locations, known fault locations, leaking well locations, other well locations, a perimeter defined by a lease, and shaded regions indicating activation potentials at various locations. The map selection panel is shown to include buttons for activation potential, ground deformation, pressure, and well leaks. In the view shown in FIG. 56, the activation potential button is selected, which causes map 590 to display activation potential information. Selecting other buttons in the map selection panel may cause map 590 to display other types of information. For example, selecting the ground deformation button may cause map 590 to display ground deformation information, as shown in FIG. 22. Similarly, selecting the pressure button may cause map 590 to display pressure information, as shown in FIG. 19.

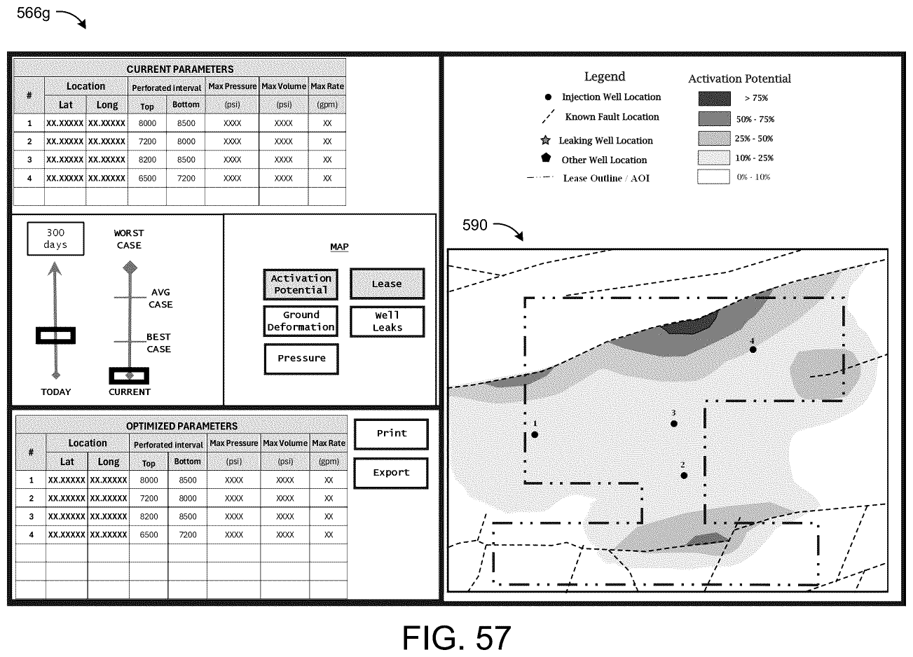

Referring now to FIG. 57, a second view of optimization user interface 566g is shown, according to an exemplary embodiment. Optimization user interface 566g is shown to include many of the same components described with reference to FIG. 56. However, the view shown in FIG. 57 corresponds to an embodiment in which the well locations are predetermined (e.g., if the wells already exist or cannot be installed at different locations). In this embodiment, the well locations are treated as fixed or constrained variables in the optimization process performed by computing system 110 and only the other parameters of the wells are optimized (e.g., pressures, volumes, rates, etc.) by wellsite optimizer 540. Accordingly, optimization user interface 566g does not include the well locations panel or functionality for changing or optimizing the well locations in the view shown in FIG. 57. The circles labeled I-4 in map 590 represent the well locations. The other components of optimization user interface 566g may be the same as described with reference to FIG. 56.

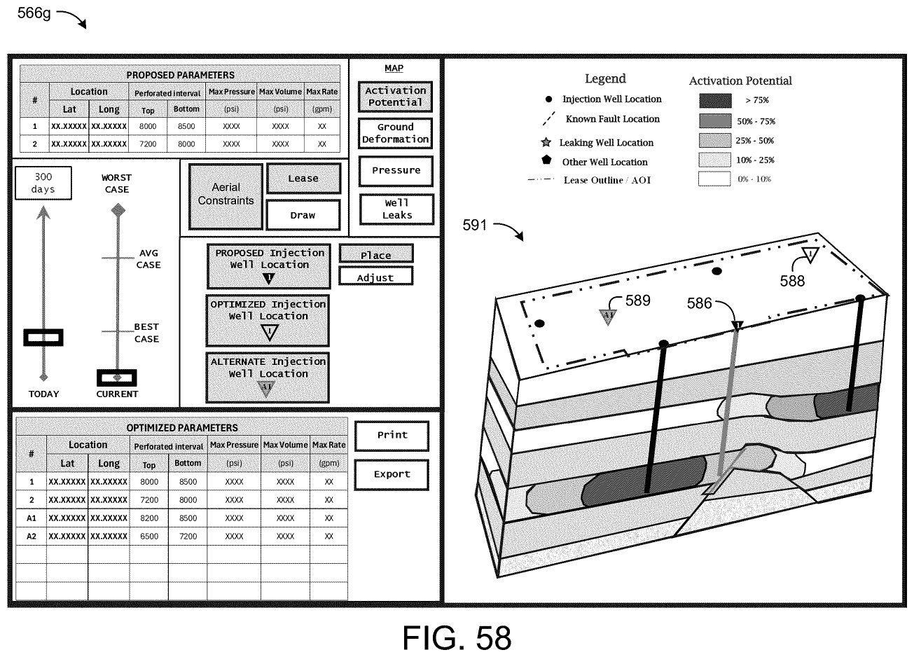

Referring now to FIG. 58, a third view of optimization user interface 566g is shown, according to an exemplary embodiment. The view of optimization user interface 566g shown in FIG. 58 includes many of the same features and components as described with reference to FIG. 56. However, the 2D map 590 has been replaced with a 3D map 591. 3D map 591 is shown to include a section of the earth showing various layers and formations, as well as the activation potential within each formation. Alternatively, 3D map 591 may show the pressure levels and/or flows within each formation. For example, the different colored or shaded regions within 3D map 591 may correspond to different activation potentials, pressure levels, or flows within the formations or reservoirs as indicated by the legend above 3D map 591. In some embodiments, a user can select (e.g., click, hover over, etc.) the formations or regions within 3D map 591 to view the activation potentials, pressure levels, or flow levels associated with each region. 3D map 591 also indicates the injection well locations, known fault locations, leaking well locations, and other well locations (if any) using the corresponding markings or icons indicated in the legend panel. A user can interact with computing system 110 via optimization user interface 566g to optimize the well locations and other parameters of the wells in the same manner as described with reference to FIG. 56.

Advantageously, the user can interact with computing system 110 via optimization user interface 566g to plan new well locations. The user can enter proposed or preferred well locations in the proposed parameters table along with expected volumes and pressures. AI model 534 can evaluate the user's proposed well location and determine optimal operating parameters for wellsite equipment 546 for that particular user-specified location, as described with reference to FIG. 5. In some embodiments, AI model 534 also suggests other well locations within a set boundary that would maximize injection at minimal risk. The boundary location may be set by the user or based on current operations, lease areas, or preferences.

### Example Processes

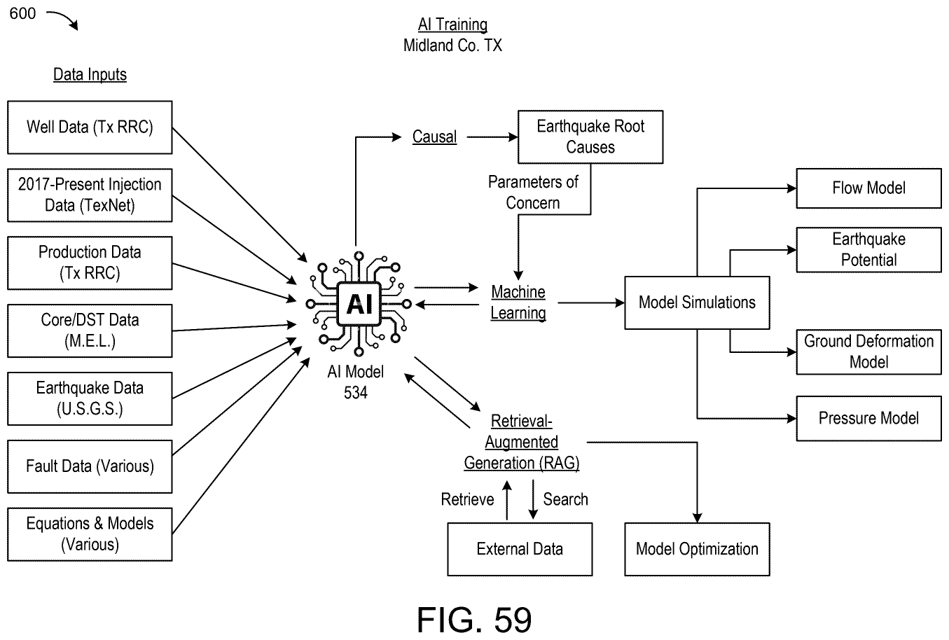

Referring now to FIGS. 59-66, flowcharts of several processes 600-614 which can be performed by computing system 110 are shown, according to some embodiments. Referring particularly to FIG. 59, process 600 illustrates various techniques for training and using AI model 534 which can be performed by model trainer 530 and/or other components of computing system 110. Process 600 is shown to include receiving data inputs including well data, historical injection data, historical production data, core/DST data, earthquake data, fault data, and equations and models. These data inputs can be received from data sources 502 as described with reference to FIGS. 5-12 and provided as inputs to AI model 534 during model training and/or model operation.

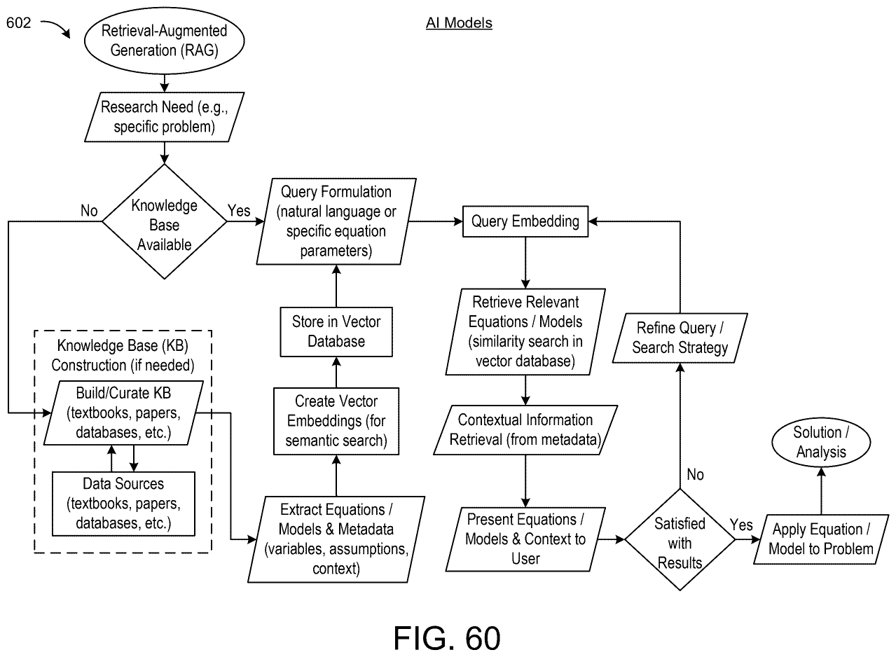

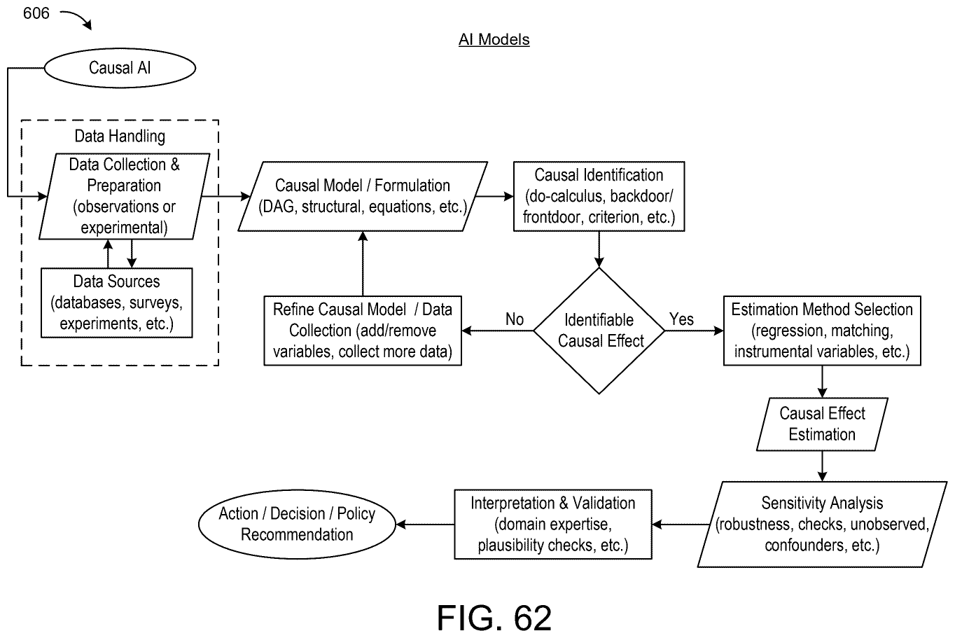

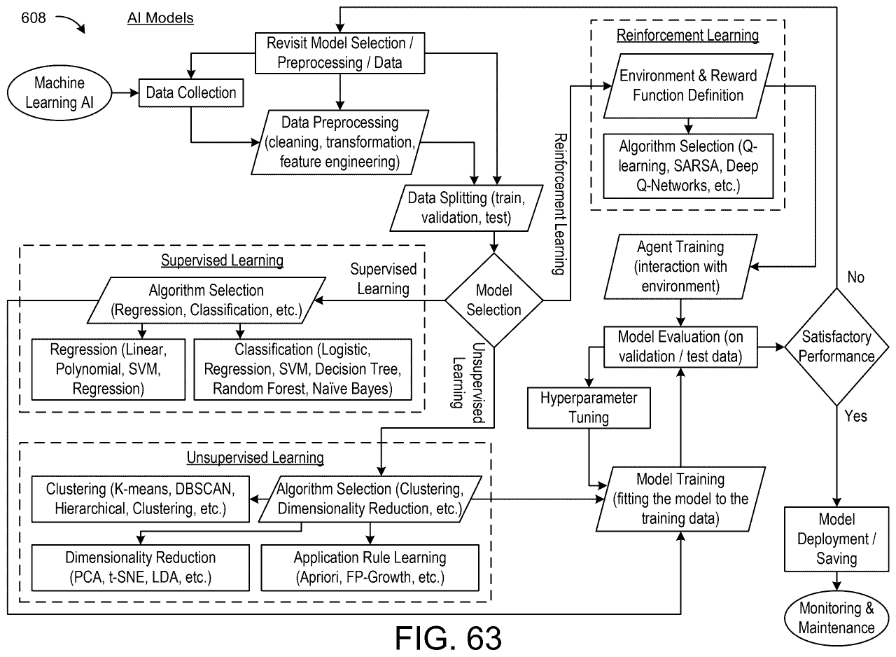

Process 600 is shown to include using retrieval-augmented generation (RAG), machine learning, and causal AI techniques in combination with AI model 534. RAG may include searching external data sources for relevant and retrieving such data from the external data sources when training or using AI model 534. RAG may further include model optimization and is described in greater detail with reference to FIG. 60. Machine learning may include using AI model 534 to perform various model simulations including simulations of fluid flow, earthquake potential, ground deformation, and pressure, and are described in greater detail with reference to FIG. 63. Causal AI may include deriving causal relationships to determine earthquake root causes and providing parameters of concern for use in machine learning, as described in greater detail with reference to FIG. 62.

Referring now to FIG. 60, a flowchart of a process 602 for using RAG techniques when training and using AI model 534 is shown, according to an exemplary embodiment. Process 602 can be used by computing system 110 for researching equations and models in geology and engineering. In some embodiments, process 602 includes knowledge base construction and semantic searching using vector embeddings, and may incorporate a feedback loop for query refinement. Process 602 begins with researching a need such as a specific research question or problem in geology or engineering that requires the use of equations or models. Process 602 may include checking whether a relevant knowledge base of equations and models already exists. If the knowledge base of equations and models does not already exist, process 602 may create the knowledge base by identifying and collecting relevant data from textbooks, research papers, databases, etc.; extracting the equations and models from the data sources, along with metadata such as variables, assumptions, limitations, and context; generating vector embeddings for the equations, models, and metadata to enable semantic search; and storing the embeddings in a vector database for efficient retrieval. However, if the knowledge base of equations and models already exists, process 602 may proceed directly to query formulation.

Process 602 may include formulating a query, either in natural language describing the problem or by specifying parameters relevant to a particular equation or model. In various embodiments, query formulation can be performed by a user or by a component of computing system 110. The query can then be converted into a vector embedding. Process 602 may include performing a similarity search in the vector database to find the equations and models whose embeddings are closest to the query embedding. In the step of contextual information retrieval, process 602 may retrieve the associated metadata (e.g., context, assumptions, etc.) for the retrieved equations and models. Process 602 may include presenting the retrieved equations, models, and their contextual information are presented to the user. If the user is not satisfied with the results, the user can refine the query or adjust the search strategy and return to the query embedding step. However, if the results are satisfactory, the user can apply the retrieved equation or model to their specific problem. The application of the equation or model leads to a solution or analysis of the problem.

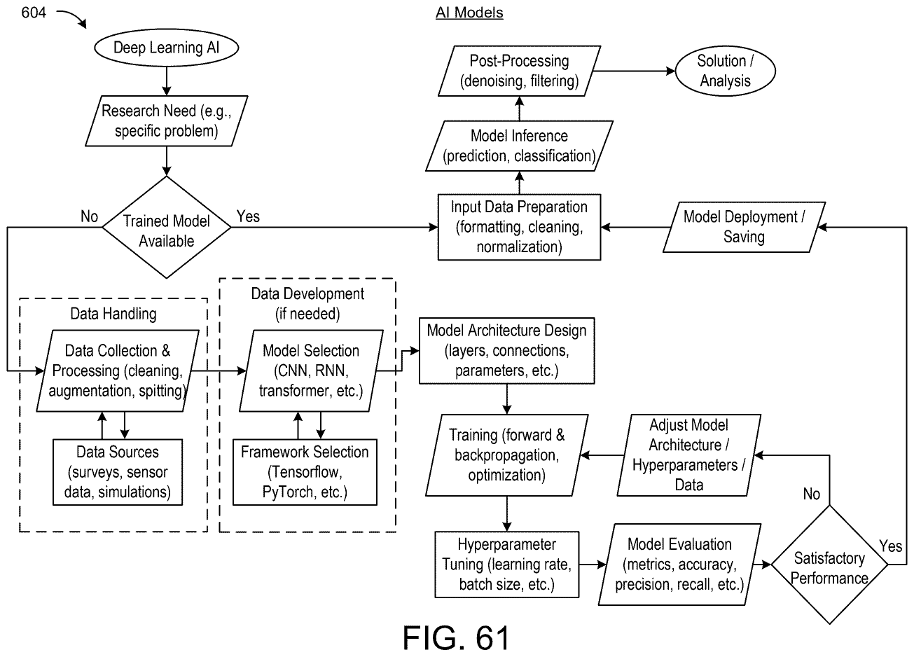

Referring now to FIG. 61, a flowchart of a process 604 for using deep learning AI techniques when training and using AI model 534 is shown, according to an exemplary embodiment. Process 604 provides an overview of a deep learning workflow which can be used when developing and deploying AI model 534 as a deep learning model for geological and engineering applications. In some embodiments, process 604 may be similar to process 602 shown in FIG. 60 with the following exceptions. Process 604 may be implemented as an iterative process of model training, hyperparameter tuning, and evaluation. Process 604 may also include more significant data preprocessing relative to process 602. It is contemplated that the choice and design of the model architecture are central to deep learning. Additionally, the deep learning models in process 604 may learn representations directly from the data and may not require a separate knowledge base or context retrieval mechanism such as RAG.

Process 604 begins with identifying a specific problem in geology or engineering that can be addressed using deep learning. Process 604 may include checking whether a suitable pre-trained model already exists. If such a model exists, process 604 can save significant time and resources by skipping directly to input data preparation. However, if a suitable pre-trained model does not already exist, process 604 may include data collection and preprocessing (e.g., cleaning, augmentation, splitting, etc.) to gather the data needed to train the model. The data collection and preprocessing may include identifying and collecting relevant data from various sources like geological surveys, sensor data, and simulations. Process 604 may include preprocessing the collected data by cleaning, transforming, augmenting, and splitting the data into training, validation, and testing sets.

Process 604 may include choosing an appropriate deep learning model architecture based on the nature of the data and the problem (e.g., convolutional neural networks (CNNs) for image analysis, recurrent neural networks (RNNs) for time series data, transformers for sequence-to-sequence tasks, etc.), as would be apparent to those skilled in the art of machine learning models and their various advantages and disadvantages. Process 604 may include defining the specific structure of the chosen model, including the number of layers, types of connections between layers, and the number of parameters and training the model using the training data and an optimization algorithm (e.g., stochastic gradient descent). In some embodiments, training the model includes forward and backpropagation to adjust the model's weights and biases. Process 604 may include adjusting hyperparameters (e.g., learning rate, batch size, and regularization parameters) to optimize model performance and evaluating the trained model's performance on the validation and test datasets using appropriate metrics (e.g., accuracy, precision, recall, F1-score, mean squared error, etc.).

Process 604 may include checking if the model's performance is satisfactory (e.g., meets predetermined criteria). If the model's performance is not satisfactory, process 604 may iteratively adjust the model's architecture, hyperparameters, or other data by repeating the corresponding steps of process 604 until satisfactory performance is achieved. Once satisfactory performance is achieved, process 604 may save the trained model for later use. Process 604 may then proceed to input data preparation to prepare the input data in the format expected by the model (e.g., formatting, cleaning, and normalization). Process 604 may include using the trained model to make predictions or classifications on new input data and applying any necessary post-processing steps to the model's output (e.g., denoising or filtering). The final output of the model provides a solution or analysis to the original research problem.

Referring now to FIG. 62, a flowchart of process 606 for using causal AI techniques when training and using AI model 534 is shown, according to an exemplary embodiment. Process 606 provides an overview of a causal AI workflow which can be used when training and using AI model 534 as a causal AI model. Process 606 can be used to configure AI model 534 to identify causal relationships and derive valid causal inferences based on the data from data sources 502. Advantageously, process 606 can be used to configure AI model 534 for causal modeling, identification, and sensitivity analysis to ensure reliable causal estimates.

In some embodiments, process 606 is similar to processes 602 and 604 with the following exceptions. In process 606, the central focus is on establishing cause-and-effect relationships rather than prediction or information retrieval. process 606 may focus on causal model formulation and identification, which are unique to causal ai, and may emphasize confounding and sensitivity analysis to assess the robustness of causal estimates. Additionally, process 606 may not require a training/inference loop (e.g., the loop used by the deep learning AI embodiment of FIG. 61) or retrieving information from a large knowledge base (e.g., such as the knowledge base used by the RAG embodiment of FIG. 60).

Process 606 may begin with a specific research question or problem that requires understanding cause-and-effect relationships. Advantageously, causal AI can be to identify specific causal relationships between variables or events, and thus can answer “why” questions (e.g., why an induced seismic event occurs). Process 606 may include collecting and preparing relevant data by gathering data from various sources (e.g., databases, surveys, or experiments) and cleaning, transforming, and preparing the data for analysis. The data handling step in process 606 may consider the nature of the data, such as whether the data are observational (e.g., gathered by passive observation) or experimental (e.g., obtained as a result of an active intervention), as this distinction may be useful for making causal inferences.

Process 606 may include constructing a causal model that represents the hypothesized relationships between variables. Causal model formation may include generating directed acyclic graphs (DAGs) including representations of causal relationships with directional links that indicate the direction of causality. In some embodiments, causal model formation includes obtaining structural equations such as mathematical equations that define the relationships between variables. Process 606 may include causal identification by determining whether the causal effect of interest can be identified from the available data and the formulated causal model. Causal identification may include using techniques such as do-calculus (i.e., mathematical framework for reasoning about interventions), backdoor criterion (i.e., a graphical criterion for identifying confounding variables that need to be controlled for), and/or frontdoor criterion (i.e., another graphical criterion used when backdoor paths are blocked).

Process 606 is shown to include checking whether the causal effect is identifiable. This step is characteristic of causal analysis because, without proper identification, any estimated effect might be biased due to confounding. If the causal effect is not identifiable, process 606 may refine the causal model by adding or removing variables or collect more data to address identification challenges (e.g., by iterative refinement of the DAG). If the causal effect is identifiable, process 606 may proceed to selecting an estimation method. For example, process 606 may choose an appropriate estimation method based on the identified causal effect and the nature of the data. Examples of suitable estimation methods include regression (e.g., adjusting for confounders in a regression model), matching (e.g., creating comparable groups based on observed characteristics), and instrumental variables (e.g., using an instrumental variable to estimate the causal effect in the presence of unobserved confounding). Process 606 may then estimate the causal effect using the chosen method.

Process 606 is shown to include performing sensitivity analysis to assess the robustness of the estimated causal effect to unobserved confounding or other assumptions. Sensitivity analysis is another step characteristic of causal modeling because it acknowledges the limitations of relying solely on observed data. Process 606 may include interpreting the estimated causal effect in the context of the research question and validating the findings using domain expertise and plausibility checks. This step ensures that the statistical results make sense in the real world. Process 606 may then make recommendations for actions, decisions, or policies based on the validated causal effect.

Referring now to FIG. 63, a flowchart of process 608 for using machine learning AI techniques when training and using AI model 534 is shown, according to an exemplary embodiment. Process 608 provides an overview of a machine learning workflow which can be used to train and execute AI model 534 using supervised, unsupervised, and/or reinforcement learning. Process 608 highlights the iterative nature of training a machine learning AI and the importance of data preprocessing, model selection, evaluation, and hyperparameter tuning. Process 608 also includes the steps of deployment and maintenance.

Process 608 may begin by defining the problem to be solved and the specific goals to be achieved with machine learning. Process 608 may gather relevant data from various sources and preprocess the data to prepare the data for training. Data preparation may include cleaning (e.g., handling missing values, outliers, and inconsistencies), transformation (e.g., converting data into a suitable format by scaling, normalization, and/or encoding categorical variables), and/or feature engineering (e.g., creating new features from existing features to improve model performance). Process 608 may include splitting the data into training, validation, and testing sets. The training set can be used to train the model, the validation set can be used to tune hyperparameters, and the test set can be used to evaluate the final model's performance.

In some embodiments, process 608 includes selecting the appropriate type of machine learning model based on the problem. Examples of types of machine learning models which can be selected include supervised learning models (e.g., when the data is prelabeled with input-output pairs), unsupervised learning (e.g., when the data is not labeled and the goal is to discover patterns or structures), and reinforcement learning (e.g., when an agent learns to interact with an environment to maximize a reward). Process 608 may then proceed to algorithm selection to select a suitable algorithm for the selected type of machine learning model. For supervised learning models, the selected algorithm may include linear regression, logistic regression, support vector machines, decision trees, random forests, etc., depending on the type of problem (e.g., regression or classification) and the characteristics of the data. For unsupervised learning models, the selected algorithm may include k-means, DBSCAN, PCA, t-SNE, etc., depending on the specific task (e.g., clustering, dimensionality reduction, etc.). For reinforcement learning models, the selected algorithm may include Q-learning, SARSA, Deep Q-Networks, etc., depending on the environment and the desired learning strategy.

Process 608 is shown to include training and agent training. Model training can be used for supervised and unsupervised learning models to fit the chosen model to the training data. Agent training can be used for reinforcement learning models to train an agent by allowing it to interact with the environment and learn from rewards. Process 608 may include model evaluation to evaluate the trained model's performance on the validation or test data using appropriate metrics and adjusting the model's hyperparameters to optimize its performance. If the model's performance is not satisfactory, process 608 may repeat earlier steps such as model selection, data preprocessing, and/or data collection until satisfactory performance is achieved. Once satisfactory performance is achieved, process 608 may deploy the model for real-world use or save the model for later use. In some embodiments, process 608 includes continuously monitoring the model's performance in the real world and retraining or updating the model as needed.

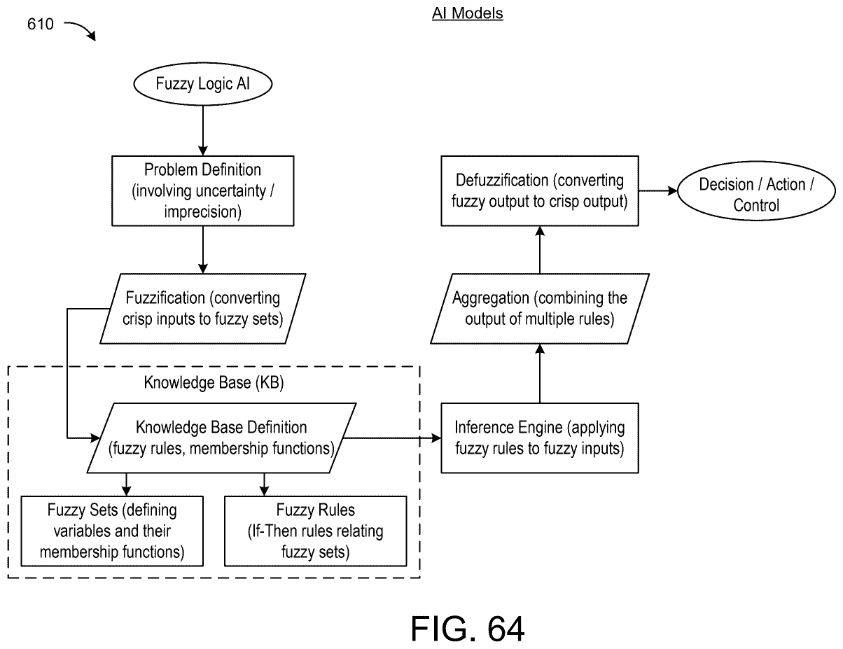

Referring now to FIG. 64, a flowchart of process 610 for using fuzzy logic AI techniques when training and using AI model 534 is shown, according to an exemplary embodiment. Process 610 provides an overview of a process which can be used to train and execute AI model 534 using fuzzy logic process, highlighting the steps involved in designing and using a fuzzy logic system. Process 610 includes unique aspects of fuzzy logic, such as fuzzification, defuzzification, and the use of fuzzy rules and membership functions.

Unlike the previous AI processes 604-608, process 610 may focus on fuzzy sets and rules. The core of fuzzy logic is the use of fuzzy sets and IF-THEN rules to represent and reason with imprecise information. Process 610 may also include the unique steps of fuzzification and defuzzification to convert between crisp and fuzzy values. Additionally, unlike machine learning (including deep learning), fuzzy logic systems are typically designed by experts and do not require a training phase. For example, the rules and membership functions can be defined based on expert knowledge or domain understanding. Fuzzy logic systems are often more interpretable than other AI approaches, as the rules and membership functions can be easily understood by humans.

Process 610 begins by defining the problem to be solved using fuzzy logic and may involve uncertainty or imprecision. Fuzzy logic is particularly well-suited for problems where information is imprecise, vague, or uncertain. Examples include controlling a washing machine using relative water levels (e.g., water level “high,” “medium,” “low”), adjusting room temperature based on imprecise temperature levels (e.g., “too hot,” “comfortable,” “too cold”), or medical diagnosis based on vague symptoms (e.g., “slightly elevated temperature,” “high blood pressure”). Process 610 is shown to include fuzzification which may include converting crisp (i.e., precise) inputs to fuzzy sets. Fuzzification may include defining membership functions that map crisp values to degrees of membership in fuzzy sets. For example, a crisp temperature of 25° C. might have a membership of 0.8 in the fuzzy set “warm” and 0.2 in the fuzzy set “comfortable.”

Process 610 is shown to include defining a knowledge base of the fuzzy system with fuzzy rules and membership functions. Defining the knowledge base may include defining linguistic variables of the fuzzy sets (e.g., “temperature,” “pressure,” “speed”) and their associated fuzzy sets (e.g., “cold,” “warm,” “hot;” “low,” “medium,” “high”). Membership functions can be defined for each fuzzy set, specifying the degree to which a crisp value belongs to the set. Defining the knowledge base may further include defining IF-THEN rules that relate fuzzy sets. These rules capture the expert knowledge or control logic. Examples of IF-THEN rules include: (i) IF temperature is “hot” THEN fan speed is “high,” (ii) IF temperature is “warm” AND humidity is “high” THEN fan speed is “medium,” and (iii) IF temperature is “cold” THEN heater is “on.”

Process 610 may include applying fuzzy rules to fuzzy inputs using an inference engine. This step may include matching (e.g., determining the degree to which the antecedent (IF part) of each rule is satisfied by the fuzzy inputs) and implication (e.g., determining the output of each rule based on the matching degree). Examples of implication methods include Mamdani (min/max) and Takagi-Sugeno. Process 610 may include aggregation by combining the outputs of multiple rules into a single fuzzy output. Examples of aggregation methods include max, sum, and probabilistic OR. Process 610 may include defuzzification by converting convert the aggregated fuzzy output back into a crisp (i.e., precise) output value. Examples of defuzzification methods include centroid, weighted average, and maximum. Process 610 may then use the crisp output value to make a decision, take an action, or control a system. For example, the defuzzified fan speed value might be used to set the actual speed of a fan.

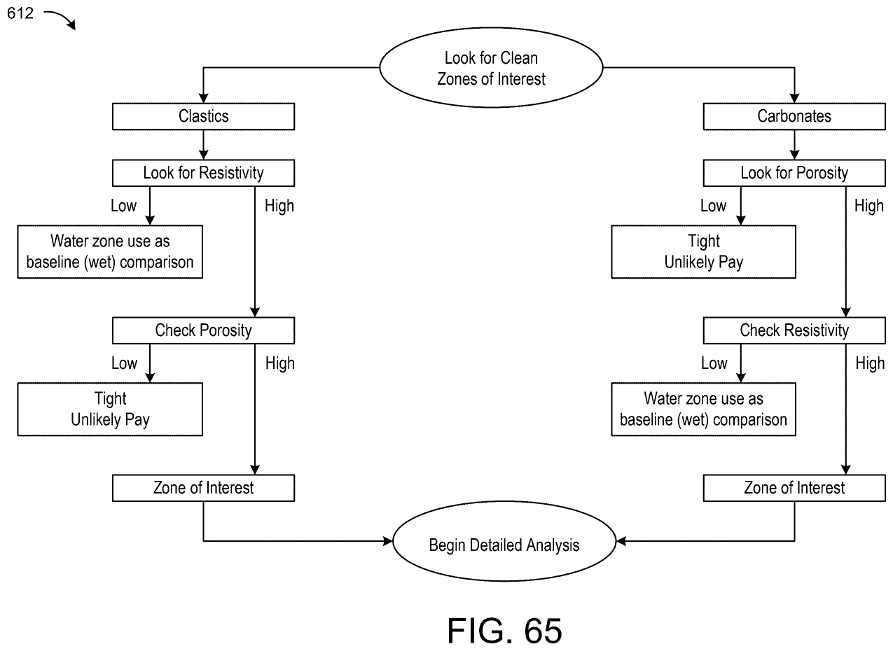

Referring now to FIG. 65, a flowchart of process 612 for scanning logs to identify zones of interest is shown, according to an exemplary embodiment. Process 612 can be performed by computing system 110 to analyze any of the logs described throughout the present disclosure (e.g., well logs, wireline logs, measurements while drilling (MWD) logs, logging while drilling (LWD) logs, resistivity logs, porosity logs, etc.). Process 612 may begin with looking for clean zones of interest. Zones that appear to be shales might be radioactive productive zones and can be avoided when looking for a clean zone.

Process 612 is shown to include two main branches including a Elastics branch and a carbonates branch. Clastics (i.e., clastic rocks) are sedimentary rocks made from fragments of pre-existing rocks and minerals. The resistivity log is the primary reconnaissance measurement for clastics because clastics tend to consist of reservoirs surrounded by shales whose resistivities vary gradually with depth. Differences in the fluid content of the reservoirs tend to produce reservoir resistivities that stand out against the relatively constant resistivity of the surrounding shales. The clastics branch of process 612 may include looking for resistivity. A low resistivity may indicate a water zone which can be used as a baseline (wet) comparison. Shaley zones might produce oil or gas even if they have low resistivity. If the resistivity is high, process 612 may check the porosity. A low porosity may indicate a tight formation and can be excluded as a zone of interest, whereas a high porosity may indicate a zone of interest.

Carbonates (i.e., carbonate rocks) are a type of sedimentary rock primarily composed of carbonate minerals such as calcium carbonate (calcite) and dolomite (calcium magnesium carbonate), with the most common examples being limestone (mainly calcite) and dolostone (mainly dolomite). In carbonates, formation resistivities tend to vary widely with changing rock types, and commonly there are few shales against which to measure changes. In this case, the porosity log is the primary reconnaissance measurement. By first finding the porous zones, the zones with the capacity to hold fluids (of any type) can be identified. The carbonates branch of process 612 may include looking for porosity. A low porosity may indicate a tight formation which can be excluded as a zone of interest. If the porosity is high, process 612 may check the resistivity. A low resistivity may indicate a water zone which can be used as a baseline (wet) comparison. If the resistivity is high, process 612 may identify the zone as a zone of interest. After a zone of interest has been identified, process 612 may proceed with the detailed analysis.

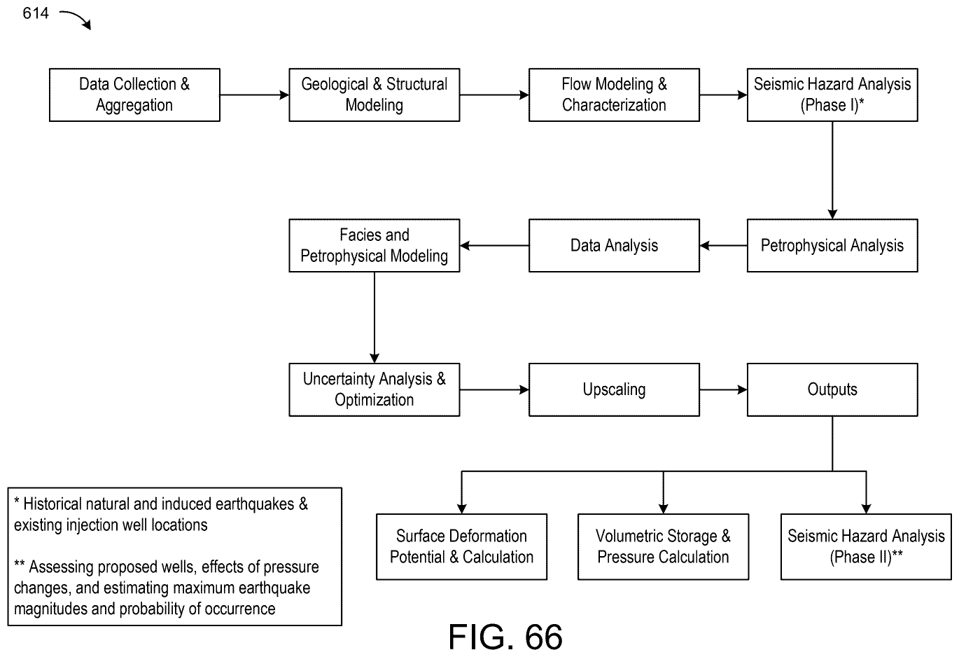

Referring now to FIG. 66, a flowchart of process 614 for constructing and using the various models described throughout the present disclosure is shown, according to an exemplary embodiment. In some embodiments, computing system 110 performs process 614 to construct one or more of the models or equations described with reference to FIG. 12 and other data sources 516. Process 614 can be performed by one or more components of computing system 110 as described with reference to FIG. 5.

Process 614 begins with data collection and aggregation, which may include data collector 526 obtaining data from any of data sources 502. Process 614 may use the collected data for geological and structural modeling and flow modeling and characterization. For example, process 614 may include using the collected data to generate and of the hydrologic models, geotechnical seismic models, pore pressure models, or reservoir characterization and dynamic flow models described with reference to FIG. 12. In some embodiments, process 614 includes using the collected data to generate the training data used by model trainer 530 to train AI model 534. Process 614 may include training AI model 534 to perform any of the types of modeling or predictions described herein.

Process 614 may use the constructed models to perform the first phase of seismic hazard analysis. The first phase of seismic hazard analysis may include analyzing historical natural and induced earthquakes and existing injection well locations to identify or derive correlations between these data. In some embodiments, the first phase of seismic hazard analysis includes training AI model 534 to predict the risk of induced seismic events based on the historical training data generated by training data generator 528. The first phase of seismic hazard analysis may include configuring AI model 534 to learn the relative importance or contribution of each factor analyzed to causing induced seismic events.

Process 614 is shown to include petrophysical analysis, data analysis, facies and petrophysical modeling, and uncertainty analysis and optimization. Petrophysical analysis may include evaluating the physical and chemical properties of the rock formations and fluids as well as their interactions. Petrophysical analysis can be used to evaluate the potential of a reservoir to produce oil and gas. Facies modeling may include creating a 3D representation of different rock types (facies) within a geological reservoir based on their depositional environment and characteristics. Petrophysical modeling may include using well log data and other measurements to estimate the reservoir's physical properties such as porosity, permeability, and saturation within each facies. Petrophysical modeling may be used to create a detailed model of the reservoir's fluid flow potential across different rock types. Uncertainty analysis and optimization may include scenarios generator 536 as described above to generate various hypothetical scenarios and generating optimal control plans for each scenario.

Process 614 may include upscaling any of the results or model predictions generated to increase the resolution of the predictions. The upscaled results can then be presented as outputs 552 as described above. Examples of such outputs 552 include surface deformation potentials, volumetric storage and pressures, and seismic hazard analysis. The seismic hazard analysis provided as outputs 552 in process 614 may include a second phase of seismic hazard analysis that involves assessing proposed wells, the effects of pore pressure changes, and estimating maximum earthquake magnitudes and probability of occurrence. The second phase of seismic hazard analysis may include generating any of the outputs 552 (e.g., maps 554, flow models 556, pressure tracking outputs 558, charts 560, alerts 562, analytics 564, user interfaces 566, etc.) described with reference to FIGS. 13-58.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also, two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

What is claimed is:

1. A system for predicting and controlling induced seismic events, the system comprising:
one or more processors; and
one or more non-transitory computer-readable storage media storing instructions that, when executed by the one or more processors, cause the one or more processors to perform operations comprising:
training a predictive model to learn a relationship between (i) well parameters of one or more historical wells that operate to inject fluid into underground geological formations or produce fluid from the underground geological formations within a geographic area during a historical time period and (ii) seismic events occurring within the geographic area during the historical time period;
using the predictive model to predict a new seismic event predicted to occur within the geographic area during a future time period as a result of operating one or more controlled wells to inject fluid into the underground geological formations or produce fluid from the underground geological formations within the geographic area during the future time period; and
adjusting the one or more controlled wells to prevent the new seismic event from occurring or mitigate an impact of the new seismic event during the future time period.

2. The system of claim 1, wherein:
the predictive model comprises an artificial intelligence (AI) model;
using the predictive model to predict the new seismic event comprises using the AI model to quantify a predicted occurrence of the new seismic event during the future time period; and
quantifying the predicted occurrence of the new seismic event comprises generating predicted values of at least one of a likelihood of the new seismic event occurring during the future time period, a magnitude of the new seismic event, a location of the new seismic event, or the impact of the new seismic event.

3. The system of claim 1, wherein adjusting the one or more controlled wells comprises adjusting at least one of an injection volume, a production volume, an injection rate, a production rate, an injection time, a production time, or an operating pressure of the one or more controlled wells during the future time period.

4. The system of claim 1, wherein adjusting the one or more controlled wells comprises providing control signals or recommendations to one or more controllers or operators that operate wellsite equipment of the one or more controlled wells during the future time period.

5. The system of claim 1, wherein:
training the predictive model comprises determining respective amounts that the well parameters contribute toward causing the seismic events; and
using the predictive model to predict the new seismic event comprises evaluating new well parameters of the one or more controlled wells using the respective amounts to quantify a predicted occurrence of the new seismic event during the future time period.

6. The system of claim 1, wherein:
the one or more controlled wells comprise one or more of the historical wells; and
adjusting the one or more controlled wells comprises adjusting operation of the one or more historical wells to reduce a hazard determined by the predictive model of the new seismic event occurring during the future time period.

7. The system of claim 1, wherein:
the one or more controlled wells comprise one or more additional wells separate from the one or more historical wells; and
adjusting the one or more controlled wells comprises adjusting at least one of (i) one or more locations of the one or more additional wells or (ii) operation of the one or more additional wells, to reduce a hazard determined by the predictive model of the new seismic event occurring during the future time period.

8. The system of claim 1, wherein:
the one or more controlled wells comprise one or more new wells to be constructed within the geographic area; and
adjusting the one or more controlled wells comprises determining optimal locations at which to construct the one or more new wells to reduce a hazard determined by the predictive model of the new seismic event occurring during the future time period.

9. The system of claim 1, the operations comprising:
using the predictive model to determine a hazard of the new seismic event occurring during the future time period based on new well parameters of the one or more controlled wells; and
determining optimal values of the new well parameters based on the hazard of the new seismic event occurring during the future time period.

10. The system of claim 9, wherein determining the optimal values of the new well parameters comprises at least one of:
performing an optimization of a first objective function that quantifies a performance of the one or more controlled wells subject to a first constraint that requires the hazard determined by the predictive model to be maintained below a hazard threshold; or
performing an optimization of a second objective function that quantifies a control objective based on the hazard determined by the predictive model subject to a second constraint that requires the performance of the one or more controlled wells to be maintained above a performance threshold.

11. A method for predicting and controlling induced seismic events, the method comprising:
training a predictive model to learn a relationship between (i) well parameters of one or more historical wells that operate to inject fluid into underground geological formations or produce fluid from the underground geological formations within a geographic area during a historical time period and (ii) seismic events occurring within the geographic area during the historical time period;
using the predictive model to predict a new seismic event predicted to occur within the geographic area during a future time period as a result of operating one or more controlled wells to inject fluid into the underground geological formations or produce fluid from the underground geological formations within the geographic area during the future time period; and
adjusting the one or more controlled wells to prevent the new seismic event from occurring or mitigate an impact of the new seismic event during the future time period.

12. The method of claim 11, wherein:
the predictive model comprises an artificial intelligence (AI) model;
using the predictive model to predict the new seismic event comprises using the AI model to quantify a predicted occurrence of the new seismic event during the future time period; and
quantifying the predicted occurrence of the new seismic event comprises generating predicted values of at least one of a likelihood of the new seismic event occurring during the future time period, a magnitude of the new seismic event, a location of the new seismic event, or the impact of the new seismic event.

13. The method of claim 11, wherein adjusting the one or more controlled wells comprises adjusting at least one of an injection volume, a production volume, an injection rate, a production rate, an injection time, a production time, or an operating pressure of the one or more controlled wells during the future time period.

14. The method of claim 11, wherein adjusting the one or more controlled wells comprises providing control signals or recommendations to one or more controllers or operators that operate wellsite equipment of the one or more controlled wells during the future time period.

15. The method of claim 11, wherein:
training the predictive model comprises determining respective amounts that the well parameters contribute toward causing the seismic events; and
using the predictive model to predict the new seismic event comprises evaluating new well parameters of the one or more controlled wells using the respective amounts to quantify a predicted occurrence of the new seismic event during the future time period.

16. The method of claim 11, wherein:
the one or more controlled wells comprise one or more of the historical wells; and
adjusting the one or more controlled wells comprises adjusting operation of the one or more historical wells to reduce a hazard determined by the predictive model of the new seismic event occurring during the future time period.

17. The method of claim 11, wherein:
the one or more controlled wells comprise one or more additional wells separate from the one or more historical wells; and
adjusting the one or more controlled wells comprises adjusting at least one of (i) one or more locations of the one or more additional wells or (ii) operation of the one or more additional wells, to reduce a hazard determined by the predictive model of the new seismic event occurring during the future time period.

18. The method of claim 11, wherein:
the one or more controlled wells comprise one or more new wells to be constructed within the geographic area; and
adjusting the one or more controlled wells comprises determining optimal locations at which to construct the one or more new wells to reduce a hazard determined by the predictive model of the new seismic event occurring during the future time period.

19. The method of claim 11, comprising:
using the predictive model to determine a hazard of the new seismic event occurring during the future time period based on new well parameters of the one or more controlled wells; and
determining optimal values of the new well parameters based on the hazard of the new seismic event occurring during the future time period.

20. The method of claim 19, wherein determining the optimal values of the new well parameters comprises at least one of:
performing an optimization of a first objective function that quantifies a performance of the one or more controlled wells subject to a first constraint that requires the hazard determined by the predictive model to be maintained below a hazard threshold; or
performing an optimization of a second objective function that quantifies a control objective based on the hazard determined by the predictive model subject to a second constraint that requires the performance of the one or more controlled wells to be maintained above a performance threshold.
